(19) United States
(12) Patent Application Publication
(10) Pub. No.: US 2013/0189592 A1
(43) Pub. Date: Jul. 25, 2013

(54) PART SOLID, PART FLUID AND FLOW ELECTROCHEMICAL CELLS INCLUDING METAL-AIR AND LI-AIR BATTERY SYSTEMS

(71) Applicants: Farshid ROUMI, Irvine, CA (US); Jamshid ROUMI, Irvine, CA (US)

(72) Inventors: Farshid ROUMI, Irvine, CA (US); Jamshid ROUMI, Irvine, CA (US)

(21) Appl. No.: 13/724,479

(22) Filed: Dec. 21, 2012

Related U.S. Application Data
(63) Continuation-in-part of application No. 13/229,479, filed on Sep. 9, 2011.
(60) Provisional application No. 61/381,400, filed on Sep. 9, 2010.
(60) Provisional application No. 61/416,193, filed on Nov. 22, 2010.
(60) Provisional application No. 61/467,112, filed on Mar. 24, 2011.
(60) Provisional application No. 61/598,467, filed on Feb. 14, 2012.
(60) Provisional application No. 61/607,324, filed on Mar. 6, 2012.
(60) Provisional application No. 61/579,782, filed on Dec. 23, 2011.

(51) Int. Cl. H01G 9/048; H01M 4/86; H01G 11/26; H01M 8/20; H01M 8/18; H01M 12/06; H01M 4/02

(52) U.S. Cl. CPC H01G 9/048; H01M 12/065; H01M 4/86; H01M 4/02; H01M 8/20; H01M 8/188; H01G 11/26
USPC 429/406; 429/405; 429/523; 429/149; 429/531; 429/528; 429/527; 429/524; 429/503; 429/504; 429/505; 429/482; 429/498; 361/502; 361/500

(57) ABSTRACT

The invention provides part solid, part fluid and flow electrochemical cells, for example, metal-air and lithium-air batteries and three-dimensional electrode arrays for use in part solid, part fluid electrochemical and flow cells and metal-air and lithium-air batteries.

### CROSS-REFERENCE TO RELATED APPLICATIONS

This application is a continuation-in-part of U.S. nonprovisional patent application Ser. No. 13/229,479, filed Sep. 9, 2011, which claims the benefit of, and priority to, U.S. Provisional Application No. 61/381,400, filed on Sep. 9, 2010, U.S. Provisional Application No. 61/416,193, filed on Nov. 22, 2010, and U.S. Provisional Application No. 61/467,112 filed on Mar. 24, 2011; and this application also claims the benefit of, and priority to, U.S. Provisional Application No. 61/598,467, filed Feb. 14, 2012, U.S. Provisional Application No. 61/607,324, filed Mar. 6, 2012, and U.S. Provisional Application No. 61/579,782, filed Dec. 23, 2011, all of which are hereby incorporated by reference in their entireties to the extent not inconsistent with the present description.

### BACKGROUND OF INVENTION

Over the last few decades revolutionary advances have been made in electrochemical storage and conversion devices expanding the capabilities of these systems in a variety of fields including portable electronic devices, air and space craft technologies, passenger vehicles and biomedical instrumentation. Current state of the art electrochemical storage and conversion devices have designs and performance attributes that are specifically engineered to provide compatibility with a diverse range of application requirements and operating environments. For example, advanced electrochemical storage systems have been developed spanning the range from high energy density batteries exhibiting very low self-discharge rates and high discharge reliability for implanted medical devices to inexpensive, light weight rechargeable batteries providing long runtimes for a wide range of portable electronic devices to high capacity batteries for military and aerospace applications capable of providing extremely high discharge rates over short time periods.

Despite the development and widespread adoption of this diverse suite of advanced electrochemical storage and conversion systems, significant pressure continues to stimulate research to expand the functionality of these systems, thereby enabling an even wider range of device applications. Large growth in the demand for high power portable electronic products, for example, has created enormous interest in developing safe, light weight primary and secondary batteries providing higher energy densities. In addition, the demand for miniaturization in the field of consumer electronics and instrumentation continues to stimulate research into novel design and material strategies for reducing the sizes, masses and form factors of high performance batteries. Further, continued development in the fields of electric vehicles and aerospace engineering has also created a need for mechanically robust, high reliability, high energy density and high power density batteries capable of good device performance in a useful range of operating environments.

Many recent advances in electrochemical storage and conversion technology are directly attributable to discovery and integration of new materials for battery components. Lithium battery technology, for example, continues to rapidly develop, at least in part, due to the discovery of novel electrode and electrolyte materials for these systems. The element lithium has a unique combination of properties that make it attractive for use in an electrochemical cell. First, it is the lightest metal in the periodic table having an atomic mass of 6.94 AMU. Second, lithium has a very low electrochemical oxidation/reduction potential (i.e., −3.045 V vs. NHE (normal hydrogen reference electrode)). This unique combination of properties enables lithium based electrochemical cells to have very high specific capacities. State of the art lithium ion secondary batteries provide excellent charge-discharge characteristics, and thus, have also been widely adopted as power sources in portable electronic devices, such as cellular telephones and portable computers. U.S. Pat. Nos. 6,852,446, 6,306,540, 6,489,055, and “Lithium Batteries Science and Technology” edited by Gholam-Abbas Nazri and Gianfranceo Pistoia, Kluer Academic Publishers, 2004, are directed to lithium and lithium ion battery systems which are hereby incorporated by reference in their entireties.

Metal air batteries are energy storage devices that have a solid anode part and a non-solid cathode active material, here oxygen. See, for example, U.S. Pat. No. 3,607,422. Metal air batteries are interesting energy storage systems due their high energy densities as the result of not carrying the cathode active material, oxygen, in the cell.

Advances in electrode structure and geometry have also recently developed. For example, U.S. Patent Application Publication US 2011/0171518 and International Patent Application publication WO 2010/007579 disclose three-dimensional battery structure for solid-state lithium ion batteries. U.S. Pat. No. 7,553,584 and U.S. Patent Application Publication US 2003/0099884 disclose quasi-three-dimensional batteries in which the electrodes are formed as complementary structures. These structures, however, may not be the best answer to be applied to part solid-part fluid electrochemical cells such as in metal air batteries or lithium water batteries or semi-solid batteries or metal-metal based redox flow couple batteries. Additionally, U.S. Patent Application Publications US 2009/0208834 A1, US 2009/0214956 A1, US 2011/0027648 A1, US 2011/0183186 A1, US 2011/0171518 A1 disclose electrode systems.

Further, these so called 3-dimensional designs of the batteries are limited to very small scales and have major problems to scale up both in terms of the fabrication time and cost and also technology limitations, Chem. Rev. 2004, 104, 4463-4492, J. Mater. Chem., 2011, 21, 9876, Nano Lett., 2012, 12 (3), pp 1198-1202, http://hdl.handle.net/10062/25375. Most of these batteries are also limited to use solid electrolytes such as by conformal coating.

Recently, semi-solid batteries are suggested, US 2010/0047671 A1, Adv. Energy Mater., 1, 511 (2011), J. Electrochem. Soc. 2012, Volume 159, Issue 8, Pages A1360-A1367, J. Solid State Electrochem. (2012) 16:2019-2029, J. Appl. Electrochem. (2011) 41:1137-1164. Although the chemistries are different from flow batteries, the structure is similar. These designs are stated to have the potential advantage of higher energy density compared to traditional flow batteries by allowing higher concentrations of active materials in the flow. However, the high viscosity of semi-solid electrodes may result in the need for strong pumps which can cause energy losses. In addition, scaling up of such designs is still based on the parallel plate structure. This further limits the size of the cells, especially due to inhomogeneous heat and electric (electronic and ionic) conductivities of the parallel plate design.

Recently, novel semi-solid batteries are suggested, US 2010/0047671 A1, Adv. Energy Mater., 1, 511 (2011), J. Electrochem. Soc. 2012, Volume 159, Issue 8, Pages A1360-A1367, J. Solid. State. Electrochem. (2012) 16:2019-2029, J. Appl. Electrochem. (2011) 41:1137-1164. Although the chemistries are different from flow batteries, the physical structure has not changed. These designs are stated to have the potential advantage of higher energy density compared to traditional flow batteries by allowing higher concentrations of active materials in the flow. However, the high viscosity of semi-solid electrodes may result in the need of strong pumps which can cause energy losses. In addition, scaling-up of such designs is still based on the parallel plate structure. This further limits the size of the cells, especially due to inhomogeneous heat and electric (electronic and ionic) conductivities of the parallel plate design.

Molten salt batteries such as NaS have also been suggested for energy storage systems, such as batteries. Still these inventions use the common parallel plate architecture that has inherent limitations. Solvated electrode batteries have also been suggested, such as in US Patent Application Publication US 2010/0266907 A1 and J. Phys. Chem. B, 2012, 116 (30), pp 9056-9060, but they are also based on a parallel plate architecture.

In addition, a major requirement of energy storage systems is cycle life. Current electrochemical systems such as batteries, especially at high charging-discharging rates may lose their cycle life earlier than is needed by some applications. Some examples are electric powered vehicles and utility energy storage application.

The current parallel plate design of electrochemical cells can result in uneven distribution of heat inside the cell, especially in thicker cells. The temperature inhomogeneity inside a cell and the electrodes can result in shorter life cycles by mechanisms such as hot spots. This may even result in failure of the cell that in some cases can cause fires and explosions and can be hazardous.

One major drawback of current parallel plate electrochemical cells is the loss of performance, especially energy density and power density, when making packs and modules by connecting cells in parallel and series. As an example li-ion battery packs have energy density and power densities of about 50% of that at the cell level which is itself about 50% of that of the active materials in the cell, resulting in only about 25% of the energy density and power density available by the active materials.

Monitoring the state of charge or state of health of electrochemical cell such as batteries is very useful in not only making these systems but also during their applications as means to properly load and unload the energy storage systems. See for example U.S. Patent Application Publication US 2012/0263986 A1 and US 2010/0090650 A1. This can be done by implementing on reference electrodes in the cells. However, it is generally a difficult task to place a reference electrode in a parallel plate cell.

### SUMMARY OF THE INVENTION

This invention is in the field of energy storage. This invention relates generally to an electrode array for use in energy storage and energy generation devices.

In a first aspect, provided are three-dimensional electrode arrays. In certain embodiments, the three-dimensional electrode array is a component of a part solid, part fluid electrochemical cell, such as a metal-air battery system like a lithium-air battery or zinc-air battery, or a metal-aqueous battery system, such as a lithium-water battery. In an embodiment, a three-dimensional electrode array comprises a plurality of plate electrodes, wherein each plate electrode includes an array of apertures, wherein the plate electrodes are arranged in a substantially parallel orientation such that the each aperture of an individual plate electrode is aligned along an alignment axis passing through an aperture of each of one or more or all other plate electrodes; and a plurality of rod electrodes, wherein the plurality of rod electrodes are in physical contact with the plurality of plate electrodes and arranged such that each rod electrode extends a length along an alignment axis passing through an aperture of each plate electrode; and wherein a first surface area includes a cumulative surface area of the plurality of plate electrodes, wherein a second surface area includes a cumulative surface area of each aperture array and wherein a third surface area includes a cumulative surface area of each of the plurality of rod electrodes. In a specific embodiment, at least some rod electrodes are not in electrical contact with the plurality of plate electrodes.

In embodiments, the three-dimensional electrode array is a component of a device selected from the group consisting of: a primary electrochemical cell, a secondary electrochemical cell, a fuel cell, a capacitor, a supercapacitor, a flow battery, a metal-air battery and a semi-solid battery.

Three-dimensional electrode arrays of this aspect include those having a variety of geometries and physical dimensions. Useful three-dimensional electrode arrays include those in which a ratio of the second surface area to the first surface area is about 2 or is selected over the range of 1 to 5 or is selected over the range of 0.2 to 1. Useful three-dimensional electrode arrays include those in which a ratio of the second surface area to the third surface area is about 2, is selected over the range of 1 to 5 or is selected over the range of 0.2 to 1. Three-dimensional electrode arrays having a ratio of the second surface area to the third surface area selected over the range of 1 to 5 are optionally useful for electrochemical cell embodiments. Three-dimensional electrode arrays having a ratio of the second surface area to the third surface area selected over the range of 0.2 to 1 are optionally useful for flow battery embodiments, fuel cell embodiments and semisolid battery embodiments. In certain embodiments, the optimal ratios are dependent upon the chemistries of the materials used. In one embodiment, the optimal ratios depend upon the ionic transport, electronic transport and mechanical behavior of the materials used.

Three-dimensional electrode arrays of this aspect include those having any orientation. For example, in one embodiment, a three-dimensional electrode array is arranged such that the plate electrodes have a horizontal orientation. In another embodiment, however, a three-dimensional electrode array is arranged such that the plate electrodes have a vertical orientation. In one embodiment, a three-dimensional electrode array is arranged such that the rod electrodes have a horizontal orientation. In another embodiment, however, a three-dimensional electrode array is arranged such that the rod electrodes have a vertical orientation.

Three-dimensional electrode arrays of this aspect include those having plate electrodes with a variety of geometries and physical dimensions. Optionally, each plate electrode in a three-dimensional electrode array has identical or substantially identical dimensions. In certain embodiments, however, the dimensions of each plate electrode are independent. Optionally, each of the plurality of plate electrodes has one or more lateral dimensions (e.g., length, width) of about 2 cm, or selected over the range of 20 nm to 20 m or selected over the range of 5 mm to 1 m. In certain embodiments, each of the plurality of plate electrodes has a thickness dimension selected over the range of 20 nm to 5 cm or selected over the range of 200 μm to 5 mm. In certain embodiments, a distance between each of the plurality of plate electrodes is selected over the range of 10 nm to 5 cm or selected over the range of 200 μm to 5 mm. In certain embodiments, each aperture in a plate electrode has a diameter or a lateral dimension selected over the range of 10 nm to 20 cm or selected over the range of 0.5 mm to 2 cm or selected over the range of 200 μm to 2 cm. In certain embodiments, each aperture in a plate electrode has a diameter or a lateral dimension selected over the range of 10 nm to 20 cm or selected over the range of 3 mm to 2 cm or selected over the range of 1 mm to 2 cm. Optionally, each aperture in a plate electrode has identical or substantially identical (e.g. within a factor of 1.5) dimensions and/or shapes. Optionally, each aperture has a lateral dimension of the same order of magnitude as a lateral dimension of a rod electrode, for example, each aperture has a lateral dimension within a factor of 2 of a lateral dimension of a rod electrode. In certain embodiments, however, the dimensions and/or shape of each aperture in a plate electrode are independent. Optionally, the dimensions and/or shape of each aperture of each plate electrode are independent. Useful aperture shapes include, but are not limited to, square, rectangular, circular and polygonal. As used herein, the terms aperture and hole are used interchangeably.

Three-dimensional electrode arrays of this aspect include those having rod electrodes with a variety of geometries and physical dimensions. Optionally, each rod electrode in a three-dimensional electrode array has identical or substantially identical dimensions. In certain embodiments, however, the dimensions of each rod electrode are independent. Optionally, each rod electrode has a circular cross-section. Optionally, each rod electrode has a non-circular or polygonal cross-section. Useful rod electrode cross-sectional shapes include, but are not limited to, square, rectangular, circular and polygonal. In an embodiment, each of the plurality of rod electrodes has a length selected over the range of 50 nm to 20 m or selected over the range of 5 mm to 1 m. In embodiments, each of the plurality of rod electrodes has a diameter or a lateral dimension selected over the range of 9 nm to 20 cm or selected over the range of 0.5 mm to 2 cm or selected over the range of 200 μm to 2 cm. Optionally for some applications each of the plurality of rod electrodes has a diameter or a lateral dimension selected over the range 3 mm to 2 cm or selected over the range of 1 mm to 2 cm. Optionally, at least one rod electrode comprises a group of rod electrodes, wherein the group of rod electrodes is arranged such that the group of rod electrodes extends a length along an alignment axis passing through an aperture of each plate electrode. Optionally, each rod electrode comprises a cylinder. Optionally one or more rod electrodes of the array and/or electrochemical cell is a hollow electrode, for example, have a central cavity extending at least a portion of a primary central axis of the rod electrode. Optionally one or more rod electrodes of the array and/or electrochemical cell is a porous electrode, for example, wherein each of the rod electrodes independently has a porosity selected from the range of 20% to 95%, preferably for some applications a porosity selected from the range of 50% to 95%.

Three-dimensional electrode arrays of the invention also work for nanometer scales, for example, electrodes having one or more physical dimensions (e.g., diameter, length, width, etc.) with dimensions selected from the range of 10 nm to 1000 nm. In an embodiment, a three-dimensional electrode array comprises one or more rod having one or more physical dimensions (e.g., diameter, length, width, etc.) with dimensions selected from the range of 10 nm to 1000 nm. In an embodiment, a three-dimensional electrode array comprises one or more plate having one or more physical dimensions (e.g., diameter, length, width, etc.) with dimensions selected from the range of 10 nm to 1000 nm, such as a plate with one or more physical dimensions (e.g., thickness, length, width, etc.) with dimensions selected from the range of 10 nm to 1000 nm, and/or a plate with one or more apertures having one or more physical dimensions (e.g., diameter, length, width, etc.) with dimensions selected from the range of 10 nm to 1000 nm.

In an embodiment, for example, the invention provides a part fluid electrochemical cell wherein the number of plates is more than 2. In an embodiment, for example, the invention provides a part fluid electrochemical cell wherein the number of anode rods is more than 2. In an embodiment, for example, the invention provides a part fluid electrochemical cell wherein the number of cathode rods is more than 2. In an embodiment, for example, the invention provides a part fluid electrochemical cell wherein the there is one plate and there are at least one anode rod and at least one cathode rod. In an embodiment, for example, the invention provides a part fluid electrochemical cell wherein the there is no plate and there are at least one anode rod and at least one cathode rod. In an embodiment, for example, the invention provides a part fluid electrochemical cell wherein the anode and cathode are interchanged.

Three-dimensional electrode arrays of this aspect include those comprising any of a variety of materials. Useful electrode materials include those used in primary electrochemical cells, secondary electrochemical cells, fuel cells, capacitors and supercapacitors. In embodiments, each plate electrode in a three-dimensional electrode array independently comprises a material selected from the group consisting of: a metal, a metal alloy, carbon, graphite, graphene, Li, Mn₂O₄, MnO₂, Pb, PbO₂, Na, S, Fe, Zn, Ag, Ni, Sn, Ge, Si, Sb, Bi, NiOOH, Cd, FeS₂, LiCoO₂, LiCoO₂ doped with Mg, LiNiO₂, LiMn₂O₄, LiMnO₂, LiMnO₂ doped with Al, LiFePO₄, doped LiFePO₄ (Mg, Al, Ti, Nb, Ta), amorphous carbon, mescocarbon microbeads, LiAl, Li₉Al₄, Li₃Al, LiZn, LiAg, Li₁₀Ag₃, B, Li₇B₆, Li₁₂Si₇, Li₁₃Si₄, Sn, LiSSn₂, Li₁₃SnS, Li₇S₂, Li₂₂SnS, Li₂Sb, Li₃Sb, LiBi, Li₃Bi, SnO₂, SnO, MnO, Mn₃O₄, CoO, NiO, FeO, LiFe₂O₄, TiO₂, LiTi₂O₄, a vanadium oxide, glass doped with a Sn—B—P—O compound, mesocarbon microbeads coated with at least one of poly(o-methoxyanaline, poly(3octylthiophene) and poly(vinylidene fluoride) and any combination of these. In certain embodiments, each plate electrode in a three-dimensional electrode array independently comprises a material with high electronic conductivity (e.g., greater than or equal to 10⁻² S/cm, preferably more than 1 S/cm) and optionally also with high ionic conductivity (e.g., greater than or equal to 10⁻⁴ S/cm, preferably more than 10⁻² S/cm). Coatings such as conductive carbon and substrates such as metallic current collectors are optionally used to achieve good conductivities. For example, in some embodiments, each plate electrode in a three-dimensional electrode array independently comprises a material selected from the group consisting of: carbon, graphite, graphene, catalyzed carbon, nanocarbon, Ketjen black, porous ZrO₂, porous metals such as porous Ni, porous Cu, porous Al, porous Ti, or their alloys or a metal mesh such as Cu mesh, Ni mesh, Al mesh, Ti mesh or their alloys and any combination of these. In embodiments, the terms “porous” and “pores” as used herein are differentiated from perforated holes. For example, perforated holes are substantially larger than the pores and are optionally round and placed in a periodic arrangement. Pores, on the other hand, generally increase the surface area of the conductive element, for example, to facilitate the reaction between solvated oxygen in the electrolyte and the lithium ion in the electrolyte. Optionally, each plate electrode in a three-dimensional electrode array comprises a porous material having a sufficient porosity to permit the transmission of a gas, such as O₂, through the material or to provide for large surface areas, for example, independently having a porosity selected from the range of 20% to 95%, preferably for some applications a porosity selected from the range of 50% to 95%. Optionally, each plate electrode in a three-dimensional electrode array comprises identical or substantially identical materials. In certain embodiments, however, the materials of two or more plate electrodes in a three-dimensional electrode array are different. In certain embodiments, electrical communication is established between each of the plurality of plate electrodes. Optionally, a plate electrode comprises lithium; a lithium alloy such as lithium-aluminum, lithium-tin, lithium-magnesium, lithium-lead, lithium-zinc or lithium-boron; an alkali metal such as Na, K, Rb or Cs; an alkaline earth metals such as Be, Mg, Ca, Sr, Ba or an alloy thereof; Zn or an alloy of Zn; or Al or an alloy of Al. Additional materials used in metal air batteries are further described in: Nature Material, 11, 19-29 (2012), J. Electrochem. Soc. 2011, Volume 159, Issue 2, Pages R1—R30, Electrochemistry Communications 14 (2012) 78-81, ACS Appl. Mater. Interfaces, 2012, 4 (1), pp 49-52, CARBON50 (2012) 727-733, ACS Catal., 2012, 2 (5), pp 844-857, Science, 3 Aug. 2012, Vol. 337 no. 6094 pp. 563-566, Chem. Soc. Rev., 2012, 41, 2172, Nature Chemistry 4, 579-585, ChemSusChem 2012, 5, 177-180, which are hereby incorporated by reference to the extent not inconsistent herewith.

Optionally, a three-dimensional electrode array comprises a component of a fuel cell. In one embodiment, the three-dimensional electrode array further comprises a fuel fluid, such as hydrogen gas or a hydrogen-containing gas or a liquid hydrocarbon fuel, positioned in contact with one or more plate electrodes, one or more rod electrodes, or both of one or more plate electrodes and one or more rod electrodes. In an embodiment, the three-dimensional electrode array further comprises an oxygen containing fluid, such as oxygen gas or air or water or a flow of particles of redox couple in an aqueous or aprotic solution such as ironcyanide in water, or a flow of semisolid active materials such as LiFePO₄ in a fluid electrolyte such as PC or DMC, positioned in contact with one or more plate electrodes, one or more rod electrodes or both one or more plate electrodes and one or more rod electrodes. Optionally, a flow is provided to the fuel fluid, for example, by a pump. Optionally, a flow is provided to the oxygen containing fluid, for example, by a pump.

Optionally, the three-dimensional electrode array comprises a component of a part solid, part fluid electrochemical cell, such as a metal-air battery system including a lithium-air battery or zinc-air battery, or a metal-aqueous battery system, such as a lithium-water battery. In one embodiment, at least one rod electrode comprises a metal or an alloy or at least one plate electrodes comprises a metal or an alloy or both at least one rod electrode and at least one plate electrode comprise a metal or an alloy. In certain embodiments, at least one plate electrode or at least one rod electrode comprises a semi-solid electrode, including metallic particles suspended in an electrolyte. In these and other embodiments, an electrochemical cell comprising such a semi-solid electrode is optionally mechanically recharged, for example by replacing the spent electrolyte and metallic particle suspension with fresh electrolyte and metallic particle suspension.

In an embodiment, the three-dimensional electrode array further comprises an oxygen containing fluid, such as oxygen gas or air, positioned in contact with one or more plate electrodes, one or more rod electrodes or both one or more plate electrodes and one or more rod electrodes. Optionally, a flow is provided to the oxygen containing fluid, for example, by a pump. Optionally, one or more rod electrodes comprises an electrochemical catalyst.

In embodiments, one or more rod electrodes in a three-dimensional electrode array independently comprises a material selected from the group consisting of: a metal, a metal alloy, carbon, graphite, graphene, Li, Mn₂O₄, MnO₂, Pb, PbO₂, Na, S, Fe, Zn, Ag, Ni, Sn, Ge, Si, Sb, Bi, NiOOH, Cd, FeS₂, LiCoO₂, LiCoO₂ doped with Mg, LiNiO₂, LiMn₂O₄, LiMnO₂, LiMnO₂ doped with Al, LiFePO₄, doped LiFePO₄ (Mg, Al, Ti, Nb, Ta), amorphous carbon, mescocarbon microbeads, LiAl, Li₉Al₄, Li₃Al, LiZn, LiAg, Li₁₀Ag₃, B, Li₇B₆, Li₁₂Si₇, Li₁₃Si₄, Sn, LiSSn₂, Li₁₃SnS, Li₇Sn₂, Li₂₂SnS, Li₂Sb, Li₃Sb, LiBi, Li₃Bi, SnO₂, SnO, MnO, Mn₃O₄, CoO, NiO, FeO, LiFe₂O₄, TiO₂, LiTi₂O₄, a vanadium oxide, glass doped with a Sn—B—P—O compound, mesocarbon microbeads coated with at least one of poly(o-methoxyanaline, poly(3octylthiophene) and poly(vinylidene fluoride) and any combination of these. In embodiments, one or more rod electrodes in a three-dimensional electrode array independently comprises a material with very high electronic conductivity. For example, in embodiments, one or more rod electrodes in a three-dimensional electrode array independently comprises carbon, graphite, graphene, catalized carbon, nanocarbon, Ketjen black, porous ZrO₂, porous metals such as porous Ni, porous Cu, porous Al, porous Ti, or their alloys or a metal mesh such as Cu mesh, Ni mesh, Al mesh, Ti mesh or their alloys or any combination of these. Optionally, each rod electrode in a three-dimensional electrode array comprises identical or substantially identical materials. In certain embodiments, however, the materials of two or more rod electrodes in a three-dimensional electrode array are different. In embodiments, electrical communication is established between a plurality of rod electrodes. Optionally, a rod electrode comprises lithium; a lithium alloy such as lithium-aluminum, lithium-tin, lithium-magnesium, lithium-lead, lithium-zinc or lithium-boron; an alkali metal such as Na, K, Rb or Cs; an alkaline earth metals such as Be, Mg, Ca, Sr, Ba or an alloy thereof; Zn or an alloy of Zn; or Al or an alloy of Al; or Si or its alloys; or Sn and it alloys; or carbon or graphite or nanocarbon or graphene or any other typical anode materials in an electrochemical cell or any combination thereof.

In certain embodiments, a rod electrode is a hollow rod comprising a porous material, for example a hollow carbon rod. Optionally, a rod electrode in a three-dimensional electrode array comprises a hollow porous material having a sufficient porosity to permit the transmission of a flow of an oxidant through the material, such as a gas, such as O₂ or an O₂ containing gas, or water or peroxide or a fluid oxidant such as metals (such as Fe, Cu, Mn, Cr, Pb, Sn, Al) or alloys or metal based redox couples in an solution such as iron cyanide in water or a semi solid cathode material such as LiFePO₄ particles in a solution, such as in a non-aqueous lithium battery electrolyte or sulfur. In one embodiment, an oxidant fluid is introduced into the hollow region of a hollow rod, wherein at least a portion of the fluid permeates through the porous material comprising the hollow rod, such as a gas, such as O₂ or an O₂-containing gas, or water or peroxide or a fluid oxidant such as metals (such as Fe, Cu, Mn, Cr, Pb, Sn, Al) or alloys or metal based redox couples in an solution such as iron cyanide in water or a semi solid cathode material such as LiFePO₄ particles in a solution such as in a non-aqueous lithium battery electrolyte or sulfur.

In an exemplary embodiment, at least one rod electrode comprises a composite rod electrode. Useful composite rod electrodes include those comprising a rod electrode inner core and a rod electrode outer shell surrounding the rod electrode inner core. Optionally, the rod electrode inner core and the rod electrode outer shell are separated by a first distance, for example, filled with an electrolyte. Optionally, a composite rod electrode comprises an electrochemical cell. Optionally a rod electrode inner core comprises a solid cylinder. Optionally a rod electrode outer shell comprises a hollow cylinder. In one embodiment, the rod electrode inner core comprises a first electrode material, the rod electrode outer shell comprises a second electrode material different from the first electrode material, and at least one plate electrode comprises the first electrode material. Optionally, in embodiments, an oxidant fluid is introduced into one or more regions of a composite rod electrode, wherein at least a portion of the fluid permeates through one or more materials of the composite rod electrode, such as a gas, such as O₂ or an O₂ containing gas, or water or peroxide or a fluid oxidant such as metals (such as Fe, Cu, Mn, Cr, Pb, Sn, Al) or alloys or metal based redox couples in an solution such as iron cyanide in water or a semi solid cathode material such as LiFePO₄ particles in a solution such as in a non-aqueous lithium battery electrolyte or sulfur.

In an embodiment, one or more rod electrodes comprise branched rod electrodes including branched segments extending along a direction perpendicular to an alignment axis passing through an aperture of each plate electrode. In one embodiment, branched segments of at least two neighboring rod electrodes extend a full distance between the at least two neighboring rod electrodes, thereby forming a bridge segment between the at least two neighboring rod electrodes. In embodiments, each rod electrode is coated with an electrolyte, such as a solid electrolyte.

In an exemplary embodiment, at least one plate electrode comprises a composite plate electrode. Useful composite plate electrodes include those comprising a plate electrode inner layer and a plate electrode outer shell surrounding the rod electrode inner layer. Optionally, the plate electrode inner layer and the plate electrode outer shell are separated by a first distance, for example, filled with an electrolyte. Optionally, a composite plate electrode comprises an electrochemical cell. In one embodiment, the plate electrode inner layer comprises a first electrode material, the plate electrode outer shell comprises a second electrode material different from the first electrode material, and at least one rod electrode comprises the first electrode material.

In one embodiment, the plate inner material comprises a vacancy, such that the composite plate comprises a hollow shell. Optionally, in embodiments, an oxidant fluid is introduced into one or more regions of a composite plate electrode, wherein at least a portion of the fluid permeates through one or more materials of the composite plate electrode, such as a gas, such as O₂ or an O₂ containing gas, or water or peroxide or a fluid oxidant such as metals (such as Fe, Cu, Mn, Cr, Pb, Sn, Al) or alloys or metal based redox couples in an solution such as iron cyanide in water or a semi solid cathode material such as LiFePO₄ particles in a solution such as in a non-aqueous lithium battery electrolyte or sulfur.

In embodiments, a three-dimensional electrode array of this aspect comprises any number of plate electrodes. For example, useful three-dimensional electrode arrays include those comprising 5 or more, 6 or more, 7 or more, 8 or more, 9 or more or 10 or more plate electrodes. In certain embodiments, a three-dimensional electrode array of this aspect comprises any number of rod electrodes. For example, useful three-dimensional electrode arrays include those comprising 50 or more, 60 or more, 70 or more, 80 or more, 90 or more or 100 or more rod electrodes.

Optionally, an electrode array includes an oxidant electrode such as an oxygen electrode or a water electrode or a metal based redox couple electrode, for example, which are useful in a part solid, part fluid electrochemical cell, such as a metal-air battery system including a lithium-air battery or zinc-air battery, or a metal-aqueous battery system such as a lithium-water battery, or in semi-solid battery or a flow battery or a fuel cell. As an example, optionally an oxygen electrode is exposed to ambient air and molecular oxygen is accessed from the ambient air. Useful electrodes include composite carbon electrodes, for example, about 10 μm to 400 μm thick, optionally 150 μm to 400 μm, made of graphite powders and a binder such as PVDF on a Ni mesh.

In certain embodiments, the three-dimensional electrode array is a component of an electrochemical cell. Useful electrochemical cells include those selected from the group consisting of: a primary cell, a secondary cell, a lead-acid cell, a lithium cell, a lithium ion cell, a metal-air cell, a zinc-carbon cell, an alkaline cell, a nickel-cadmium cell, a nickel metal hydride cell, a silver oxide cell, a sodium sulfur cell, a solid electrochemical cell or a fluid electrochemical cell. Optionally, a three-dimensional electrode array further comprises an electrolyte positioned between each of the plurality of plate electrodes and each of the plurality of rod electrodes or around each of the plurality of rod electrodes. In a specific embodiment, the electrolyte comprises a first electrolyte surrounding each of the plurality of plate electrodes and a second electrolyte surrounding each of the plurality of rod electrodes. Optionally, the first electrolyte and the second electrolyte are different. Optionally, the first electrolyte and the second electrolyte are the same. Optionally, the first electrolyte and the second electrolyte each independently comprise a solid electrolyte. In a specific embodiment, a membrane is positioned between the first and second electrolytes. Optionally, the first and second electrolytes are both liquids. Optionally, an electrolyte is a fluid of variable viscosity, velocity, composition or any combination of these.

In embodiments, the electrolyte includes any of a variety of electrolytes, for example useful in primary and secondary electrochemical cells. Useful electrolytes include, but are not limited to: an aqueous solution; an organic solvent; a lithium salt; sulfuric acid; potassium hydroxide; an ionic liquid; a solid electrolyte; a polymer; poly(ethylene oxide); poly(propylene oxide); poly(styrene); poly(imide); poly(amine); poly(acrylonitrile); poly(vinylidene fluoride); methoxyethoxyethyoxy phosphazine; diiodomethane; 1,3-diiodopropane; N,N-dimethylformamide; imethypropylene urea; ethylene carbonate; diethylene carbonate; dimethyl carbonate; propylene carbonate; a block copolymer lithium electrolyte doped with a lithium salt; glass; glass doped with at least one of LiI, LiF, LiCl, Li₂O—B₂O₃—Bi₂O₃, Li₂O—B₂O₃—P₂O₅ and Li₂OB₂O₃; a sol of at least one oxide of Si, B, P, Ti, Zr, Bb and Bi; a sol of at least one hydroxide of Si, B, B, Ti, Zr, Pb and Bi; a gel of at least one oxide of Si, B, P, Ti, Zr, Bb and Bi; a gel of at least one hydroxide of Si, B, B, Ti, Zr, Pb and Bi; or any combination of these. Useful polymers further include polyacryonitrile, poly(vinyl chloride), poly(vinyl sulfone), poly(ethylene glycol diacrylate), poly(vinyidene fluoride), poly(tetrahydrofuran), poly(dioxolane), poly(ethylane oxide), poly(propylene oxide), poly(vinyl pyrrolidinoe) and mixtures thereof. Useful electrolytes further include those comprising LiClO₄, LiBF₄, LiAsF₆, LiCF₃, SO₃, LiPF₆, and LiN(SO₂ CF₃)2. Optionally, an electrolyte comprises a salt selected from the group of salts consisting of Mg(ClO₄)₂, Zn(ClO₄)₂, LiAlCl₄, and Ca(ClO₄)₂. Optionally, an electrolyte is a solid, for example comprising a material selected from the group consisting of phosphorous based glass, oxide based glass, oxide sulfide based glass, selenide glass, gallium based glass, germanium based glass, sodium and lithium betaalumina, glass ceramic alkali metal ion conductors, and Nasiglass. Optionally, an electrolyte is a polycrystalline ceramic selected from the group consisting of LISICON, NASICON, Li_{0.3}La_{0.7} TiO₃, sodium and lithium beta alumina, LISICON polycrystalline ceramic such as lithium metal phosphates.

In certain embodiments, the three-dimensional electrode array is a component of a capacitor or a supercapacitor. In one embodiment, a three-dimensional electrode array further comprises one or more dielectric materials positioned between each of the plurality of plate electrodes and each of the one or more rod electrodes or around each of the one or more of rod electrodes. Useful dielectric materials include, but are not limited to: a metal oxide, a silicon oxide, a metal nitride, a silicon nitride, and any combination of these. Useful dielectric materials for some embodiments also include carbon, nanocarbon, graphene and/or graphite. Optionally, a dielectric is substituted by a synthetic resin or polypropylene.

For a variety of three-dimensional electrode arrays, embodiments include one or more current collectors. In a specific embodiment, each of the plurality of plate electrodes comprises a current collector. In a specific embodiment, each of the plurality of rod electrodes comprises a current collector. In a specific embodiment, each of the plurality of plate electrodes and each of the plurality of rod electrodes comprises a current collector.

Optionally, one or more current collectors are positioned in thermal communication with a heat sink or a heat source. Current collectors positioned in thermal communication with a heat sink or a heat source are useful, for example, for heating, cooling and/or controlling the temperature of a three-dimensional electrode array or a device comprising a three-dimensional electrode array, such as an electrochemical cell. In a specific embodiment, each of the plurality of plate electrodes comprises a current collector positioned in thermal communication with a heat sink or a heat source. In a specific embodiment, each of the plurality of rod electrodes comprises a current collector positioned in thermal communication with a heat sink or a heat source. In a specific embodiment, one or more of the plurality of rod electrodes' current collectors and one or more of the plurality of plate electrodes' current collectors are positioned in thermal communication with a heat sink or a heat source. Useful current collectors include those comprising a material selected from the group consisting of: a metal, a metal alloy, Cu, Ag, Au, Pt, Pd, Ti, Al and any combination of these. Optionally, each current collector comprises and/or is constructed as a heat pipe. In certain embodiments, each current collector is a structural element of the three-dimensional electrode array or provides structural support to the three-dimensional electrode array. Optionally, one or more current collectors is under tension. Current collectors positioned under tensions are useful, for example, for providing structural rigidity to a three-dimensional electrode array. Useful current collectors include those comprising Ni or Al or Ti or Cu, such as a porous Ni sheet or Al sheet or Ti sheet or Cu sheet or a Ni screen or Al screen or Ti screen or Cu screen or a Ni rod or a porous Ni rod. Optionally, a rod electrode comprises a porous rod. Optionally a porous rod electrode comprises a hollow rod electrode with porous walls. Porous rod electrodes are useful, for example, for permitting the passage of active materials, such as a gas, air, or a liquid, such as in a semi-solid battery, a flow battery or a fuel cell.

In a specific embodiment, a three-dimensional electrode of this aspect further comprises one or more heat transfer rods arranged such that each heat transfer rod extends a length along an alignment axis passing through an aperture of each plate electrode. For example, one or more heat transfer rods are positioned analogous to a rod electrode in a three-dimensional array. Optionally, at least one of the one or more heat transfer rods are positioned in thermal communication with a heat sink or a heat source, for example, for heating, cooling and/or controlling the temperature of a three-dimensional electrode array or a device comprising a three-dimensional electrode array. Useful heat transfer rods include, but are not limited to those comprising a material selected from the group consisting of: a metal, a metal alloy, Cu, Ag, Au, Pt, Pd, Ti, Al and any combination of these. Optionally, each heat transfer rod independently comprises a metal or a metal alloy.

In certain embodiments, a three-dimensional electrode array of this aspect further comprises an inert coating on a surface of one or more apertures, for example on a surface of each aperture. An inert coating on an aperture is useful, for example, for preventing electrical contact between a rod electrode and a plate electrode, for preventing the growth of dendrites on a plate electrode and/or for preventing an oxidation reaction or a reduction reaction from occurring at a plate electrode at positions covered by the inert coating. Useful inert coatings include those comprising a material selected from the group consisting of: Teflon, Delrin, Kapton, polytetrafluoroethylene (PTFE), a perfluoroalkoxy (PFA), fluorinated ethylene propylene (FEP), polypropylene (PP), polyethylene (PE) and any combination of these.

In certain embodiments, a three-dimensional electrode array of this aspect further comprises one or more inert spacer elements positioned to provide a space between each plate electrode, between each rod electrode or between each plate electrode and each rod electrode. Useful inert spacers include those comprising a material selected from the group consisting of: Teflon, Delrin, Kapton, polytetrafluoroethylene (PTFE), a perfluoroalkoxy (PFA), fluorinated ethylene propylene (FEP), polypropylene (PP), polyethylene (PE) and any combination of these. Useful inert spacers further include those comprising a non-conducting material.

Optionally, for a three-dimensional electrode array embodiment, at least one rod electrode comprises a first cathode material and wherein at least one rod electrode comprises a second cathode material different from the first cathode material. Optionally, for a three-dimensional electrode array embodiment, at least one rod electrode comprises a first anode material and wherein at least one rod electrode comprises a second anode material different from the first anode material. Optionally, an oxidant fluid is introduced into one or more regions of a rod electrode of this nature. For example, in one embodiment, at least a portion of the fluid permeates through one or more materials of the rod electrode, such as a gas, such as O₂ or an O₂-containing gas, or water or peroxide or a fluid oxidant such as metals (such as Fe, Cu, Mn, Cr, Pb, Sn, Al) or alloys or metal based redox couples in an solution such as iron-cyanide in water or a semi solid cathode material such as LiFePO₄ particles in a solution such as in a non-aqueous lithium battery electrolyte or sulfur.

Optionally, for a three-dimensional electrode array embodiment, at least one plate electrode comprises a first cathode material and wherein at least one plate electrode comprises a second cathode material different from the first cathode material. Optionally, for a three-dimensional electrode array embodiment, at least one plate electrode comprises a first anode material and wherein at least one plate electrode comprises a second anode material different from the first anode material.

Optionally, for a three-dimensional electrode array embodiment, one or more plate electrodes have a rectangular geometry, a square geometry, an ellipsoidal geometry or a circular geometry. Optionally, for a three-dimensional electrode array embodiment one or more rod electrodes have a diameter or a lateral dimension that changes over a length of a rod electrode or linearly increases or decreases over a length of a rod electrode. Optionally, for a three-dimensional electrode array embodiment, each aperture has a diameter or a lateral dimension that differs on each plate electrode, changes along a length of a rod electrode, or linearly increases or decreases along a length of a rod electrode.

Optionally, one or more of the plurality of rod electrodes has two different diameters or lateral dimensions, a first diameter or lateral dimension positioned at a region of the rod electrode adjacent to an aperture in a plate electrode, and a second diameter or lateral dimension positioned at a region of the rod electrode at regions between plate electrodes, as an example it is optionally thinner in the vicinity of the walls of the holes and thicker in the vicinity of the space between the plates.

Optionally, a space between one or more of the plate electrodes acts as a buffer, especially when the plate active material has a significant shape change such as in Si anodes in Li-ion batteries.

Optionally, in a three-dimensional electrode array embodiment, a space between the plate electrodes is filled with gas, liquid, oil or water or a heat transfer fluid or a heat transfer solid positioned in thermal communication with a thermostat, thereby maintaining the temperature of the three-dimensional electrode array at a specified temperature.

Optionally, a three dimensional electrode array further comprises a plurality of inert material gaskets, PTFE gaskets or silicone gaskets, wherein the gas, liquid, oil or water or heat transfer liquid or heat transfer solid is separated from an electrolyte between the rods and the hole-walls by the inert material gaskets, PTFE gaskets or silicone gaskets and wherein the inert material gaskets, PTFE gaskets or silicone gaskets have a shape of a cylinder with a length dimension at least as long as a length dimension of a rod electrode and an outer diameter equal to that of the apertures in the plate electrode, and wherein inert material gaskets, PTFE gaskets or silicone gaskets are completely solid between the plates and is more than 80% open at a vicinity of the apertures in the plate electrodes. Optionally, for each aperture, two diaphragms having a donut shape are placed at the top and bottom of apertures to completely prevent mixing and/or contact of the oil or water or heat transfer liquid or heat transfer solid with the electrolyte.

In an embodiment, a three-dimensional electrode array further comprises one or more metal, glass, ceramic, steel, or polymer rods arranged such that each metal, glass, ceramic, steel or polymer rod extends a length along an alignment axis passing through an aperture of each plate electrode. Such metal, glass, ceramic, steel or polymer rods are useful, for example for providing structural integrity to the three-dimensional electrode array. Optionally, apertures which the metal, glass, ceramic, steel or polymer rods pass through are larger than apertures which the plurality of rod electrodes pass through.

In an embodiment, a three-dimensional electrode array further comprises one or more metal, glass, ceramic, steel or polymer plates including an array of apertures, wherein the one or more metal, glass, ceramic, steel or polymer plates are arranged in a substantially parallel orientation such that the each aperture of an individual metal, glass, ceramic, steel or polymer plate is aligned along the alignment axis passing through the apertures of each of the plate electrodes. Such metal, glass, ceramic, steel or polymer plates are useful, for example, for providing structural integrity to the three-dimensional electrode array. In an embodiment, the electrode array further comprises one or more insulating plates comprising an electrically insulating material and having a plurality of apertures for passing the rod electrodes. In an embodiment, for example, the insulating plates are provided between adjacent plate electrodes of the array and in an orientation such that the apertures accommodate the rod electrodes of the array. In an embodiment, for example, electrically insulating plates are interleaved between adjacent plate electrodes to prevent shorting between adjacent plate electrodes.

In an embodiment, a three-dimensional electrode array further comprises a pump to flow a fluid positioned in a space between the plate electrodes and the rod electrodes or a space between each of the plate electrodes or a space inside each of the rod electrodes. Optionally, one or more of the rod electrodes comprise hollow and/or porous tubes.

Optionally, for use of different electrolytes, such as one between each rod and the corresponding wall of the holes of the plates and another between the perforated plates, a thin membrane is included, for example, tens of micrometers thick, between the two electrolyte systems to separate them. Such a membrane is useful when the two electrolyte systems are both fluid such as liquid, as an example similar to a thin O-ring. Optionally, the membrane is used to remove unwanted products from the cell or to add assisting materials to the cell. Examples of removing unwanted products from the cell are some gas phases that happen as the product of the chemistry cell reactions, such as hydrogen gas, as, for example, is generated in Flow batteries or in Lead Acid batteries, especially in flooded lead-acid batteries. In embodiments, the membranes used here are optionally inert materials such as PTFE or PE or other membrane products with desired pore sizes or chemistry or surface behavior.

In an embodiment, a three-dimensional electrode further comprises one or more desiccant plates including an array of apertures and comprising a desiccant selected from the group consisting of silica gel, activated charcoal, calcium sulfate, calcium chloride, montmorillonite clay, molecular sieves and any combination of these, wherein the one or more desiccant plates are arranged in a substantially parallel orientation such that the each aperture of an individual desiccant plate is aligned along the alignment axis passing through the apertures of each of the plate electrodes. Optionally, one or more desiccant plates comprise an inert coating or a PTFE coating. Inert coatings or PTFE coatings are useful, for example, when the three-dimensional electrode array is a Li battery and/or a part solid, part fluid electrochemical cell, such as a metal-air battery system including a lithium-air battery or zinc-air battery, or a metal-aqueous battery system, such as a lithium-water battery. Optionally, the inert coating or PTFE coating increases the safety and/or performance the battery. In certain embodiments, a desiccant plate is removed from the three-dimensional electrode array after the desiccant plate is saturated with water.

In another aspect, also provided are methods for controlling a temperature of an electrochemical cell. A specific method of this aspect comprises the steps of: providing an electrochemical cell comprising: a plurality of plate electrodes, wherein each plate electrode includes an array of apertures, wherein the plate electrodes are arranged in a substantially parallel orientation such that the each aperture of an individual plate electrode is aligned along an alignment axis passing through an aperture of each of one or more or all other plate electrodes; and a plurality of rod electrodes, wherein the plurality of rod electrodes are not in physical contact with the plurality of plate electrodes and arranged such that each rod electrode extends a length along an alignment axis passing through an aperture of each plate electrode; wherein a first surface area includes a cumulative surface area of the plurality of plate electrodes, wherein a second surface area includes a cumulative surface area of each aperture array and wherein a third surface area includes a cumulative surface area of each of the plurality of rod electrodes; wherein each of the plurality of plate electrodes comprises a current collector, wherein each of the plurality of rod electrodes comprises a current collector or wherein each of the plurality of plate electrodes comprises a current collector and each of the plurality of rod electrodes comprises a current collector; and positioning one or more of the current collectors in thermal communication with a heat sink or a heat source. Optionally, each current collector independently comprises a material selected from the group consisting of: a metal, a metal alloy, Cu, Ag, Au, Pt, Pd, Ti, Al and any combination of these.

In one embodiment, the positioning step comprises removing heat from at least a portion of the electrochemical cell. In one embodiment, the positioning step comprises adding heat to at least a portion of the electrochemical cell. In one embodiment, the method further comprises a step of positioning one or more of the current collectors in thermal communication with a second heat sink or a second heat source.

Optionally, the electrochemical cell further comprises one or more heat transfer rods arranged such that each heat transfer rod extends a length along an alignment axis passing through an aperture of each plate electrode and the method further comprises the step of positioning one or more of the heat transfer rods in thermal communication with the heat sink or the heat source.

In embodiments, a three-dimensional electrode comprises a flow battery. Optionally a three-dimensional electrode array further comprises a plurality of tubes arranged such that each tube extends a length along an alignment axis passing through an aperture of each plate electrode and wherein at least one rod electrode is positioned within each tube. Optionally, a space within each tube between an inner wall of the tube and a surface of a rod electrode is filled with a fluid, an electrolyte, an aqueous solution or a gas. Optionally, a space between an outer wall of each and wall of one or more apertures is filled with a fluid, an electrolyte, an aqueous solution or a gas, for example different than a fluid, an electrolyte, an aqueous solution or a gas that is present within a space inside each tube. In certain embodiments, each fluid, electrolyte, aqueous solution or gas is flowing along an alignment axis passing through an aperture of each plate electrode. Optionally, a fluid inside each tube is flowing in a direction opposite to a fluid outside each tube.

In embodiments using different electrolytes, for example one between each rod and the corresponding wall of the holes of the plates and another between the perforated plates, a thin membrane is optionally provided, for example about tens of micrometers thick, between the different electrolyte systems to separate them, for example when the different electrolytes are both fluid such as liquid. Optionally, the thin membrane is a thin O-ring. Optionally, membranes are used, about tens of micrometers thin, in the shape of tubes, outer radius the same as the holes, inner radius the same as the rods, which are placed around the rods at the top and at the bottom of the plates.

Optionally, a membrane is used during operation of an electrochemical cell to remove unwanted products from the cell or to add assisting materials to the cell. Example of removing unwanted products from the cell are gas phases that form as the product of the chemistry cell reactions, such as hydrogen gas as forms in flow batteries or in lead acid batteries, such as in flooded lead-acid batteries. The membranes used here are optionally inert materials such as PTFE or PE or other membrane products with desired pore sizes or chemistry or surface behavior.

In one embodiment, the separator itself is a flowing fluid. In an embodiment, that small particles with desired area to volume ratio are transported in a flowing fluid separator and larger particles are not transported in the flowing fluid separator.

In a specific embodiment, a three-dimensional electrode array further comprises a plurality of second tubes arranged such that each second tube extends a length along an alignment axis passing through an aperture of each plate electrode and wherein at least one second tube is positioned with each tube and wherein at least one rod electrode is positioned within each second tube. In this embodiment, each second tube provides a further space in which an optional additional fluid can be flowed.

Another method of this aspect for controlling a temperature of an electrochemical cell comprises the steps of: providing an electrochemical cell comprising: a plurality of plate electrodes, wherein each plate electrode includes an array of apertures, wherein the plate electrodes are arranged in a substantially parallel orientation such that the each aperture of an individual plate electrode is aligned along an alignment axis passing through an aperture of each of one or more or all other plate electrodes; a plurality of rod electrodes, wherein the plurality of rod electrodes are not in physical contact with the plurality of plate electrodes and arranged such that each rod electrode extends a length along an alignment axis passing through an aperture of each plate electrode; and one or more heat transfer rods arranged such that each heat transfer rod extends a length along an alignment axis passing through an aperture of each plate electrode; wherein a first surface area includes a cumulative surface area of the plurality of plate electrodes, wherein a second surface area includes a cumulative surface area of each aperture array and wherein a third surface area includes a cumulative surface area of each of the plurality of rod electrodes; wherein each of the plurality of plate electrodes comprises a current collector, wherein each of the plurality of rod electrodes comprises a current collector or wherein each of the plurality of plate electrodes comprises a current collector and each of the plurality of rod electrodes comprises a current collector; and positioning one or more of the heat transfer rods in thermal communication with a heat sink or a heat source.

In yet another aspect, provided are methods of making electrode arrays. A specific method of this aspect comprises the steps of: providing a plurality of plate electrodes, wherein each plate electrode includes an array of apertures; arranging the plurality of plate electrodes in a substantially parallel orientation such that the each aperture of an individual plate electrode is aligned along an alignment axis passing through an aperture of each of one or more or all other plate electrodes; providing a plurality of rod electrodes; and arranging the plurality of rod electrodes such that the plurality of rod electrodes are not in physical contact with the plurality of plate electrodes and such that each rod electrode extends a length along an alignment axis passing through an aperture of each plate electrode.

In a specific method of this aspect, the step of providing a plurality of plate electrodes comprises providing a plurality of current collectors and coating an electrode material on at least a portion of the surface of each current collector. In a specific method of this aspect, the step of providing the plurality of rod electrodes comprises providing a plurality of current collectors and coating an electrode material on at least a portion of the surface of each current collector.

A specific method of this aspect comprises making an electrochemical cell. For example a method for making an electrochemical cell further comprises a step of providing an electrolyte between each of the plurality of plate electrodes and each of the plurality of rod electrodes, thereby making an electrochemical cell. Optionally, the method further comprises a step of providing the electrolyte between each of the plurality of plate electrodes and between each of the plurality of rod electrodes.

In another aspect, provided is a redox flow energy storage device. A device of this aspect comprises a positive electrode current collector in the form of one or more rods, a negative electrode current collector in the form of a grid or a grating of crossed bars, and an ion-permeable membrane separating said positive and negative current collectors; a positive electrode disposed between the positive electrode current collector and the ion-permeable membrane; the positive electrode current collector and the ion-permeable membrane defining a positive electroactive zone accommodating the positive electrode; a negative electrode disposed between the negative electrode current collector and the ion-permeable membrane; the negative electrode current collector and the ion-permeable membrane defining a negative electroactive zone accommodating the negative electrode; wherein at least one of the positive and negative electrode comprises a flowable semi-solid or condensed liquid ion-storing redox composition capable of taking up or releasing ions during operation of the cell.

In an embodiment of this aspect, both of the positive and negative electrodes comprise the flowable semi-solid or condensed liquid ion-storing redox compositions. In an embodiment, one of the positive and negative electrodes comprises the flowable semi-solid or condensed liquid ion-storing redox composition and the remaining electrode is a conventional stationary electrode. In an embodiment, the flowable semi-solid or condensed liquid ion-storing redox composition comprises a gel. In an embodiment, a steady state shear viscosity of the flowable semi-solid or condensed liquid ion-storing redox composition is between about 1 cP and 1,000,000 cP at the temperature of operation of the redox flow energy storage device.

In an embodiment, the flowable semi-solid ion-storing redox composition comprises a solid comprising amorphous carbon, disordered carbon, graphitic carbon, graphene, carbon nanotubes or a metal-coated or metal-decorated carbon. In an embodiment, the flowable semi-solid ion-storing redox composition comprises a solid comprising a metal or metal alloy or metalloid or metalloid alloy or silicon or any combination of these. In an embodiment, the flowable semi-solid ion-storing redox composition comprises a solid comprising nanostructures selected from the group consisting of nanowires, nanorods, nanotetrapods and any combination of these. In an embodiment, the flowable semi-solid ion-storing redox composition comprises a solid comprising an organic redox compound.

In an embodiment, a redox flow energy storage device further comprises a storage tank for storing the flowable semi-solid or condensed liquid ion-storing redox composition, the storage tank in flow communication with the redox flow energy storage device. Optionally, a redox flow energy storage device comprises an inlet for introduction of the flowable semi-solid or condensed liquid ion-storing redox composition into the positive/negative electroactive zone and an outlet for the exit of the flowable semi-solid or condensed liquid ion-storing redox composition out of the positive/negative electroactive zone. Optionally a redox flow energy storage device further comprises a fluid transport device to enable flow communication, for example a fluid transport device comprising a pump. Optionally, a condensed-liquid ion-storing material comprises a liquid metal alloy.

In another aspect, provided are methods of operating a redox flow energy storage device. A method of this aspect comprises the steps of providing a redox flow energy storage device, such as described above; and transporting the flowable semi-solid or condensed liquid ion-storing redox composition into the electroactive zone during operation of the device. Optionally, at least a portion of the flowable semi-solid or condensed liquid ion-storing redox composition in the electroactive zone is replenished by introducing new semi-solid or condensed liquid ion-storing redox composition into the electroactive zone during operation.

Optionally, a method of this aspect further comprises a step of transporting depleted semi-solid or condensed liquid ion-storing material to a discharged composition storage receptacle for recycling or recharging. Optionally a method of this aspect further comprises a step of applying an opposing voltage difference to the flowable redox energy storage device; and transporting charged semi-solid or condensed liquid ion-storing redox composition out of the electroactive zone to a charged composition storage receptacle during charging. Optionally, a method of this aspect further comprises the step of applying an opposing voltage difference to the flowable redox energy storage device; and transporting discharged semi-solid or condensed liquid ion-storing redox composition into the electroactive zone to be charged.

In another aspect, provided is a redox flow battery comprising a stack of perforated cells and a group of rods (for example of arbitrary aspect ratio; from one that is a circle cross section to a very large number that is a rectangular cross section; the cross-section itself can vary for example in size), and anolyte and catholyte compartments divided from each other by an ionically selective and conductive separator and having respective electrodes; and anolyte and catholyte tanks, with respective pumps and pipeworks to provide fluid communication between the respective anolyte and catholyte tanks and compartements. In use, the pumps circulate the electrolytes to and from the tanks, to the compartments and back to the tanks. Electricity optionally flows to a load. The electrolyte lines are optionally provided with tappings via which fresh electrolyte can be added and further tappings via which spent electrolyte can be withdrawn, the respective tappings being for anolyte and catholyte. Optionally, on recharging, typically via a coupling for lines to all the tappings, a remote pump pumps fresh anolyte and fresh catholyte from remote storages and draws spent electrolyte to other remote storages.

Optionally, a redox flow battery further comprises an anode in a catholyte compartment, a cathode in an anolyte compartment and, an ion selective membrane separator between the compartments, a pair of electrolyte reservoirs, one for anolyte and the other for catholyte, and electrolyte supply means for circulating anolyte from its reservoir, to the anolyte compartment in the cell and back to its reservoir and like circulating means for catholyte; the battery comprising: connections to its electrolyte reservoirs and/or its electrolyte supply means so that the battery can be recharged by withdrawing spent electrolyte and replacing it with fresh electrolyte. Optionally, an electrolyte divider or membrane is a diaphragm between each rod and the walls of the corresponding holes, or a thin tube shape that the inner and outer radii are chosen to fit between the rod and the corresponding wall and is as long as each of the rods or a thin tube shape as long as the thickness of each of the perforated plates.

In an aspect, the invention provides a part solid, part fluid electrochemical cell comprising: (i) a plurality of plate electrodes, wherein each plate electrode includes an array of apertures, wherein the plate electrodes are arranged in a substantially parallel orientation such that the each aperture of an individual plate electrode is aligned along an independent plate alignment axis passing through an aperture of each of one or more or all other plate electrodes; (ii) one or more solid rod electrodes, wherein the plurality of solid rod electrodes are arranged such that each solid rod electrode extends a length along an independent solid rod alignment axis passing through an aperture of each plate electrode; (iii) one or more porous rod electrodes, wherein the plurality of porous rod electrodes are arranged such that each porous rod electrode extends a length along an independent porous rod alignment axis passing through an aperture of each plate electrode; (iv) at least one electrolyte provided between the solid rod electrodes and the plate electrodes and the porous rod electrodes, wherein the electrolyte is capable of conducting charge carriers; wherein a first surface area includes a cumulative surface area of the plurality of plate electrodes, wherein a second surface area includes a cumulative surface area of each aperture array, wherein a third surface area includes a cumulative surface area of each of the solid rod electrodes and wherein a fourth surface area includes a cumulative surface area of each of the porous hollow rod electrodes.

In an embodiment, the invention provides a flow electrochemical cell comprising: (i) a plurality of plate electrodes, wherein each plate electrode includes an array of apertures, wherein the plate electrodes are arranged in a substantially parallel orientation such that the each aperture of an individual plate electrode is aligned along an independent plate alignment axis passing through an aperture of each of one or more or all other plate electrodes; (ii) one or more porous rod positive electrodes, wherein the plurality of porous rod positive electrodes are arranged such that each porous rod positive electrode extends a length along an independent positive electrode alignment axis passing through an aperture of each plate electrode; (iii) one or more porous rod negative electrodes, wherein the plurality of porous rod negative electrodes are arranged such that each porous rod negative electrode extends a length along an independent negative electrode alignment axis passing through an aperture of each plate electrode; (iv) at least one electrolyte provided between the porous rod negative electrodes and the plate electrodes or between the porous rod negative electrodes and the porous rod positive electrodes, wherein the electrolyte is capable of conducting charge carriers; wherein a first surface area includes a cumulative surface area of the plurality of plate electrodes, wherein a second surface area includes a cumulative surface area of each aperture array, wherein a third surface area includes a cumulative surface area of each of the porous rod positive electrodes and wherein a fourth surface area includes a cumulative surface area of each of the porous rod negative electrodes

In an embodiment, for example, the invention provides an electrochemical cell wherein a ratio of the second surface area to the first surface area is selected over the range of 0.01 to 20, and optionally for some embodiments selected over the range of 1 to 5 and optionally for some embodiments selected over the range of 2.5 to 5. In an embodiment, for example, the invention provides an electrochemical cell wherein a ratio of the second surface area to the sum of the third surface area and fourth surface area is selected over the range of 0.01 to 20 and optionally for some embodiments selected over the range of 0.2 to 5 and optionally for some embodiments selected over the range of 0.2 to 1 and optionally for some embodiments selected over the range of 1 to 5.

In an embodiment, for example, the invention provides an electrochemical cell further comprising at least one electrolyte provided between at least a portion of the plate electrodes and at least a portion of the rod electrodes, wherein the electrolyte is capable of conducting charge carriers. In an embodiment, for example, one or more electrolytes are provided between at least a portion of the porous rod electrodes and at least a portion of the solid rod electrodes; or is provided between at least a portion of the porous rod positive electrodes and at least a portion of the porous rod negative electrodes; or is provided between at least a portion of the plate electrodes and at least a portion of the solid rod electrodes; or is provided between at least a portion of the plate electrodes and at least a portion of the porous rod negative electrodes. In invention includes embodiments wherein electrolytes having difference compositions are provided in contact with the plate electrodes, solid rod electrodes, porous rod electrodes, porous rod positive electrodes and/or porous rod negative electrodes.

In an embodiment, for example, the invention provides an electrochemical cell further comprising one or more electronically insulating and ion-permeable separators positioned between the plate electrodes and the solid rod electrodes or positioned between the plate electrodes and the porous rod negative electrodes or positioned between the plate electrodes and the porous rod positive electrodes or positioned between the porous rod positive electrodes and the porous rod negative electrodes.

In an embodiment, for example, the invention provides an electrochemical cell wherein the one or more electronically insulating and ion-permeable separators separate the solid rod electrodes from the plate electrodes and the porous rod electrodes; or wherein the one or more electronically insulating and ion-permeable separators separate the porous rod negative electrodes from the plate electrodes, the porous rod positive electrodes or both the plate electrodes and the porous rod positive electrodes.

In an embodiment, for example, the invention provides an electrochemical cell wherein the solid rod alignment axes and porous rod alignment axis are parallel or wherein the negative electrode alignment axes and the positive electrode alignment axes are parallel. Alternatively, the invention provides an electrochemical cell wherein the solid rod alignment axes and porous rod alignment axis are parallel or wherein the negative electrode alignment axes and the positive electrode alignment axes are nonparallel.

In an embodiment, for example, the invention provides an electrochemical cell comprising a single porous rod electrode or porous rod positive electrode. In an embodiment, for example, the invention provides an electrochemical cell comprising two or more porous rod electrodes or porous rod positive electrodes, for example, for some applications more than 5 porous rod electrodes or porous rod positive electrodes and for some applications more than 10 porous rod electrodes or porous rod positive electrodes. In an embodiment, for example, the invention provides an electrochemical cell comprising a single solid rod electrode or porous rod negative electrode. In an embodiment, for example, the invention provides an electrochemical cell comprising two or more solid rod electrodes or porous rod negative electrodes, for example, for some applications more than 5 solid rod electrodes or porous rod negative electrodes and for some applications more than 10 solid rod electrodes or porous rod negative electrodes.

In an embodiment, for example, the invention provides an electrochemical cell further comprising an in-line sensor operationally arranged to determine a property of a flowable ion-storing redox composition provided to the plate electrodes, the porous rod electrodes, the porous rod positive electrodes, or the porous rod negative electrodes.

In an embodiment, for example, the invention provides an electrochemical cell wherein each or one or more plate electrodes comprise a porous material, for example a porous material having a porosity selected from the range of 10% to 99%. In an embodiment, for example, the invention provides an electrochemical cell wherein each or one or more plate electrodes comprise a thin gas diffusion layer or a flow channel. In an embodiment, for example, the invention provides an electrochemical cell wherein each plate electrode independently comprises a material selected from the group of: carbon, graphite, graphene, catalized carbon, nanocarbon, Ketjen black, carbon paper, carbon cloth, carbon fiber material, metal foams, metal netting, stainless steel mesh, porous PTFE, porous metal oxide, porous ZnO, porous ZrO₂, porous metals such as porous Ni, porous Cu, porous gold, porous platinum, porous Al, porous Ti, or their alloys, a metal mesh, a Cu mesh, Ni mesh, Al mesh, Ti mesh, a porous metal or alloy thereof, an electronic conductive polymer mesh, an electronic conductive porous polymer, an electronic and thermal conductor, any alloy thereof and any combination of these. In an embodiment, for example, the invention provides an electrochemical cell wherein each plate electrode comprises a porous material and one or more coatings provided on a surface of the porous material or within the porous material. In an embodiment, for example, the one or more coatings provide for catalytic behavior improving an electrochemical reaction efficiency. In an embodiment, for example, each of the coatings independently comprise one or more of a manganese oxide, a transient metal alloy, a noble metal or any alloys thereof. In an embodiment, for example, each of the coatings independently comprise one or more materials selected from the group consisting of Pt, Au, Ru, Rh, Pd, Pt, Pt—Ru, Pt—Sn, Pt—Ru—W, Pt—Co, and Pt—Ru—Sn. In an embodiment, for example, wherein the one or more coatings provide for improvement of the chemical, electrochemical or mechanical stability of the porous material. In an embodiment, for example, wherein the one or more coatings independently comprise a polymer coating or a metal coating. In an embodiment, for example, wherein the one or more coatings provide for a selected hydrophilic behavior or hydrophobic behavior. In an embodiment, for example, wherein the one or more coatings independently comprise a polytetrafluoroethylene coating.

In an embodiment, for example, the invention provides an electrochemical cell wherein each of the porous rod electrodes comprises a porous rod positive electrode of the electrochemical cell. In an embodiment, for example, the invention provides an electrochemical cell wherein each of the porous rod electrodes or the porous rod positive electrode further comprises a flowable ion-storing redox composition, for example, wherein the flowable ion-storing redox composition is capable of taking up or releasing ions during operation of the electrochemical cell. In an embodiment, for example, the invention provides an electrochemical cell wherein the porous rod electrodes provide for transport of an active cathode flow or active anode flow from the outside of the electrochemical cell into the cell or from inside of the electrochemical cell to outside of the electrochemical cell. In an embodiment, for example, the invention provides an electrochemical cell wherein each porous rod electrode independently comprises a material selected from the group of: carbon, graphite, graphene, catalized carbon, nanocarbon, Ketjen black, carbon paper, carbon cloth, carbon fiber material, stainless steel mesh, porous metal oxide, porous ZnO, metal foams or metal netting, calcium, calcium oxide, porous ZrO₂, porous metals such as porous Ni, porous Cu, porous gold, porous platinum, porous Al, porous Ti, or alloys thereof, a metal mesh, a Cu mesh, a Ni mesh, an Al mesh, a Ti mesh, porous metals or their alloys, an electronic conductive polymer mesh, an electronic conductive porous polymer, an electronic and thermal conductor and any combinations these. In an embodiment, for example, the invention provides an electrochemical cell wherein each porous rod electrode comprises a porous material having a porosity selected from the range of 10% to 99%. In an embodiment, for example, the invention provides an electrochemical cell wherein each porous rod electrode further comprises a selective membrane that is permeable to active cathode materials and is impermeable to unwanted materials and impurities, such as CO₂. In an embodiment, for example, the invention provides an electrochemical cell wherein the selective membrane is further impermeable to an electrolyte.

In an embodiment, for example, the invention provides an electrochemical cell wherein the solid rod electrodes comprise negative electrodes of the electrochemical cell. Optionally any solid rod electrode of an electrochemical cell comprises a metal rod electrode. In an embodiment, for example, one or more solid rod electrodes, one or more porous rod negative electrodes or one or more plate electrodes comprise an active material selected from the group consisting of: lithium, a lithium metal oxide; a lithium alloy such as lithium-aluminum, lithium-tin, lithium-magnesium, lithium-lead, lithium-zinc or lithium-boron; an alkali metal such as Na, K, Rb or Cs; lithium metal alloyed with one or more of Ca, Mg, Sn, Ag, Zn, Bi, Al, Cd, Ga, In and Sb; an alkaline earth metals such as Be, Mg, Ca, Sr, Ba or an alloy thereof; Zn or an alloy of Zn; or Al or an alloy of Al; or Fe or its alloys; or Ni and its alloys; or copper or its alloys; or Si or its alloys; or Sn and it alloys; or carbon or graphite or nanocarbon or graphene or Pb or its alloys; lithium metal oxide, lithium metal phosphate, LiFePO₄, LiCoO₂, LiMn₂O₄, FeO, Vanadium pentoxide, bromine, sulfur, an alkaline cathode, an alkaline anode, a lithium ion based anode, a lithium ion based cathode; any oxides of these, any solutions of these, any solutions of oxides of these, any solutions containing suspended particles of these; and any combination thereof. In an embodiment, for example, each solid rod electrode comprises lithium or an alloy thereof. In an embodiment, for example, each solid rod electrode comprises a current collector provided at the core of the solid rod electrode, such as a stainless steel or tin or copper or aluminum. In an embodiment, for example, each solid rod electrode comprises active anode materials as the shell. In an embodiment, for example, each solid rod electrode is formed at least partially after fabrication of at least a portion of other components of the cell, for example by electrochemical deposition of the active material from the oxidation of an auxiliary cathodic flow, on the current collector or on the existing active material. For example, in a lithium metal-air the cell can be made with thin stainless steel metal rods and flow of lithiated metal oxides such as LiCoO₂ solution in an organic electrolyte in the hollow rods such that lithium anode can be electrodeposited on stainless steel metals rods after the cell fabrication and before the first cycling use.

In an embodiment, for example, the invention provides an electrochemical cell wherein the solid rod electrodes are not in physical contact with the plurality of plate electrodes. In an embodiment, for example, the invention provides an electrochemical cell wherein the porous rod electrodes are in not physical contact with the plurality of plate electrodes. In an embodiment, for example, the invention provides an electrochemical cell wherein the porous rod electrodes are in physical contact with the plurality of plate electrodes. In an embodiment, for example, the invention provides an electrochemical cell wherein each aperture of the plate electrodes has a cross sectional dimension independently selected from the range of 10 nm to 100 mm, and optionally for some embodiments selected from the range of 1 μm to 1 mm. In an embodiment, for example, the invention provides an electrochemical cell wherein each solid rod electrode has a cross sectional dimension independently selected from the range of 10 nm to 100 mm and optionally for some embodiments selected from the range of 1 μm to 1 mm. In an embodiment, for example, the invention provides an electrochemical cell wherein each porous rod electrode has a cross sectional dimension independently selected from the range of 10 nm to 100 mm and optionally for some embodiments selected from the range of 1 μm to 1 mm. In an embodiment, for example, the invention provides an electrochemical cell wherein one or more porous rod electrodes comprises a hollow cavity surrounded by a porous electrode material, for example, wherein the hollow cavities independently having a cross sectional dimension independently selected from the range of 10 nm to 100 mm and optionally for some embodiments selected from the range of 1 μm to 1 mm. In an embodiment, a porous rod electrode comprises a porous hollow rod electrode. In an embodiment, a porous rod negative electrode comprises a porous hollow rod negative electrode. In an embodiment, a porous rod positive electrode comprises a porous rod positive electrode.

In an embodiment, for example, the invention provides an electrochemical cell wherein each porous rod electrode has a wall thickness independently selected from the range of 10 nm to 100 mm. In an embodiment, for example, the invention provides an electrochemical cell wherein a spacing between adjacent rod electrodes, such as adjacent porous rod or solid electrodes, is independently selected over the range of 10 nm to 100 mm. In an embodiment, for example, a spacing between adjacent plate electrodes is independently selected from the range of 10 nm to 10 mm and optionally for some embodiments selected from the range of 1 μm to 1 mm.

In an embodiment, for example, the invention provides an electrochemical cell further comprising a comprising a flowable ion-storing redox composition provided within at least a portion of the porous rod electrodes, the plate electrodes, the porous rod positive electrodes, the porous rod negative electrodes or any combination of these. In some embodiments, for example, the porous rod electrodes, the plate electrodes, the porous rod positive electrodes, the porous rod negative electrodes or any combination of these provides a means of delivering a flowable ion-storing redox composition to the cell. In an embodiment, for example, flowable ion-storing redox composition comprises a reactant that undergoes an electrochemical reaction at the positive electrode or negative electrode of the electrochemical cell. In an embodiment, for example, flowable ion-storing redox composition comprises an oxygen containing gas or liquid, such as water or air. In an embodiment, for example, the flowable ion-storing redox composition comprises a flow of particles of redox couple in an aqueous or aprotic solution, vanadium pentoxide, bromine, graphite in a fluid electrolyte, ironcyanide in water, or a flow of semisolid active materials such as LiFePO₄ in a fluid electrolyte such as PC or DMC or EC or DMF or an ether within one or more porous rod electrodes, plate electrodes or both. In an embodiment, for example, the flowable ion-storing redox composition comprises at least one compound selected from a ketone; a diketone; a triether; a compound containing 1 nitrogen and 1 oxygen atom; a compound containing 1 nitrogen and 2 oxygen atoms; a compound containing 2 nitrogen atoms and 1 oxygen atom; a phosphorous containing compound, and/or fluorinated, nitrile, and/or perfluorinated derivatives within one or more porous rod electrodes, plate electrodes or both.

In an embodiment, for example, the invention provides an electrochemical cell further comprising a first electrolyte surrounding each solid rod electrode or porous rod negative electrode and a second electrolyte surrounding the porous rod electrodes, the porous rod positive electrodes, the plate electrodes or any combination of these, wherein the first electrolyte and the second electrolyte may have the same composition or different compositions. In an embodiment, for example, the invention provides an electrochemical cell further comprising a third solid electrolyte separating the first electrolyte and the second electrolyte. In an embodiment, for example, the first electrolyte, the second electrolyte and the third electrolyte are independently a solid electrolyte, a polymer electrolyte, a gel electrolyte or a liquid electrolyte. In an embodiment, for example, each of the first electrolyte, the second electrolyte and the third electrolyte independently comprises one or more materials selected from the group consisting of: an aqueous solution; an organic solvent; a lithium salt; sulfuric acid; potassium hydroxide; an ionic liquid; a solid electrolyte; a polymer; poly(ethylene oxide); poly(propylene oxide); poly(styrene); poly(imide); poly(amine); poly(acrylonitrile); poly(vinylidene fluoride); polyacryonitrile, poly(vinyl chloride), poly(vinyl sulfone), poly(ethylene glycol diacrylate), poly(vinyidene fluoride), poly(tetrahydrofuran), poly(dioxolane), poly(ethylane oxide), poly(propylene oxide), poly(vinyl pyrrolidinoe); EC, PC, DME, DMC, LiClO₄, methoxyethoxyethyoxy phosphazine; diiodomethane; 1,3-diiodopropane; N,N-dimethylformamide; imethypropylene urea; ethylene carbonate; diethylene carbonate; dimethyl carbonate; propylene carbonate; a block copolymer lithium electrolyte doped with a lithium salt; glass; glass doped with at least one of LiI, LiF, LiCl, Li₂O—B₂O₃—Bi₂O₃, Li₂O—B₂O₃—P₂O₅ and Li₂OB₂O₃; a sol of at least one oxide of Si, B, P, Ti, Zr, Bb and Bi; a sol of at least one hydroxide of Si, B, B, Ti, Zr, Pb and Bi; a gel of at least one oxide of Si, B, P, Ti, Zr, Bb and Bi; a gel of at least one hydroxide of Si, B, B, Ti, Zr, Pb and Bi; LiClO₄, LiBF₄, LiAsF₆, LiCF₃, SO₃, LiPF₆, and LiN(SO₂CF₃)₂; salts of Mg(ClO₄)₂, Zn(ClO₄)₂, LiAlCl₄, and Ca(ClO₄)₂; solids of phosphorous based glass, oxide based glass, oxide sulfide based glass, selenide glass, gallium based glass, germanium based glass, sodium and lithium betaalumina, glass ceramic alkali metal ion conductors, Nasiglass; a polycrystalline ceramic of LISICON, NASICON, Li_{0.3}La_{0.7}TiO₃, sodium and lithium beta alumina; LISICON polycrystalline ceramics of lithium metal phosphates, LiTi₂(PO₄)₃; composite reaction products of alkali metal with Cu₃N, L₃N, Li₃P, LiI, LiF, LiBr, LiCl and LiPON; amides, amines, nitriles, organophosphorous solvents, and organasulfur solvents, N,N-dimethylformamide (DMF), N,N-dimethylacetamide (DMAC), dimethylsulfoxide (DMSO), hexamethylphosphoramide (HMPA), acetonitrile (AN) alcohols, dials and liquid polyols, diol, ethylene glycol, ethers, glymes, carbonates, g-butyrolactone (GBL), PEO, PVDF, KOH, NaOH, Sulfuric Acid, and any combination of these.

In an embodiment, for example, the invention provides an electrochemical cell further comprising a one or more of semi-permeable layers, wherein each semi-permeable layer is positioned to surround at least one porous rod electrode, is positioned to surround at least one solid rod electrode, is positioned to surround at least one porous plate electrode, is positioned to surround at least one solid plate electrode, or is positioned inside at least one aperture of the plate electrodes, or is positioned on one or more sides of the cell or one or more faces of the cell. In an embodiment, for example, each semi-permeable layer has a thickness independently selected over the range of 10 nm to 10 μm. In an embodiment, for example, each semi-permeable layer comprises a semi-permeable membrane or a semi-permeable coating. In an embodiment, for example, each semi-permeable layer selectively permits the transmission of O₂ or water or a flow of particles of redox couple in an aqueous or aprotic solution such as ironcyanide in water, or a flow of semisolid active materials such as LiFePO₄ in a fluid electrolyte such as PC or EC or DMC or Oxygen ions or Metal ions or OH⁻ ions, or H⁺ ions. In an embodiment, for example, each semi-permeable layer prevents transmission of unwanted impurities from entering the cell, such as preventing transmission of H₂O, CO₂ and/or other pollutants. In an embodiment, for example, each semi-permeable layer or prevents unwanted impurities from precipitating on any of surfaces inside the cell or is an anionic polymeric membrane or is composed of two interpenetrated polymers network to provide an ionic network and a structural polymer to provide mechanical stability and reduce swelling, or is composed of polycationic crosslinked polyepichlorhydrine (PECH) and poly(hydroxylethyl metacrylate); or is an cationic polymeric membrane; or prevents precipitation of reaction products on its surface. In an embodiment, for example, each semi-permeable layer comprises a solid phase material, a hydrophobic material, or a hydrophilic material. In an embodiment, for example, each semi-permeable layer comprises a material selected from the group consisting of a gel from an aqueous solution; a gel from an organic solvent; a gel from a lithium salt; a gel from sulfuric acid; a gel from potassium hydroxidea gel from an ionic liquid; a solid electrolyte; a polymer; poly(ethylene oxide); poly(propylene oxide); poly(styrene); poly(imide); poly(amine); poly(acrylonitrile); poly(vinylidene fluoride); polyacryonitrile, poly(vinyl chloride), poly(vinyl sulfone), poly(ethylene glycol diacrylate), poly(vinyidene fluoride), poly(tetrahydrofuran), poly(dioxolane), poly(ethylane oxide), poly(propylene oxide), poly(vinyl pyrrolidinoe); methoxyethoxyethyoxy phosphazine; diiodomethane; 1,3-diiodopropane; N,N-dimethylformamide; imethypropylene urea; ethylene carbonate; diethylene carbonate; dimethyl carbonate; propylene carbonate; a block copolymer lithium electrolyte doped with a lithium salt; glass; glass doped with at least one of LiI, LiF, LiCl, Li₂O—B₂O₃—Bi₂O₃, Li₂O—B₂O₃—P₂O₅ and Li₂OB₂O₃; a sol of at least one oxide of Si, B, P, Ti, Zr, Bb and Bi; a sol of at least one hydroxide of Si, B, B, Ti, Zr, Pb and Bi; a gel of at least one oxide of Si, B, P, Ti, Zr, Bb and Bi; a gel of at least one hydroxide of Si, B, B, Ti, Zr, Pb and Bi; a gel of LiClO₄, LiBF₄, LiAsF₆, LiCF₃, SO₃, LiPF₆, and LiN(SO₂CF₃)₂; a gel of salts of Mg(ClO₄)₂, Zn(ClO₄)₂, LiAlCl₄, and Ca(ClO₄)₂; solids of phosphorous based glass, oxide based glass, oxide sulfide based glass, selenide glass, gallium based glass, germanium based glass, sodium and lithium betaalumina, glass ceramic alkali metal ion conductors, Nasiglass; a polycrystalline ceramic of LISICON, NASICON, Li_{0.3}La_{0.7}TiO₃, sodium and lithium beta alumina; LISICON polycrystalline ceramics of lithium metal phosphates, LiTi₂(PO₄)₃; composite reaction products of alkali metal with Cu₃N, L₃N, Li₃P, LiI, LiF, LiBr, LiCl and LiPON; amides, amines, nitriles, organophosphorous solvents, and organasulfur solvents, N,N-dimethylformamide (DMF), N,N-dimethylacetamide (DMAC), dimethylsulfoxide (DMSO), hexamethylphosphoramide (HMPA), acetonitrile (AN) alcohols, dials and liquid polyols, diol, ethylene glycol, ethers, glymes, carbonates, g-butyrolactone (GBL), OHARA INC lithium conducting solid and any combination of these.

In an embodiment, for example, the invention provides an electrochemical cell further comprising a plurality of ion conducting layers, wherein each ion conducting layer surrounds a solid rod electrode or a porous rod electrode or a plate electrode. In an embodiment, for example, the ion conducting layers are directly in physical contact with an active material of the solid rod electrode or a porous rod electrode or a plate electrode or wherein the ion conducting layers is physically separated from the solid rod electrode or a porous rod electrode or a plate electrode by a separator, such as a separator comprising porous or perforated PE, PP, PET or Kapton or by a protective layer. In an embodiment, for example, the ion conducting layers separate the solid rod electrode active material or the porous rod negative electrode active material from other components of the cell, such as the plate electrodes and porous rod positive electrodes. In an embodiment, for example, each ion conducting layer has a thickness independently selected over the range of 10 nm to 1000 μm. In an embodiment, for example, each ion conducting layer comprises a material selected from the group consisting of an aqueous solution; an organic solvent; a lithium salt; sulfuric acid; potassium hydroxide; an ionic liquid; a solid electrolyte; a polymer; poly(ethylene oxide); poly(propylene oxide); poly(styrene); poly(imide); poly(amine); poly(acrylonitrile); poly(vinylidene fluoride); polyacryonitrile, poly(vinyl chloride), poly(vinyl sulfone), poly(ethylene glycol diacrylate), poly(vinyidene fluoride), poly(tetrahydrofuran), poly(dioxolane), poly(ethylane oxide), poly(propylene oxide), poly(vinyl pyrrolidinoe); EC, PC, DME, DMC, LiClO₄, methoxyethoxyethyoxy phosphazine; diiodomethane; 1,3-diiodopropane; N,N-dimethylformamide; imethypropylene urea; ethylene carbonate; diethylene carbonate; dimethyl carbonate; propylene carbonate; a block copolymer lithium electrolyte doped with a lithium salt; glass; glass doped with at least one of LiI, LiF, LiCl, Li₂O—B₂O₃—Bi₂O₃, Li₂O—B₂O₃—P₂O₅ and Li₂OB₂O₃; a sol of at least one oxide of Si, B, P, Ti, Zr, Bb and Bi; a sol of at least one hydroxide of Si, B, B, Ti, Zr, Pb and Bi; a gel of at least one oxide of Si, B, P, Ti, Zr, Bb and Bi; a gel of at least one hydroxide of Si, B, B, Ti, Zr, Pb and Bi; LiClO₄, LiBF₄, LiAsF₆, LiCF₃, SO₃, LiPF₆, and LiN(SO₂CF₃)₂; salts of Mg(ClO₄)₂, Zn(ClO₄)₂, LiAlCl₄, and Ca(ClO₄)₂; solids of phosphorous based glass, oxide based glass, oxide sulfide based glass, selenide glass, gallium based glass, germanium based glass, sodium and lithium betaalumina, glass ceramic alkali metal ion conductors, Nasiglass; a polycrystalline ceramic of LISICON, NASICON, Li_{0.3}La_{0.7}TiO₃, sodium and lithium beta alumina; LISICON polycrystalline ceramics of lithium metal phosphates, LiTi₂(PO₄)₃; composite reaction products of alkali metal with Cu₃N, L₃N, Li₃P, LiI, LiF, LiBr, LiCl and LiPON; amides, amines, nitriles, organophosphorous solvents, and organasulfur solvents, N,N-dimethylformamide (DMF), N,N-dimethylacetamide (DMAC), dimethylsulfoxide (DMSO), hexamethylphosphoramide (HMPA), acetonitrile (AN) alcohols, dials and liquid polyols, diol, ethylene glycol, ethers, glymes, carbonates, g-butyrolactone (GBL), and polymer electrolytes and solid electrolytes such as PEO, PVDF, LIPON, OHARA lithium ion conducting glass and any combination of these. In an embodiment, for example, the invention provides an electrochemical cell further comprising an ion conducting layer surrounding walls of one or more apertures of the plate electrodes. In an embodiment, for example, each ion conducting layer has a thickness independently selected over the range of 10 nm to 1000 μm, and optionally for some embodiments selected over the range of 1 μm to 1000 μm. In an embodiment, for example, each ion conducting layer comprises a semi-permeable membrane or anionic polymer membrane or cationic polymer membrane. In an embodiment, for example, the semi-permeable membrane permits the transmission of O₂ or water or a flow of particles of redox couple in an aqueous or aprotic solution such as ironcyanide in water, or a flow of semisolid active materials such as LiFePO₄ in a fluid electrolyte such as PC or DMC or Oxygen ions or Metal ions or OH⁻ ions, or H⁺ ions. In an embodiment, for example, the semi-permeable membrane prevents the transmission of H₂O, CO₂ or other pollutants from entering the cell. In an embodiment, for example, the ion conducting layer comprises a material selected from the group consisting of an aqueous solution; an organic solvent; a lithium salt; sulfuric acid; potassium hydroxide; an ionic liquid; a solid electrolyte; a polymer; poly(ethylene oxide); poly(propylene oxide); poly(styrene); poly(imide); poly(amine); poly(acrylonitrile); poly(vinylidene fluoride); polyacryonitrile, poly(vinyl chloride), poly(vinyl sulfone), poly(ethylene glycol diacrylate), poly(vinyidene fluoride), poly(tetrahydrofuran), poly(dioxolane), poly(ethylane oxide), poly(propylene oxide), poly(vinyl pyrrolidinoe); EC, PC, DME, DMC, LiClO₄, methoxyethoxyethyoxy phosphazine; diiodomethane; 1,3-diiodopropane; N,N-dimethylformamide; imethypropylene urea; ethylene carbonate; diethylene carbonate; dimethyl carbonate; propylene carbonate; a block copolymer lithium electrolyte doped with a lithium salt; glass; glass doped with at least one of LiI, LiF, LiCl, Li₂O—B₂O₃—Bi₂O₃, Li₂O—B₂O₃—P₂O₅ and Li₂OB₂O₃; a sol of at least one oxide of Si, B, P, Ti, Zr, Bb and Bi; a sol of at least one hydroxide of Si, B, B, Ti, Zr, Pb and Bi; a gel of at least one oxide of Si, B, P, Ti, Zr, Bb and Bi; a gel of at least one hydroxide of Si, B, B, Ti, Zr, Pb and Bi; LiClO₄, LiBF₄, LiAsF₆, LiCF₃, SO₃, LiPF₆, and LiN(SO₂CF₃)₂; salts of Mg(ClO₄)₂, Zn(ClO₄)₂, LiAlCl₄, and Ca(ClO₄)₂; solids of phosphorous based glass, oxide based glass, oxide sulfide based glass, selenide glass, gallium based glass, germanium based glass, sodium and lithium betaalumina, glass ceramic alkali metal ion conductors, Nasiglass; a polycrystalline ceramic of LISICON, NASICON, Li_{0.3}La_{0.7}TiO₃, sodium and lithium beta alumina; LISICON polycrystalline ceramics of lithium metal phosphates, LiTi₂(PO₄)₃; composite reaction products of alkali metal with Cu₃N, L₃N, Li₃P, LiI, LiF, LiBr, LiCl and LiPON; amides, amines, nitriles, organophosphorous solvents, and organasulfur solvents, N,N-dimethylformamide (DMF), N,N-dimethylacetamide (DMAC), dimethylsulfoxide (DMSO), hexamethylphosphoramide (HMPA), acetonitrile (AN) alcohols, dials and liquid polyols, diol, ethylene glycol, ethers, glymes, carbonates, g-butyrolactone (GBL), OHARA INC lithium conducting solid electrolyte and any combination of these.

In an embodiment, for example, the invention provides an electrochemical cell further comprising one or more electrolyte layers, wherein the electrolyte layers surround the solid rod electrodes, the porous rod electrodes, the plate electrode, the porous rod positive electrode, the porous rod negative electrode or any combination of these. In an embodiment, for example, each electrolyte layer independently comprises a material selected from the group consisting of an aqueous solution; an organic solvent; a lithium salt; sulfuric acid; potassium hydroxide; an ionic liquid; a solid electrolyte; a polymer; poly(ethylene oxide); poly(propylene oxide); poly(styrene); poly(imide); poly(amine); poly(acrylonitrile); poly(vinylidene fluoride); polyacryonitrile, poly(vinyl chloride), poly(vinyl sulfone), poly(ethylene glycol diacrylate), poly(vinyidene fluoride), poly(tetrahydrofuran), poly(dioxolane), poly(ethylane oxide), poly(propylene oxide), poly(vinyl pyrrolidinoe); EC, PC, DME, DMC, LiClO₄, methoxyethoxyethyoxy phosphazine; diiodomethane; 1,3-diiodopropane; N,N-dimethylformamide; imethypropylene urea; ethylene carbonate; diethylene carbonate; dimethyl carbonate; propylene carbonate; a block copolymer lithium electrolyte doped with a lithium salt; glass; glass doped with at least one of LiI, LiF, LiCl, Li₂O—B₂O₃—Bi₂O₃, Li₂O—B₂O₃—P₂O₅ and Li₂OB₂O₃; a sol of at least one oxide of Si, B, P, Ti, Zr, Bb and Bi; a sol of at least one hydroxide of Si, B, B, Ti, Zr, Pb and Bi; a gel of at least one oxide of Si, B, P, Ti, Zr, Bb and Bi; a gel of at least one hydroxide of Si, B, B, Ti, Zr, Pb and Bi; LiClO₄, LiBF₄, LiAsF₆, LiCF₃, SO₃, LiPF₆, and LiN(SO₂CF₃)₂; salts of Mg(ClO₄)₂, Zn(ClO₄)₂, LiAlCl₄, and Ca(ClO₄)₂; solids of phosphorous based glass, oxide based glass, oxide sulfide based glass, selenide glass, gallium based glass, germanium based glass, sodium and lithium betaalumina, glass ceramic alkali metal ion conductors, Nasiglass; a polycrystalline ceramic of LISICON, NASICON, Li_{0.3}La_{0.7}TiO₃, sodium and lithium beta alumina; LISICON polycrystalline ceramics of lithium metal phosphates, LiTi₂(PO₄)₃; composite reaction products of alkali metal with Cu₃N, L₃N, Li₃P, Lit, LiF, LiBr, LiCl and LiPON; amides, amines, nitriles, organophosphorous solvents, and organasulfur solvents, N,N-dimethylformamide (DMF), N,N-dimethylacetamide (DMAC), dimethylsulfoxide (DMSO), hexamethylphosphoramide (HMPA), acetonitrile (AN) alcohols, dials and liquid polyols, diol, ethylene glycol, ethers, glymes, carbonates, g-butyrolactone (GBL), LIPON, PvDF, PEO, KOH, NaOH, LiOH, OHARA INC lithium conducting solid electrolyte and water and acids and bases and any combination of these.

In an embodiment, for example, the invention provides an electrochemical cell further comprising one or more ion conducting layers, wherein the ion conducting layers surround the solid rod electrodes, the porous rod electrodes, the plate electrode, the porous rod positive electrode, the porous rod negative electrode or any combination of these. In an embodiment, for example, each ion conducting layer independently comprises a material selected from the group consisting of an aqueous solution; an organic solvent; a lithium salt; sulfuric acid; potassium hydroxide; an ionic liquid; a solid electrolyte; a polymer; poly(ethylene oxide); poly(propylene oxide); poly(styrene); poly(imide); poly(amine); poly(acrylonitrile); poly(vinylidene fluoride); polyacryonitrile, poly(vinyl chloride), poly(vinyl sulfone), poly(ethylene glycol diacrylate), poly(vinyidene fluoride), poly(tetrahydrofuran), poly(dioxolane), poly(ethylane oxide), poly(propylene oxide), poly(vinyl pyrrolidinoe); EC, PC, DME, DMC, LiClO₄, methoxyethoxyethyoxy phosphazine; diiodomethane; 1,3-diiodopropane; N,N-dimethylformamide; imethypropylene urea; ethylene carbonate; diethylene carbonate; dimethyl carbonate; propylene carbonate; a block copolymer lithium electrolyte doped with a lithium salt; glass; glass doped with at least one of LiI, LiF, LiCl, Li₂O—B₂O₃—Bi₂O₃, Li₂O—B₂O₃—P₂O₅ and Li₂OB₂O₃; a sol of at least one oxide of Si, B, P, Ti, Zr, Bb and Bi; a sol of at least one hydroxide of Si, B, B, Ti, Zr, Pb and Bi; a gel of at least one oxide of Si, B, P, Ti, Zr, Bb and Bi; a gel of at least one hydroxide of Si, B, B, Ti, Zr, Pb and Bi; LiClO₄, LiBF₄, LiAsF₆, LiCF₃, SO₃, LiPF₆, and LiN(SO₂CF₃)₂; salts of Mg(ClO₄)₂, Zn(ClO₄)₂, LiAlCl₄, and Ca(ClO₄)₂; solids of phosphorous based glass, oxide based glass, oxide sulfide based glass, selenide glass, gallium based glass, germanium based glass, sodium and lithium betaalumina, glass ceramic alkali metal ion conductors, Nasiglass; a polycrystalline ceramic of LISICON, NASICON, Li_{0.3}La_{0.7}TiO₃, sodium and lithium beta alumina; LISICON polycrystalline ceramics of lithium metal phosphates, LiTi₂(PO₄)₃; composite reaction products of alkali metal with Cu₃N, L₃N, Li₃P, LiI, LiF, LiBr, LiCl and LiPON; amides, amines, nitriles, organophosphorous solvents, and organasulfur solvents, N,N-dimethylformamide (DMF), N,N-dimethylacetamide (DMAC), dimethylsulfoxide (DMSO), hexamethylphosphoramide (HMPA), acetonitrile (AN) alcohols, dials and liquid polyols, diol, ethylene glycol, ethers, glymes, carbonates, g-butyrolactone (GBL), LIPON, PEO, PvDF, KOH, LiOH, NaOH, OHARA INC lithium conducting solid electrolyte and water and acids and bases and any combination of these.

In an embodiment, for example, the invention provides an electrochemical cell further comprising one or more electrolyte layers surrounding walls of one or more apertures of the plate electrodes, for example, wherein the electrolyte layers comprise a material selected from the group consisting of an aqueous solution; an organic solvent; a lithium salt; sulfuric acid; potassium hydroxide; an ionic liquid; a solid electrolyte; a polymer; poly(ethylene oxide); poly(propylene oxide); poly(styrene); poly(imide); poly(amine); poly(acrylonitrile); poly(vinylidene fluoride); polyacryonitrile, poly(vinyl chloride), poly(vinyl sulfone), poly(ethylene glycol diacrylate), poly(vinyidene fluoride), poly(tetrahydrofuran), poly(dioxolane), poly(ethylane oxide), poly(propylene oxide), poly(vinyl pyrrolidinoe); EC, PC, DME, DMC, LiClO₄, methoxyethoxyethyoxy phosphazine; diiodomethane; 1,3-diiodopropane; N,N-dimethylformamide; imethypropylene urea; ethylene carbonate; diethylene carbonate; dimethyl carbonate; propylene carbonate; a block copolymer lithium electrolyte doped with a lithium salt; glass; glass doped with at least one of LiI, LiF, LiCl, Li₂O—B₂O₃—Bi₂O₃, Li₂O—B₂O₃—P₂O₅ and Li₂OB₂O₃; a sol of at least one oxide of Si, B, P, Ti, Zr, Bb and Bi; a sol of at least one hydroxide of Si, B, B, Ti, Zr, Pb and Bi; a gel of at least one oxide of Si, B, P, Ti, Zr, Bb and Bi; a gel of at least one hydroxide of Si, B, B, Ti, Zr, Pb and Bi; LiClO₄, LiBF₄, LiAsF₆, LiCF₃, SO₃, LiPF₆, and LiN(SO₂CF₃)₂; salts of Mg(ClO₄)₂, Zn(ClO₄)₂, and Ca(ClO₄)₂; solids of phosphorous based glass, oxide based glass, oxide sulfide based glass, selenide glass, gallium based glass, germanium based glass, sodium and lithium betaalumina, glass ceramic alkali metal ion conductors, Nasiglass; a polycrystalline ceramic of LISICON, NASICON, Li_{0.3}La_{0.7}TiO₃, sodium and lithium beta alumina; LISICON polycrystalline ceramics of lithium metal phosphates, LiTi₂(PO₄)₃; composite reaction products of alkali metal with Cu₃N, L₃N, Li₃P, LiI, LiF, LiBr, LiCl and LiPON; amides, amines, nitriles, organophosphorous solvents, and organasulfur solvents, N,N-dimethylformamide (DMF), N,N-dimethylacetamide (DMAC), dimethylsulfoxide (DMSO), hexamethylphosphoramide (HMPA), acetonitrile (AN) alcohols, dials and liquid polyols, diol, ethylene glycol, ethers, glymes, carbonates, g-butyrolactone (GBL), OHARA INC lithium conducting solid electrolyte and water and acids and bases and any combination of these.

In an embodiment, the invention provide an electrochemical cell comprising at least one solid rod electrode or porous rod negative electrode and at least one porous rod electrode or porous rod positive electrode. In an embodiment, the invention provide an electrochemical cell comprising a metal-air battery. In an embodiment, the invention provide an electrochemical cell comprising a lithium-air battery. In an embodiment, the invention provide an electrochemical cell comprising a zinc-air battery. In an embodiment, the invention provide an electrochemical cell comprising a lithium-water battery. In an embodiment, the invention provide an electrochemical cell wherein at least one of the positive and negative electrode comprises electrode-active material comprising an insoluble flowable semi-solid or condensed liquid ion-storing redox composition or redox compound which is capable of taking up or releasing the ions and remains insoluble during operation of the cell.

Optionally, an electrochemical cell comprises a metal-air battery. Optionally an electrochemical cell comprises a lithium-air battery. Optionally, an electrochemical cell comprises a zinc-air battery. Optionally an electrochemical cell comprises a lithium-water battery.

Optionally, for electrochemical cells of this aspect, each rod electrode comprises a positive electrode. Optionally, for electrochemical cells of this aspect, each rod electrode comprises a negative electrode. Optionally, for electrochemical cells of this aspect, each plate electrode comprises a positive electrode. Optionally, for electrochemical cells of this aspect, each plate electrode comprises a negative electrode. Optionally, in an electrochemical cell of the invention any of the plate electrodes and any of the rod electrodes independently comprise a negative electrode. Optionally, in an electrochemical cell of the invention any of the plate electrodes and any of the rod electrodes comprise a positive electrode.

Optionally, in an electrochemical cell embodiment, one or more plate electrodes have identical dimensions. Optionally, in an electrochemical cell embodiment, one or more plate electrodes have different dimensions. Optionally, in an electrochemical cell embodiment, each plate electrode comprises an electronically and thermally conductive material. Optionally, in an electrochemical cell embodiment, one or more porous rod electrodes comprise a temperature control fluid. Useful temperature control fluids include, but are not limited to, liquid nitrogen, water, air and a refrigerant.

Optionally, in an electrochemical cell embodiment, any of the plate electrodes or any of the rod electrodes independently form a positive electrodes or a negative electrodes. Optionally, in an electrochemical cell embodiment, at least some of the porous rod electrodes or porous plate electrodes are used to cool down the cell by the flow of a coolant fluid. Optionally, in an electrochemical cell embodiment, each plate electrode independently comprises an electronic and thermal conductor. Optionally, in an electrochemical cell embodiment, the electrochemical cell comprises a flow battery. Optionally, in an electrochemical cell embodiment, the electrochemical cell comprises an alkaline flow battery. Optionally, in an electrochemical cell embodiment, the electrochemical cell comprises a lithium-ion based flow battery. Optionally, in an electrochemical cell embodiment, the electrochemical cell comprises a fuel cell. Optionally, in an electrochemical cell embodiment, hydrogen or a fossil fuel or methanol flows through one or more porous rods and wherein oxygen flows through one or more porous rods, and wherein one or more plates electrodes comprise a cathode current collectors and wherein one or more plate electrodes comprise anode current collectors. Optionally, in an electrochemical cell embodiment the electrochemical cell comprises a flowable electrochemical capacitor.

In another aspect, the invention provides a composition for a redox flow energy storage device, comprising a flowable ion-storing redox composition which is capable of taking up or releasing the ions during operation of the device, wherein the flowable ion-storing redox composition comprises at least one compound selected from a ketone; a diketone; a triether; a compound containing 1 nitrogen and 1 oxygen atom; a compound containing 1 nitrogen and 2 oxygen atoms; a compound containing 2 nitrogen atoms and 1 oxygen atom; a phosphorous containing compound, and fluorinated, nitrile, and/or perfluorinated derivatives of these. Compositions of this aspect are useful as a component of an electrochemical cell of other aspects.

In another aspect, the invention provides a composition for a redox flow energy storage device, comprising a flowable semi-solid or condensed liquid ion-storing redox composition which is capable of taking up or releasing the ions during operation of the device, wherein the flowable ion-storing redox composition comprises at least one of an ether, a ketone, a diether, diketone, an ester, a triether, a carbonate; an amide, a sulfur containing compound; a phosphorous containing compound, an ionic liquid, and fluorinated, nitrile, and perfluorinated derivatives of these. Compositions of this aspect are useful as a component of an electrochemical cell of other aspects.

In another aspect, the invention provides an electrochemical cell comprising: (i) a plurality of plate electrodes, wherein each plate electrode includes an array of apertures, wherein the plate electrodes are arranged in a substantially parallel orientation such that the each aperture of an individual plate electrode is aligned along an independent plate alignment axis passing through an aperture of each of one or more or all other plate electrodes; (ii) a plurality of rod electrodes, wherein the plurality of rod electrodes are arranged such that each rod electrode extends a length along an alignment axis passing through an aperture of each plate electrode; and (iii) at least one electrolyte provided between the plate electrodes and the rod electrodes, wherein the at least one electrolyte is capable of conducting charge carriers; wherein at least one of the plate electrodes, at least one of the rod electrodes or both at least one of the plate electrodes and at least one of the rod electrodes each independently comprise a porous material for flowing a flowable ion-storing redox composition, wherein a first surface area includes a cumulative surface area of the plurality of plate electrodes, wherein a second surface area includes a cumulative surface area of each aperture array and wherein a third surface area includes a cumulative surface area of each of the plurality of rod electrodes. In an embodiment, for example, the ratio of the second surface area to the first surface area is selected over the range of 0.1 to 5, optionally selected over the range of 1 to 5 and selected over the range of 2.5 to 5. In an embodiment, for example, the ratio of the second surface area to the third surface area is selected over the range of 0.2 to 5, and optionally for some embodiments selected over the range of 0.2 to 1 and optionally for some embodiments selected over the range of 1 to 5.

In an embodiment, for example, the invention provides an electrochemical cell further comprising one or more electronically insulating and ion-permeable separators positioned between each of the rod electrodes and the plate electrodes. In an embodiment, for example, the invention provides an electrochemical cell wherein the rod electrodes comprise the porous materials for flowing the flowable ion-storing redox composition. In an embodiment, for example, the invention provides an electrochemical cell wherein the rod electrodes comprise positive electrodes. In an embodiment, for example, the invention provides an electrochemical cell wherein the rod electrodes comprise negative electrodes. In an embodiment, for example, the invention provides an electrochemical cell wherein the rod electrodes are hollow rod structures comprising a porous and electrically conductive material. In an embodiment, for example, the invention provides an electrochemical cell wherein the flowable ion-storing redox composition is flowed through the hollow rod structure comprising the porous materials. In an embodiment, for example, the invention provides an electrochemical cell wherein each of the rod electrodes further comprise a central cavity extending along a longitudinal axis of the hollow rod structure, thereby providing a fluid path for the flowable ion-storing redox composition. In an embodiment, for example, the invention provides an electrochemical cell wherein the rod electrodes comprise solid rod electrodes, such as electrodes comprising Li, Na, Al, Mg, Fe, Si, Carbon, Zn or Ag or Au or their alloys or their oxides or their metal oxides or LiFePO₄ or LiCoO₂ or LiMn₂O₄ or their solutions or their slurries or powders made of them or any combination thereof.

In an embodiment, for example, the invention provides an electrochemical cell wherein the rod electrodes further comprise an ion conductive membrane positioned on at least a portion of one or more exterior surfaces of the rod electrodes. In an embodiment, for example, the invention provides an electrochemical cell wherein the rod electrodes further comprise a current collector in electrical contact with the porous and electrically conductive material.

In an embodiment, for example, the invention provides an electrochemical cell further comprising a plurality of solid rod electrodes or porous rod negative electrodes, wherein the plurality of solid rod electrodes or porous rod negative electrodes are arranged such that each solid rod electrode extends a length along an independent negative electrode alignment axis passing through an aperture of each plate electrode. In an embodiment, for example, the invention provides an electrochemical cell wherein the solid rod electrodes or porous rod negative electrodes comprise negative electrodes in the electrochemical cell. In an embodiment, for example, the solid rod electrodes or porous rod negative electrodes are not in physical contact with the rod electrodes or where the solid rod electrodes or porous rod negative electrodes are not in physical contact with the plate electrodes or wherein the solid rod electrodes or porous rod negative electrodes are not in physical contact with the rod electrodes and plate electrodes. In an embodiment, for example, the solid rod electrodes or porous rod negative electrodes comprise an anode active material, such as an anode active material is selected from the group consisting of Li, Na, Al, Mg, Fe, Si, Carbon, Zn or Ag or Au or their alloys or their oxides or or their metal oxides or LiFePO₄ or LiCoO₂ or LiMn₂O₄ or their solutions or their slurries or powders made of them or any combination thereof. In an embodiment, for example, the invention provides an electrochemical cell wherein the solid rod electrodes or porous rod negative electrodes further comprise an electrolyte in contact with the anode active material. In an embodiment, for example, the invention provides an electrochemical cell wherein the solid rod electrodes or porous rod negative electrodes further comprise an ionic conductive electronically insulating membrane electrolyte in contact with the electrolyte or the anode active material. In an embodiment, for example, the invention provides an electrochemical cell wherein the solid rod electrodes or porous rod negative electrodes further comprise a current collector in electrical contact with the anode active material. In an embodiment, for example, the invention provides an electrochemical cell wherein the solid rod electrodes or porous rod negative electrodes further comprise a current collector provided in a central cavity within the anode active material or provided on an external surface of the anode active material. In an embodiment, for example, the invention provides an electrochemical cell wherein each of the solid rod electrodes or porous rod negative electrodes are provided in an aperture of the plate electrode adjacent to at least one aperture of the plate electrode having the rod electrode.

In an embodiment, for example, the invention provides an electrochemical cell wherein the plate electrodes comprise the porous materials for flowing the flowable ion-storing redox composition. In an embodiment, for example, the invention provides an electrochemical cell wherein each plate electrode comprises a thin gas diffusion layer or a flow channel. In an embodiment, for example, the flowable ion-storing redox composition is flowed through the plate electrode comprising the porous materials. In an embodiment, for example, the plate electrodes are separated from each other by spaces provided between adjacent plate electrodes.

In an embodiment, for example, the invention provides an electrochemical cell wherein at least a portion of the rod electrodes are composite electrodes independently comprising an anode active material and a porous and electrically conductive material, wherein the anode active material and the porous and electrically conductive material are separated by a solid electrolyte or a separator. In an embodiment, for example, the invention provides an electrochemical cell having a composite electrode wherein the anode active material and the porous and electrically conductive material are separated by an ionic conductive and electronically insulating layer. In an embodiment, for example, the composite electrode further comprises a first current collector in electrical contact with the anode active material and a second current collector in electrical contact with the porous and electrically conductive material. In a specific embodiment, a composite electrode comprises a copper current collector surrounded by a graphite shell, surrounded by a solid electrolyte surrounded by a gas diffusion layer.

In an embodiment, for example, the invention provides an electrochemical cell further comprising a membrane to filter the flowing flowable ion-storing redox composition prior to reaction at an electrode.

In an embodiment, for example, the invention provides an electrochemical cell with one or more electrode capable of receiving one or more flowable ion-storing redox composition that undergoes reaction at the positive electrode or negative electrode. In an embodiment, for example, the flowable ion-storing redox composition is a fluid oxidant. In an embodiment, for example, the flowable ion-storing redox composition is O₂, air or water. In an embodiment, for example, the flowable ion-storing redox composition is flowed longitudinally, laterally or radially in the electrochemical cell.

In an embodiment, for example, the invention provides an electrochemical cell wherein one or more plate electrodes and one or more rod electrodes comprise an air cathode that has a bi-electrode configuration including an oxygen evolution electrode and an oxygen reduction electrode different from the oxygen evolution electrode. In an embodiment, for example, the invention provides an electrochemical cell wherein air cathode reduction during discharging is by means of current collectors of one or more parallel porous plate electrodes and air cathode oxidation during charging is by means of current collectors of one or more porous rods. In an embodiment, for example, the invention provides an electrochemical cell wherein air cathode reduction during discharging is by means of current collectors of one or more porous rod electrodes and air cathode oxidation during charging is by means of current collectors of one or more porous plate electrodes. In an embodiment, for example, the invention provides an electrochemical cell wherein any or all of the porous rod electrodes or porous plate electrodes have a bi-electrode configuration.

In another aspect, the invention provides a method of generating electrical current, the method comprising the steps of: (i) providing a part solid, part fluid electrochemical cell; wherein the electrochemical cell comprises: (1) a plurality of plate electrodes, wherein each plate electrode includes an array of apertures, wherein the plate electrodes are arranged in a substantially parallel orientation such that the each aperture of an individual plate electrode is aligned along an independent plate alignment axis passing through an aperture of each of one or more or all other plate electrodes; (2) one or more solid rod electrodes, wherein the plurality of solid rod electrodes are arranged such that each solid rod electrode extends a length along an independent solid rod alignment axis passing through an aperture of each plate electrode; (3) one or more porous rod electrodes, wherein the plurality of porous rod electrodes are arranged such that each porous rod electrode extends a length along an independent porous rod alignment axis passing through an aperture of each plate electrode; (4) at least one electrolyte provided between the solid rod electrodes and the plate electrodes and the porous rod electrodes, wherein the at least one electrolyte is capable of conducting charge carriers; wherein a first surface area includes a cumulative surface area of the plurality of plate electrodes, wherein a second surface area includes a cumulative surface area of each aperture array, wherein a third surface area includes a cumulative surface area of each of the solid rod electrodes and wherein a fourth surface area includes a cumulative surface area of each of the porous rod electrodes; (ii) flowing a flowable ion-storing redox composition through the porous rod electrodes; wherein the flowable ion-storing redox composition undergoes a redox reaction at the porous rod electrodes; and (iii) discharging the electrochemical cell, thereby generating the electrical current.

In another aspect, the invention provides a method of generating electrical current, the method comprising the steps of: (i) providing an electrochemical cell; wherein the electrochemical cell comprises: (1) a plurality of plate electrodes, wherein each plate electrode includes an array of apertures, wherein the plate electrodes are arranged in a substantially parallel orientation such that the each aperture of an individual plate electrode is aligned along an independent plate alignment axis passing through an aperture of each of one or more or all other plate electrodes; (2) one or more porous rod positive electrodes, wherein the plurality of porous rod positive electrodes are arranged such that each porous rod positive electrode extends a length along an independent positive electrode alignment axis passing through an aperture of each plate electrode; (3) one or more porous rod negative electrodes, wherein the plurality of porous rod negative electrodes are arranged such that each porous rod negative electrode extends a length along an independent negative electrode alignment axis passing through an aperture of each plate electrode; (4) at least one electrolyte provided between the porous rod negative electrodes and the plate electrodes or between the porous rod negative electrodes and the porous rod positive electrodes, wherein the at least one electrolyte is capable of conducting charge carriers; wherein a first surface area includes a cumulative surface area of the plurality of plate electrodes, wherein a second surface area includes a cumulative surface area of each aperture array, wherein a third surface area includes a cumulative surface area of each of the porous hollow positive rod electrodes and wherein a fourth surface area includes a cumulative surface area of each of the porous hollow negative rod electrodes; (ii) flowing a first flowable ion-storing redox composition through the porous rod negative electrodes; wherein the first flowable ion-storing redox composition undergoes a redox reaction at the porous rod negative electrodes; (iii) flowing a second flowable ion-storing redox composition through the porous rod positive electrodes; wherein the second flowable ion-storing redox composition undergoes a redox reaction at the porous rod positive electrodes and (iv) discharging the electrochemical cell, thereby generating the electrical current.

In another aspect, the invention provides a method of generating electrical current, the method comprising the steps of: (1) providing an electrochemical cell; wherein the electrochemical cell comprises: (1) a plurality of plate electrodes, wherein each plate electrode includes an array of apertures, wherein the plate electrodes are arranged in a substantially parallel orientation such that the each aperture of an individual plate electrode is aligned along an independent plate alignment axis passing through an aperture of each of one or more or all other plate electrodes; (2) a plurality of rod electrodes, wherein the plurality of rod electrodes are not in physical contact with the plurality of plate electrodes and are arranged such that each rod electrode extends a length along an alignment axis passing through an aperture of each plate electrode; and (3) an electrolyte provided between the plate electrodes and the rod electrodes, wherein the electrolyte is capable of conducting charge carriers; wherein the plate electrodes, the rod electrodes or both the plate electrodes and the rod electrodes each independently comprise a porous material for flowing a flowable ion-storing redox composition, wherein a first surface area includes a cumulative surface area of the plurality of plate electrodes, wherein a second surface area includes a cumulative surface area of each aperture array and wherein a third surface area includes a cumulative surface area of each of the plurality of rod electrodes; (ii) flowing a flowable ion-storing redox composition through the porous rod electrodes; wherein the flowable ion-storing redox composition undergoes a redox reaction at the porous rod electrodes; and (iii) discharging the electrochemical cell, thereby generating the electrical current.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIGS. 1A and 1B provide views of components of a three-dimensional electrode array embodiment, for example, a three-dimensional electrode array useful in a part solid, part fluid electrochemical cell.

FIGS. 2A and 2B provide front views of components of a three-dimensional electrode array embodiment showing alternate cross-sectional shapes.

FIGS. 3A and 3B provide views of a three-dimensional electrode array embodiment.

FIGS. 4A and 4B provide views of a three-dimensional electrode array embodiment comprising two different electrolytes.

FIGS. 5A and 5B provide views of a three-dimensional electrode array embodiment comprising elements for controlling the temperature of the electrode array.

FIG. 6 provide views of a three-dimensional electrode array embodiment with plate electrodes having a thickness larger than the spacing between plates.

FIGS. 7A and 7B provide views of a three-dimensional electrode array embodiment comprising a fluid and a solid in the interelectrode space.

FIG. 8 provide views of a three-dimensional electrode array embodiment comprising closely spaced apertures in plate electrodes.

FIG. 9 provide views of a three-dimensional electrode array embodiment comprising different rod electrode materials.

FIG. 10 provide views of a three-dimensional electrode array embodiment comprising different plate electrode materials.

FIG. 11 provides a view of a three-dimensional electrode array in which a fluid surrounding the electrodes is induced to flow.

FIG. 12 provides views of a three-dimensional electrode array comprising hollow tube rod electrodes.

FIGS. 13A and 13B provide views of a three-dimensional electrode array comprising a first flowing fluid surround the plate electrodes and a second flowing fluid surrounding the rod electrodes.

FIG. 14 provides views of a rod electrode embodiment.

FIGS. 15A and 15B provides views of a three-dimensional electrode array comprising hollow tube rod electrodes.

FIGS. 16A and 16B provide schematic drawings of a composite rod electrode structure.

FIGS. 17A-17E provide schematic drawings of a three dimensional electrode array and optionally one or more flowing electrolyte components.

FIGS. 18A and 18B provide views of a composite rod electrode structure comprising a porous rod.

FIG. 19 provides data showing a charge-discharge curve for cycling an electrochemical cell embodiment comprising a three-dimensional electrode array including Ewe versus time and Current (I) versus time.

FIG. 20 provides a view of a single aperture of a plate electrode showing multiple rod electrodes.

FIG. 21 provides a schematic cross-sectional side view of a three-dimensional electrode array comprising branched rod electrodes. The inset shows a top view.

FIG. 22 provides a schematic cross-sectional side view of a three-dimensional electrode array comprising a bridge type structure linking the rod electrodes. The inset shows a top view.

FIGS. 23A and 23B provide a schematic diagram illustrating a hollow rod cathode for use in some of the electrochemical cells of the invention, particularly part solid, part fluid electrochemical cells such as a metal-air battery system including a lithium-air battery or zinc-air battery, or a metal-aqueous battery system, such as a lithium-water battery.

FIGS. 24A and 24B provide a schematic diagram illustrating another hollow rod cathode for use in some of the electrochemical cells of the invention, particularly part solid, part fluid electrochemical cells such as a metal-air battery system including a lithium-air battery or zinc-air battery, or a metal-aqueous battery system, such as a lithium-water battery.

FIGS. 25A and 25B provide a schematic diagram illustrating a rod anode for use in some of the electrochemical cells of the invention, particularly part solid, part fluid electrochemical cells such as a metal-air battery system including a lithium-air battery or zinc-air battery, or a metal-aqueous battery system, such as a lithium-water battery.

FIGS. 26A and 26B provide a schematic diagram illustrating another rod anode for use in some of the electrochemical cells of the invention, particularly part solid, part fluid electrochemical cells such as a metal-air battery system including a lithium-air battery or zinc-air battery, or a metal-aqueous battery system, such as a lithium-water battery.

FIG. 27 provides a side view of an electrochemical cell of the invention particularly useful for part solid, part fluid electrochemical cells such as a metal-air battery system including a lithium-air battery or zinc-air battery, or a metal-aqueous battery system, such as a lithium-water battery.

FIG. 28 provides a side view of another electrochemical cell of the invention particularly useful for part solid, part fluid electrochemical cells such as a metal-air battery system including a lithium-air battery or zinc-air battery, or a metal-aqueous battery system, such as a lithium-water battery.

FIG. 29 provides a side view of another electrochemical cell of the invention particularly useful for part solid, part fluid electrochemical cells such as a metal-air battery system including a lithium-air battery or zinc-air battery, or a metal-aqueous battery system, such as a lithium-water battery.

FIG. 30 provides a side view of another electrochemical cell of the invention particularly useful for part solid, part fluid electrochemical cells wherein the cylindrical anode has a current collector (e.g., metal wire) provided in its core.

FIG. 31 provides a side view of another electrochemical cell of the invention particularly useful for part solid, part fluid electrochemical cells wherein the cylindrical anode has a current collector (e.g., metal wire) provided in its core and the hollow rod cathode has a current collectors provided at the bottom and on the exterior of the rod.

FIG. 32 provides a side view of another electrochemical cell of the invention particularly useful for part solid, part fluid electrochemical cells further comprising a membrane for filtering the flow of cathode active material.

FIG. 33 provides a side view of another electrochemical cell of the invention particularly useful for part solid, part fluid electrochemical cells further comprising a membrane 3310 for filtering the flow of cathode active material.

FIG. 34 provides a side view of another electrochemical cell of the invention particularly useful for part solid, part fluid electrochemical cells wherein tightly packed parallel cylinders of anode and cathode are in a bath of the electrolyte. In the specific embodiment shown in FIG. 34, there is no perforated plate component of the cell.

FIG. 35 provides a side view of another electrochemical cell of the invention particularly useful for part solid, part fluid electrochemical cells wherein tightly packed parallel cylinders of anode and cathode are in a matrix of an electronic and ionic media (e.g., porous carbon and electrolyte). In the specific embodiment shown in FIG. 35, there is one thick perforated plate component of the cell.

FIG. 36 provides a side view of another electrochemical cell of the invention particularly useful for part solid, part fluid electrochemical cells wherein tightly packed parallel cylinders of anode and cathode are in a matrix of a, electronic and ionic media (e.g., porous carbon and electrolyte). In the specific embodiment shown in FIG. 36, there is one thick perforated plate component of the cell with layers of current collectors 3610 (e.g. perforated plates, network or mesh of metals).

FIG. 37 provides a side view of another electrochemical cell of the invention particularly useful for part solid, part fluid electrochemical cells wherein tightly packed parallel cylinders of anode and cathode are in a matrix of an electronic and ionic media (e.g., porous carbon and electrolyte). In the specific embodiment shown in FIG. 37, there is one thick perforated plate component of the cell.

FIG. 38 provides a top view of an electrochemical cell of the invention particularly useful for part solid, part fluid electrochemical cells showing an electrode array configuration.

FIG. 39 provides a top view of an electrochemical cell of the invention particularly useful for part solid, part fluid electrochemical cells showing another electrode array configuration and an assembly of current collectors.

FIG. 40 provides a top view of an electrochemical cell of the invention particularly useful for part solid, part fluid electrochemical cells showing another electrode array configuration and an assembly of current collectors.

FIG. 41 provides a top view of an electrochemical cell of the invention particularly useful for part solid, part fluid electrochemical cells showing another electrode array configuration.

FIG. 42 provides a top view of an electrochemical cell of the invention particularly useful for part solid, part fluid electrochemical cells showing another electrode array configuration.

FIG. 43 provides a top view of an electrochemical cell of the invention particularly useful for part solid, part fluid electrochemical cells showing another electrode array configuration.

FIGS. 44A and 44B provide a schematic diagram illustrating an composite rod electrode wherein at least a portion of the rod is a composite cylinder comprising the anode and the cathode.

FIGS. 45A and 45B provide a schematic diagram illustrating an composite rod electrode wherein at least a portion of the rod is a composite cylinder comprising the anode, the cathode and current collectors.

FIGS. 46A and 46B provide a schematic diagram illustrating an composite rod electrode wherein at least a portion of the rod is a composite cylinder comprising the anode and the cathode.

FIGS. 47A and 47B provide a schematic diagram illustrating a composite rod electrode wherein at least a portion of the rod is a composite cylinder comprising the anode and the cathode.

FIGS. 48A and 48B provide a schematic diagram illustrating a composite rod electrode wherein at least a portion of the rod is a composite cylinder comprising the anode, the cathode and current collectors.

FIG. 49 provides a side view of an electrochemical cell of the invention particularly useful for part solid, part fluid electrochemical cells such as a metal-air battery system including a lithium-air battery or zinc-air battery, or a metal-aqueous battery system, such as a lithium-water battery.

FIG. 50 provides a side view of an electrochemical cell of the invention particularly useful for part solid, part fluid electrochemical cells similar to that shown in FIG. 27 but including both lateral (or radial) and longitudinal flows of cathode active materials (schematically represented as arrows)

FIG. 51 provides a side view of an electrochemical cell of the invention particularly useful for part solid, part fluid electrochemical cells similar to that shown in FIG. 27 but including both lateral (or radial) and longitudinal flows of cathode active materials (schematically represented as arrows).

FIG. 52 provides a top view of an electrochemical cell of the invention particularly useful for part solid, part fluid electrochemical cells showing an electrode array configuration, wherein the arrows indicate the fluid flow of the cathode active materials.

FIG. 53 provides a top view of an electrochemical cell of the invention particularly useful for part solid, part fluid electrochemical cells showing an electrode array configuration, wherein the arrows indicate the fluid flow of the cathode active materials.

FIG. 54 provides a side view of an electrochemical cell of the invention particularly useful for part solid, part fluid electrochemical cells such as a metal-air battery system having an electrically insulating and non-permeable ring component into the 3D electrode array.

FIG. 55 illustrates an exemplary lithium-air cell.

FIG. 56 provides a schematic diagram illustrating a 3-dimensional electrode array of the invention showing a first series of electrodes (each designated “Electrode 1”) and a second series of electrodes (each designated “Electrode 2”)

FIGS. 57A and 57B provides a schematic diagrams illustrating a 3 dimensional electrode array of the present invention, for example for use in a metal-air batteries such as in lithium-air batteries.

FIGS. 58A and 58B provide schematic diagrams of an example electrode array of the present invention, for example, for use in a metal—air battery of the present invention.

FIG. 59A provides a plot of 3D cell capacity for a cell comprising LiCoO₂ plates and lithium rods, versus number of cycles illustrating the charge-discharge capacity. FIG. 59B provides a plot of 3D cell power density in comparison to a conventional parallel plate cell with the same mass of active material and same current per anode surface area versus time, illustrating the surface power density of an electrochemical cell having the 3D electrode geometry of the present invention.

FIGS. 60A, 60B and 60C provide images of an aprotic Li-Air electrochemical cell of the invention and components thereof.

FIGS. 61A and 61B show the results of experimental testing of a 3-d cell of the present invention comprising 2 lithium rods, each about 2 mm diameter, 3 carbon based gas diffusion layers (no catalyst) and 7 holes for oxygen gas. FIG. 61C shows the open circuit voltage of the cell.

FIG. 62 provides a side view of an electrochemical cell of the invention having a gap between the rod electrodes and plate electrodes, for example, a gap provided by a spacer or other mechanical separation component (e.g., a frame).

FIG. 63 provides a side view of an alternative embodiment similar to that shown in FIG. 62, but wherein a gap is provide between only a portion of the rod electrodes and the plate electrodes, such as a gap provided by a spacer or other mechanical separation component (e.g., a frame).

FIG. 64 provides schematics providing a top view and front view of components of an electrochemical cell of the present invention having plate electrodes with varying physical dimensions.

FIGS. 65A and 65B provide schematics showing side views of 3D electrode array geometries of the invention including plate electrodes having varying physical dimensions.

### DETAILED DESCRIPTION OF THE INVENTION

In general, the terms and phrases used herein have their art-recognized meaning, which can be found by reference to standard texts, journal references and contexts known to those skilled in the art. The following definitions are provided to clarify their specific use in the context of the invention.

Referring to the drawings, like numerals indicate like elements and the same number appearing in more than one drawing refers to the same element. In addition, hereinafter, the following definitions apply:

The term “electrochemical cell” refers to devices and/or device components that convert chemical energy into electrical energy or electrical energy into chemical energy. Electrochemical cells have two or more electrodes (e.g., positive and negative electrodes) and an electrolyte, wherein electrode reactions occurring at the electrode surfaces result in charge transfer processes. Electrochemical cells include, but are not limited to, primary batteries, secondary batteries and electrolysis systems. In certain embodiments, the term electrochemical cell includes fuel cells, supercapacitors, capacitors, flow batteries, part solid, part fluid electrochemical cells, such as metal-air batteries including lithium-air batteries and zinc-air batteries, and metal-aqueous batteries system, such as a lithium-water battery and semi-solid batteries. General cell and/or battery construction is known in the art, see e.g., U.S. Pat. Nos. 6,489,055, 4,052,539, 6,306,540, Seel and Dahn J. Electrochem. Soc. 147(3) 892-898 (2000).

The term “capacity” is a characteristic of an electrochemical cell that refers to the total amount of electrical charge an electrochemical cell, such as a battery, is able to hold. Capacity is typically expressed in units of ampere-hours. The term “specific capacity” refers to the capacity output of an electrochemical cell, such as a battery, per unit weight. Specific capacity is typically expressed in units of ampere-hours kg⁻¹.

The term “discharge rate” refers to the current at which an electrochemical cell is discharged. Discharge current can be expressed in units of amperes. Alternatively, discharge current can be normalized to the rated capacity of the electrochemical cell, and expressed as C/(X t), wherein C is the capacity of the electrochemical cell, X is a variable and t is a specified unit of time, as used herein, equal to 1 hour.

“Current density” refers to the current flowing per unit electrode area.

Electrode refers to an electrical conductor where ions and electrons are exchanged with electrolyte and an outer circuit. “Positive electrode” and “cathode” are used synonymously in the present description and refer to the electrode having the higher electrode potential in an electrochemical cell (i.e. higher than the negative electrode). “Negative electrode” and “anode” are used synonymously in the present description and refer to the electrode having the lower electrode potential in an electrochemical cell (i.e. lower than the positive electrode). Cathodic reduction refers to a gain of electron(s) of a chemical species, and anodic oxidation refers to the loss of electron(s) of a chemical species. Positive electrodes and negative electrodes of the present electrochemical cell may further comprises a conductive diluent, such as acetylene black, carbon black, powdered graphite, coke, carbon fiber, graphene, and metallic powder, and/or may further comprises a binder, such polymer binder. Useful binders for positive electrodes in some embodiments comprise a fluoropolymer such as polyvinylidene fluoride (PVDF). Positive and negative electrodes of the present invention may be provided in a range of useful configurations and form factors as known in the art of electrochemistry and battery science, including thin electrode designs, such as thin film electrode configurations. Electrodes are manufactured as disclosed herein and as known in the art, including as disclosed in, for example, U.S. Pat. Nos. 4,052,539, 6,306,540, 6,852,446. For some embodiments, the electrode is typically fabricated by depositing a slurry of the electrode material, an electrically conductive inert material, the binder, and a liquid carrier on the electrode current collector, and then evaporating the carrier to leave a coherent mass in electrical contact with the current collector.

“Electrode potential” refers to a voltage, usually measured against a reference electrode, due to the presence within or in contact with the electrode of chemical species at different oxidation (valence) states.

“Electrolyte” refers to an ionic conductor which can be in the solid state, the liquid state (most common) or more rarely a gas (e.g., plasma).

“Standard electrode potential”) (E°) refers to the electrode potential when concentrations of solutes are 1 M, the gas pressures are 1 atm and the temperature is 25 degrees Celsius. As used herein standard electrode potentials are measured relative to a standard hydrogen electrode.

“Active material” refers to the material in an electrode that takes part in electrochemical reactions which store and/or delivery energy in an electrochemical cell.

“Cation” refers to a positively charged ion, and “anion” refers to a negatively charged ion.

“Electrical contact” and “electrical communication” refers to the arrangement of one or more objects such that an electric current efficiently flows from one object to another. For example, in some embodiments, two objects having an electrical resistance between them less than 100Ω are considered in electrical communication with one another. An electrical contact can also refer to a component of a device or object used for establishing electrical communication with external devices or circuits, for example an electrical interconnection. “Electrical communication” also refers to the ability of two or more materials and/or structures that are capable of transferring charge between them, such as in the form of the transfer of electrons. In some embodiments, components in electrical communication are in direct electrical communication wherein an electronic signal or charge carrier is directly transferred from one component to another. In some embodiments, components in electrical communication are in indirect electrical communication wherein an electronic signal or charge carrier is indirectly transferred from one component to another via one or more intermediate structures, such as circuit elements, separating the components.

“Thermal contact” and “thermal communication” are used synonymously and refer to an orientation or position of elements or materials, such as a current collector or heat transfer rod and a heat sink or a heat source, such that there is more efficient transfer of heat between the two elements than if they were thermally isolated or thermally insulated. Elements or materials may be considered in thermal communication or contact if heat is transported between them more quickly than if they were thermally isolated or thermally insulated. Two elements in thermal communication or contact may reach thermal equilibrium or thermal steady state and in some embodiments may be considered to be constantly at thermal equilibrium or thermal steady state with one another. In some embodiments, elements in thermal communication with one another are separated from each other by a thermally conductive material or intermediate thermally conductive material or device component. In some embodiments, elements in thermal communication with one another are separated by a distance of 1 μm or less. In some embodiments, elements in thermal communication with one another are provided in physical contact.

“Porosity” refers to the amount of a material or component, such as a rode electrode or plate electrode, that corresponds to pores, such as apertures, channels, voids, etc. Porosity may be expressed as the percentage of the volume of a material, structure or device component, such as a high mechanical strength layer, that corresponds to pores, such as apertures, channels, voids, etc., relative to the total volume occupied by the material, structure or device component. In an embodiment, one or more rod electrodes and/or one or more plate electrodes of the array and/or electrochemical cell is a porous electrode, for example, independently having a porosity selected from the range of 20% to 95%, preferably for some applications a porosity selected from the range of 50% to 95%.

“Parallel orientation” refers to a relative orientation between two or more objects, such as two or more electrodes, such that the two or more objects have axes that do not intersect. The phrase “substantially parallel orientation” refers to a relative orientation between two or more objects where axes of the objects have deviations from a perfectly parallel orientation, such as a deviation of less than 10 degrees from parallel, a deviation of less than 5 degrees from parallel or a deviation of less than 1 degree from perfectly parallel. Optionally, objects that have a substantially parallel orientation are perfectly parallel.

“Flowable ion-storing redox composition” refers to a component of a fluid, whether itself a fluid, a suspended particulate matter or a dissolved moiety, that participates in a half-reaction and reacts at or with either or both of the anode electrode and the cathode electrode of an electrochemical cell. In embodiments, a flowable ion-storing redox composition is provided to a porous electrode, such that the flowable ion-storing redox composition permeates through the porous electrode to reach another component of an electrochemical cell, such as an electrode or an electrolyte. Useful flowable ion-storing redox compositions include, but are not limited to, compositions that can be both oxidized and reduced. Useful specific flowable ion-storing redox compositions include, but are not limited to O₂, H₂O, ketones, diketones, triether, a compound containing 1 nitrogen atom and 1 oxygen atom, a compound containing 1 nitrogen atom and 2 oxygen atoms, a compound containing 2 nitrogen atoms and 2 oxygen atoms, a phosphorus containing compound or fluorinated, perfluorinated or nitrile derivatives thereof. In a specific embodiment, a flowable ion-storing redox composition is a fluid oxidant. In a specific embodiment, a flowable ion-storing redox composition is a fluid reductant.

The 3-dimensional (3-D) electrochemical cells described herein provide a versatile cell construction, useful with a variety of types and chemistries of electrochemical cells. In general, the 3-D electrochemical cell design described herein includes arrays of one or more parallel plate electrodes intersected by an array of a plurality of rod electrodes. The 3-D cell design approach described herein provides a number of unique benefits and advantages over prior electrochemical cell designs.

For example, the 3-D design is readily scalable, can be used by either liquid electrolyte or solid or polymer electrolytes and can be made in any sizes from nanosize to large scale systems for utility scale storage. In addition, the 3-D design allows implementing current manufacturing methods in several existing industries such as automation, packaging, MEMS and semiconductors, in addition to the battery industry.

Compared with the current parallel plate approach for semi-solid batteries, the 3-D approach, when combined with flowing active materials, significantly improves the performance by providing 3 dimensional electric conductivities and better heat conductivity even at larger scales. Another major benefit of the 3-D design versus parallel plate systems of molten salt batteries like NaS is that unlike the large amount of heat that is needed to operate the systems such as NaS systems with the common parallel plate design, the 3-D design allows using less external heat by better usage of the generated heat inside the cell and better saving and distributing the applied heat. This results in improvements in energy storage efficiency. Similarly, solvated electrode batteries can significantly benefit from the 3-D design described herein, improving their performance.

Batteries in general and especially lithium-air batteries can provide high energy density for many energy storage applications, however power densities and charging rates of current batteries may not be adequate for some applications in which current capacitors or electrochemical capacitors are used. The novel 3-D structure that is described herein results in significant increases in charging and discharging rates of electrochemical cells.

In contrast with a parallel plate electrochemical cell design, the novel 3-D described herein results in better heat distribution in a cell, resulting in more homogeneous temperate inside the cell. This may increase the cycle life of the cell and result in safer cells, especially in high energy and power cells. Further, the 3-D approach described herein significantly improves the performance at the cell level and at the pack/module level by reducing the amount of inactive and supporting materials. It allows making electrochemical systems having a significant improvement in energy density and power density.

In conventional electrochemical cells, such as batteries, the surface area of anode and cathode are comparable (such as differing by less than a factor of 2), due to the limitations of the parallel plate design. As the energy density, power density and electric (ionic and electronic) conductivities of different materials can vary significantly, the same surface area results in less efficient energy storage. As a simple example, Li-ion batteries commonly used in cellphones and laptops use carbon anode and LiCoO₂ cathode materials; however, the energy density of carbon is about two times higher than that of LiCoO₂, resulting in cells that are not performing (energy density, power density and even cycle life) as best as they can (the so called cathode limited cells). The 3-D design described herein provides a unique and beneficial approach to address this problem by allowing adjustment of cathode and anode weight or volume or surface area ratios to be used. The 3-D design approach is optionally combined with new high performance cathode materials or is optionally used on its own for conventional systems as an alternative economic solution to maximize the performance of the cell.

A further benefit of the 3-D design described herein is that it permits easy placement of reference electrodes in different parts of the cell, in contrast to conventional parallel plate designs. In addition, the 3-D design also allows using other methods of cell monitoring. For example, by placing piezoelectric plates or rods or thermometer plates or rods or other types of sensors such as acoustic sensors to monitor the strain, stress, temperature, fracture or other parameters of the cell at different locations inside the cell. This optionally aids with not only evaluating the energy storage active materials at the production and before shipping to the customers but also to make better and safer and more efficient energy storage load and unloading during operation of the systems. A battery management unit is optionally used in this regard, which is connected to the sensors and the reference electrodes and the working and counter electrodes.

The 3-D design further allows using different cathode materials and anode materials and electrolytes inside a single cell. Previous batteries are limited to single anode and cathode materials. The ability of having different electrode materials that may have different behavior, energies and voltages, inside a cell may result in unprecedented energy storage systems. All or some of the electrode active materials are optionally placed during the building of the cell or are optionally placed on the current collectors or other parts of the cell, using for example electrochemical deposition, after building the cell.

A further problem with current parallel plate electrochemical energy storage systems is that it is very difficult to monitor and control different part of the system at any levels of pack/module or cells. The 3-D design further allows monitoring and controlling individual rods and plates, and this significantly aids better performance and safety of the cell. Monitoring and even shutting down a single part of the battery, for example, can prevent hazardous failures. It also aids with continuing the use of the healthy parts of the system which can be important in many special or life and death situations in which a full power shut down can be very undesirable.

A drawback of current parallel plate design of electrochemical cells and reactors and especially batteries is the tradeoff between energy density, cycling rate (charging and power density) and cycle life of the cell. Making thicker electrodes to have higher energy densities results in longer ionic diffusion in the electrode and thus decreases in the allowable rate of cycling (charging and power density). In addition the heat generated in the cell will distribute more inhomogeneously and cycle life may decrease unless operating in low rates. In one aspect, the 3-D design solves this problem by providing better ionic and heat conductivity in the cell and thus can help in decoupling the energy density and cycling rate (charging and power density) and also increase of the cycle life.

Manufacturing electrochemical cells such as batteries has been based on assembling cells of parallel plates of electrodes and then building larger systems such as packs and modules for different applications. Most of the common processes are thus based on simple cell designs and complicated pack/module designs. The complexity at the higher level adds to the cost and also reduces the efficiency. On the other hand, the 3-D structure results in new methods of manufacturing such that the complexity of the system is minimized for the end customer. This results in cheaper and more effective larger systems in comparison to the current state of the art. The 3-D manufacturing further benefits from advancements in machinery and automation that can help with a rapid scale up of the design at any scale.

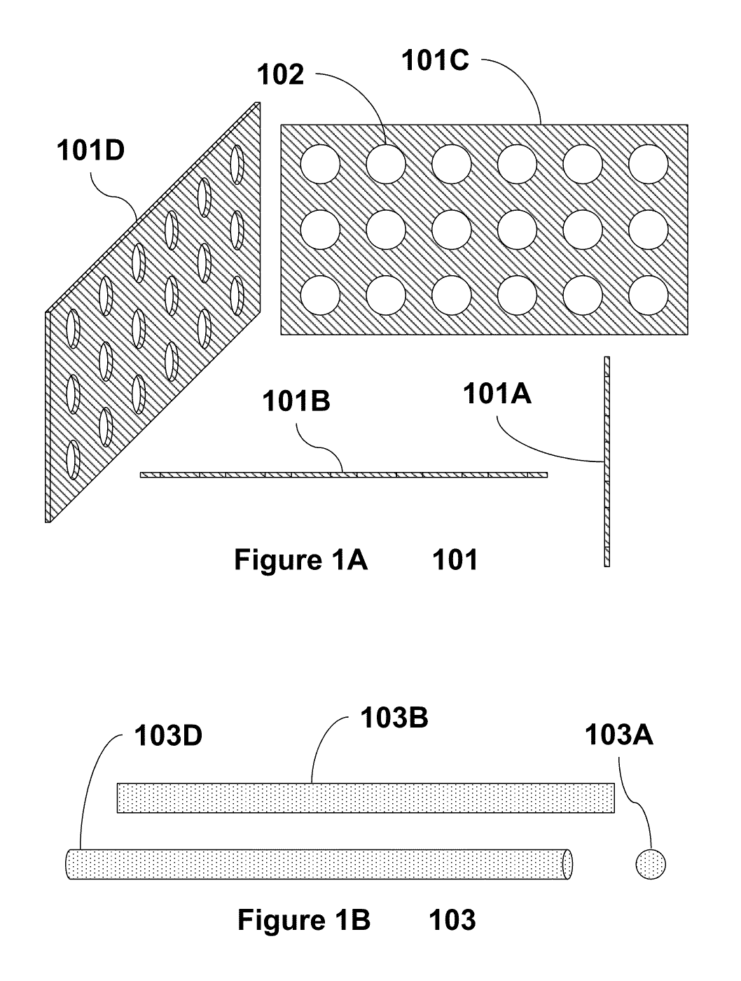

FIG. 1A provides views of a plate electrode 101 of a three-dimensional electrode array embodiment, including side 101A, top 101B, front 101C and perspective 101D views. Here, plate electrode 101 includes a plurality of apertures 102, each having a circular shape. FIG. 1B provides views of a rod electrode 103 of a three-dimensional electrode array embodiment, including front 103A, side 103B and perspective 103D views. Here, rod electrode 103 has a circular cross-sectional shape.

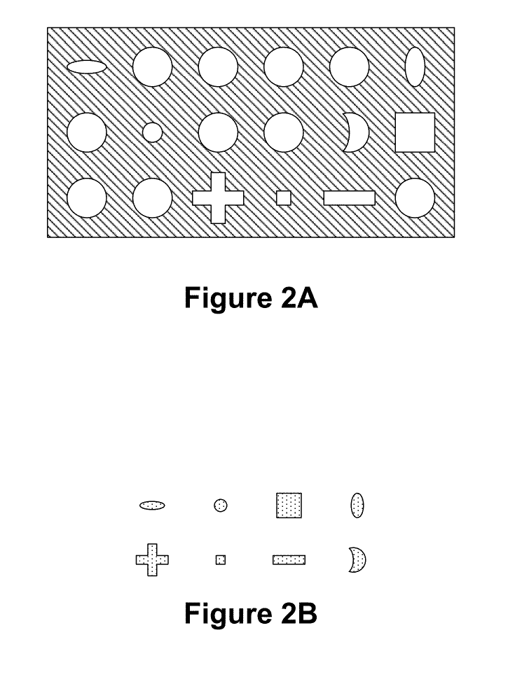

FIG. 2A provides a front view of a plate electrode. Here, plate electrode includes a plurality of apertures of a variety of shapes. FIG. 2B provides a front view of a plurality of rod electrodes showing a variety of useful cross-sectional shapes.

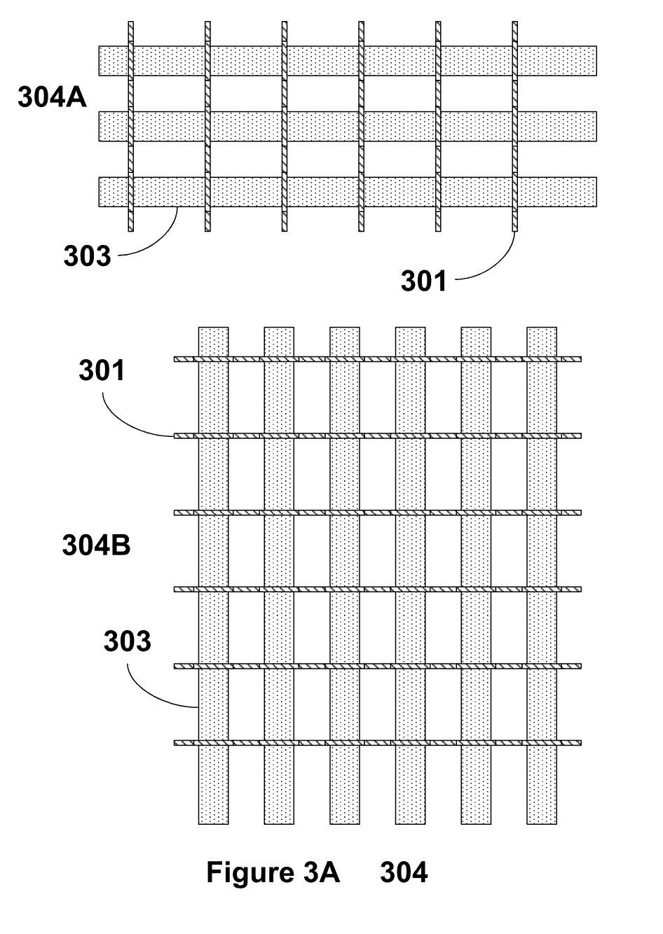

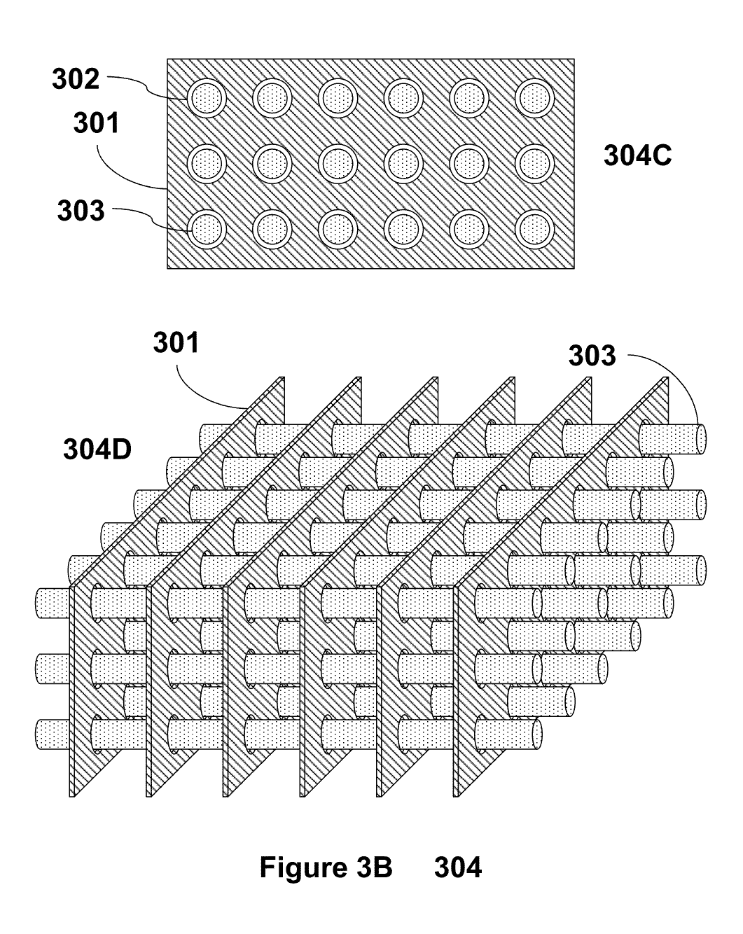

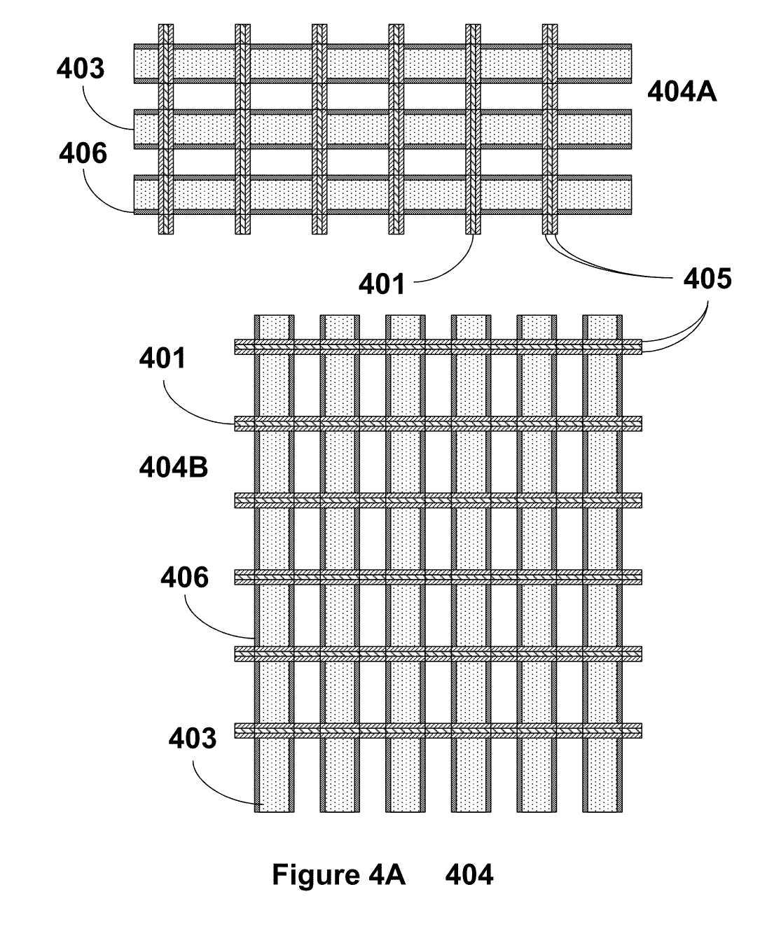

FIGS. 3A and 3B provide views of a three-dimensional electrode array 304. FIG. 3A shows side 304A and top 304B views and FIG. 3B shows top 304C and perspective 304D views. Three dimensional electrode array 304 includes 6 plate electrodes 301 and 18 rod electrodes 303. Here, each rod electrode 303 passes through an aperture 302 of each of the 6 plate electrodes 301. Optionally, the vacant space between each of the plate electrodes, between each of the rod electrodes and between each of the plate electrodes and each of the rod electrodes (i.e., in the apertures) is filled with an electrolyte.

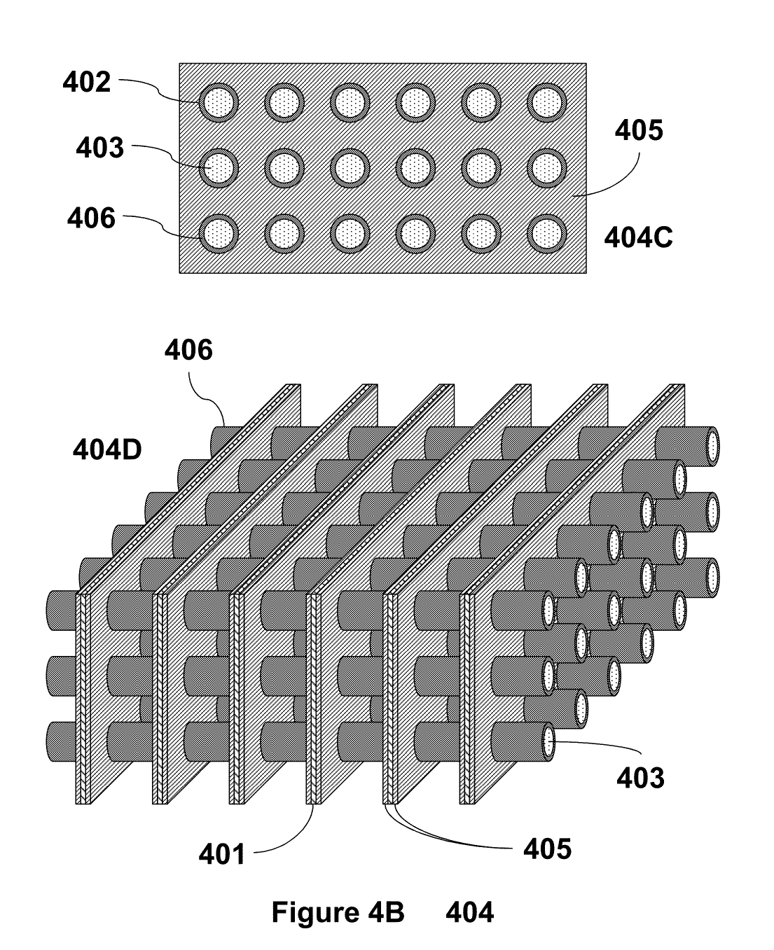

FIGS. 4A and 4B provide views of a three-dimensional electrode array 404. FIG. 4A shows side 404A and top 404B views and FIG. 4B shows top 404C and perspective 404D views. Three dimensional electrode array 404 includes 6 plate electrodes 401 and 18 rod electrodes 403. Here, each rod electrode 403 passes through an aperture 402 of each of the 6 plate electrodes 401. Each plate electrode is flanked on both sides by a first electrolyte 405. Each rode electrode is surrounded by a second electrolyte 406. In this embodiment, second electrolyte 406 and rod electrode 403 completely fill aperture 402. In this embodiment, first electrolyte 405 and second electrolyte 406 are different. For clarity, views 404A and 404B show a cross sectional view of rod electrode 403 and surrounding second electrolyte 406.

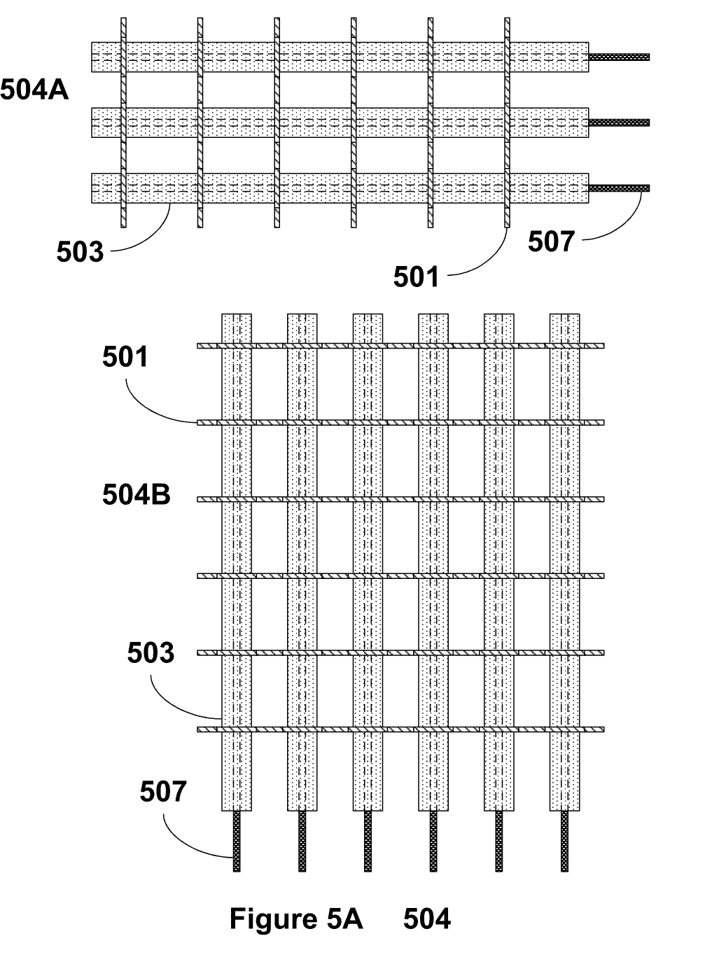

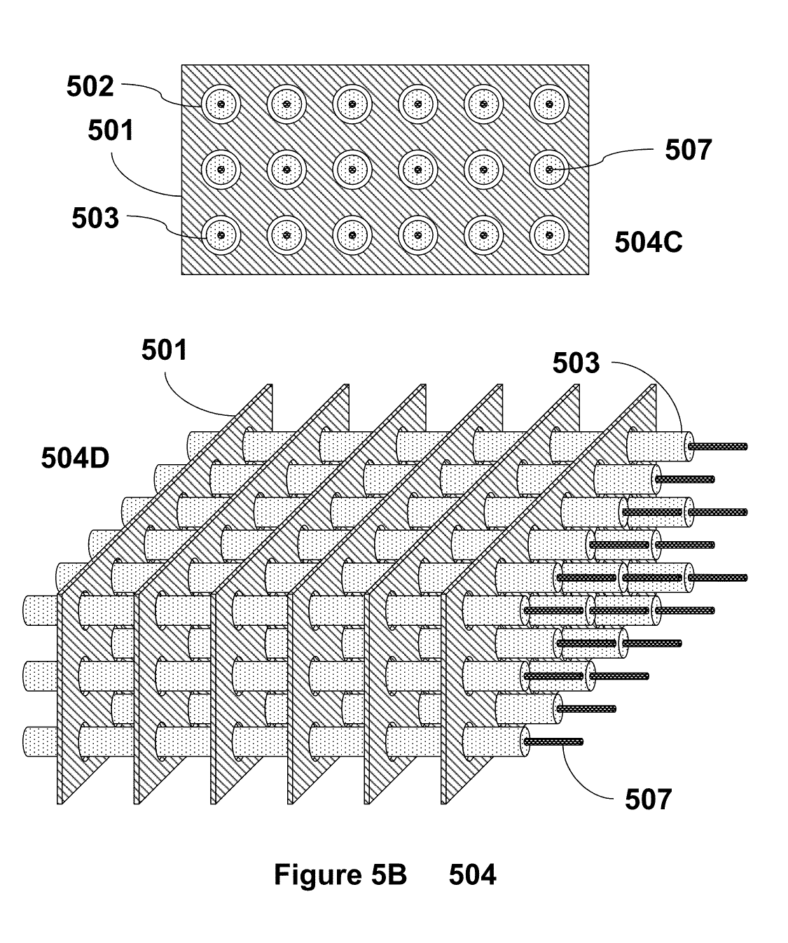

FIGS. 5A and 5B provide views of a three-dimensional electrode array 504. FIG. 5A shows side 504A and top 504B views and FIG. 5B shows top 504C and perspective 504D views. Three dimensional electrode array 504 includes 6 plate electrodes 501 and 18 rod electrodes 503. Here, each rod electrode 503 passes through an aperture 502 of each of the 6 plate electrodes 501. In this embodiment, each rod electrode includes a current collector 507. Optionally, one or more current collectors 507 are placed in thermal communication with a heat sink or heat source to control a temperature of the three-dimensional electrode array.

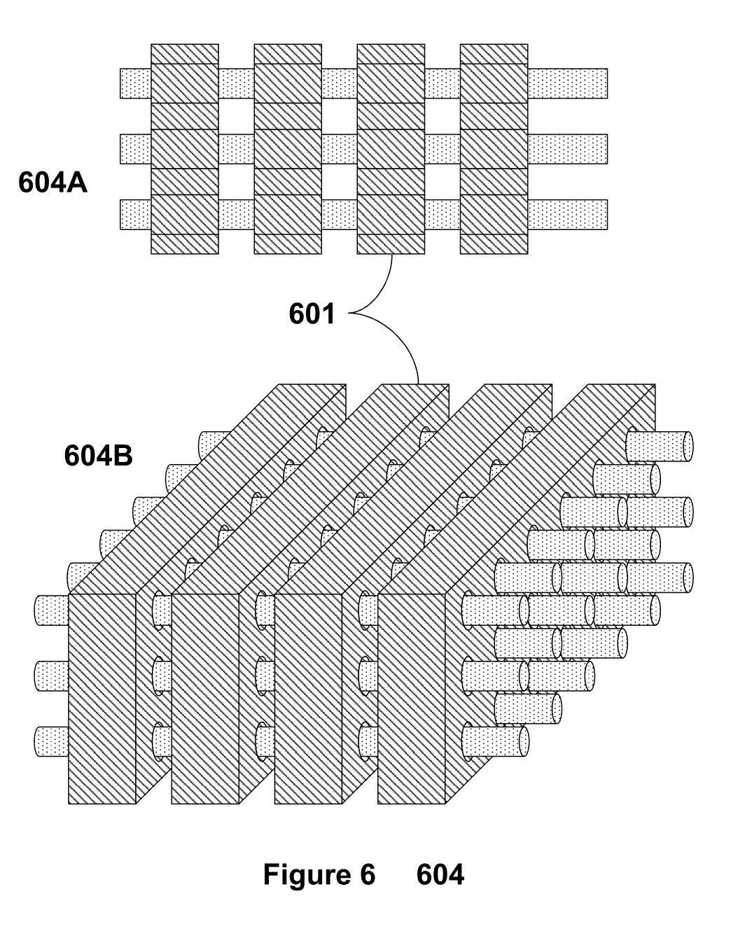

FIG. 6 provides views of a three-dimensional electrode array 604, showing side 604A and perspective 604B views. In this embodiment, the space between plate electrodes 601 is smaller than the thickness of the plate electrodes 601.

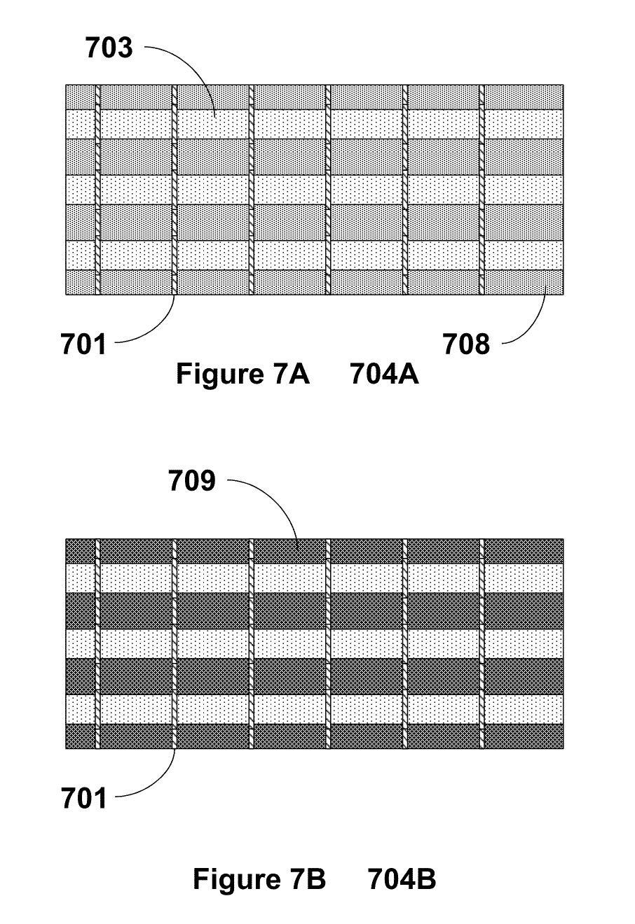

FIG. 7A provides a side view of a three-dimensional electrode array 704A, where the space between the plate electrodes 701 and the rod electrodes 703 is filled with a fluid 708, such as a gas or a liquid electrolyte. FIG. 7B provides a side view of a three-dimensional electrode array 704B, where the space between the plate electrodes 701 is filled with a solid 709.

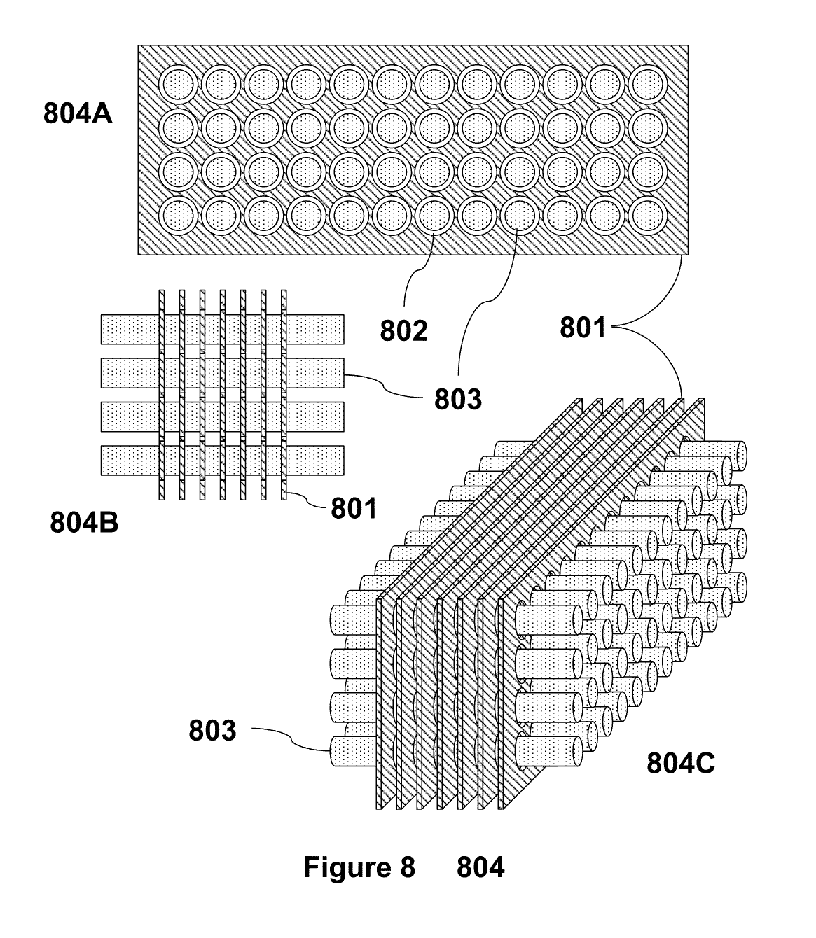

FIG. 8 provides views of a three-dimensional electrode array 804. FIG. 8 shows front 804A, side 804B and perspective 804C views. In this embodiment, there are 7 plate electrodes 801 and 48 rod electrodes 803. The apertures 802 in the plate electrodes are closely spaced in this embodiment, for example at a distance less than 10% of the diameter of the apertures 802.

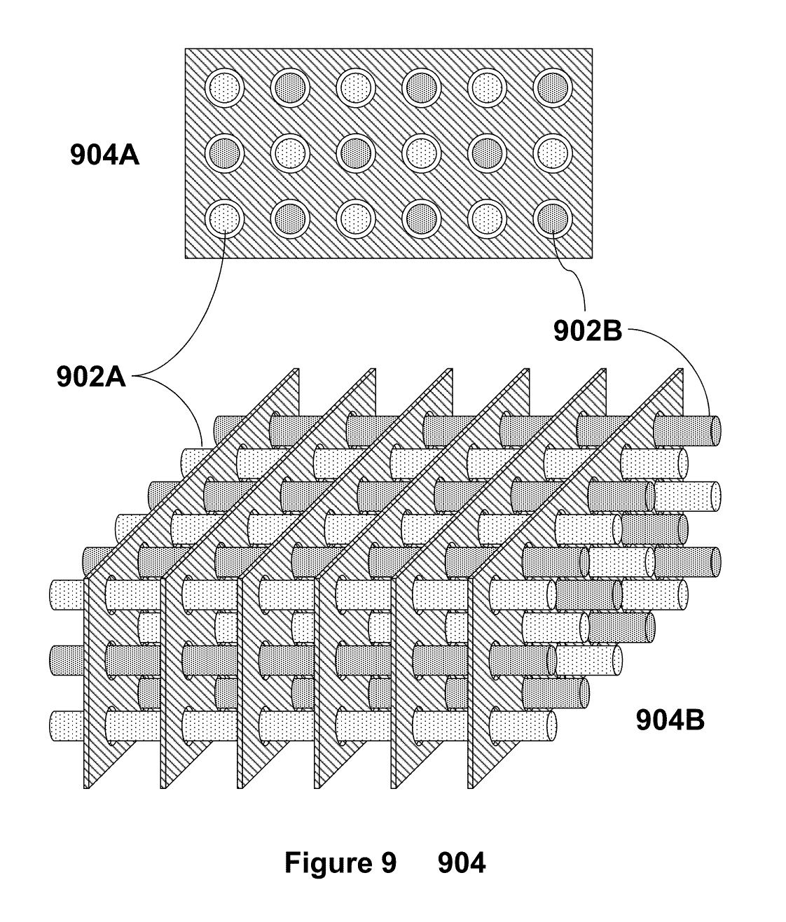

FIG. 9 provides views of a three-dimensional electrode array 904 and shows front 904A and perspective 904B views. In this embodiment, the rod electrodes include two different materials, first rod electrode material 902A and second rod electrode material 902B.

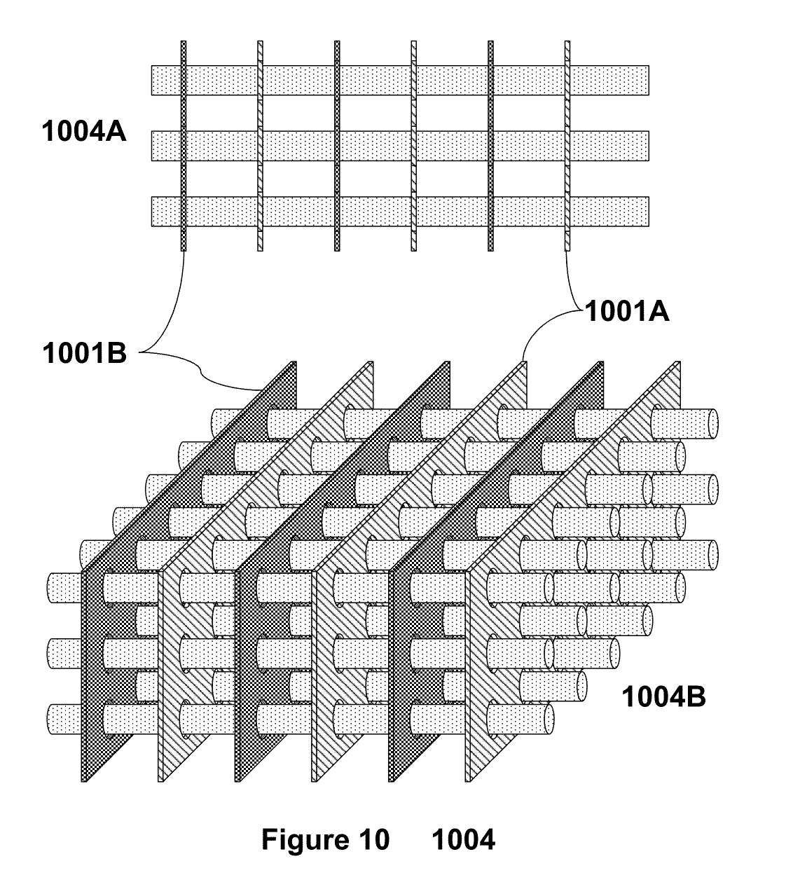

FIG. 10 provides views of a three-dimensional electrode array 1004 and shows side 1004A and perspective 1004B views. In this embodiment, the plate electrodes include two different materials, first plate electrode material 1001A and second plate electrode material 1001B. Optional embodiments also include those with multiple plate electrode materials and multiple rod electrode materials.

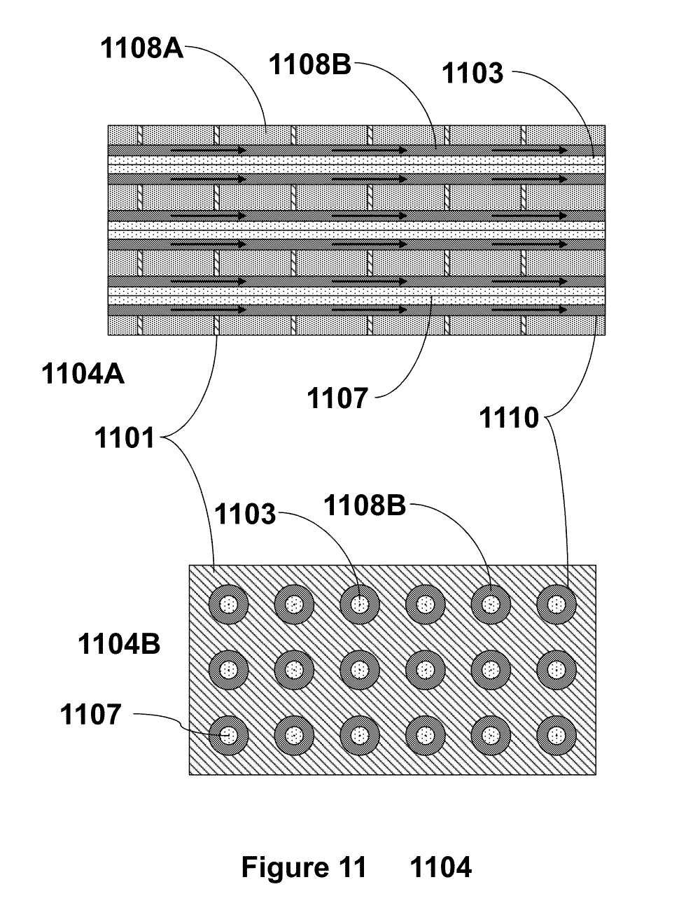

FIG. 11 provides views of a three-dimensional electrode array 1104, including a side view 1104A and a front view 1104B. In this embodiment, a thin tube 1110 fills each aperture in plate electrodes 1101. The space between plate electrodes 1101 is filled with a first fluid 1108A. For clarity, electrolyte 1108A is not shown in front view 1104B. Each thin tube 1110 is filled with a second fluid 1108B surrounding rod electrode 1103. Here, rod electrodes 1103 comprise an electron collector 1107. In this embodiment, a flow is provided such that fluid 1108B flows in the direction shown by the arrows.

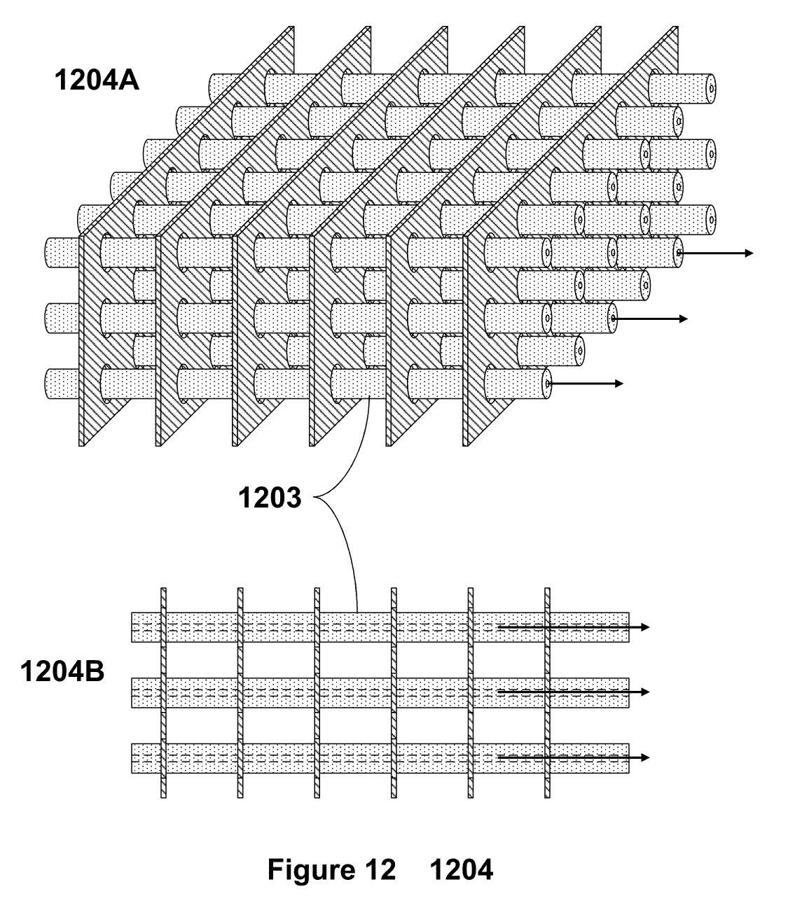

FIG. 12 provides views of a three-dimensional electrode array 1204 and shows perspective 1204A and side 1204B views. In this embodiment, rod electrodes 1203 are constructed as hollow tubes, such that fluid can flow along the interior of the rod electrodes 1203 as indicated by the arrows. Certain embodiments comprising hollow rod electrodes are useful for a number of applications, including electrode array temperature control, fuel cell, metal-air batteries and flow batteries. In certain embodiments, rod electrodes 1203 comprise a porous material.

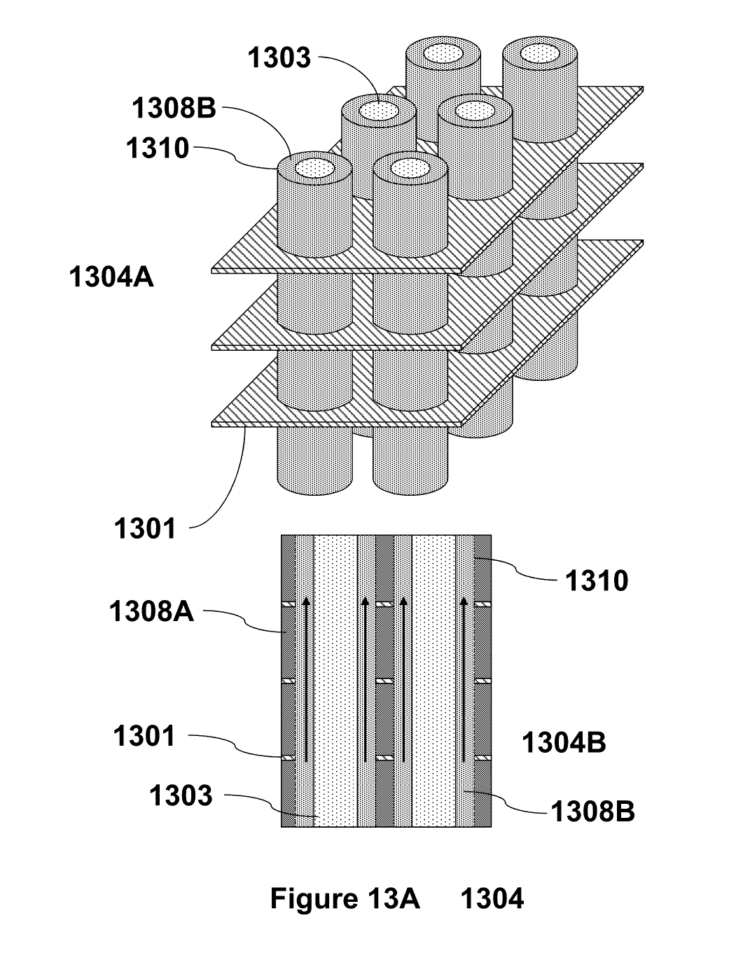

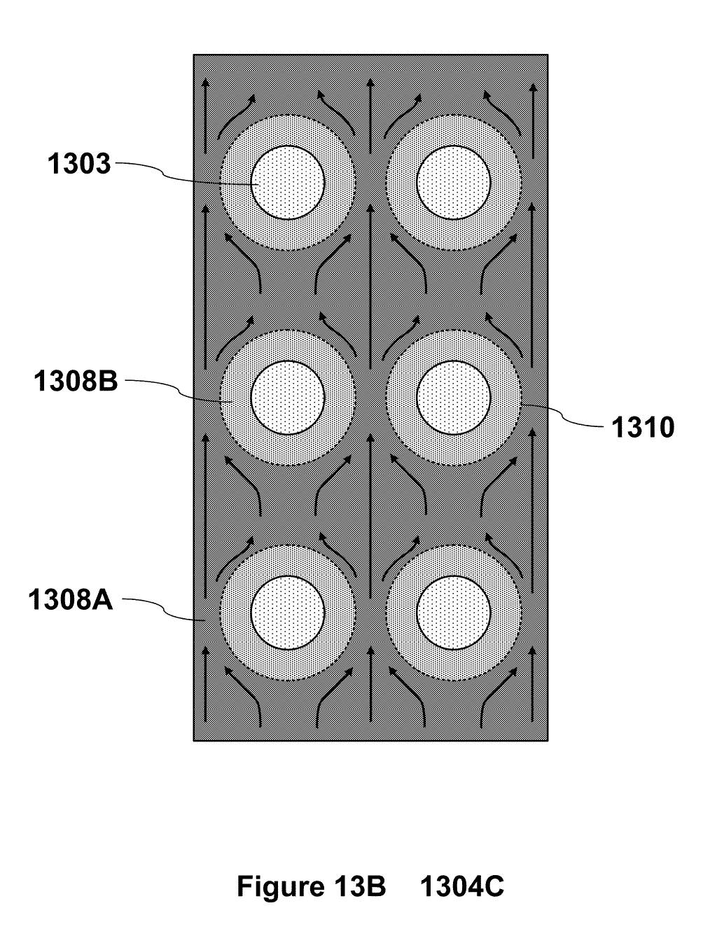

FIGS. 13A and 13B provides views of a three-dimensional electrode array 1304, including perspective 1304A, front cross-sectional 1304B and top 1304C views. This embodiment comprises 3 plate electrodes 1301 and 6 rod electrodes 1303. Here, the space between the plate electrodes 1301 is filled with a first fluid 1308A. For clarity, perspective view 1304A does not show first fluid 1308A. Surrounding each rod electrode 1303 is a thin tube 1310 filled with a second fluid 1308B. Each thin tube 1310 fills an entire aperture in plate electrodes 1301. In front cross-sectional view 1304B and top view 1304C, thin tubes 1310 are indicated by a dashed line. In embodiments, first fluid 1308A is induced to flow within thin tubes 1310, for example, as shown by the arrows in front cross-sectional view 1304B. In embodiments, second fluid 1308B is induced to flow across the space between plate electrodes 1301, for example, as shown by the arrows in FIG. 13B. First fluid 1308A flows in the spaces between plate electrodes 1301 and second fluid 1308B flows within thin tubes 1310.

Optionally, the plate electrodes 1301 comprise graphite and are optionally useful as an anode. Optionally, the rod electrodes 1303 useful as a cathode. Optionally, the rod electrodes 1303 comprise a carbon shell and include electron collectors (not shown) comprising copper. Optionally, first fluid 1308A and second fluid 1308 independently comprises electrolytes. In an embodiment where three-dimensional electrode array 1304 is a component of a semi-solid battery, first fluid 1308A comprises a first electrolyte and a first active material and second fluid 1308B comprises a second electrolyte and a second active material. In an embodiment where three-dimensional electrode array 1304 is a component of a flow battery, first fluid 1308A comprises a first electrolyte second fluid 1308B comprises a second electrolyte. In an embodiment where three-dimensional electrode array 1304 is a component of a fuel cell, first fluid 1308A comprises a fuel, such as H₂, and second fluid 1308B comprises an oxygen containing fluid, such as air.

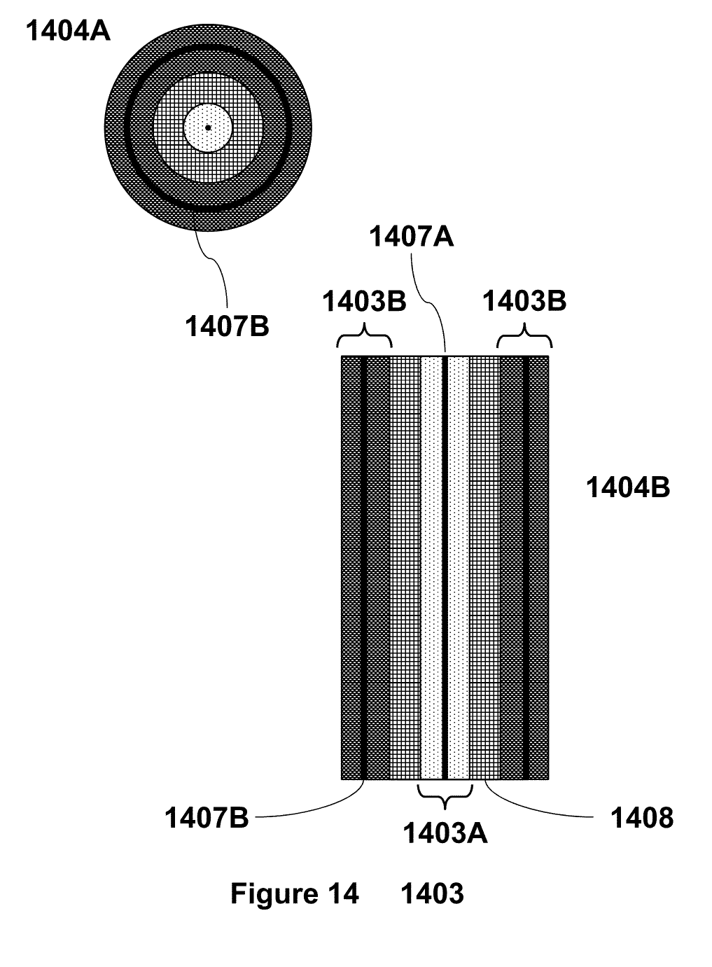

FIG. 14 provides views of a rod electrode embodiment 1403, including end view 1404A and cross-sectional view 1404B. In this embodiment, each rod electrode 1403 comprises an electrode pair, including rod inner core 1403A and rod outer shell 1403B. In this embodiment, rod inner core 1403A comprises a first electron collector 1407A. In this embodiment, rod outer shell 1403B comprises a second electron collector 1407B. Between rod inner core 1403 and rod outer core 1403B is material 1408. In certain embodiments, each rod electrode 1403 is an electrochemical cell, and material 1408 comprises an electrolyte.

Rod electrodes of the embodiment shown in FIG. 14 are useful, for example, in any three-dimensional electrode array described herein. Optionally, the rod electrode inner core and a plate electrode comprise identical or substantially identical materials. Embodiments of this aspect are useful, for example, for increasing the ratio of the amount of the rod inner core/plate material to the amount of rod outer core material.

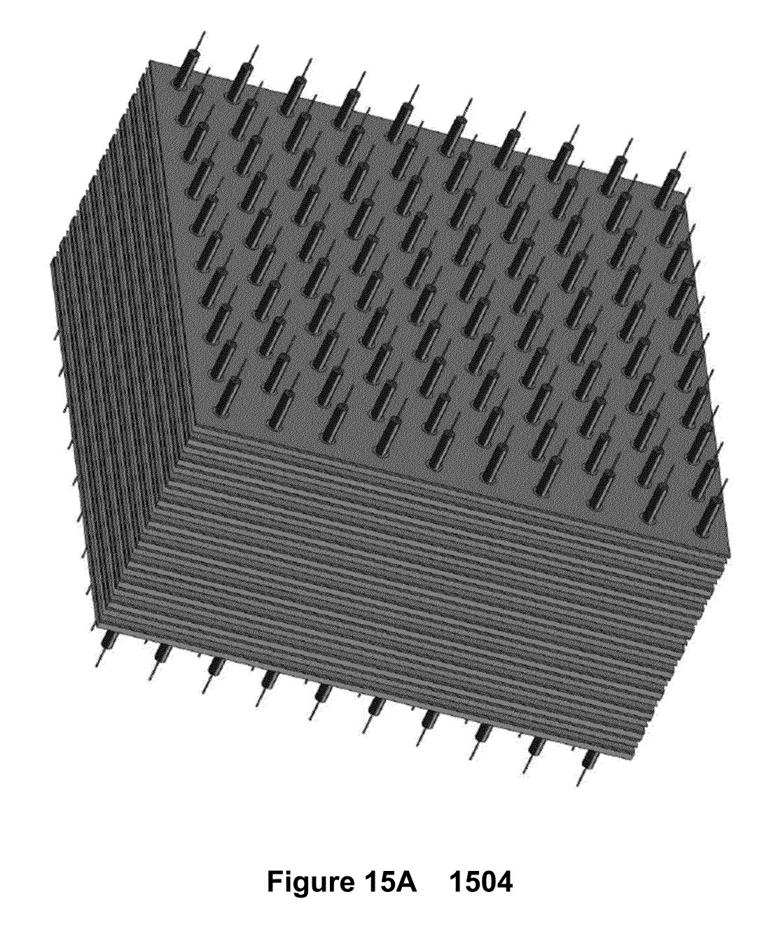

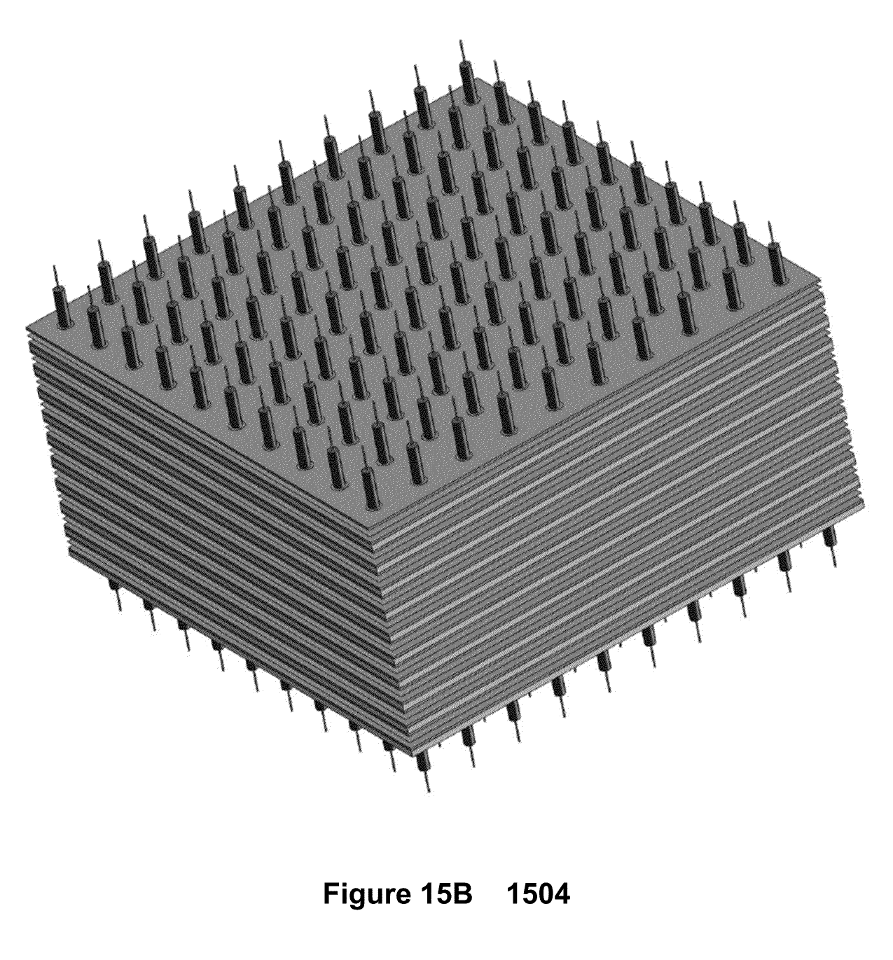

FIGS. 15A and 15B provide three-dimensional views of a three-dimensional electrode array. In this embodiment, many plate electrodes are stacked, sandwiching materials, such as a solid electrolyte, between the plate electrodes. Many rod electrodes are shown, including a current collector. Optionally, the current collectors are held under tension to provide structural rigidity to the electrode array.

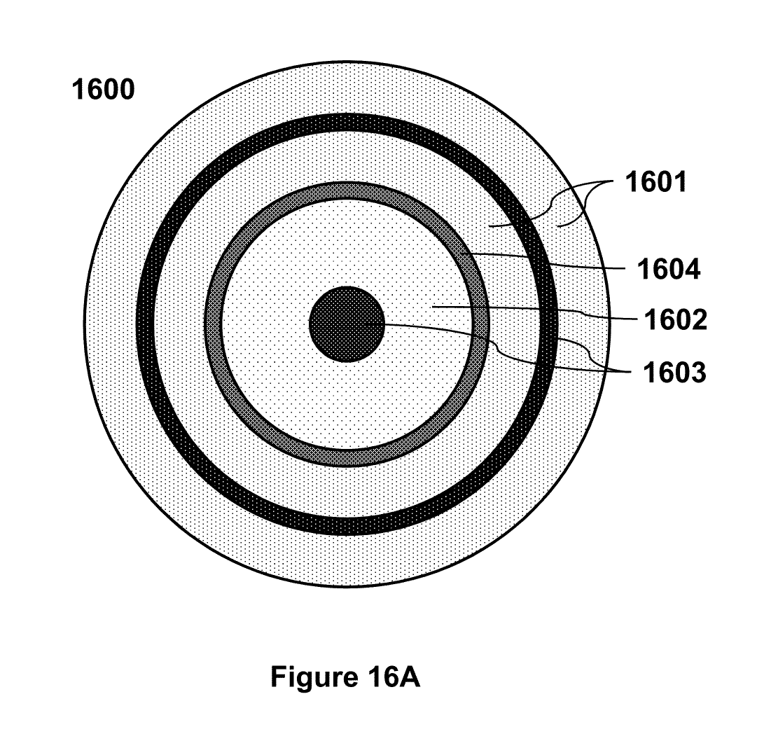

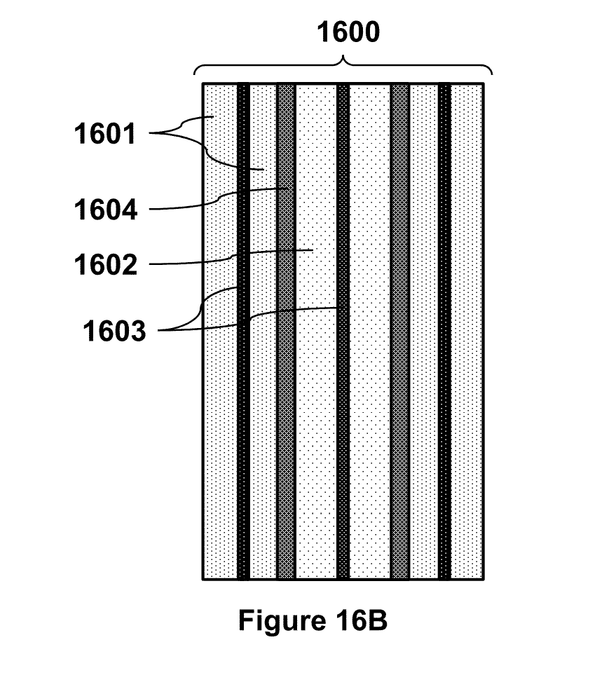

FIGS. 16A and 16B provide views of a composite rod electrode structure. FIG. 16A provides an end view of the composite rod electrode structure 1600 having electrodes 1601, electrode 1602, current collector 1603 and electrolyte 1604. FIG. 16B provides a cross sectional side view of the composite rod electrode 1600 also showing electrodes 1601, electrode 1602, current collector 1603 and electrolyte 1604. In an embodiment, electrodes 1601 are an anode and electrode 1602 is a cathode. Alternatively, the invention includes composite rod electrodes wherein electrodes 1601 is a cathode and electrode 1602 is an anode. In an embodiment, composite rod electrode structure 1600 provides an electrochemical cell, a fuel cell, a flow cell, a metal air battery, or a supercapacitor device.

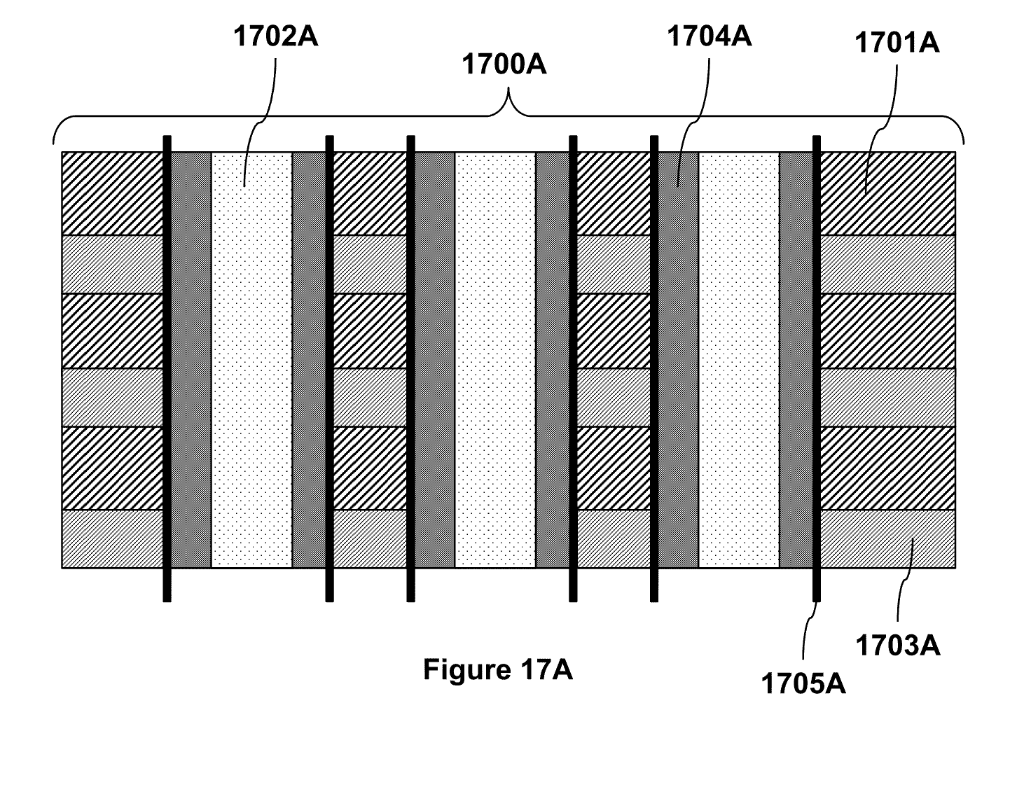

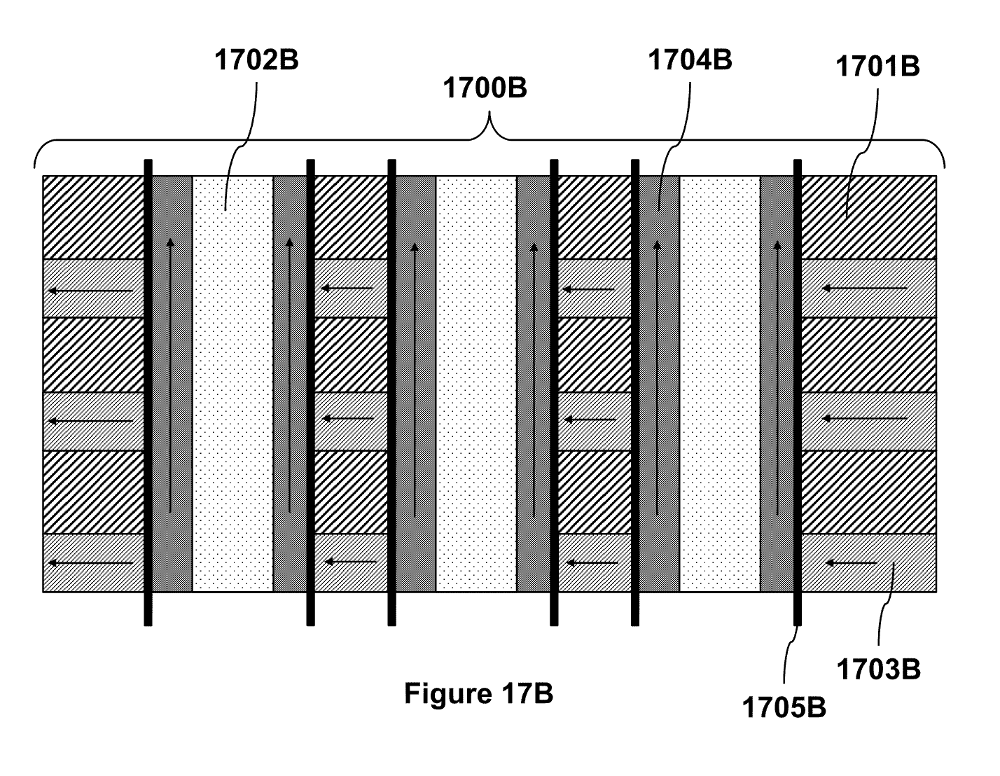

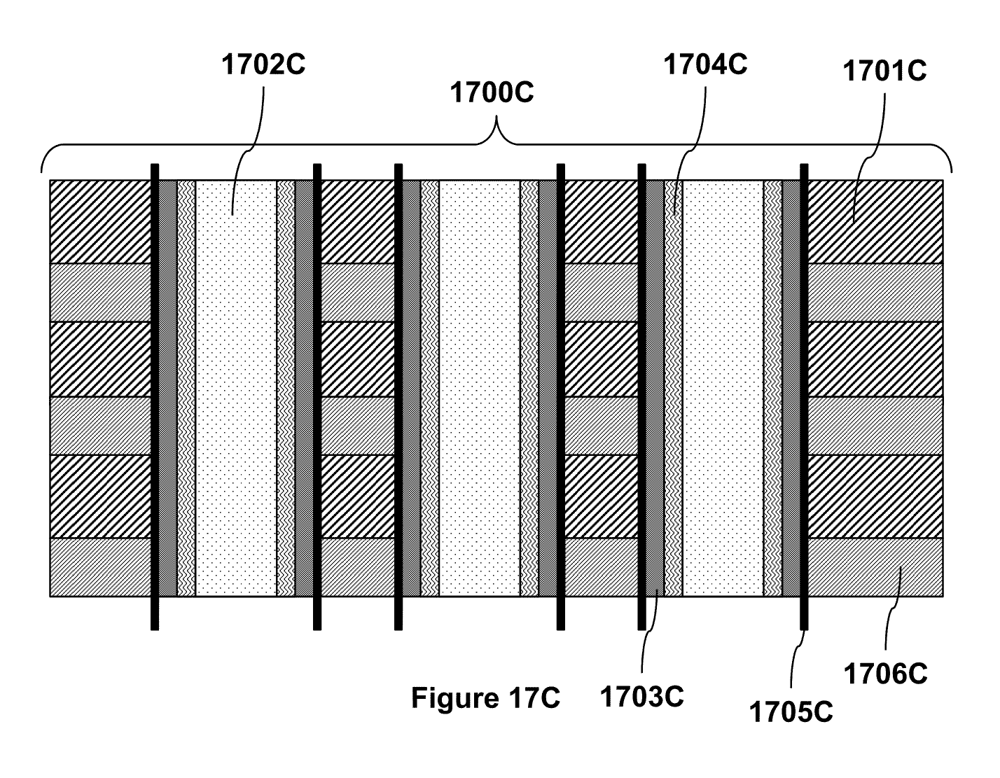

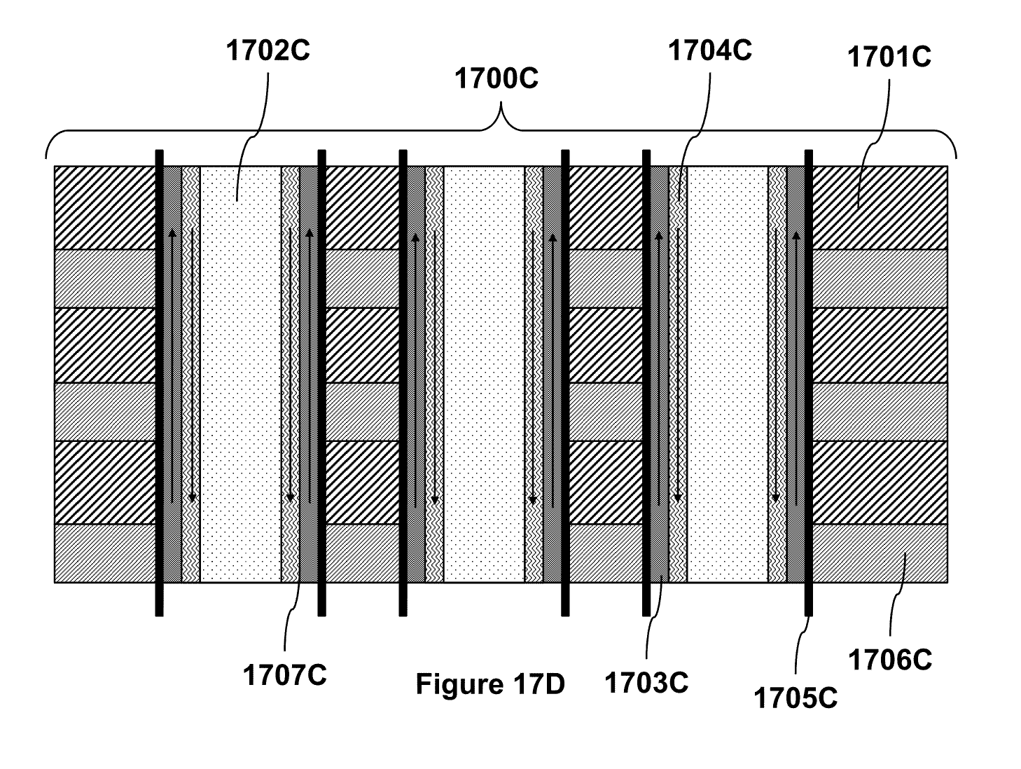

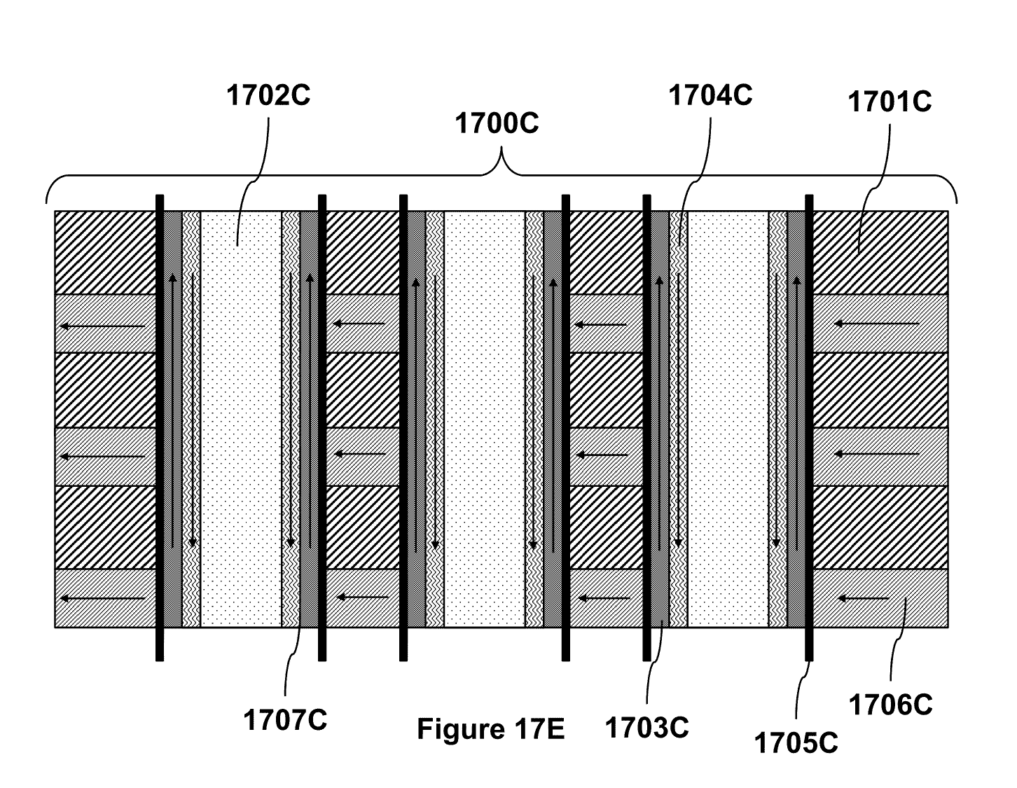

FIGS. 17A-17E provide schematic drawings of three-dimensional electrode arrays, optionally including one or more flowing electrolyte components. FIG. 17A provides a side view of an electrode array electrode structure 1700A having plate electrodes 1701A, rod electrodes 1702A, first electrolyte 1703A, second electrolyte 1704A and membrane 1705A. As shown in this figure, rod electrodes 1702A extend through holes provided in plate electrodes 1701A. Rod electrodes 1702A are provide in an array geometry and plate electrodes 1701A are provided in a stacked configuration. In an embodiment, plate electrodes 1701A and rod electrodes 1702A are solid electrodes. In an embodiment, first electrolyte 1703A and second electrolyte 1704A are independently a solid, a gel or a fluid electrolyte. In an embodiment, for example, first electrolyte 1703A and second electrolyte 1704A are the same electrolyte. In an alternative embodiment, for example, first electrolyte 1703A and second electrolyte 1704A are different electrolytes. In an embodiment, membrane 1705A is a solid membrane providing a barrier between plate electrodes 1701A and rod electrodes 1702A.

FIG. 17B provides a side view of an electrode array structure 1700B having plate electrodes 1701B, rod electrodes 1702B and membrane 1705B and demonstrating an embodiment including a flowing electrolyte configuration, for example, having a flowing first electrolyte 1703B and a flowing second electrolyte 1704B. In FIG. 17B, the arrows indicate the direction of flow of electrolytes. In an embodiment, electrolyte 1703B is a flowing fluid that optionally includes active nanoparticles and/or microparticles, for example, which participate in oxidation-reduction reactions. In an embodiment, electrolyte 1704 is a flowing fluid that optionally includes active nanoparticles and/or microparticles, for example, nanoparticles and/or microparticles which participate in oxidation-reduction reactions.

FIG. 17C provides a side view of an electrode array structure 1700C, for example for an electrochemical cell, having plate electrodes 1701C, rod electrodes 1702C, first electrolyte 1703C, second electrolyte 1704C, membrane 1705C and space 1706C. In an embodiment, for example, space 1706C is filled with liquid to control the temperature of the cell or to remove the unwanted products from the cell, for example, via membrane 1705C. In an embodiment, for example, space 1706C is filled with electrolyte or with porous PE or porous PP and electrolyte.

FIGS. 17D and 17E provide a side view of the composite rod electrode structure 1700C used in a flowing electrolyte configuration, for example, having a flowing first electrolyte 1703 and a flow second electrolyte 1704. In FIGS. 17D and 17E, the arrows indicate the direction of flow of electrolyte. As shown in FIG. 17D, for example, the system may have a flowing first electrolyte 1703C and a flowing second electrolyte 1704C. As shown in FIG. 17D, for example, the system may have a flowing first electrolyte 1703C, a flowing second electrolyte 1704C and a flowing electrolyte in space 1706C. To prevent mixing of first electrolyte 1703C and second electrolyte 1704C, a barrier 1707C is optionally provided, for example comprising a thin tube of inert material.

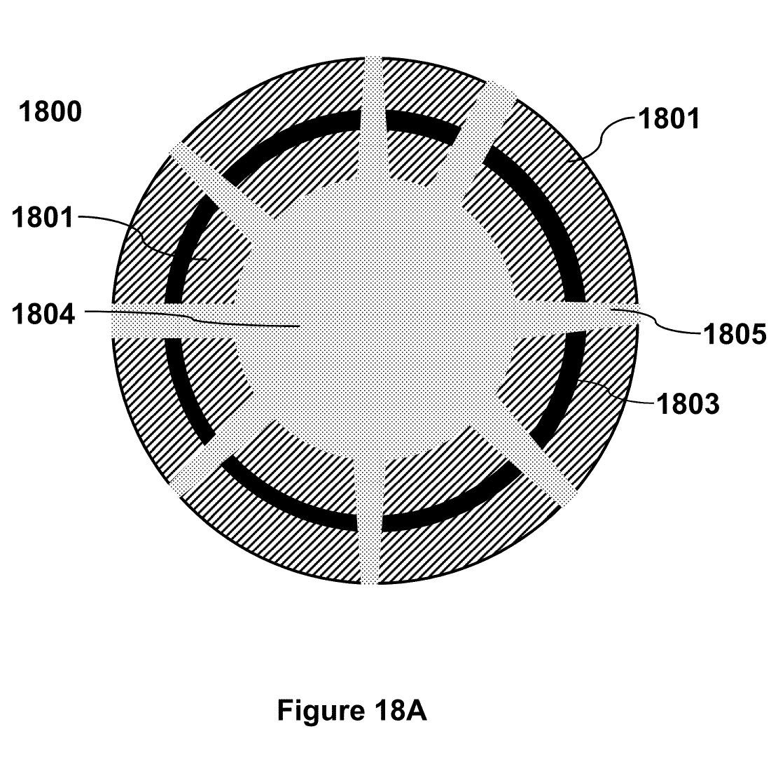

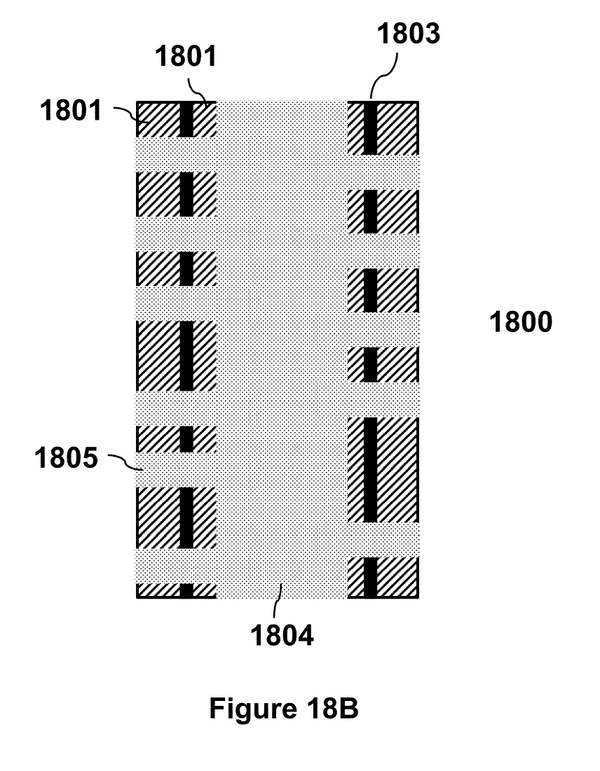

FIGS. 18A and 18B provide views of a composite rod electrode comprising a porous rod. FIG. 18A provides an end view of the composite rod electrode structure 1800 having an anode or cathode 1801, current collector 1803, an electrolyte 1804, and pores 1805. FIG. 18B provides a cross sectional view of the composite rod electrode 1800 also having an anode or cathode 1801, current collector 1803, an electrolyte 1804, and pores 1805. In an embodiment, electrolyte 1804 comprises a fluid. In an embodiment, electrolyte 1804 comprises a solid. In an embodiment, electrolyte 1804 comprises a fluid and a separator. In an embodiment, pores 1805 provide for fluid communication of the electrolyte 1804 inside the composite rod electrode structure 1800 to components outside of the rod electrode structure 1800, for example plate electrodes and the space between the plate electrodes.

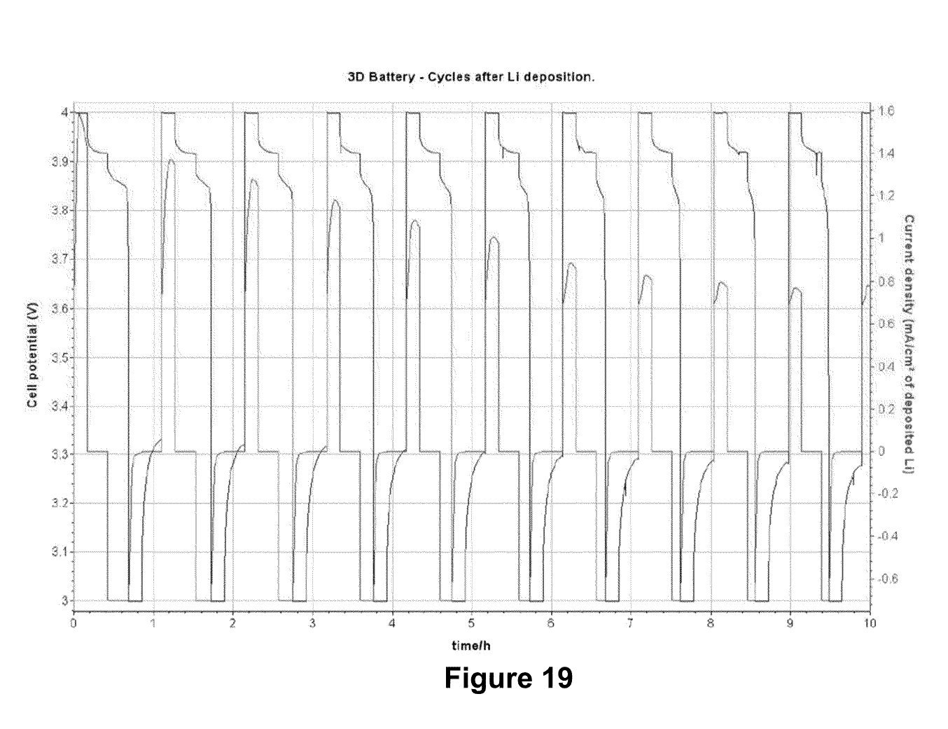

FIG. 19 provides data showing a charge-discharge curve for cycling an electrochemical cell embodiment comprising a three-dimensional electrode array including Ewe versus time and Current (I) versus time. For this embodiment, the cell comprises three parallel plates comprised of LiCoO2, each of dimensions 20 mm×20 mm×0.2 mm with an Al current collector of 0.01 mm thick in the middle of each plate electrode. Electrolyte was 1M LiClO4 in EC and PC (1:1). No separator was used. Narrow rings of 0.025 mm PE/PP (Celgard) was used as spacer between the plates. The cell also comprises five copper rod electrodes of about 1 mm diameter on which we deposited lithium anode by dilithiating the LiCoO2 plates after the fabrication of the cell. The voltage shown is the difference between the LiCoO2 plates and the lithium deposited on copper rods.

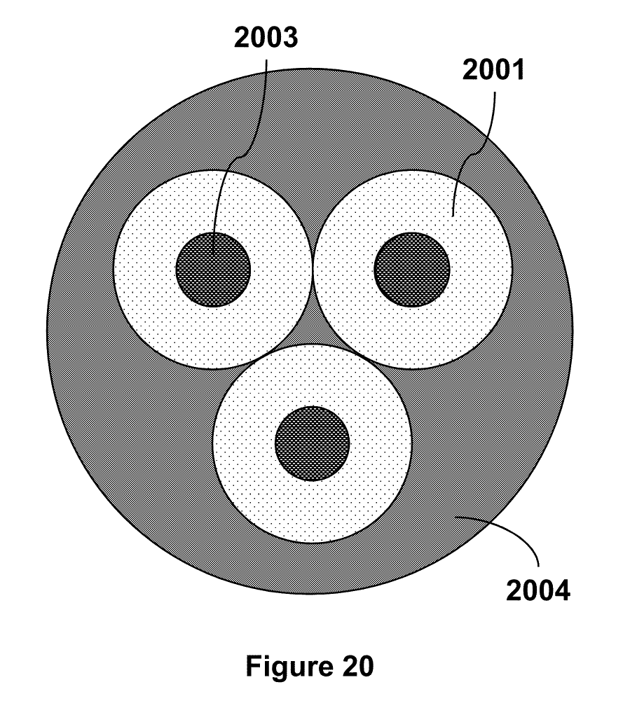

FIG. 20 provides a view of a single aperture of a plate electrode showing multiple rod electrodes 2001 positioned within the single plate electrode. Here, rod electrodes include an electron collector 2003 and the aperture is filled with a fluid 2004. Optionally, fluid 2004 is an electrolyte. In an embodiment, fluid 2004 is a flowing fluid that optionally includes active nanoparticles and/or microparticles, for example, nanoparticles and/or microparticles which participate in oxidation-reduction reactions.

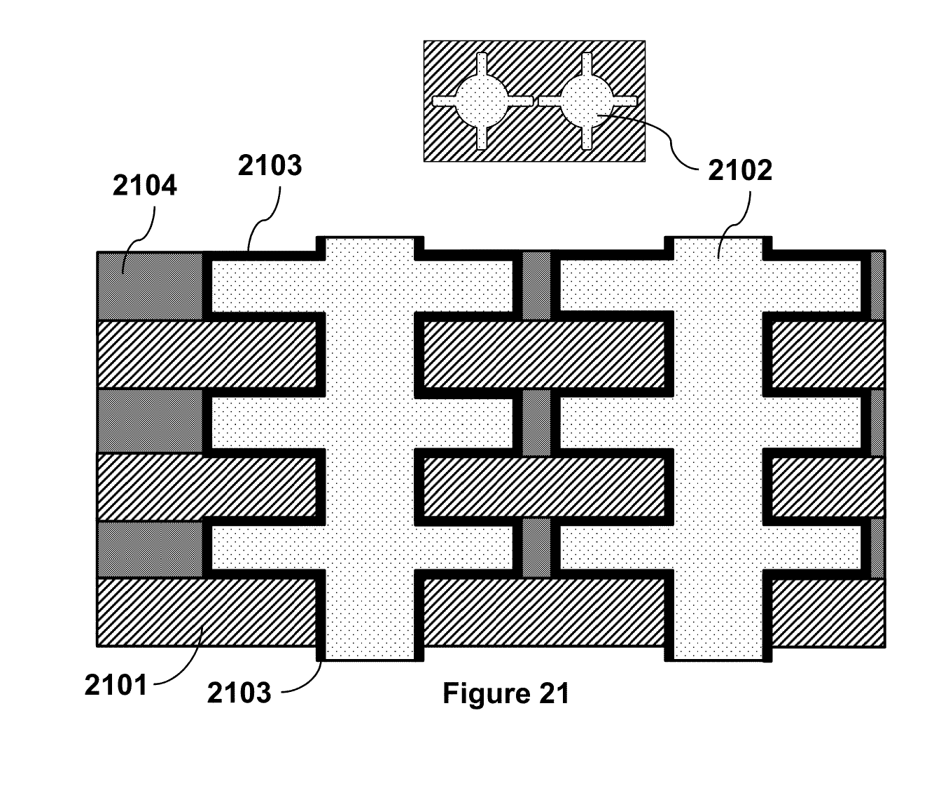

FIG. 21 provides a schematic cross-sectional side view of a three-dimensional electrode array comprising branched rod electrodes. The inset shows a top view. Here, the electrode array comprises plate electrodes 2101, rod electrodes 2102 and electrolyte 2103. A space is provided between plate electrodes 2101 and is optionally filled with a solid, fluid or gel electrolyte 2104. For clarity, the inset view does not show electrolyte 2104. Rod electrodes 2102 branch along lateral dimensions from an aperture in plate electrodes 2101. Optionally, electrolyte 2103, which separates rod electrodes 2102 from plate electrodes 2101, is applied as a coating on the rod electrode 2102.

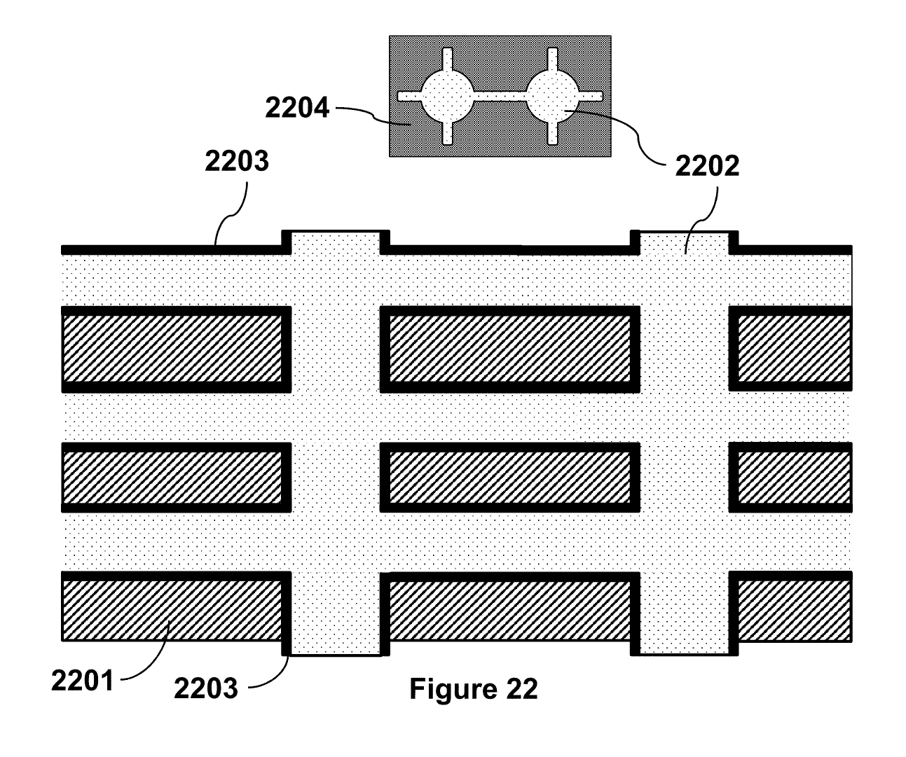

FIG. 22 provides a schematic cross-sectional side view of a three-dimensional electrode array comprising a bridge type structure linking the rod electrodes. The inset shows a top view. Here, the electrode array comprises plate electrodes 2201, rod electrodes 2202 and electrolyte 2203. A space (not explicitly shown in the cross-sectional view) is provided between plate electrodes 2201 and is optionally filled with a solid, fluid or gel electrolyte 2204. Here, the inset view shows electrolyte 2204 surrounding rod electrode 2202 and electrolyte 2203. Rod electrodes 2202 form bridges to neighboring rod electrodes 2203 along lateral dimensions from an aperture in plate electrodes 2101. Optionally, electrolyte 2203, which separates rod electrodes 2202 from plate electrodes 2201, is applied as a coating on the rod electrode 2202.

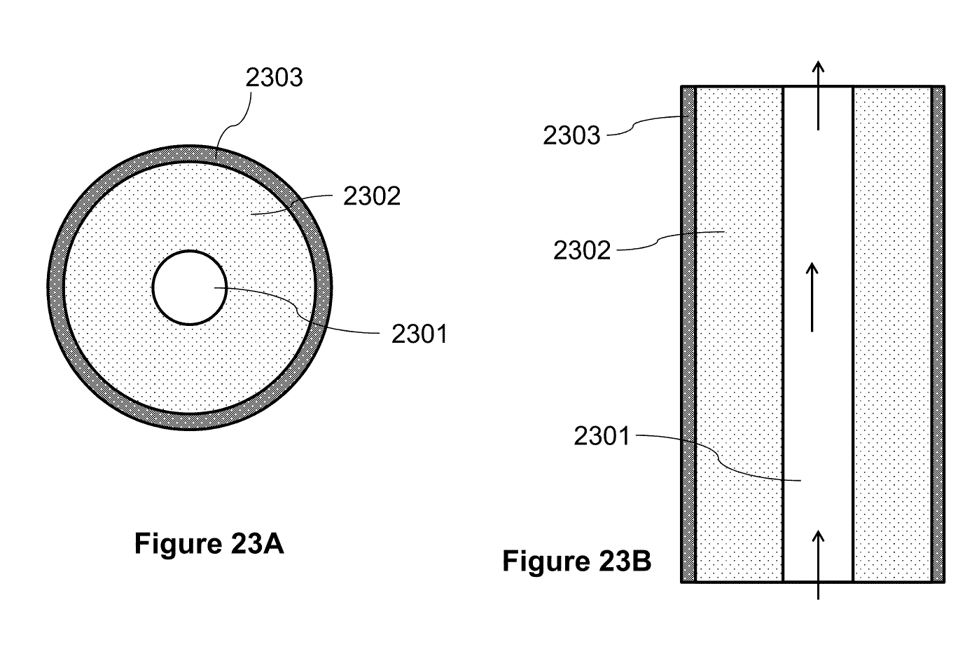

FIGS. 23A and 23B provide a schematic diagram illustrating a hollow rod cathode for use in some of the electrochemical cells of the invention, particularly part solid, part fluid electrochemical cells such as a metal-air battery system including a lithium-air battery or zinc-air battery, or a metal-aqueous battery system, such as a lithium-water battery. FIG. 23A provides a top view and FIG. 23B provides a side view. As illustrated in these figures one or more of the cathode electrode rods of the electrochemical cell comprises a hollow cylinder having an ionic conductive membrane 2303 (optional), a porous and electric (ionic and electronic) conductive material 2302 (e.g. porous carbon and electrolyte) and a hollow region 2301 providing a flow path for a fluid reagent (e.g. gas or liquid), for example a fluid oxidant such as O₂, air or water or a slurry of active materials that optionally have added conductive carbon to improve electronic conductivity of the active material. The arrows in FIG. 23B schematically represent an example of the flow path of the fluid reagent. In some embodiments, the hollow region 2301 optionally is a very porous structure such as a Gas Diffusion Layer, similar to those used in fuel cells or other types of fluid transport materials. In some embodiments, a membrane is optionally placed between the hollow region 2301 and the cathode current collectors 2302; the membrane filters unwanted materials or impurities, such as CO₂ in the case of metal-air batteries, from reaching the rest of the cell.

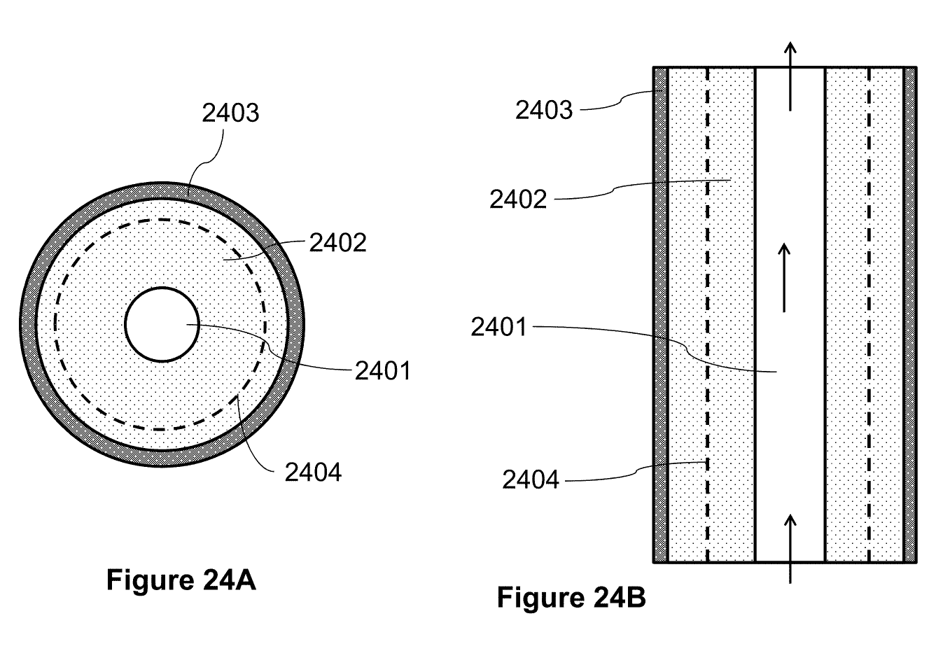

FIGS. 24A and 24B provide schematic diagrams illustrating another hollow rod cathode for use in some of the electrochemical cells of the invention, particularly part solid, part fluid electrochemical cells such as a metal-air battery system including a lithium-air battery or zinc-air battery, or a metal-aqueous battery system, such as a lithium-water battery. FIG. 24A provides a top view and FIG. 24B provides a side view. As illustrated in these figures one or more of the cathode electrode rods of the electrochemical cell is a hollow cylinder comprising an ionic conductive membrane 2403 (optional), a porous and electrically (ionic and electronic) conductive material 2402 (e.g. porous carbon and electrolyte), a current collector 2404 (e.g., metal mesh or foam) and a hollow region 2401 providing a flow path for a fluid reagent (e.g. gas or liquid), for example a fluid oxidant such as O₂, air or water or water or flow of an alkali-ion cathode (e.g. 0.1 M K₃Fe(CN)₆). The arrows in FIG. 24B schematically represent an example of the flow path of the fluid reagent.

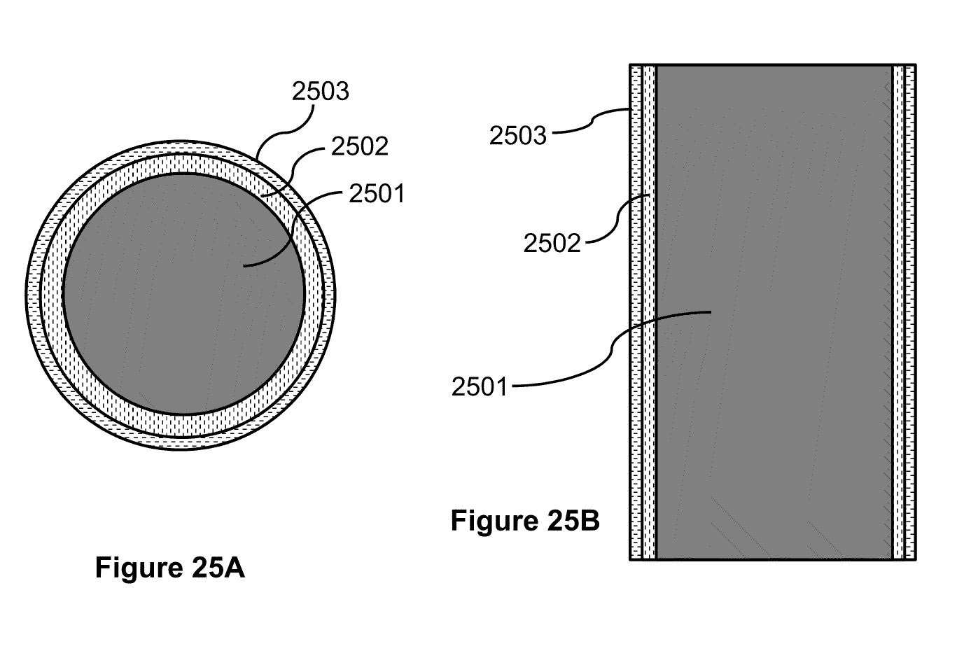

FIGS. 25A and 25B provide a schematic diagram illustrating a rod anode for use in some of the electrochemical cells of the invention, particularly part solid, part fluid electrochemical cells such as a metal-air battery system including a lithium-air battery or zinc-air battery, or a metal-aqueous battery system, such as a lithium-water battery. FIG. 25A provides a top view and FIG. 25B provides a side view. As illustrated in these figures one or more of the anode electrode rods of the electrochemical cell is a cylinder having a shell of electrolyte materials (solid or liquid). As shown in these figures, for example, the anode comprises an ionic conductive-electronic insulating membrane 2503 (optional), an electrolyte 2502, and an anode active material 2501 (e.g. metal such as Li, Na or Zn).

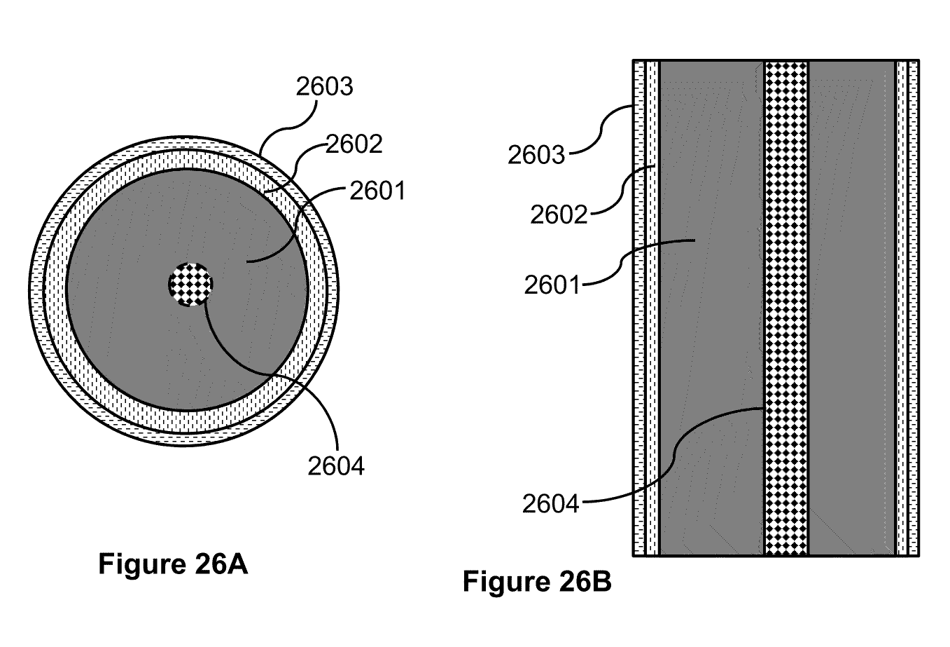

FIGS. 26A and 26B provide a schematic diagram illustrating another rod anode for use in some of the electrochemical cells of the invention, particularly part solid, part fluid electrochemical cells such as a metal-air battery system including a lithium-air battery or lithium-water battery, or an aluminum-air battery or zinc-air battery or silicon-air battery or alkali-ion cathode flow battery or solid oxide redox flow battery (see, e.g., Mater. Chem., 2011, 21, 10113-10117 and US patent application publication US 20120270088 A1 for other optional materials and chemistries). FIG. 26A provides a top view and FIG. 26B provides a side view. As illustrated in these figures one or more of the anode electrode rods of the electrochemical cell is a cylinder having a shell of electrolyte materials (solid or liquid). As shown in these figures, for example, the anode comprises an ionic conductive-electronic insulating membrane 2603 (optional), an electrolyte 2602, a current collector 2604 (e.g., metal wire) and an anode active material 2601 (e.g., metals such as Li, Na, Fe, Si, Mg, Pb, Ni, Al or Zn or their alloys or their oxides or their solutions).

Cylindrical metal-air batteries, in which the anode forms the core and the cathode forms the shell and the air comes from surrounding of the shell, such as lithium-air and zinc-air batteries, are known in the art. Parallel plate design of metal-air batteries or semi-solid batteries or cathode flow batteries or flow batteries are also known in the art. However, scaling up these designs and also making packs and modules of these cells with the current art is not effective and results in loses in volumetric energy density. In the art of fuel cells the tubular design of Siemens-Westinghouse implements series of hollow cylinders of oxygen cathode in a matrix of the fuel anode, such as hydrogen or natural gas. The Siemens-Westinghouse design, however, has only been introduced for fuel cells and not any other electrochemical reactors. Even the Siemens-Westinghouse design for the fuel cells has limitations due to the electric and thermal conductivities. The 3-D design described herein significantly improves the electronic conductivity and thermal conductivity of the reactor (cell) by providing extra paths for the heat and electrons using the high electronic and thermal conductivity of the perforated plates. The perforated plates, for example, further adds to the structural stability of the cell and allows longer tubes and cells, even though they are optionally porous to reduce weight and increase surface area. It also significantly enhances the scale up and packing/modeling of the cells. In this format, the described 3D design overcomes the shortages of the current state of the art.

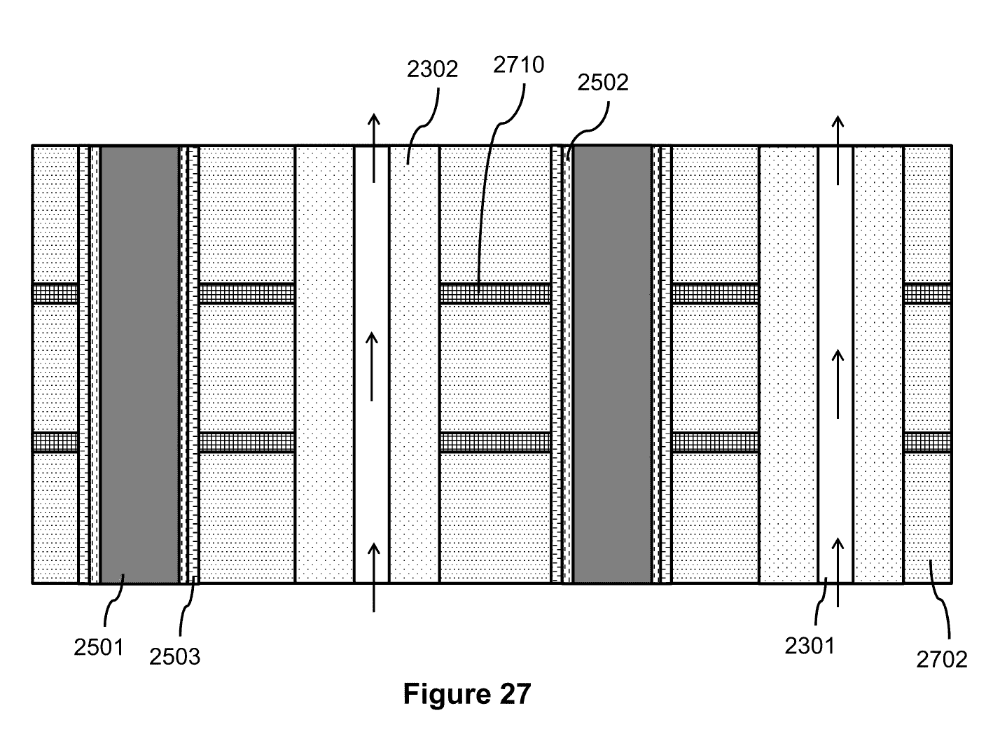

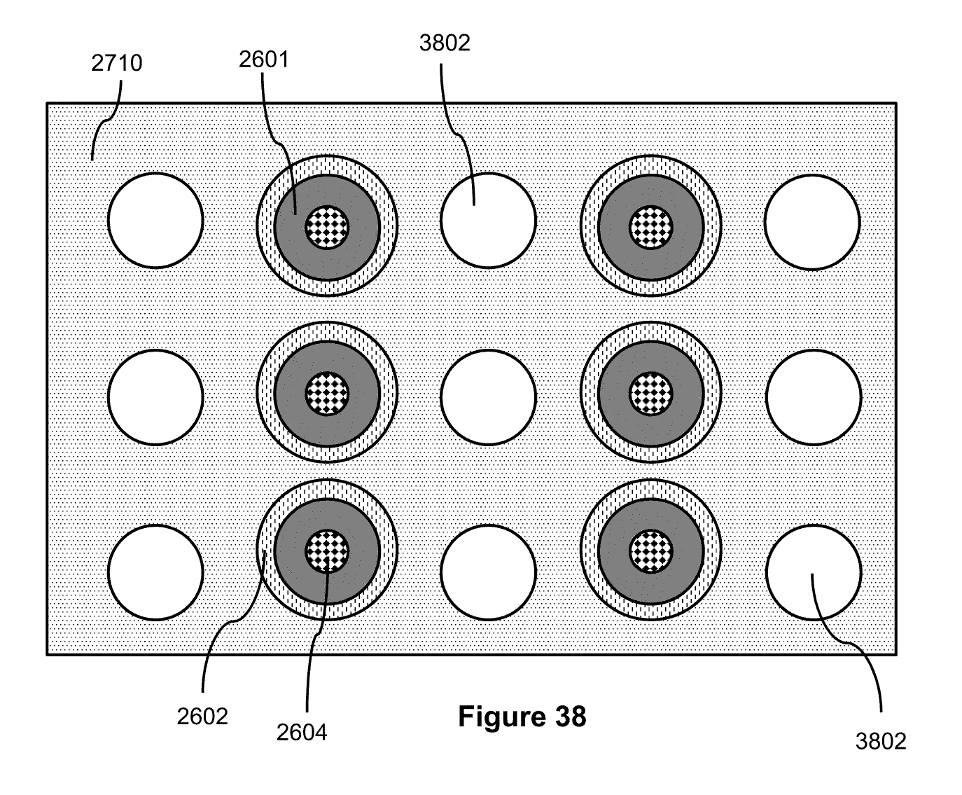

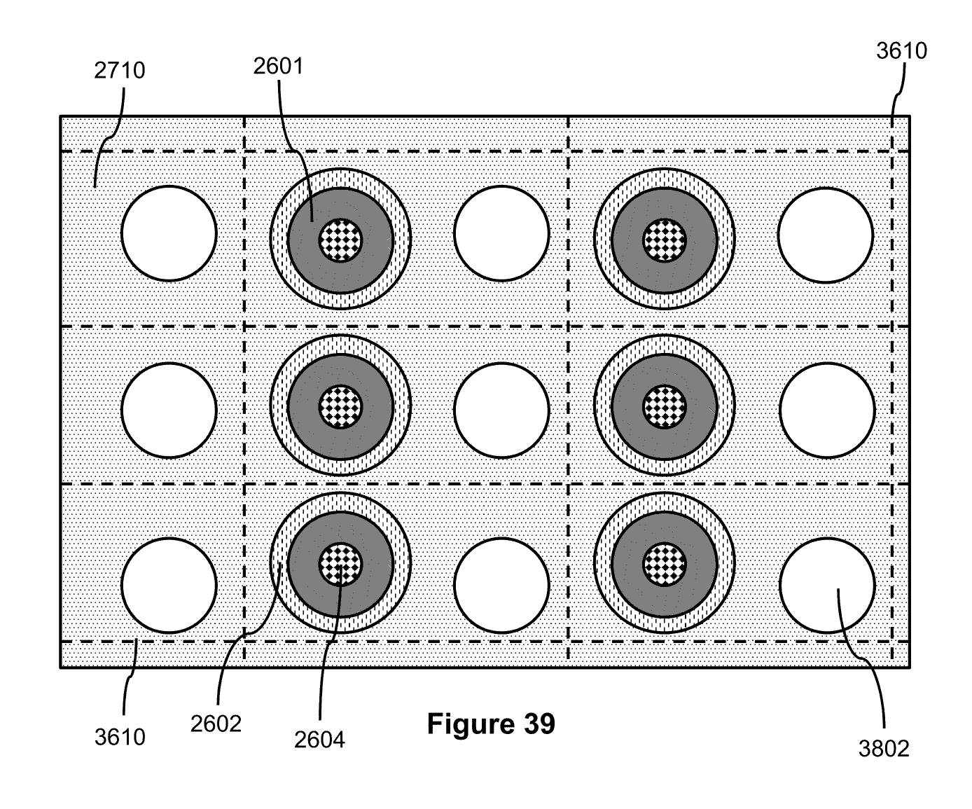

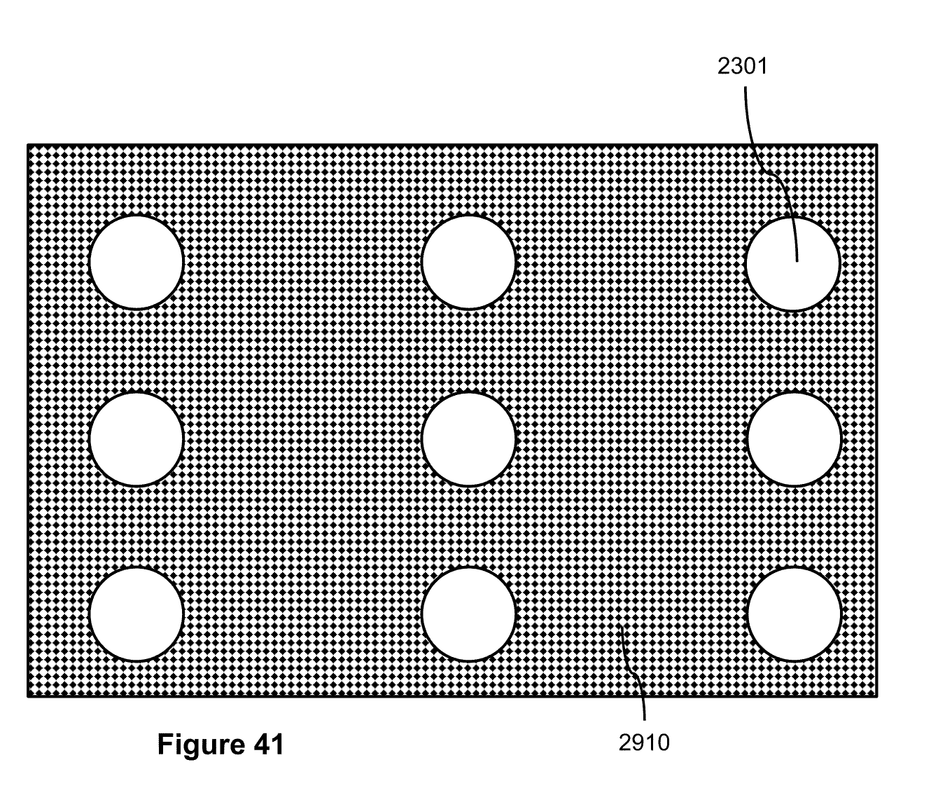

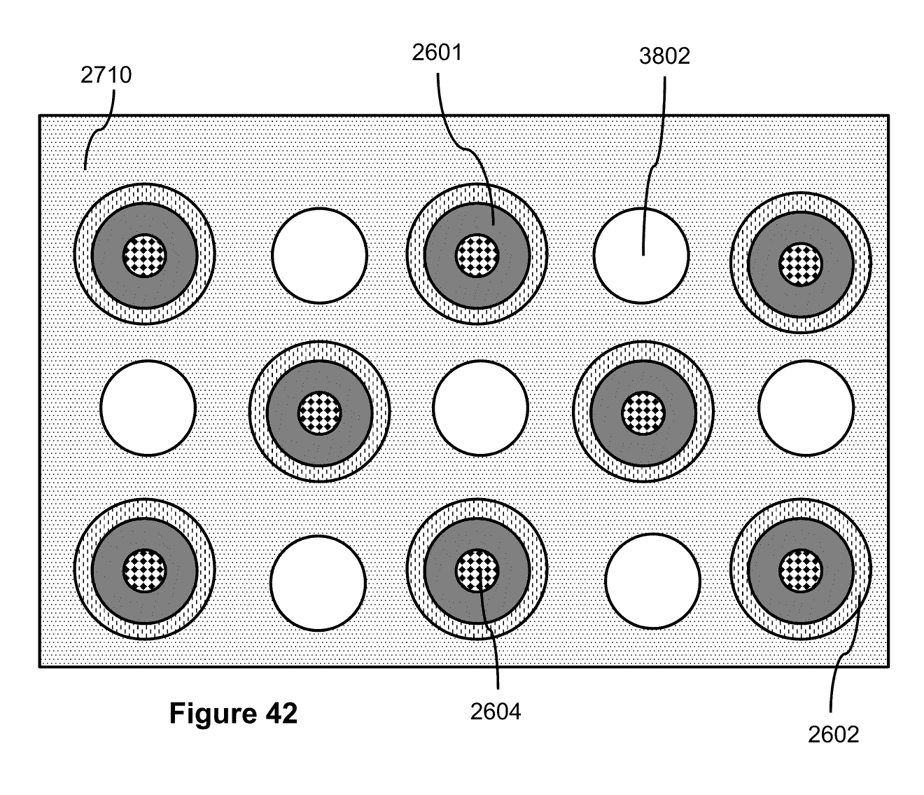

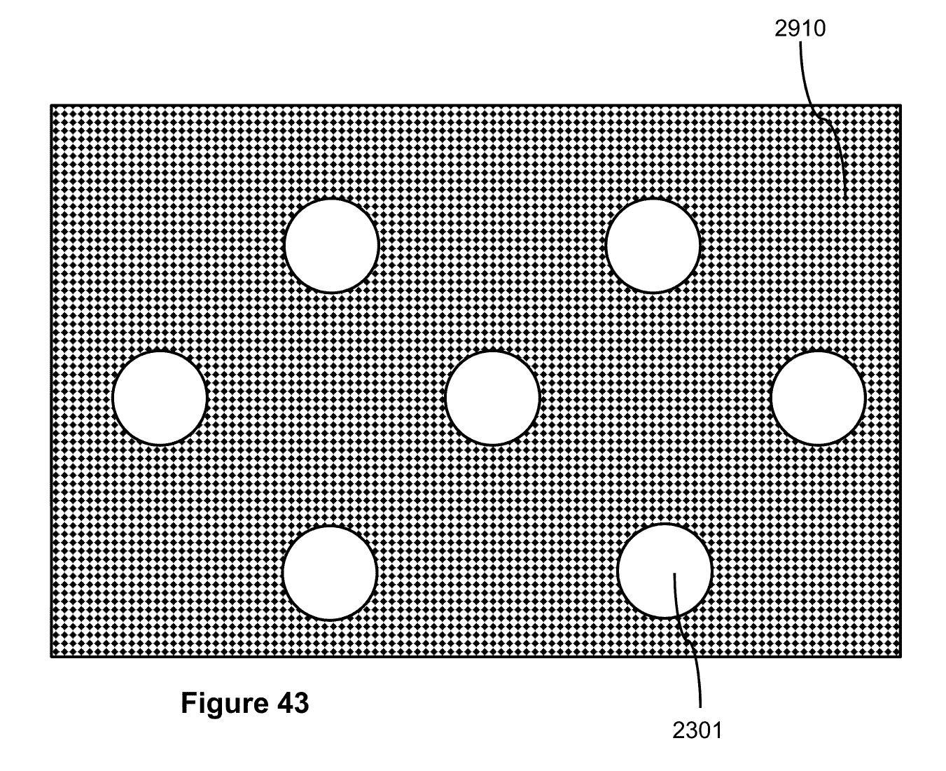

Each of FIGS. 38-41 provides a top view of an electrochemical cell of the invention particularly useful for part solid, part fluid electrochemical cells, consisting of perforated plates (not shown here), optionally for electronic transport (current collector) and cathode rods and anode rods as shown in FIGS. 23-26, with front or side views shown in FIGS. 27-37, showing an electrode array configuration. FIG. 39 provides a top view of an electrochemical cell of the invention particularly useful for part solid, part fluid electrochemical cells showing another electrode array configuration and a possible assembly of assistive current collectors, as shown in FIGS. 27-37. FIG. 41 provides a top view of an electrochemical cell of the invention particularly useful for part solid, part fluid electrochemical cells showing another electrode array configuration, consisting of series of parallel perforated plates (not shown here) of anode active material and optionally cathode current collector perforated plates between each of two successive anode plates and also consisting of cathode rods as shown in FIGS. 23-24, with front or side views shown in FIG. 17. FIG. 42 provides a top view of an electrochemical cell of the invention particularly useful for part solid, part fluid electrochemical cells showing another electrode array configuration, consisting of perforated plates (not shown here), optionally for electronic transport (current collector) and cathode rods and anode rods as shown in FIGS. 23-26, with front or side views shown in FIGS. 27-37. FIG. 43 provides a top view of an electrochemical cell of the invention particularly useful for part solid, part fluid electrochemical cells showing another electrode array configuration, consisting of series of parallel perforated plates (not shown here) of anode active material and optionally cathode current collector perforated plates between each of two successive anode plates and also consisting of cathode rods as shown in FIGS. 23-24, with front or side views shown in FIG. 17.

FIG. 27 provides a side view of an electrochemical cell of the invention particularly useful for part solid, part fluid electrochemical cells such as a metal-air battery system including a lithium-air battery or zinc-air battery, or a metal-aqueous battery system, such as a lithium-water battery. The electrochemical cell of this embodiment integrates the hollow rod cathodes of FIGS. 23A and 23B and rod anodes of FIGS. 25A and 25B. As shown in this Figure, the cathode and anode electrodes extend through a series of perforated plates 2702 to form the 3D electrode array geometry. In addition, spaces 2710 are provided between perforated plates 2702 which are optionally filled with electrolyte. In some embodiments, for example, solid discharge products form in spaces 2710.

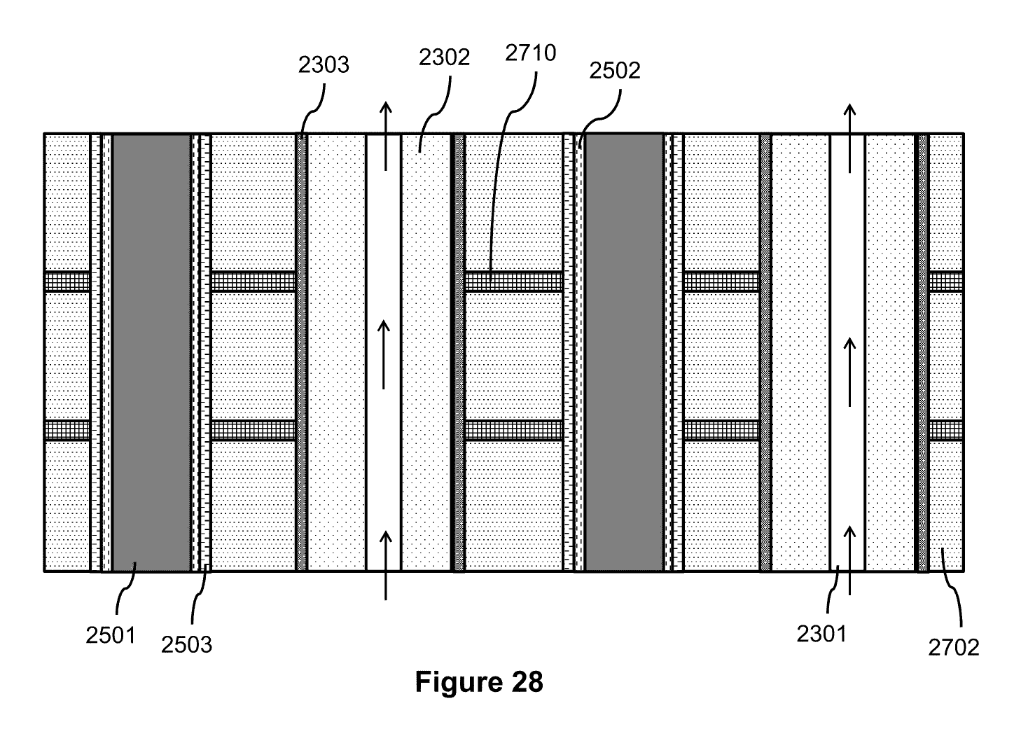

FIG. 28 provides a side view of another electrochemical cell of the invention particularly useful for part solid, part fluid electrochemical cells such as a metal-air battery system including a lithium-air battery or zinc-air battery, or a metal-aqueous battery system, such as a lithium-water battery. The electrochemical cell of this embodiment integrates the hollow rod cathodes of FIGS. 23A and 23B and rod anodes of FIGS. 25A and 25B. As shown in this Figure, the cathode and anode electrodes extend through a series of perforated plates 2702 to form the 3D electrode array geometry. In addition, spaces 2710 are provided between perforated plates 2702 which are optionally filled with electrolyte. In some embodiments, for example, solid discharge products form in spaces 2710. In addition, the hollow rod cathodes further comprise an ionic conductive membrane 2303 positioned proximate to perforated plates 2702.

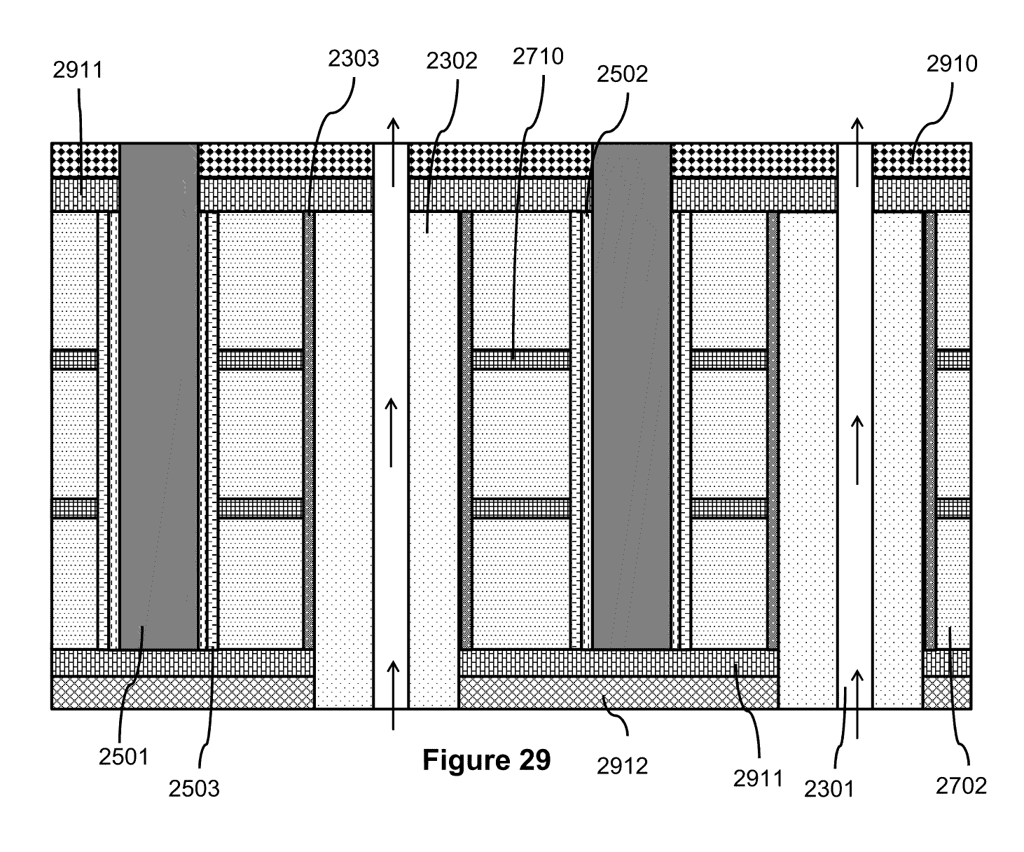

FIG. 29 provides a side view of another electrochemical cell embodiment particularly useful for part solid, part fluid electrochemical cells such as a metal-air battery system including a lithium-air battery or zinc-air battery, or a metal-aqueous battery system, such as a lithium-water battery. The electrochemical cell shown in FIG. 29 is similar to that shown in FIG. 28, but further comprises current collectors on the top and bottom of the cell. In the embodiment shown in this figure, for example, the electrochemical cell further comprises an electrically insulating layer 2911 (e.g. perforated Teflon), an anode current collector 2910 (e.g., perforated metal) and a cathode current collector 2912 (e.g. perforated metal).

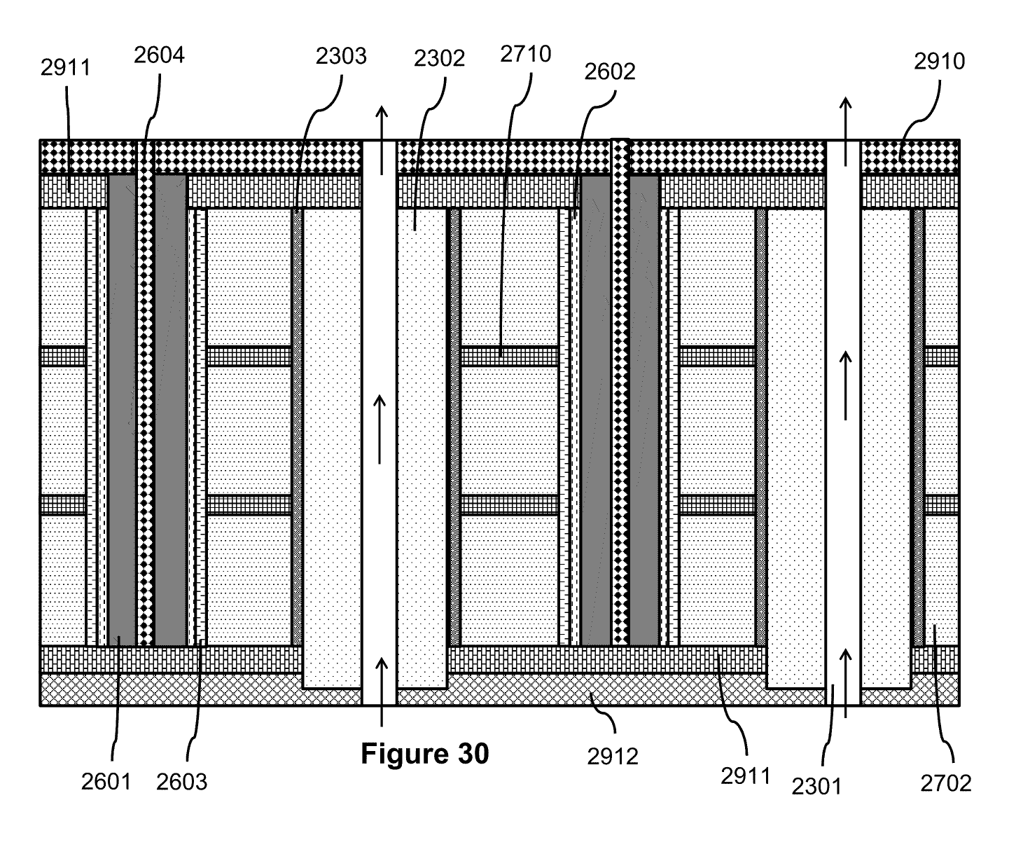

FIG. 30 provides a side view of another electrochemical cell of the invention particularly useful for part solid, part fluid electrochemical cells such as a metal-air battery system including a lithium-air battery or zinc-air battery, or a metal-aqueous battery system, such as a lithium-water battery. The electrochemical cell shown in FIG. 30 is similar to that shown in FIG. 29, but further comprises a current collector (e.g., metal wire) 2604 provided at the core of the cylindrical anodes.

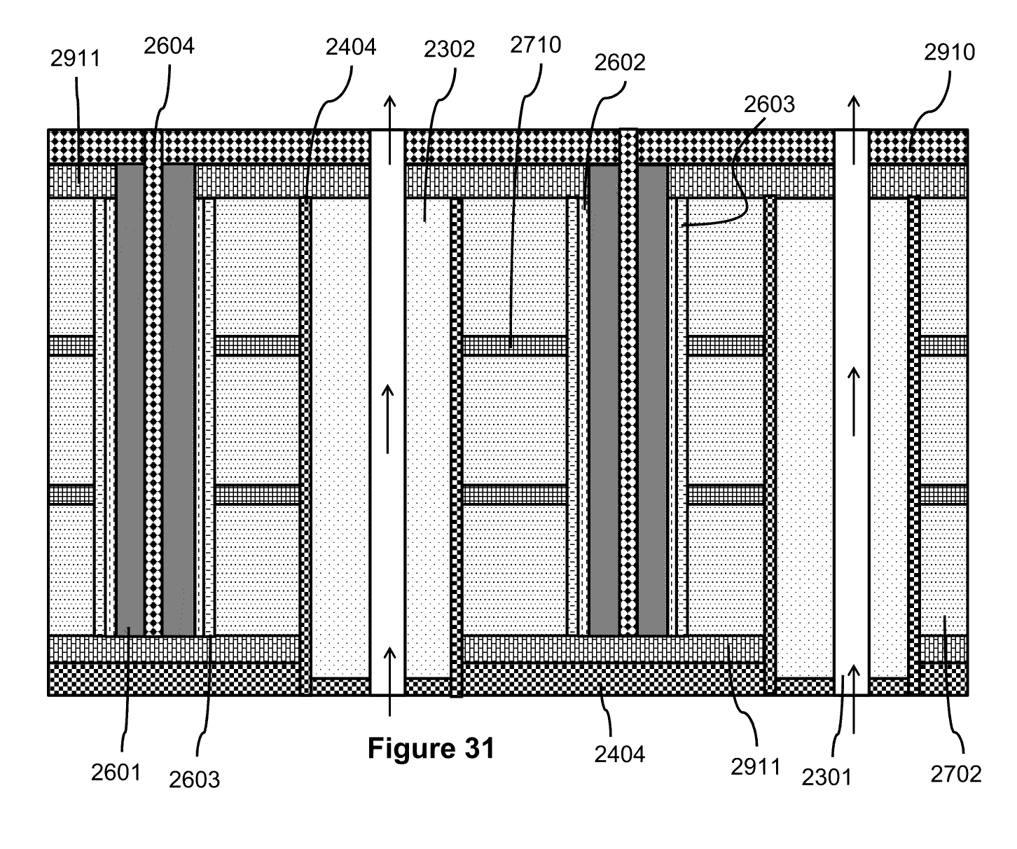

FIG. 31 provides a side view of another electrochemical cell of the invention particularly useful for part solid, part fluid electrochemical cells such as a metal-air battery system including a lithium-air battery or zinc-air battery, or a metal-aqueous battery system, such as a lithium-water battery. The electrochemical cell shown in FIG. 31 is similar to that shown in FIG. 30, but wherein the hollow rod cathode has a current collector 2404 provided at the bottom and on the exterior of the hollow rod cathode 2303.

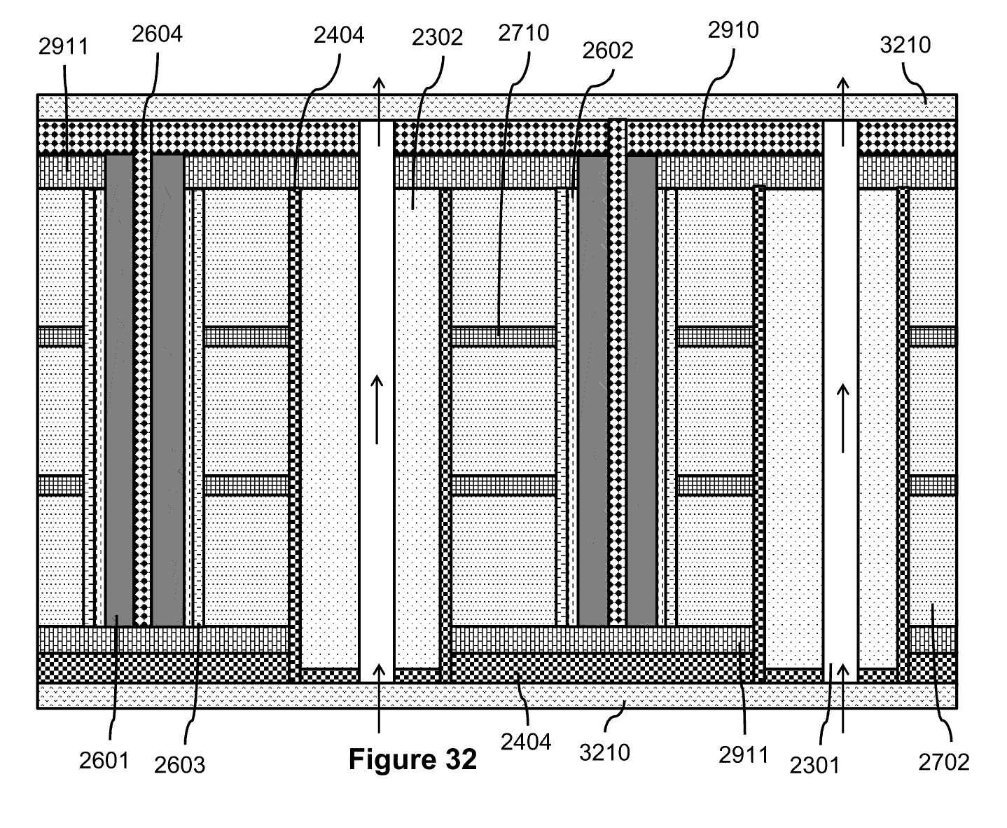

FIG. 32 provides a side view of another electrochemical cell of the invention particularly useful for part solid, part fluid electrochemical cells such as a metal-air battery system including a lithium-air battery or zinc-air battery, or a metal-aqueous battery system, such as a lithium-water battery. The electrochemical cell shown in FIG. 32 is similar to that shown in FIG. 31, but further comprises a membrane 3210 for filtering the flow of cathode active material.

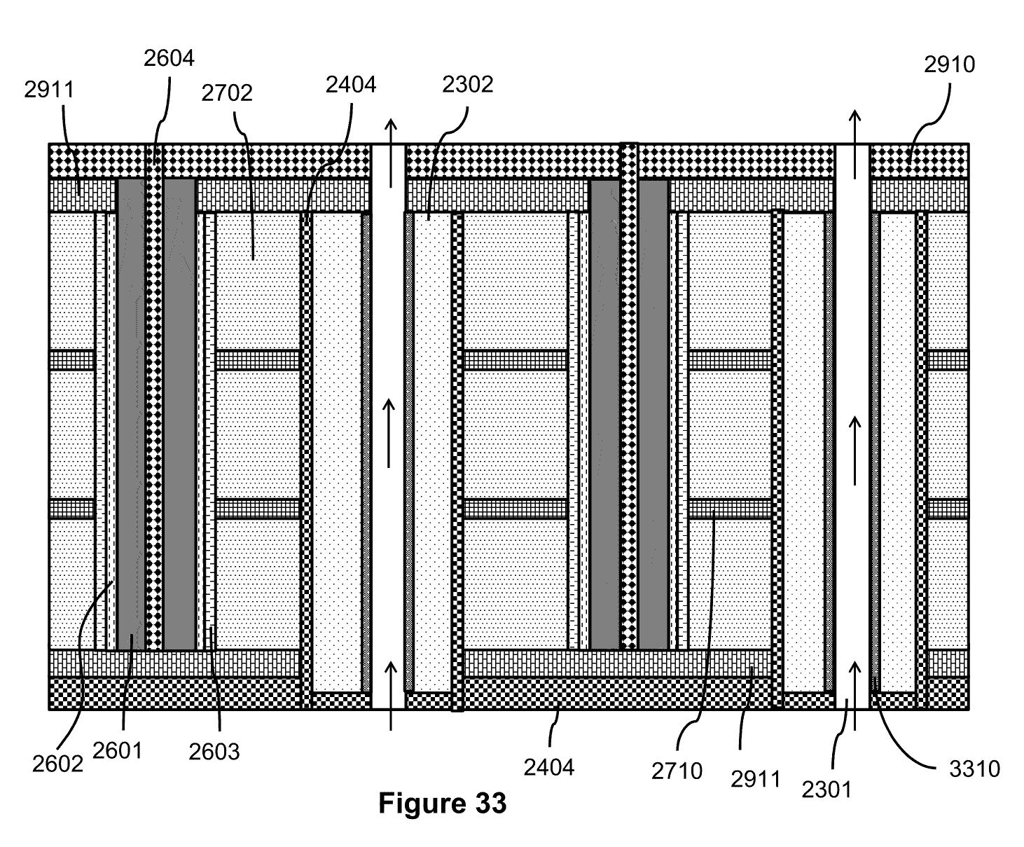

FIG. 33 provides a side view of another electrochemical cell of the invention particularly useful for part solid, part fluid electrochemical cells such as a metal-air battery system including a lithium-air battery or zinc-air battery, or a metal-aqueous battery system, such as a lithium-water battery. The electrochemical cell shown in FIG. 33 is similar to that shown in FIG. 31, but further comprises a membrane 3310, located proximal to hollow space 2301, for filtering the flow of cathode active material.

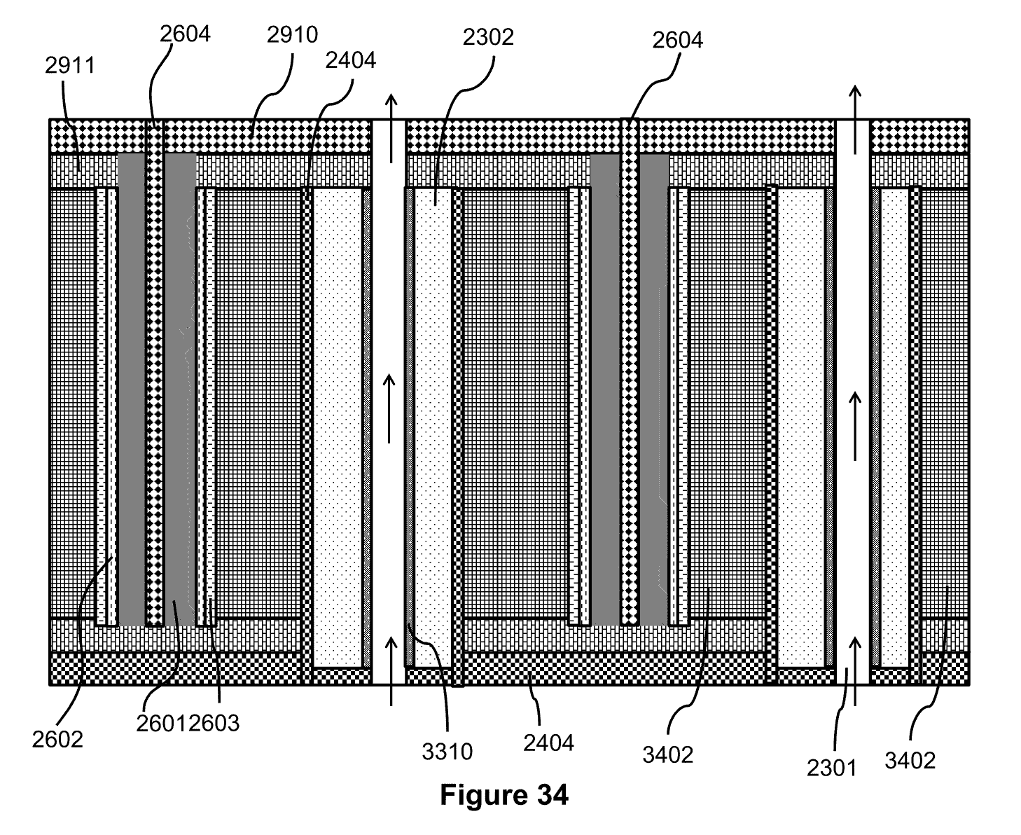

FIG. 34 provides a side view of another electrochemical cell of the invention particularly useful for part solid, part fluid electrochemical cells such as a metal-air battery system including a lithium-air battery or zinc-air battery, or a metal-aqueous battery system, such as a lithium-water battery. In the electrochemical cell shown in FIG. 34, the tightly packed parallel cylinders of anode and cathode are in a bath of the electrolyte 3402. In the specific embodiment shown in FIG. 34, there is no perforated plate component of the cell.

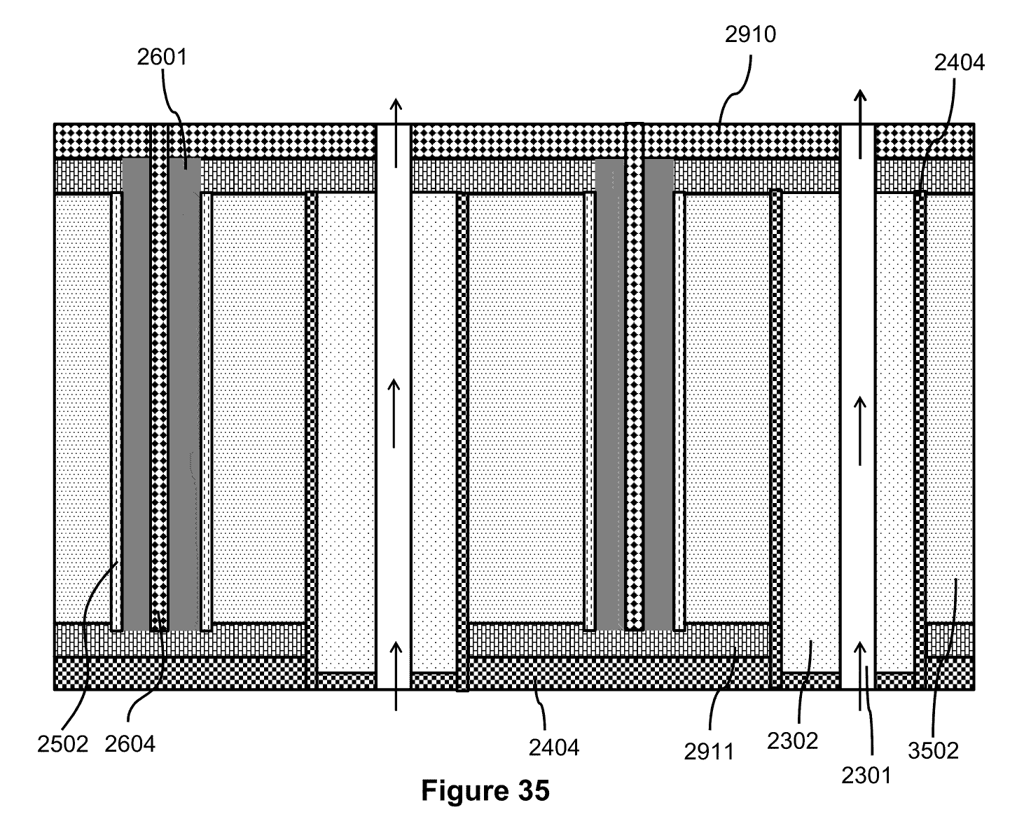

FIG. 35 provides a side view of another electrochemical cell of the invention particularly useful for part solid, part fluid electrochemical cells such as a metal-air battery system including a lithium-air battery or zinc-air battery, or a metal-aqueous battery system, such as a lithium-water battery. In the electrochemical cell shown in FIG. 35, the tightly packed parallel cylinders of anode and cathode are in a matrix of an electronic and ionic media (e.g., porous carbon and electrolyte). In the specific embodiment shown in FIG. 35, there is one thick perforated plate 3502 component of the cell.

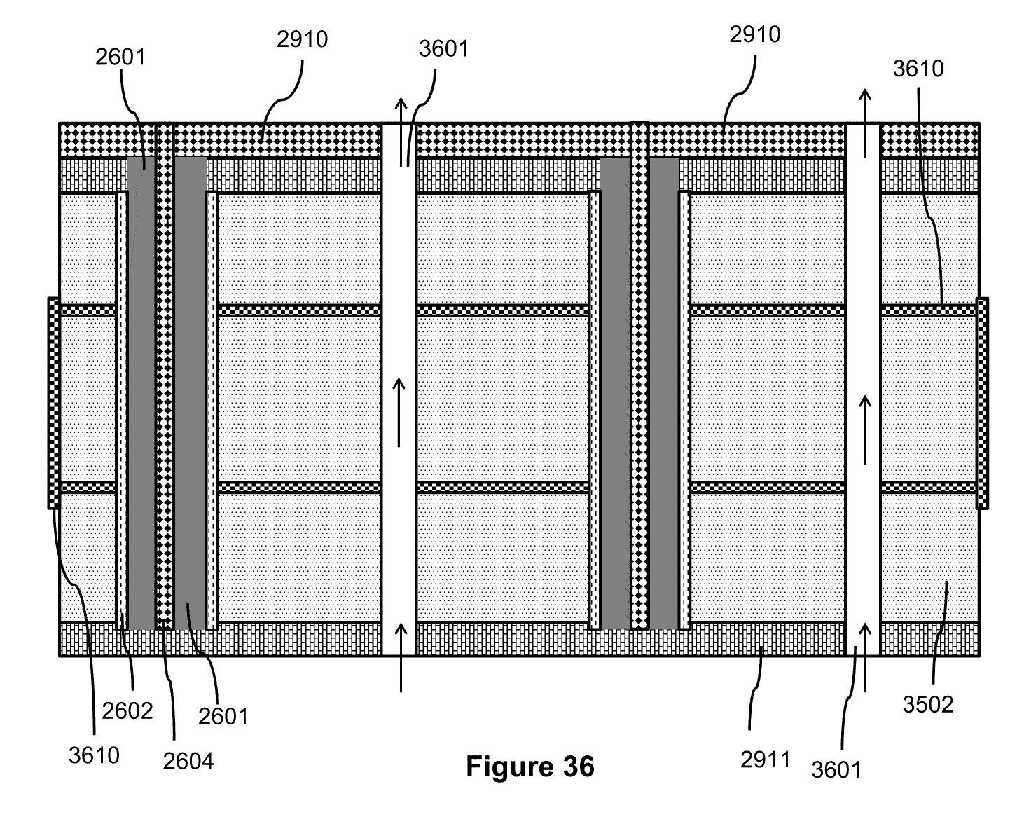

FIG. 36 provides a side view of another electrochemical cell of the invention particularly useful for part solid, part fluid electrochemical cells such as a metal-air battery system including a lithium-air battery or zinc-air battery, or a metal-aqueous battery system, such as a lithium-water battery. In the electrochemical cell shown in FIG. 36, the tightly packed parallel cylinders of anode and cathode are in a matrix of an electronic and ionic media (e.g., porous carbon and electrolyte). In the specific embodiment shown in FIG. 36, there is one thick perforated plate 3502 component of the cell, with layers of current collectors 3610 (e.g., perforated plates, network or mesh of metals) interspersed throughout the thick perforated plate 3502. Hollow region 3601 provides a flow path for a fluid reagent (e.g., gas or liquid), for example a fluid oxidant such as O₂, air or water. The arrows in FIG. 36 schematically represent the flow path of the fluid reagent.

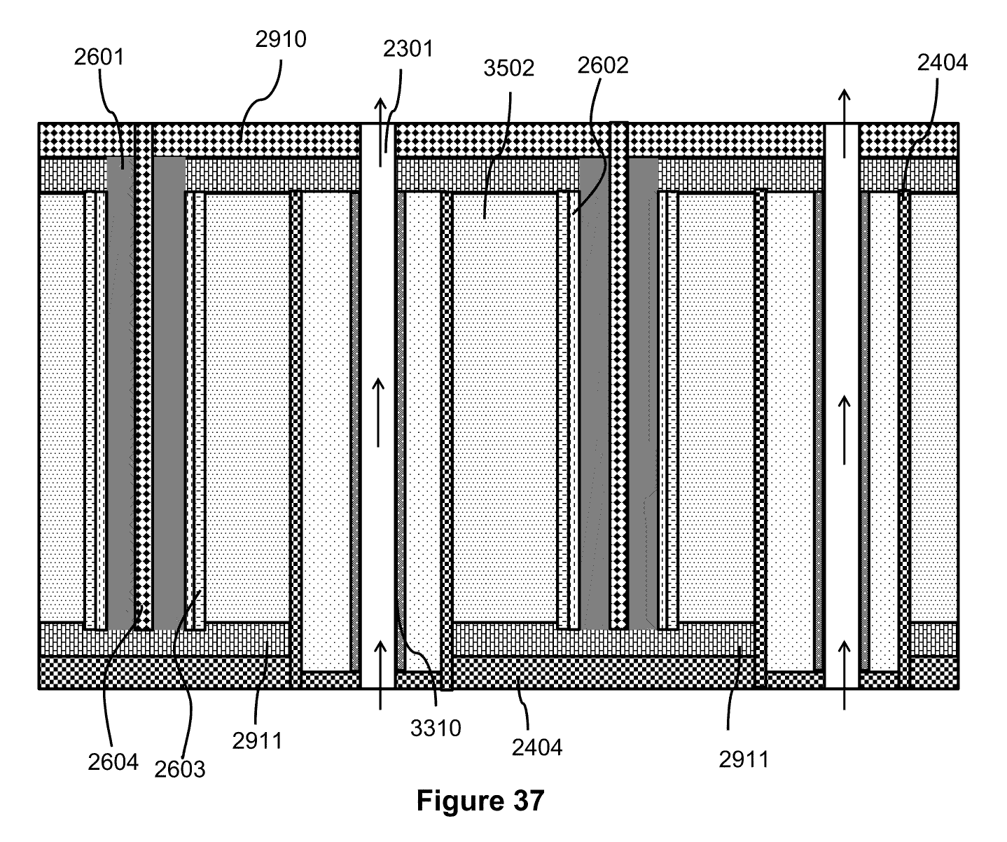

FIG. 37 provides a side view of another electrochemical cell of the invention particularly useful for part solid, part fluid electrochemical cells such as a metal-air battery system including a lithium-air battery or zinc-air battery, or a metal-aqueous battery system, such as a lithium-water battery. The electrochemical cell shown in FIG. 37 is similar to that shown in FIG. 35, with one thick perforated plate 3502, but further comprises a membrane 3310, located proximal to hollow space 2301, for filtering the flow of cathode active material.

FIG. 38 provides a top view of an electrochemical cell of the invention particularly useful for part solid, part fluid electrochemical cells showing an electrode array configuration. The electrochemical cell of this embodiment comprises plate electrodes 2710 having a plurality of apertures 3802 and includes a plurality of rod electrodes comprising anode active material 2601, electrolyte 2602 and current collector 2604.

FIG. 39 provides a top view of an electrochemical cell of the invention particularly useful for part solid, part fluid electrochemical cells showing another electrode array configuration. The electrochemical cell of this embodiment comprises plate electrodes 2710 having a plurality of apertures 3802 and current collectors 3610 and includes a plurality of rod electrodes comprising anode active material 2601, electrolyte 2602 and current collector 2604.

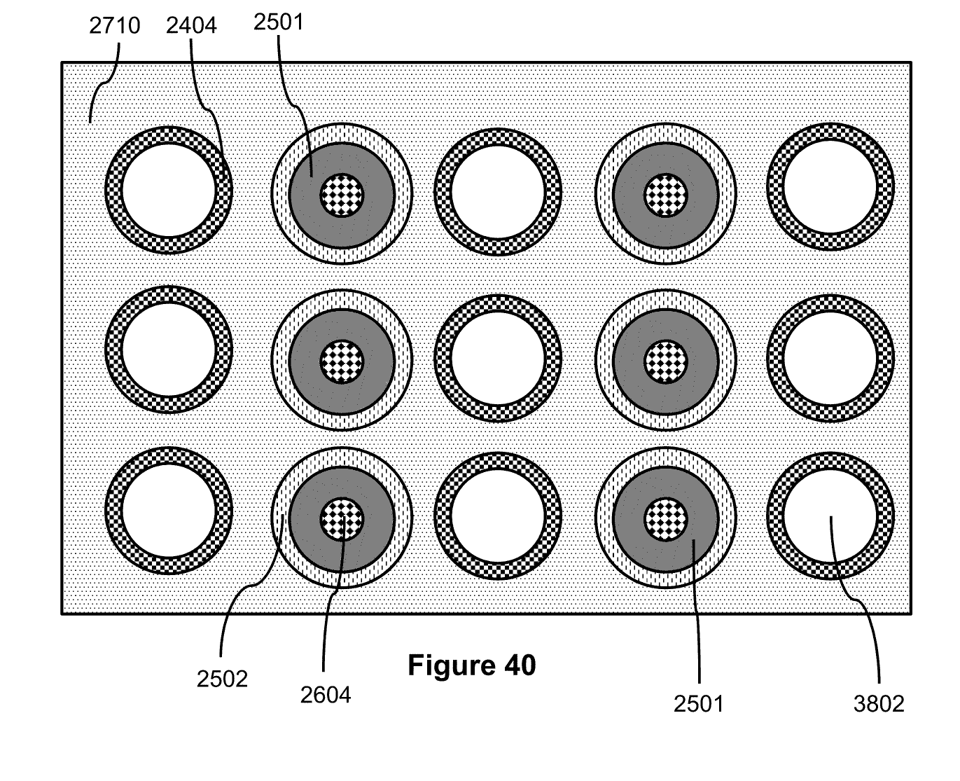

FIG. 40 provides a top view of an electrochemical cell of the invention particularly useful for part solid, part fluid electrochemical cells showing another electrode array configuration. The electrochemical cell of this embodiment comprises plate electrodes 2710 having a plurality of apertures 3802 lined with current collectors 2404 and includes a plurality of rod electrodes comprising anode active material 2501, electrolyte 2502 and current collector 2604.

FIG. 41 provides a top view of a component of an electrochemical cell. FIG. 41 specifically shows a current collector 2910 with hollow regions 2301.

FIG. 42 provides a top view of an electrochemical cell of the invention particularly useful for part solid, part fluid electrochemical cells showing another electrode array configuration. The electrochemical cell of this embodiment comprises plate electrodes 2710 having a plurality of apertures 3802 and includes a plurality of rod electrodes comprising anode active material 2601, electrolyte 2602 and current collector 2604.

FIG. 43 provides a top view of a component of an electrochemical cell. FIG. 43 specifically shows a current collector 2910 with hollow regions 2301.

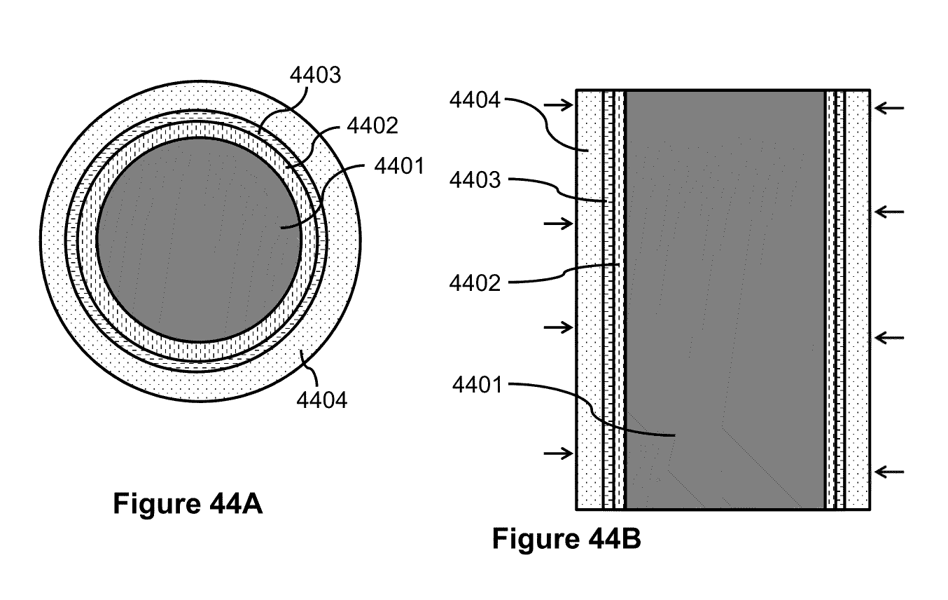

FIGS. 44A and 44B provide a schematic diagram illustrating a composite rod electrode wherein at least a portion of the rod is a composite cylinder comprising the anode and the cathode. FIG. 44A provides a top view and FIG. 44B provides a side view. In some embodiments, the flow of active cathode material (e.g. semi-solid cathode active materials or redox cathode flow materials or O2 or air) is radial (as indicated schematically by arrows). A shown in this figure, the composite rod electrode comprises ionic conductive-electronic insulating membrane or a separator 4403, electrolyte 4402, anode active material 4401 (e.g. metal such as Li, Na or Zn) and optionally a current collector in the center, and porous and electric conductive material 4404 (e.g., porous carbon and electrolyte that is optionally the same as or different from the electrolyte in contact with the anode 4402). This composite cylinder of FIG. 44 then optionally forms the rods of the 3-D architecture while perforated plates (not shown in FIG. 44) such as gas diffusion layers or fluidic transport channels optionally provide the flow of the cathode active materials such as oxygen or air or cathode slurry or molten cathode or solvated cathode.

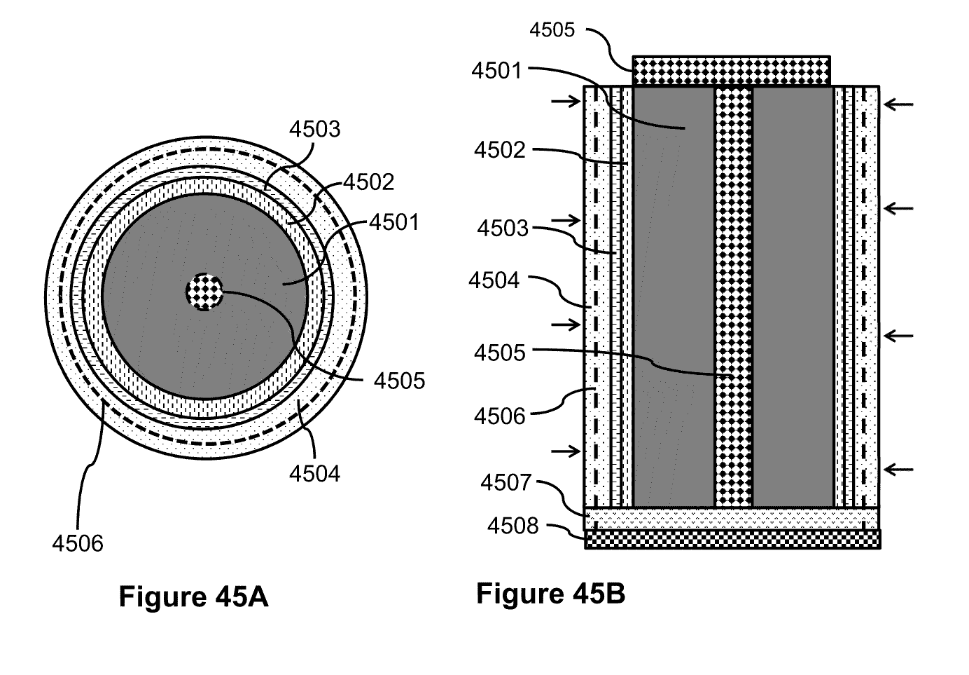

FIGS. 45A and 45B provide a schematic diagram illustrating a composite rod electrode wherein at least a portion of the rod is a composite cylinder comprising the anode, the cathode and current collectors. FIG. 45A provides a top view and FIG. 45B provides a side view. In some embodiments, the flow of active cathode material (e.g. O₂ or air) is radial (as indicated schematically by arrows). As shown in this figure, the composite rod electrode comprises ionic conductive-electronic insulating membrane or a separator 4503, electrolyte 4502, anode active material 4501 (e.g. metal such as Li, Na or Zn, Mg, Fe, Al or their alloys or flow of the anode active material (e.g., lithium droplets or molten sodium or solvated lithium or hydrogen gas or redox metallic oxide flows or semi-solid active cathode materials or vanadium pentoxide or zinc bromide)), anode current collectors 4505 and 4508, porous and electric conductive material 4504 (e.g., porous carbon and electrolyte that is optionally the same or different from the electrolyte in contact with the anode 4502), cathode current collector 4506 and its extension to the outside of the cell 4508 and electrically insulating layer 4507 separating the anode current collector 4505 from the extension of the cathode current collector 4508.

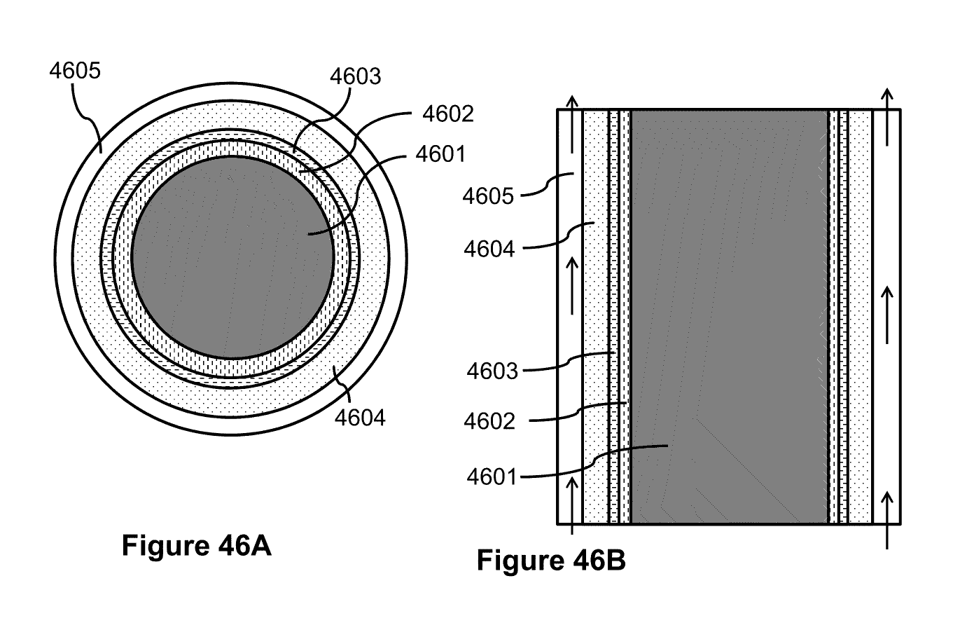

FIGS. 46A and 46B provide a schematic diagram illustrating a composite rod electrode wherein at least a portion of the rod is a composite cylinder comprising the anode and the cathode. FIG. 46A provides a top view and FIG. 46B provides a side view. In some embodiments, the flow of active cathode material (e.g. O₂ or air) is longitudinal (as indicated schematically by arrows). As shown in this figure, the composite rod electrode comprises an active cathode fluid passage 4605, which is optionally porous, ionic conductive-electronic insulating membrane or a separator 4603, anode side electrolyte 4602, anode active material 4601 (e.g. metal such as Li, Na or Zn) and optionally a current collector in the center (not shown), and porous and electrically conductive material 4604 (e.g., porous carbon and cathode side electrolyte that optionally is the same as or different from the electrolyte in contact with the anode 4602). This composite cylinder of FIG. 46 then optionally forms the rods of the 3-D architecture while perforated plates (not shown in FIG. 46) such as gas diffusion layers or fluidic transport channels optionally provide the electronic conductivity (cathode current collector) and thermal conductivity in the cell and also optionally provide mechanical stability to the cell and also optionally provide at least part of the flow of the cathode active materials such as oxygen or air or cathode slurry or molten cathode or solvated cathode.

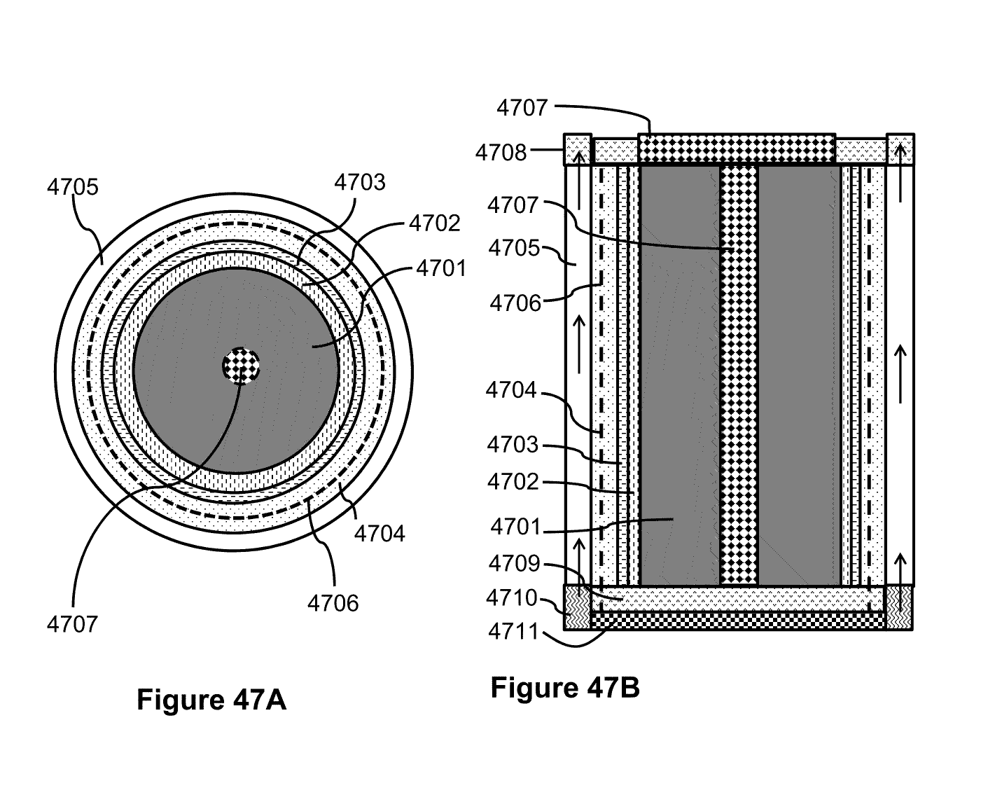

FIGS. 47A and 47B provide a schematic diagram illustrating a composite rod electrode wherein at least a portion of the rod is a composite cylinder comprising the anode and the cathode. In some embodiment, composite rod electrode further comprises a ring shape filtering membrane. FIG. 47A provides a top view and FIG. 47B provides a side view. In some embodiments, the flow of active cathode material (e.g. O₂ or air) is longitudinal (as indicated schematically by arrows). As shown in this figure, the composite rod electrode comprises an active cathode fluid passage 4705, ionic conductive-electronic insulating membrane or a separator 4703, electrolyte 4702, anode active material 4701 (e.g. metal such as Li, Na or Zn), porous and electrically conductive material 4704 (e.g., porous carbon and electrolyte cathode side electrolyte that is optionally the same as or different from the electrolyte in contact with anode 4602), current collectors 4707, 4706 and 4711 and electrically insulating layer 4709. This composite cylinder of FIG. 47 then optionally form the rods of the 3-D architecture while perforated plates (not shown in FIG. 47) such as gas diffusion layers or fluidic transport channels optionally provide the electronic conductivity (cathode current collector) and thermal conductivity in the cell and also optionally provide mechanical stability to the cell and also optionally provide at least part of the flow of the cathode active materials such as oxygen or air or cathode slurry or molten cathode or solvated cathode. Semi-permeable layers 4708 and 4710 prevent the unwanted impurities from entering the cell while also preventing liquids within the cell from exiting.

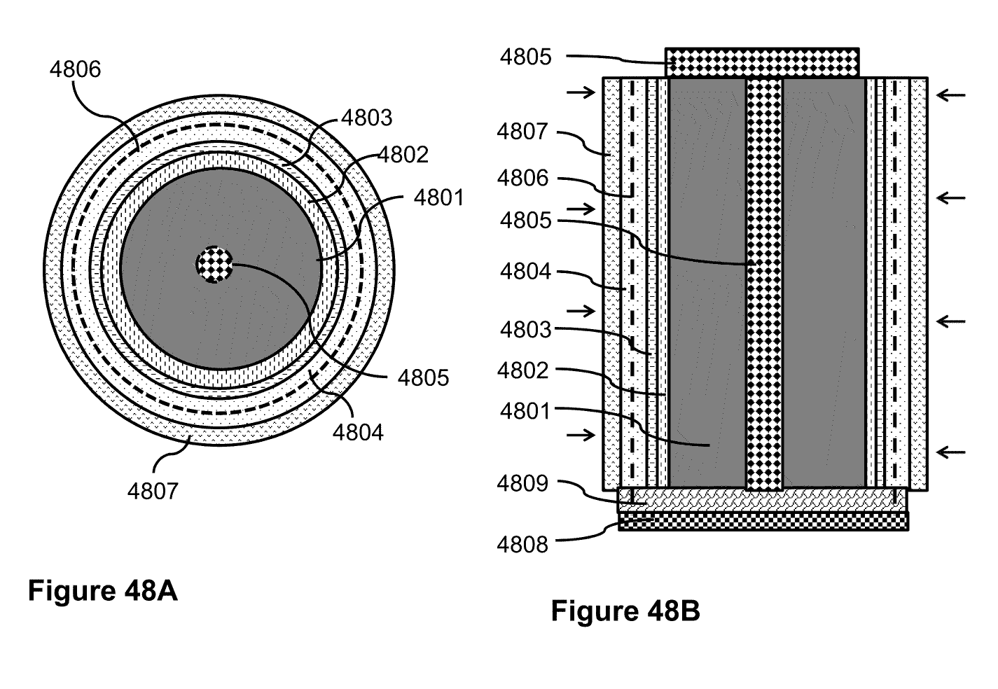

FIGS. 48A and 48B provide a schematic diagram illustrating a composite rod electrode wherein at least a portion of the rod is a composite cylinder comprising the anode, the cathode and current collectors. In some embodiment, composite rod electrode further comprises a longitudinal filtering membrane. FIG. 48A provides a top view and FIG. 48B provides a side view. In some embodiments, the flow of active cathode material (e.g. O₂ or air) is longitudinal (as indicated schematically by arrows). A shown in this figure, the composite rod electrode comprises current collectors 4805, 4806 and 4808, ionic conductive-electronic insulating membrane or a separator 4803, electrolyte 4802, anode active material 4801 (e.g. metal such as Li, Na, Fe, Al, Si, Mg, Carbon or Zn), porous and electronically conductive material 4804 (e.g., porous carbon and cathode side electrolyte that is optionally the same as or different from the electrolyte in contact with anode 4602) and filtering membrane 4807. Current collectors 4805 and 4806 are electrically isolated by separator 4809. This composite cylinder of FIG. 48, then, optionally forms the rods of the 3-D architecture while perforated plates (not shown in FIG. 48) such as gas diffusion layers or fluidic transport channels optionally provide the electronic conductivity (cathode current collector) and thermal conductivity in the cell and also optionally provide mechanical stability to the cell and also optionally provide at least part of the flow of the cathode active materials such as oxygen or air or cathode slurry or molten cathode or solvated cathode.

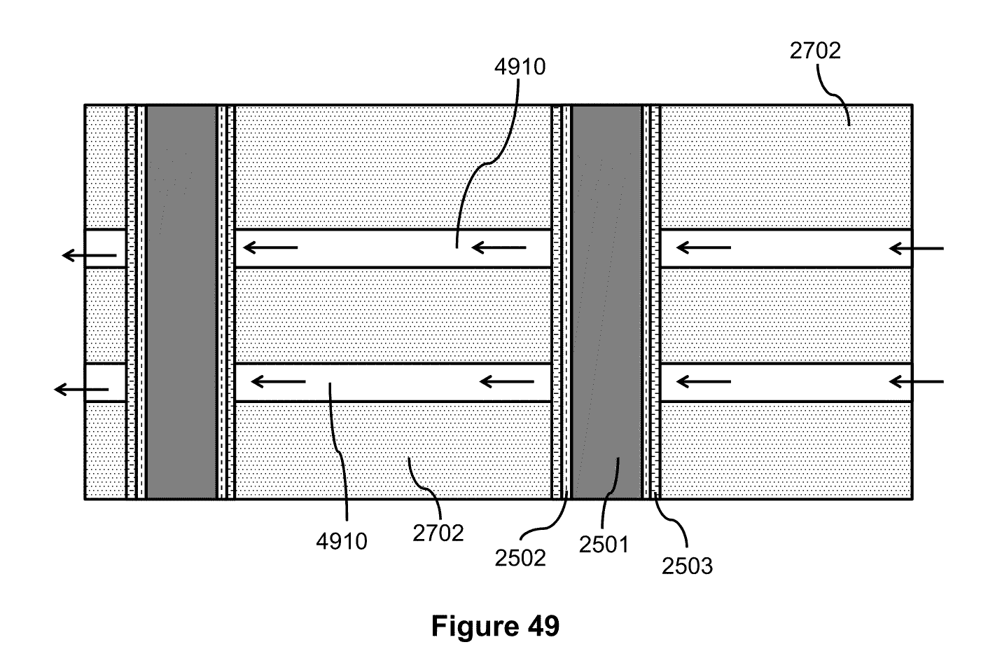

FIG. 49 provides a side view of an electrochemical cell of the invention particularly useful for part solid, part fluid electrochemical cells such as a metal-air battery system including a lithium-air battery or zinc-air battery, or a metal-aqueous battery system, such as a lithium-water battery. The electrochemical cell of this embodiment integrates the rod anodes of FIGS. 25 and 26. For clarity, therefore, the drawing labels in FIGS. 49-51 reference those shown in FIGS. 23A, 23B, 25A and 25B. As shown in this Figure, the anode electrodes extend through a series of perforated plates 2702 to form the 3D electrode array geometry. In addition, passages 4910 are provided between perforated plates 2702 for the passage of flow of the cathode active materials (schematically represented as arrows).

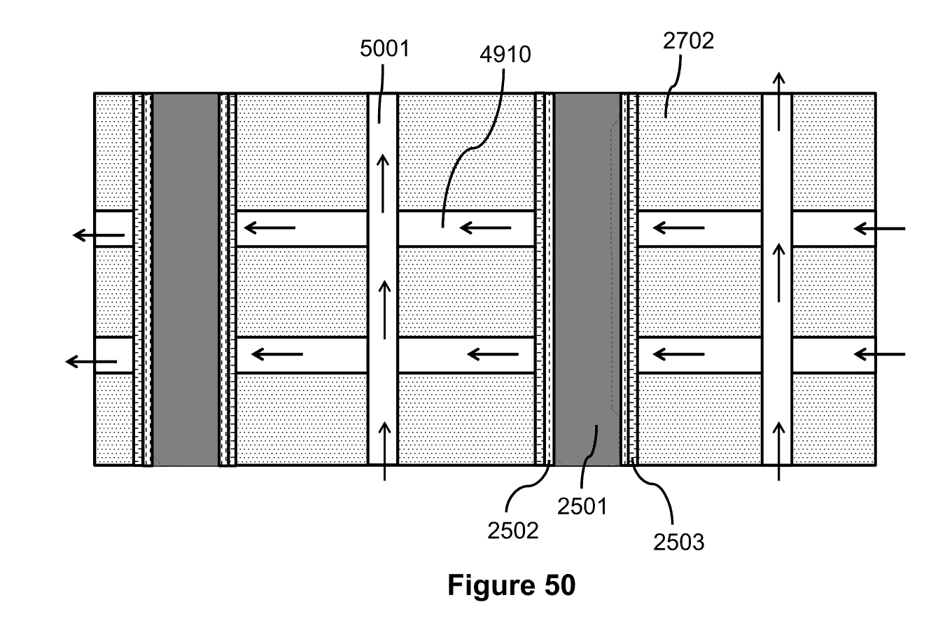

FIG. 50 provides a side view of an electrochemical cell of the invention particularly useful for part solid, part fluid electrochemical cells similar to that shown in FIG. 27 but including both lateral (or radial) and longitudinal flows of cathode active materials (schematically represented as arrows) such that the cell is made of anode rods and cathode rods and cathode plates (e.g., carbon) and three dimensional transport of cathode active material transport. As shown in FIG. 50, longitudinal passages 5001 are provided in addition to passages 4910 to provide for fluid flow of the cathode active materials.

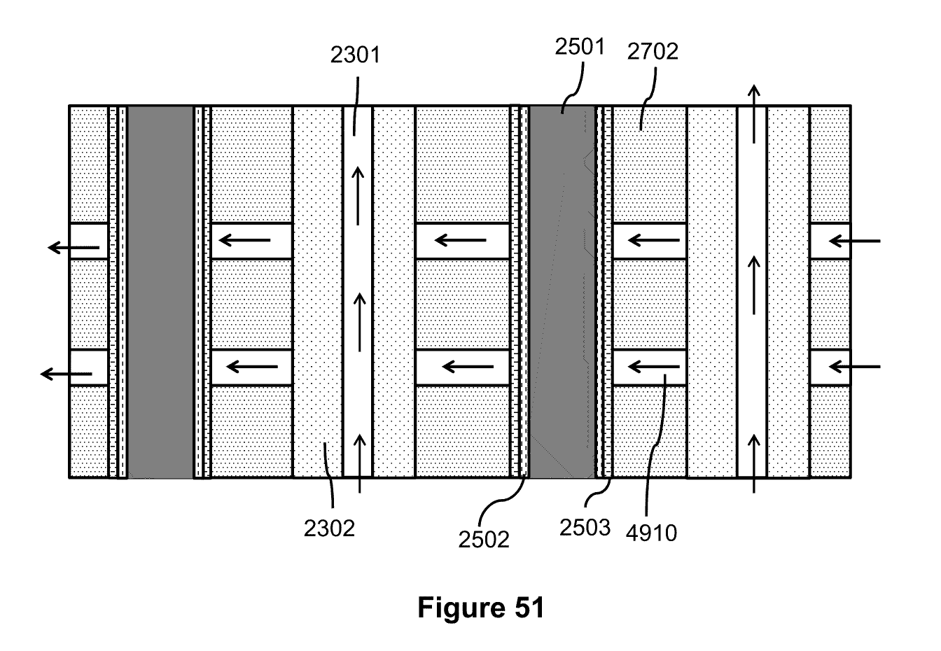

FIG. 51 provides a side view of an electrochemical cell of the invention particularly useful for part solid, part fluid electrochemical cells similar to that shown in FIG. 27 but including both lateral (or radial) and longitudinal flows of cathode active materials (schematically represented as arrows). As shown in FIG. 51, longitudinal hollow region 2301 are provided in addition to passages 4910 to provide for fluid flow of the cathode active materials such that the cell is made of anode rods and cathode rods and cathode plates (e.g., carbon) and three dimensional transport of cathode active material transport. In FIG. 50 the entire cathode is optionally one piece, whereas in FIG. 21, the cylindrical cathode is optionally different from the perforated plate part, for example it optionally includes a liquid impervious layer to prevent spill out of the electrolyte or optionally includes a membrane to prevent the entrance of impurities such as CO₂ into the cell.

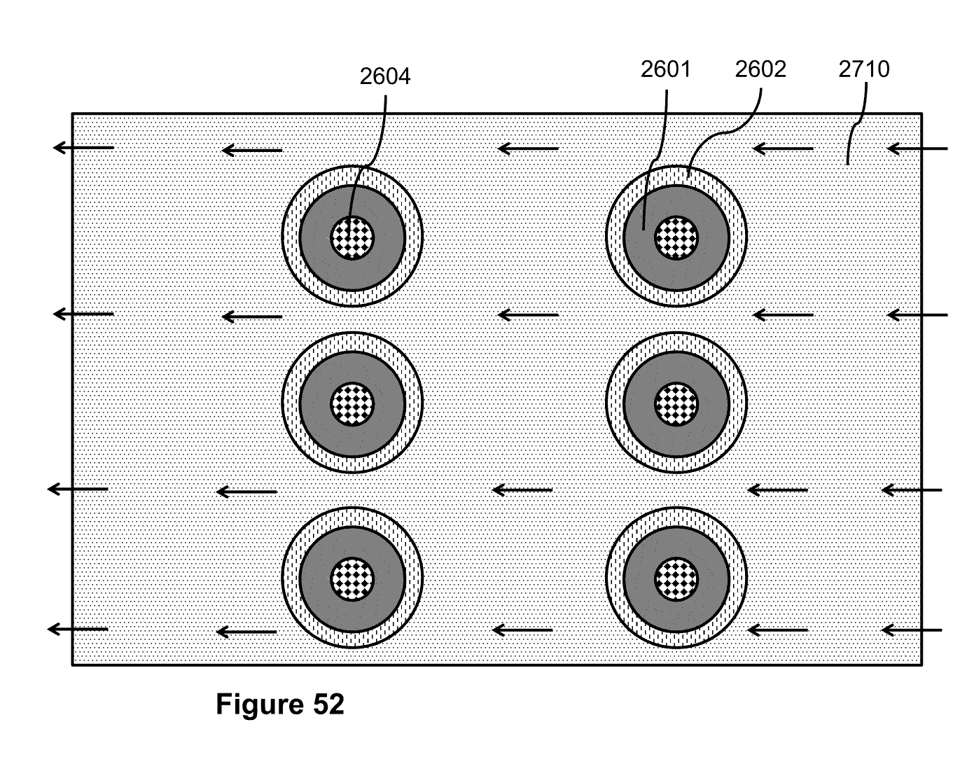

FIG. 52 provides a top view of an electrochemical cell of the invention particularly useful for part solid, part fluid electrochemical cells showing an electrode array configuration, wherein the arrows indicate the fluid flow of the cathode active materials. The electrochemical cell of this embodiment comprises plate electrodes 2710 and rod electrodes comprising anode active material 2601, electrolyte 2602 and current collector 2604.

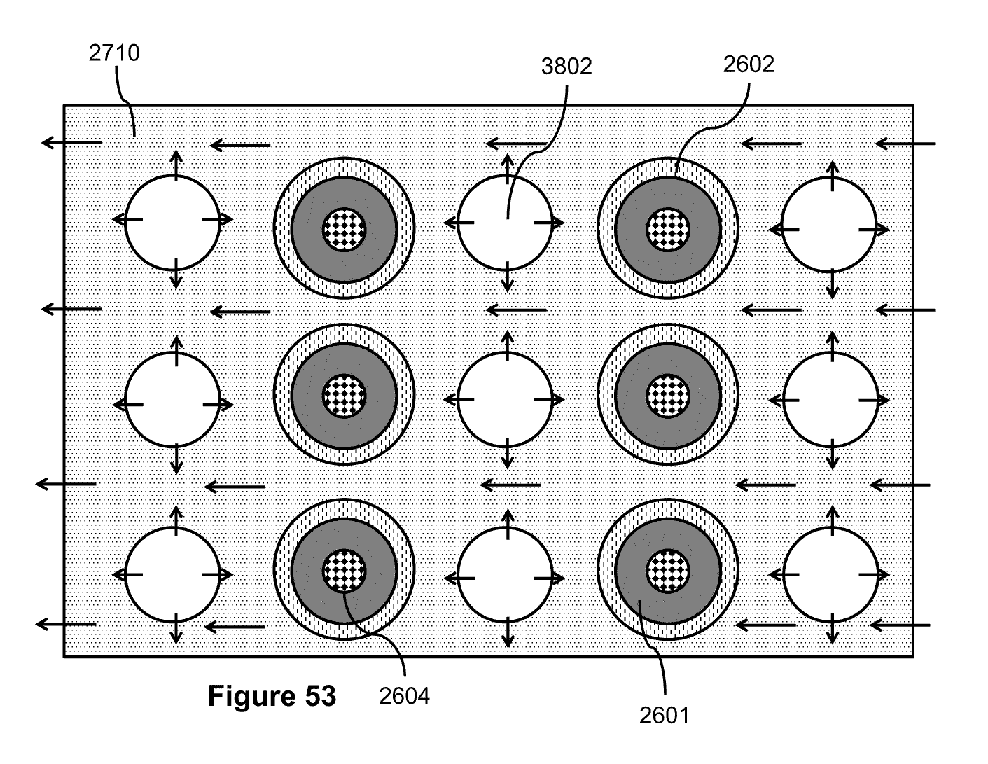

FIG. 53 provides a top view of an electrochemical cell of the invention particularly useful for part solid, part fluid electrochemical cells showing an electrode array configuration, wherein the arrows indicate the fluid flow of the cathode active materials. The electrochemical cell of this embodiment comprises plate electrodes 2710 with apertures 3802 and includes rod electrodes comprising anode active material 2601, electrolyte 2602 and current collector 2604. Arrows in FIG. 52 schematically illustrate the flow of cathode active materials.

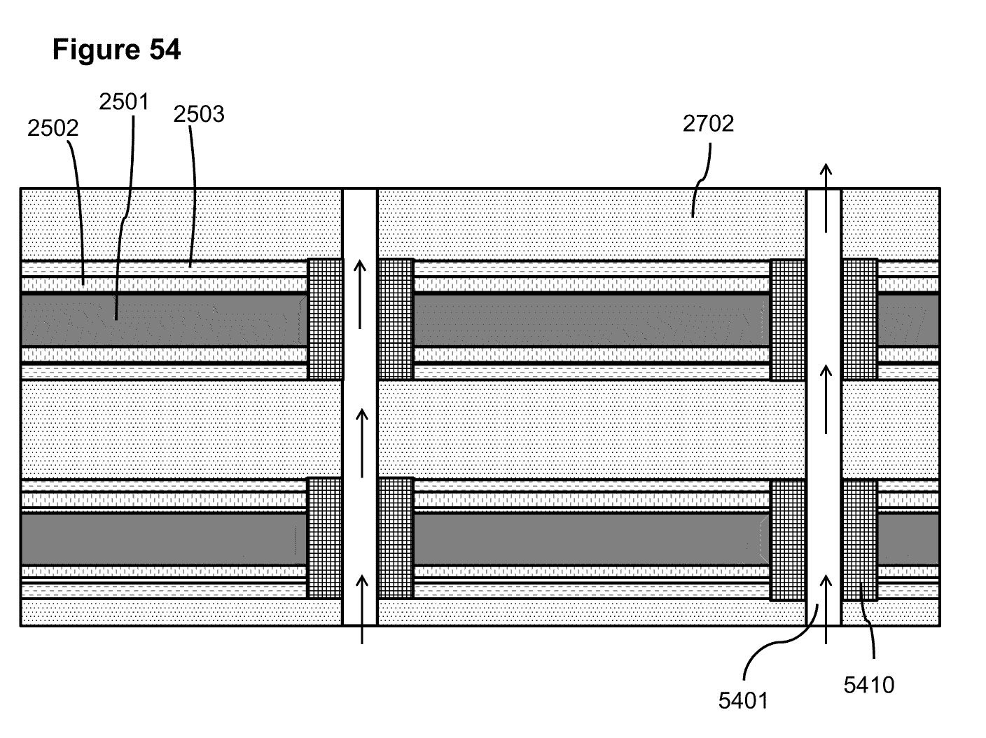

FIG. 54 provides a side view of an electrochemical cell of the invention particularly useful for part solid, part fluid electrochemical cells such as a metal-air battery system having an electrically insulating and non-permeable ring component into the 3D electrode array. As shown in FIG. 54, the cell comprises non-permeable rings 5410 proximate to rod anodes comprising an ionic conductive-electronic insulating membrane 2503 (optional), an electrolyte 2502, and an anode active material 2501 (e.g. metal such as Li, Na or Zn). In addition, passages 5401 are provided between non-permeable rings 5410 for the passage of flow of the cathode active materials (schematically represented as arrows).

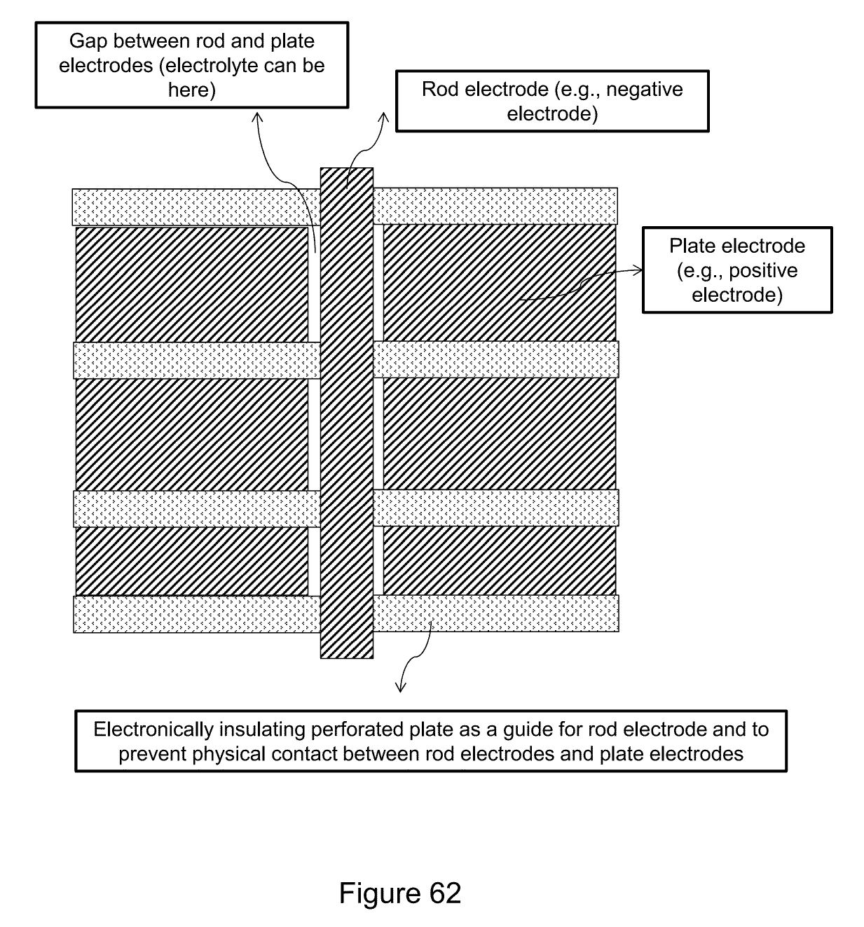

FIG. 62 provides a side view of an electrochemical cell of the invention having a gap between the rod electrodes and plate electrodes, for example, a gap provided by a spacer or other mechanical separation component (e.g., a frame, ring, hollow support, etc.). As shown in cell configuration in FIG. 62, a gap is provided between one or more plate electrodes, such as positive plate electrodes, and one or more rod electrodes, such as negative rod electrodes. In addition, an electronically insulating perforated plate is provided to function as a guide or mechanical support for the rod electrode(s) and to prevent physical contact between the rod electrodes and plate electrodes. In an embodiment of this aspect, for example, insulating perforated plates are used as guides to mechanically hold the rods in place and prevent them from physically contacting the opposite polarity plate electrodes.

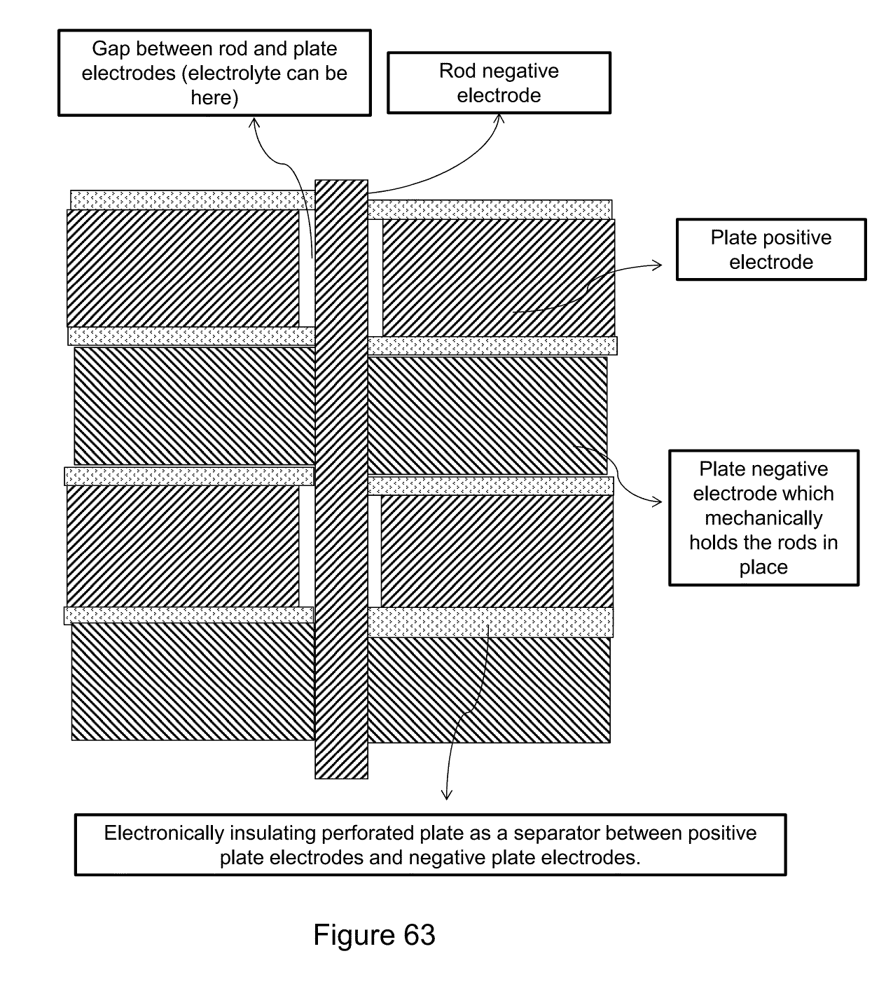

FIG. 63 provides a side view of an alternative embodiment similar to that shown in FIG. 62, but wherein a gap is provide between only a portion of the rod electrodes and the plate electrodes, such as a gap provided by a spacer or other mechanical separation component (e.g., a frame, ring, hollow support, etc.). As shown in cell configuration in FIG. 63, a gap is provided between some, but not all, of the plate electrodes and the rod electrodes. In an embodiment incorporating both positive plate electrodes and negative plate electrodes, for example, gaps are provided between the positive plate electrodes and the negative rod electrodes and no gaps are provided between the negative plate electrodes and the negative rod electrodes. In an embodiment, of this aspect, for example, plate electrodes having the same polarity as the rod electrodes function as guides to mechanically position and hold rods of the same polarity in place and prevent them from physically contacting the opposite polarity plate electrodes. In an embodiment, a separator is used between opposite polarity electrode plates

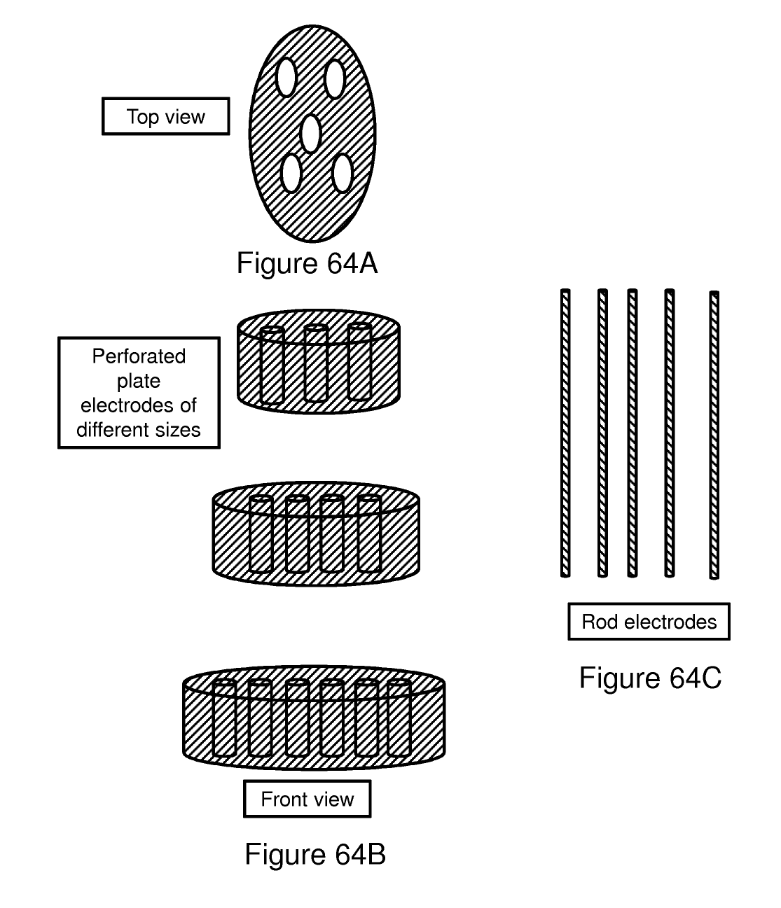

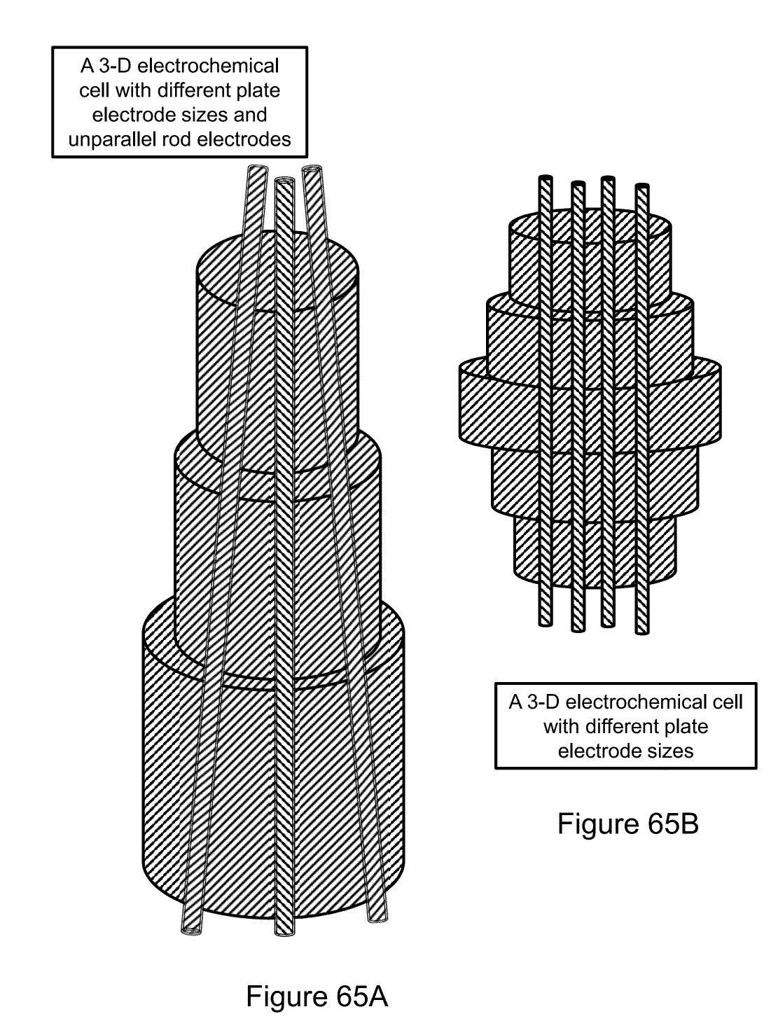

FIG. 64 provides schematics providing a top view and front view of components of an electrochemical cell of the present invention having plate electrodes with varying physical dimensions. As shown in this figure, the plate electrodes comprise perforated disks with different sizes (e.g., different radial dimensions). FIGS. 65A and 65B provide schematics showing side views of 3D electrode array geometries of the invention including plate electrodes having varying physical dimensions. In FIG. 65A, a series of plate electrodes, such as perforated disks, having decreasing radial dimensions are provided with rod electrodes provided with a nonparallel spatial orientation. In FIG. 65B, a series of plate electrode having varying radial dimensions (increasing and decreasing) are provided with rod electrodes provided with a parallel spatial orientation.

As will be understood by one of skill in the art, the figures provided are illustrative of embodiments of the invention. Unless otherwise indicated, the dimensions shown in the figures are not intended to be to scale. Orientations of embodiments shown include both horizontal and vertical orientations; that is, where an embodiment is shown with a single orientation, another orientation, rotated 90° is also disclosed.

Note that in some electrochemical cell designs of the invention, the cathode and anode may be interchangeable. In an embodiment, for example, the fluid electrode rod is the cathode or the anode. In an embodiment, for example, the solid (metal) electrode rod is the cathode or the anode. In an embodiment, for example, the plate electrodes are the cathode or the anode.

Note that in some electrochemical cell designs of the invention, some of the rods are optionally used only for structural and/or mechanical integrity, for example, by using metal or ceramic or glass or polymer rods, such as steel rods. The holes optionally have larger diameter than the electrode rods. Some of the space bottom the parallel plates are optionally also used only for structural and/or mechanical integrity, by using metal or ceramic plates. For example by using steel plates or glass plates.

An advantage of the designs described herein is that the maintenance can be done easier and faster, for example, when the cell is composed of many individual rods and plates. Another advantage is that, as the ratios of volume/foot-print surface area and active surface area/foot print surface area can be increase significantly over prior art designs, there is much less of the problem of electrolyte evaporation (which is a major problem, for example, in metal air batteries and in fuel cells) or ambient air-moisture contamination. Additional advantages are provided by the cell designs and embodiments described herein including benefits obtained due to transport of ions and electron in three-dimensions.

Optionally, current collectors are included in a three-dimensional cell. Not only are current collectors useful for transporting electrons in charge-discharge, but also current collectors optionally provide mechanical-structural stability to the cell. Optionally, some current collectors are used to help with the temperature control of the cell and thus can hinder overheating of the battery and can increase the performance and life.

Optionally, the current collector/temperature control element is solid or is liquid such as a molten metal or molten salt flowing inside a tube-pipe or it can be a metallic tube, for example Al or Cu or Ni to transport electrons, where inside the tube there is a fluid such as air or a liquid coolant such as oil or water or heat transfer fluid that can flow from one end to the other end, and be useful for controlling the temperature of the cell, for example for mid-large scale applications such as electric cars, renewable energy storage and grid storage.

For embodiments comprising a fluid electrolyte, a separator is optionally included between the rods and the walls of the plates to avoid their contact. For example, useful materials include PE or PP or a combination from Celgard Co. or Kapton or a fibrous material. In some embodiments, the thickness of the separator is between 0.005 mm to 0.5 mm, and optionally between 0.01 mm to 0.5 mm. In some embodiments, the thickness of the separator is about 0.02 mm.

Note that graphite alone or combined with metals such as Al, are optionally useful as current collectors. Optionally, an electrolyte comprises an imide salt.

An important advantage of the current design is longer cycle life. As the cell is much more homogeneous comparing to the conventional design, the materials deformations and the temperature distribution are more homogeneous, resulting in lower stresses, lower cracks, less fatigue, and thus higher cycle life of the cell.

The distance between the parallel plates is optionally filled with a material solely for temperature control such as heat pipe or heat pin that can use thermal conductivity and phase transition. This is especially useful in mid-large scales, such as in electric cars and grid storage. As an example, such a material is a screen made of metals, such as thin steel or copper (e.g., a few micrometers thick for small cells to a few centimeters thick for bigger cells). In an embodiment, there is no contact between the screen and the rods. Optionally, the distance between the parallel plates is used to transport active materials such as the oxidant, for example O₂.

Optionally, the space between plates is optionally filled with oil or water or a heat transfer fluid to maintain the temperature of the cell at a specified temperature by using a thermostat. This liquid is optionally separated from the electrolyte between the rods and the hole-walls by using inert material (as an example PTFE or Silicone) gaskets with the shape of a long cylinder (as long as the rods) with outer diameter equals that of the holes, and thickness of, as an example about 1 mm, which is completely solid between the plates and is more than 80% open at the vicinity of the walls of the holes. Further, for each hole, two diaphragms, donut shape: each 0.05 mm wide and 0.05 mm thick, are optionally placed at the top and bottom of the holes to completely prevent the mixture of the cooling liquid with the electrolyte. Optionally, the distance is used to transport active materials such as the oxidant, for example O₂.

Optionally, a gas or liquid coolant is used for controlling an electrode array temperature. Useful gas coolants include air, hydrogen, inert gases such as nitrogen, helium or carbon dioxide or Sulfur hexafluoride or steam. Useful liquid coolants include oil, mineral oil, castor oil, water, deionized water, heavy water, liquefied neon, molten salts, NaF—NaBF₄, FLiBe, FLiNaK, liquid lead, liquid lead-bismuth alloy, silicone oils, fluorocarbon oils, Freons, Halomethanes, ammonia, sulfur dioxide, carbon dioxide, Polyalkylene glycol, or can be a solution of an organic chemical in water, such as betaine, ethylene glycol, diethylene glycol, propylene glycol. Useful coolants further include liquids such as liquid nitrogen, liquid helium, and liquid hydrogen. The coolant is optionally a solid such as dry ice or water ice. Useful coolants also include nanofluids or semisolids comprising of a carrier liquid such as water dispersed with tiny (10 nm to a few mm size) particles made of CuO, Aluminia, titanium dioxide, carbon nanotubes, carbon powders, silica, or metals such as copper or silver.

Optionally, each of the electrodes or electrolytes or dielectric materials are a heterogeneous material such as a layered composite, such as a first material with a second coating at least on one side of it.

The invention may be further understood by the following non-limiting examples.

### Example 1

### Industrial Applications

Worldwide, there are ever-growing demands for electricity. At the same time, there is an increasing push to harness reusable sources of energy to help meet these increasing electricity demands and offset and/or replace traditional carbon-based generators which continue to deplete natural resources around the world.

Many solutions have been developed to collect and take advantage of reusable sources of energy, such as solar cells, solar mirror arrays, and wind turbines. Solar cells produce direct current energy from sunlight using semiconductor technology. Solar mirror arrays focus sunlight on a receiver pipe containing a heat transfer fluid which absorbs the sun's radiant heat energy. This heated transfer fluid is then pumped to a turbine which heats water to produce steam, thereby driving the turbine and generating electricity. Wind turbines use one or more airfoils to transfer wind energy into rotational energy which spins a rotor coupled to an electric generator, thereby producing electricity when the wind is blowing. All three solutions produce electricity when their associated reusable power source (sun or wind) is available, and many communities have benefited from these clean and reusable forms of power.

When the sun or wind is not available, such solutions are not producing any power then nonreusable energy solutions are often turned, some form of energy storage is needed to store excess energy from the reusable power sources during power generation times to support energy demands when the reusable power source is unavailable or unable to meet peak demands for energy. So far people have tried molten salt thermal storage as a candidate to store heat as a form of energy; however the technology is very costly.

This example describes an electrochemical energy storage apparatus. The electrochemical energy storage apparatus has at least a positive terminal and a negative terminal which are electrically insulated from each other. It also has a non-electro-conductive material, which can be solid or fluid or gas, between the two terminals. This medium is a conductor for some of the ions of materials used for the terminals. Electro conductive materials such as metals can be used on the outer surface of the terminals to facilitate the passage of the electrons. Related methods of constructing and controlling an electro chemical energy storage system are also disclosed. An electro chemical energy power system utilizing an electrochemical energy storage apparatus is further disclosed, as is a charge exchanger for the electrochemical energy storage system.

The medium between the terminals can be selected from the group consisting of a salt, a salt mixture, a eutectic salt mixture, lithium nitrate, potassium nitrate, sodium nitrate, sodium nitrite, calcium nitrate, lithium carbonate, potassium carbonate, sodium carbonate, rubidium carbonate, magnesium carbonate, lithium hydroxide, lithium fluoride, beryllium fluoride, potassium fluoride, sodium fluoride, calcium sulfate, barium sulfate, lithium sulfate, lithium chloride, potassium chloride, sodium chloride, iron chloride, tin chloride, and zinc chloride, sulphuric acid, water and any combination of these.

The terminals optionally have any shape and geometry, such as plates or tubes or cylinders or parts of them.

Optionally, the whole storage system is contained in a non-conductive container.

Optionally, non-conductive spacers are used between the terminals especially when the medium is a fluid or gas to prevent short circuit through physical contact.

Optionally, the container comprise a conductive material or a non-conductive material such as a material selected from the group consisting of plastics, ceramics, firebrick, refractory material, castable refractories, refractory brick, mixtures of alumina (Al₂O₃), silica (SiO₂), magnesia (MgO), zirconia (ZrO₂), chromium oxide (Cr₂O₃), iron oxide (Fe₂O₃), calcium oxide (CaO), silicon carbide (SiC), carbon (C); metallic materials, plain carbon steels; alloy steels, manganese, silicon, silicon-manganese, nickel, nickel chromium, molybdenum, nickel-molybdenum, chromium, chromium-molybdenum, chromium molybdenum-cobalt, silicon-molybdenum, manganese-silicon-molybdenum, nickel-chromium molybdenum, silicon-chromium-molybdenum, manganese-chromium-molybdenum, manganese silicon-chromium-molybdenum, vanadium, chromium-vanadium, silicon-chromium-vanadium, manganese-silicon-chromium-vanadium, chromium-vanadium-molybdenum, manganese-silicon chromium-vanadium-molybdenum, chromium-tungsten, chromium-tungsten-molybdenum, chromium-tungsten-vanadium, chromium-vanadium-tungsten-molybdenum, chromium vanadium-tungsten-cobalt, chromium-vanadium-tungsten-molybdenum-cobalt; stainless steels, austenitic, ferritic, martensitic, duplex, precipitation-hardening, superaustenitic, superferritic; nickel alloys, nickel-chromium-iron, nickel-chromium-iron-aluminum, nickel-chromium-iron aluminum-titanium, nickel-chromium-iron-aluminum-titanium-niobium, nickel-chromium-iron cobalt-molybdenum, nickel-chromium-iron-niobium, nickel-chromium-iron-molybdenum niobium, nickel-chromium-iron-molybdenum-niobium-titanium-aluminum, nickel-chromium molybdenum-iron-tungsten, nickel-chromium-iron-molybdenum-copper-titanium, nickel chromium-iron-molybdenum-titanium, nickel-iron-cobalt-aluminum-titanium-niobium, nickel copper, nickel-copper-aluminum-titanium, nickel-molybdenum-chromium-iron, nickel chromium-molybdenum-copper, nickel-chromium-molybdenum-iron-tungsten-copper, and nickel-chromium-molybdenum.

The base for the storage system comprises a material selected from the group consisting of earth, firebrick, refractory material, concrete, castable refractories, refractory concrete, refractory cement, insulating refractories, gunning mixes, ramming mixes, refractory plastics, refractory brick, mixtures of alumina (Al₂O₃), silica (SiO₂), magnesia (MgO), zirconia (ZrO₂), chromium oxide (Cr₂O₃), iron oxide (Fe₂O₃), calcium oxide (CaO), silicon carbide (SiC), carbon (C); metallic materials, carbon steels; alloy steels, manganese, silicon, silicon-manganese, nickel, nickel-chromium, molybdenum, nickel-molybdenum, chromium, chromium-molybdenum, chromium-molybdenum-cobalt, silicon-molybdenum, manganese-silicon-molybdenum, nickel chromium-molybdenum, silicon-chromium-molybdenum, manganese-chromium-molybdenum, manganese-silicon-chromium-molybdenum, vanadium, chromium-vanadium, silicon-chromium vanadium, manganese-silicon-chromium-vanadium, chromium-vanadium-molybdenum, manganese-silicon-chromium-vanadium-molybdenum, chromium-tungsten, chromium-tungsten molybdenum, chromium-tungsten-vanadium, chromium-vanadium-tungsten-molybdenum, chromium-vanadium-tungsten-cobalt, chromium-vanadium-tungsten-molybdenum-cobalt; stainless steels, austenitic, ferritic, martensitic, duplex, precipitation-hardening, superaustenitic, superferritic; nickel alloys, nickel-chromium-iron, nickel-chromium-iron-aluminum, nickel chromium-iron-aluminum-titanium, nickel-chromium-iron-aluminum-titanium-niobium, nickel chromium-iron-cobalt-molybdenum, nickel-chromium-iron-niobium, nickel-chromium-iron molybdenum-niobium, nickel-chromium-iron-molybdenum-niobium-titanium-aluminum, nickel chromium-molybdenum-iron-tungsten, nickel-chromium-iron-molybdenum-copper-titanium, nickel-chromium-iron-molybdenum-titanium, nickel-iron-cobalt-aluminum-titanium-niobium, nickel-copper, nickel-copper-aluminum-titanium, nickel-molybdenum-chromium-iron, nickel chromium-molybdenum-copper, nickel-chromium-molybdenum-iron-tungsten-copper, and nickel-chromium-molybdenum.

In embodiments, an energy storage system is positioned such that the terminals face vertical, such that the terminals face the ground, such that the terminals face horizontal, such that the terminals do not face the ground, for example, perpendicular to the ground.

Optionally, a group of terminals are used in parallel or series configurations.

Optionally, the terminals comprise material selected from the group consisting of iron oxides; metals; lithium phosphates; sodium phosphates; plain carbon steels; graphite, lead metal, lead dioxide, alloy steels, manganese, silicon, silicon-manganese, nickel, nickel-chromium, molybdenum, nickel-molybdenum, chromium, chromium-molybdenum, chromium-molybdenum-cobalt, silicon-molybdenum, manganese-silicon-molybdenum, nickel-chromium-molybdenum, silicon-chromium-molybdenum, manganese-chromium-molybdenum, manganese-silicon-chromium molybdenum, vanadium, chromium-vanadium, silicon-chromium-vanadium, manganese-silicon chromium-vanadium, chromium-vanadium-molybdenum, manganese-silicon-chromium vanadium-molybdenum, chromium-tungsten, chromium-tungsten-molybdenum, chromium tungsten-vanadium, chromium-vanadium-tungsten-molybdenum, chromium-vanadium-tungsten cobalt, chromium-vanadium-tungsten-molybdenum-cobalt; stainless steels, austenitic, ferritic, martensitic, duplex, precipitation-hardening, superaustenitic, superferritic; nickel alloys, nickel chromium-iron, nickel-chromium-iron-aluminum, nickel-chromium-iron-aluminum-titanium, nickel-chromium-iron-aluminum-titanium-niobium, nickel-chromium-iron-cobalt-molybdenum, nickel-chromium-iron-niobium, nickel-chromium-iron-molybdenum-niobium, nickel-chromium iron-molybdenum-niobium-titanium-aluminum, nickel-chromium-molybdenum-iron-tungsten, nickel-chromium-iron-molybdenum-copper-titanium, nickel-chromium-iron-molybdenum titanium, nickel-iron-cobalt-aluminum-titanium-niobium, nickel-copper, nickel-copper aluminum-titanium, nickel-molybdenum-chromium-iron, nickel-chromium-molybdenum-copper, nickel-chromium-molybdenum-iron-tungsten-copper, and nickel-chromium-molybdenum.

As an example the system used for a 400 MWh storage can be made of a plates of 35 m by 35 m with the thickness of a few centimeters as the terminals and medium of a few centimeters thickness between them. The plates can be parallel to each other and they can be either standing vertically in or above the ground or they can be parallel to the ground in or above the ground.

The materials used as an example can be an oxide such as lithium ion phosphate, and graphite as the plates with a medium of lithium salts, such as LiPF₆, LiBF₄, or LiClO₄, in an organic solvent, such as ether. Depending on the materials used, different operating temperatures are contemplated including room temperature.

Another example can be the same geometry as above but with the materials of lead metal (Pb) and lead (IV) dioxide (PbO₂) in a medium of about 33.5% v/v (6 Molar) sulphuric acid (H₂SO₄).

The electricity source from the energy source is connected to the two terminals. The electric energy makes one of the terminals to get reduced and the other one to get oxidized. This way the ions from one terminal leave the terminal and go the medium. The medium transfers the ions to the opposite terminal. This way the chemical energy is stored in the system. Then the electricity source is opened from the storage system.

When it is desired to use the stored energy, the two plates are connected to each other by a conductive material, with the user application between the two ends of the conductive material.

The chemistry used in the system can be any known chemistry of batteries such as Lead-Acid battery, NaS battery, Metal-Air battery, Li-ion battery, etc., however the electrode geometry is different. Optionally, it is in larger scales and it can be honey-comb geometry or any other porous geometry. Thin honey comb structures are optionally used, to minimum stresses due to shape changes in charge/discharge. Optionally, a sponge type matrix filled with the electrode material can be utilized. The thickness of the plates or the diameter of the cables/rods/wires can optionally be millimeters or centimeters. The width and length of the plates and the length of the cables/rods/wires can optionally be centimeters or meters. The plates and cables/rods/wires can be connected in any combination of parallel or series.

The system can be buried under the ground or can be put in a room to stay away from the environmental hazards including temperature changes. All the solid parts can be controlled at the boundaries such as by pulling the cables/rods/wires to minimize the risk of electrical shorts in the system.

### Example 2

### Electrochemical Cells

Many scientists have been working on the chemistry of batteries. This example describes a new configuration for the electrodes that can be used for any chemistry, including anode, cathode and electrolyte, which can result in higher power/energy density batteries, faster batteries, lighter batteries, cheaper batteries, and more durable batteries.

In designing the most historically successful industrial batteries, the lead-acid battery configuration played a key role. Plante's and Faure's changes of the configurations resulted in the commercialization of lead-acid battery which has been the dominant battery for more than a century.

The new configuration described here can be used for primary and secondary batteries. It can transform primary batteries to secondary batteries and it can provide better cyclability and safety for secondary batteries. As an example, the new configuration can be used for primary and secondary lithium batteries. Lithium metal anode in Lithium based batteries has energy density an order of magnitude higher than currently used carbon anode. Though, due to the formation of dendrites on lithium anode during the recharging process, the cell may short circuit and explode. For this reason in rechargeable batteries, currently, carbon anode is the only option. In addition to lower energy density comparing to lithium metal, carbon anodes needs special electrolytes, which adds to the cost. The new configuration described herein solves the shorting problem in Li-metal anodes. This will result in much cheaper rechargeable batteries that can last longer than available lithium based batteries.

Currently, the active electrochemical materials compose only one third of the weight of a battery pack. The problem is that the prior art battery configurations limit the size of the battery. At the macro-scale one goal of the present systems is to remove the constraints on the size of the battery pack by changing the configuration. This makes the batteries more efficient, as there is less need of the supporting materials that do not play any electrochemical roles. It results in getting closer to ideal battery systems for electric vehicles. In addition, it results in lighter and cheaper batteries that can be used for large-scale energy storage systems needed for grid electricity storage and also renewable energy sources such as solar farms and wind farms.

The new configuration/geometry described herein can improve all battery chemistries including those with the Li-metal anode. In this novel 3-dimensional configuration, perforated anode (or cathode) plates are placed parallel to each other with electrolyte between them. Cathode (or anode) rods go through the plate holes to form a mesh. The radius of each rod is less than that of the holes to allow for the electrolyte passage between the rods and the holes. When using lithium metal plates, the wall of the holes can be covered with an inert material so that dendrites do not happen between the opposite electrodes but happen between the lithium plates.

Each plate can have different geometries such as rectangular plates, cylindrical plates or any other geometry. The thickness of each of the plates can be from 20 nm to 5 cm, as an example around 100 micrometers for lithium batteries and 2 mm for lead-acid batteries. The holes of the plates can have different geometries such as cylindrical or rectangular or any other geometry. The radius of the holes can be from 10 nm to 2 cm, as an example 50 micrometers for lithium batteries and 500 micrometers for lead-acid batteries. The rods can have different geometries similar to the holes with the radius smaller than the holes. The surface fraction of the holes is arbitrary. The distance between the holes can be a few nanometers to a few millimeters, as an example can be a few micrometers in lithium batteries and a few hundred micrometers in lead acid batteries. The plates can be from 20 nm to 20 meters long/wide, as an example 10 mm for lithium batteries and 10 cm for lead-acid batteries. The distance between any two plates can be from 10 nm to 5 cm, as an example 10 micrometers, as an example 1 micrometer for lithium batteries and 1 mm for lead acid batteries. The inert material, as shown in the picture, covers the walls of the holes. It can be made of any material that doesn't have any chemical or electrical reaction with the electrodes or electrolyte, such as rubber, plastic, or ceramics. Its thickness can be from a few nanometers to a few millimeters.

### Example 3

### Lithium Batteries

This example focuses on lithium batteries. A great degree of attention has been devoted to rechargeable Lithium batteries in the past few years, but still there are many unknowns that should be scrutinized. Here, a new configuration of the electrodes is described. As an example a Li-metal anode is considered. Lithium metal used as an anode active material has a very high theoretical capacity of 3860 Ah/kg, which is the highest among metallic anode materials. In addition, the standard electrode potential of lithium is high (−3.045V vs SHE). This makes lithium metal a very attractive anode material.

Because of safety problems, a safer lithium cell, the lithium ion cell, was developed and is now commercially available. Currently Li-metal anodes are only used in primary lithium batteries. They can't be used in rechargeable cells due to the lithium dendrites that form on the lithium metal anode in the recharging process. The dendrites make shorts between the opposite electrodes and cause fire and explosion of the cell.

However, the high energy density of lithium metals cells is still very attractive, if the safety problem can be overcome. The conductivity of the nonaqueous electrolyte used in the AA-size lithium metal anode prototype cells is one order of magnitude lower than that of an aqueous system. Thus, if one can solve the safety problem, the rate of charging of the battery will improve a lot.

The new configuration/geometry described herein improves all battery chemistries including those with the Li-metal anode. In this novel 3-dimensional configuration, perforated anode plates are placed parallel to each other with electrolyte between them. The cathode rods go through the plate holes to form a mesh. The radius of each rod is less than that of the holes to allow for the electrolyte passage between the rods and the holes. When using lithium metal plates, the wall of the holes can be covered with an inert material so that dendrites do not happen between the opposite electrodes but happen between the lithium plates. Each plate can have different geometries such as rectangular plates, cylindrical plates or any other geometry. The thickness of each of the plates can be from 20 nm to 5 cm, as an example around 100 micrometers. The holes of the plates can have different geometries such as cylindrical or rectangular or any other geometry. The radius of the holes can be from 10 nm to 2 cm, as an example 50 micrometers. The rods can have different geometries similar to the holes with the radius smaller than the holes. The plates can be from 20 nm to 20 meters long/wide. The distance between any two plates can be from 10 nm to 5 cm, as an example 10 micrometers.

There are many possible choices for the cathode. The most popular are lithium manganese dioxide, lithium cobalt, and FeS₂. The suggested configuration/geometry works for any chemistry of batteries including the lithium-air chemistry.

The temperature of the cell also plays an important role on the safety and cyclability of the battery. A novel approach is suggested here. If current collectors are needed the cathode current collector is in the core of the rods; the anode current collector, if needed, can be formed of a grid in the plate. As each current collector runs in the entire cell, by using the current collectors as heat conductive material we can set the cell temperature very cheap and effectively.

### Example 4

### Lead-Acid Batteries

The lead acid cell can be demonstrated using sheet lead plates for the two electrodes. However such a construction produces only around one ampere for roughly postcard sized plates, and for only a few minutes. The plate dimensions are typically about 50×50×1.5 mm. Since the capacity of a lead-acid battery is proportional to the surface area of the electrodes that is exposed to the electrolyte, various schemes are employed to increase the surface area of the electrodes per unit volume or weight. Plates are grooved or perforated to increase their surface area. Faure pasted-plate construction is typical of automotive batteries. Each plate consists of a rectangular lead grid alloyed with antimony or calcium to improve the mechanical characteristics. Each plate consists of a rectangular lead grid alloyed with antimony or calcium to improve the mechanical characteristics.

The holes of the grid are filled with a paste of red lead and 33% dilute sulfuric acid. (Different manufacturers vary the mixture). The paste is pressed into the holes in the grid which are slightly tapered on both sides to better retain the paste. This porous paste allows the acid to react with the lead inside the plate, increasing the surface area many fold. At this stage the positive and negative plates are similar; however expanders and additives vary their internal chemistry to assist in operation.

The present design results in higher energy densities and also less problems with the volume changes of the electrodes. The present design results in more cyclability due to more homogeneous cell design and by putting the positive electrodes parallel to each other and the ground, the active material just transfers from the top layers to the bottom layers but will not be lost. This also adds to the safety of the cell by reducing the likelihood of shorts.

As an example construction consisting of: Positive electrode: 20 plates of 400×400×5 mm as the grid with holes of 5.5 mm diameter with a distance between the holes of 5 mm, wall to wall; Negative electrodes: rods with diameter of 5 mm. The rods can be placed horizontally; optionally a metal such as steel core is used to support the rods mechanically.

### Example 5

### Sample Electrochemical Cell

This example describes the use of a LiMn₂O₄ cathode (0.2 mm thick two sided with an aluminum current collector 15 micrometers in between) and a graphite anode (0.2 mm thick two sided with the copper current collector 15 micrometers in between) with 1-molar LiClO₄—PC electrolyte in the new design as follows.

This design has the same amount of active materials (cathode and anode) comparable to a conventional two parallel plates of anode and cathode; each 48.5 mm×48.5 mm=2350 mm² surface area with 0.1 mm thickness, one sided. This gives 235 mm³ active material volume. In summary, the surface area is 2350 mm² and the volume is 235 mm³.

This sample electrochemical cell is in the form of a cube with 1 cm³ volume. Materials: 40 perforated plates, each 10 mm×10 mm with an array of 10×10 holes evenly distributed, of LiMn₂O₄ cathode. Rods of graphite 10 mm length and 0.1 mm thick (inner shell) around copper wire of 0.65 mm diameter (core). The rods also have a 0.05 mm thick, outer shell, separator, for example PP or PE from Celgard, around them.

The holes in the plates are each 0.95 mm diameter. The distance between the holes, wall to wall, is then 0.05 mm.

The active surface area of the LiMn₂O₄ cathode here then includes: 2350 mm² on the surface between the holes (40 two sided perforated plates) AND 2390 mm² on the walls of the holes. This shows that the new design has 4740 mm² surface area which is about 2 times more surface area comparing to the conventional to parallel plate design with the same amount of cathode material.

The active surface area of the graphite anode is 2665 mm² which is still slightly higher than the conventional design.

This shows that half the material is used for the cathode plate, saving money on the most expensive part of the battery, and still reaching the same energy density from the storage system. As this is only an illustrative example, the following parameters and geometry can be optimized: number of the holes, number of the plates, and size of the holes. Also note that alternatively this example could utilize graphite perforated plates and LiMn₂O₄ rods.

### Example 6

### Metal-Air Batteries

Optionally methods are used to accelerate the air flow inside the cell, such as by using pumps. Optionally, the space between the parallel plates is filled by perforated plates, at least on the very top and very bottom layer. For example, this is made of desiccants such as silica gel, activated charcoal, calcium sulfate, calcium chloride, montmorillonite clay, and molecular sieves materials. The material can be covered in a very thin inert coating such as 0.01 mm PTFE. This helps to increase the safety, performance and life of Li batteries, especially in Li-air batteries. The desiccant layers can be removed and replaced after they are saturated with water.

Useful battery chemistries for this design include, but are not limited to: alkaline battery, Zn—MnO₂ primary, Zn—MnO₂ secondary, Zn-Air, Zn—AgO, Ni—Zn, Cd—AgO, Zn—HgO, Cd—HgO Ni—Cd, Ni-Metal Hydride, or N₁—H₂ battery, or Li-Air or Li-water or Li-flow of iron cyanide (aq) or Li-flow of sulfur particles in an electrolyte.

Optionally, when using different electrolytes, one between each rod and the corresponding wall of the holes of the plates and another between the perforated plates, a thin membrane is useful. For example about tens of micrometers thick, between the two electrolyte systems to separate them, for example when they are both fluid such as liquid, as an example similar to a thin O-ring. Optionally the membrane is used to remove unwanted products from the cell or to add assisting materials to the cell. Examples of removing unwanted products from the cell include some gas phases that happen as the product of the chemistry cell reactions, such as hydrogen gas as for example it happens in Flow batteries or in Lead Acid batteries, especially in flooded lead-acid batteries. The membranes used here optionally are inert materials such as PTFE or PE or other membrane products with desired pore sizes or chemistry or surface behavior.

### Example 7

### Zn-Air Battery

This example describes a Zn-Air battery embodiment. Each rod is: a (Ni-mesh carbon-layers) tube comprising a manganese-based catalyzed carbon layer on a screen of Ni. Electrolyte is KOH, for example, 5M in water. The anode is a zinc metal, for example with a rough surface such as from applying sand paper on it, as the perforated plates. The air cathode contains a hydrophobic Teflon layer (inner part of the tube, for example porous to allow oxygen but stop vapor), a thin Nickel mesh layer acting as a current collector and providing a structural support (middle layer of the tube), and a carbon catalyst layer (outer part of the tube).

The manganese-based catalyzed carbon layer is, for example between 0.05 mm to 0.5 mm thick. The tube inner radius is, for example, 1 mm. There is a 0.02 mm separator between each rod and the associated hole. The separator can be, for example, PVA. The thickness of the Zn plates is, for example, 2 mm. The dimensions of the cell are, for example, 1 cm diameter cylinder with the height of 1 cm.

In this example, there are 4 parallel Zn plates. The distance between the Zn plates is optionally partially filled with electrolyte, here with KOH solution in water and partially with 0.2 mm perforated steel plates, and partially filled with air. A space partially filled with liquid electrolyte and air helps with the life of the battery.

Optionally, zero space is used between Zn plates and have 5 parallel Zn plates, each 2 mm, to resemble one Zn plate of 1 cm thick.

The entire cell is inside a case made of steel and covered by a skin made of PTFE. The case has openings on two parallel sides, say top and bottom, to allow the air flow. A benefit of the new design is that the tubes are open from both ends so the cell can get more air.

### Example 8

### Zn-Air Battery with Assisted Flow

This example describes a Zn-Air battery with assisted flow. Each rod is: a (Ni-mesh carbon-layers) tube comprising a manganese-based catalyzed carbon layer on a screen of Ni. The electrolyte is KOH. The anode is a zinc metal, for example, with a rough surface, such as from applying sand paper on it, as the perforated plates. The air cathode contains a hydrophobic Teflon layer (inner part of the tube, for example, porous to allow oxygen but stop vapor), a thin Nickel mesh layer acting as a current collector and providing a structural support (middle layer of the tube), and a carbon catalyst layer (outer part of the tube).

Here the holes in the plates of metal electrode, for example Zn perforated plates, have the same size for each plate but have a different size for different plates.

The manganese-based catalyzed carbon layer is 0.5 mm thick. The tube inner radius is variable, for example linearly varying from 0.5 mm from one side to 2 mm on the other side. The size of the holes-inner radius can be optimized, using fluid mechanics principles based on the density and temperature and viscosity and other parameters of the flow, for efficient flow of the cathode electrode, here air, through them. Further assisted flow can be applied by using pumps, for example, at the two ends of the cell where there is access to air to facilitate the flow of the cathode materials, here air.

There is a 0.02 mm separator between each rod and the associated hole. The separator can be for example PVA. The thickness of the Zn plates is, for example, 2 mm. The dimensions of the cell are, for example, 1 cm diameter cylinder with the height of 1 cm.

In this example, there are 4 parallel Zn plates. The distance between the Zn plates is optionally partially filled with electrolyte, here with KOH solution in water and partially with 0.2 mm perforated steel plates, and partially filled with air. A space partially filled with liquid electrolyte and air helps with the life of the battery.

Optionally, zero space is used between Zn plates and have 5 parallel Zn plates, each 2 mm, to resemble one Zn plate of 1 cm thick.

The entire cell is inside a case made of steel and covered by a skin made of PTFE. The case has openings on two parallel sides, for example, top and bottom, to allow the air flow.

### Example 9

### Li-Air Battery

This example describes a Li-Air battery. The setup of the cells comprises metallic lithium as the anode, three membrane laminates (two PC layers and one LAGP layer), and a cathode. The membrane is PC(BN)/LAGP/PC(BN) with the thickness of 1.5 mm, where each layer of pC is about 200-300 micrometers thick. The plates are 20 mm×20 mm×0.4 mm. The cathode is 25% C*+75% LAGP on Ni mesh tube. The cathode tube has an inner opening of 1 mm diameter. Its thickness is 0.5 mm. C* is 60% PWA activated carbon+40% Ketjen carbon black.

The air cathode contains a hydrophobic Teflon layer, on the inner size, say 0.01 thick (inner part of the tube is, for example, porous to allow oxygen but stop vapor), a thin Nickel mesh layer acting as a current collector and providing a structural support (middle layer of the tube), and a carbon catalyst layer (outer part of the tube).

The cell comprises 4 parallel Li perforated plates. The distance between the plates is optionally partially filled with liquid nonaquous electrolyte, for example, 1M LiPFe/PC/EC/DMC (1:1:3) and partially with 0.2 mm perforated steel plates, and partially can be filled with dry oxygen.

Optionally, zero space is used between plates and there are 5 parallel plates, each 0.4 mm, to resemble one plate of 1 mm thick.

The entire cell can is inside a case made of steel and covered by a skin made of PTFE. The case has openings on two parallel sides, top and bottom, to allow the air flow.

As a note, the concepts of assisted flow, varying hole-sizes and pumps, as described in the flow assisted Zn-Air battery in the above example, are useful with Li-Air batteries of this example as well.

### Example 10

### Flow Batteries

This example describes flow batteries. Useful electrodes for flow batteries include, but are not limited to: Vanadium, Bromine, Iron, H₂-Zinc, Cerium, B₂, Chromium, Polysulfide and any combination of these.

Two electrolytes are used, one surrounding the anode and one surrounding the cathode. Useful electrolytes include, but are not limited to, H₂SO₄, VCl₃—HCl, NaBr—HCl, NaS₂, NaBr, HCL, Polymer Electrolyte Membrane-HBR, ZnBr₂, CH₃SO₃H and any combination of these.

A redox flow battery with a stack of perforated cells and a group of rods (arbitrary aspect ratio; from one that is a circle cross section to a very large number that is a rectangular cross section; the cross-section itself can vary for example in size), with anolyte and catholyte compartments divided from each other by an ionically selective and conductive separator and having respective electrodes. The battery has anolyte and catholyte tanks, with respective pumps and a pipework. In use, the pumps circulate the electrolytes to and from the tanks, to the compartments and back to the tanks. Electricity flows to a load. The electrolyte lines are provided with tappings via which fresh electrolyte can be added and further tappings via which spent electrolyte can be withdrawn, the respective tappings being for anolyte and catholyte. On recharging, typically via a coupling for lines to all the tappings, a remote pump pumps fresh anolyte and fresh catholyte from remote storages and draws spent electrolyte to other remote storages.

In an embodiment, the cell comprises: an anode in a catholyte compartment, a cathode in an anolyte compartment and, an ion selective membrane separator between the compartments, a pair of electrolyte reservoirs, one for anolyte and the other for catholyte, and electrolyte supply means for circulating anolyte from its reservoir, to the anolyte compartment in the cell and back to its reservoir and like circulating means for catholyte; the battery comprising: connections to its electrolyte reservoirs and/or its electrolyte supply means so that the battery can be recharged by withdrawing spent electrolyte and replacing it with fresh electrolyte,

In this design, the electrolyte divider or membrane is optionally a diaphragm between each rod and the walls of the corresponding holes. It optionally is a thin tube shape that the inner and outer radii are chosen to fit between the rod and the corresponding wall and is as long as each of the rods or it can be a thin tube shape as long as the thickness of each of the perforated plates.

### Example 11

### Flow Battery First Example

This example describes a flow battery embodiment. Electrolyte 1 and 2 are the same in this example: between rods and walls of the holes and between the plates: 2M VOSO₄ in 2M H₂SO₄. Temperature: 25 Celsius.

Negative Electrode: Graphite rods, 100 mm long, 1 mm thick on a copper wire of 1 mm diameter. The wires are held in tension from the top and bottom outside of the cell, so that they stay straight. Electrolyte 1 runs from the outside of the cell into the cell from one end, from the holes between the rods and the walls of the holes in plates; and exits from the opposite end. A pumping system is optionally used to flow the electrolyte 1.

Positive Electrode: 10 Platinized titanium Perforated Plates which are 100×100×3 mm. The holes are periodic in the plane, 5 mm diameter, and 5 mm wall to wall. There is a 5 mm distance between the perforated plates. The Electrolyte 2 flows from outside of the cell into the cell through this space and exits from the opposite end. A pumping system is optionally used to flow the electrolyte 2.

The membrane is CMV polystryne sulphoric acid cation-selective type membrane and is placed next-to the walls of the plates. It is in the form of a thin tube with outer radius of 5 mm and thickness of 0.02 mm.

### Example 12

### Flow Battery Second Example

This example describes a flow battery embodiment.

Electrolyte 1 and 2 are: between rods and walls of the holes. The positive electrolyte 0.8 mol dm-3 Ce(III) methanesulfonate in 4.0 mol dm-3 methanesulfonic acid. The negative electrolyte compartment contains 1.5 mol dm-3 Zn(II) methanesulfonate in 1.0 mol dm-3 methanesulfonic acid.

The electrolytes are circulated through the cell at 4 cm/s using two peristaltic pumps with high-pressure tubings (Cole-Parmer, 6 mm inner diameter) on one face of the cell.

The electrolytes (200 cm³ each) are contained in separate tanks.

Carbon polyvinyl-ester composite is used as the negative electrode.

Platinised titanium mesh (70 g Pt/m² loading) is used as the positive electrode.

Negative Electrodes are 3 mm diameter rods 100 mm long: 1 mm thick negative electrode material (here Carbon polyvinyl-ester) shell on a copper wire of 1 mm diameter. The wires are held in tension from the top and bottom, outside of the cell, so that they stay straight.

Positive Electrode: 10 Platinized titanium Perforated Plates which are 100×100×4 mm. The holes are periodic in the plane, 10 mm diameter, and 10 mm wall to wall. 5% of the space between each two parallel plates is filled with spacers, the same material as the plates, 5 mm thick and a few millimeters surface area with an arbitrary shape such as cube or cylinder, and in a periodic arrangement. The rest is filled with negative electrolyte.

The membrane is CMV polystryne sulphoric acid cation-selective type membrane and is placed next-to the walls of the plates. It is in the form of a thin tube with outer radius of 5 mm and thickness of 0.02 mm. The membrane is also 100 mm long.

Positive electrolyte enters from one face of the cell, flows in the holes between the rods and the walls of the holes in plates; and exits from the opposite end. Positive electrolyte enters from one face of the cell, runs parallel to the plane of the plates, and exits from the opposite face. The rods and the walls of the holes are separated by the membrane sandwiched between two silicone gaskets. Gaskets are tubes each 100 mm long, each about 1 mm thick. The inner gaskets have an inner diameter of 6 mm (that is a 1.5 mm thick shell is left for the flow of the positive electrolyte). The outer gaskets have an outer diameter of 10 mm. Inner gaskets have large openings in vicinity of the walls of the plates-holes their cylindrical cross section has at least 80% opening, but has less opening between the parallel plates. Outer gaskets have large openings, at least 80%, everywhere.

From outer to inner, the construction of the rod is as follows: Silicone gasket (8.04 mm inner diameter, 10 mm outer diameter) (separator): Membrane (8 mm inner diameter, 8.04 mm outer diameter): Silicone gasket (6 mm inner diameter, 8 mm outer) (separator): Negative electrode rod (Carbon polyvinyl-ester 1 mm thick) and Copper wire (3 mm diameter): Copper wire (1 mm diameter)(current collector).

### Example 13

### Fuel Cells

The three dimensional electrode design is applied to alkaline fuel cell (AFC), polymeric-electrolyte-membrane fuel cell (PEMFC) and phosphoric-acid fuel cell (PAFC) and molten-carbonate fuel cells (MCFCs) and solid-oxide fuel cells (SOFCs).

In some fuel cells or metal air batteries, a major advantage of the new design is the ease of CO₂ recirculation from the anode exhaust to the cathode input, especially as needed in molten-carbonate fuel cells. This is achieved by using a specific membrane between the two spaces: the space between the rods and the walls of the holes and the space between the parallel plates.

In some fuel cells or metal air batteries, another advantage is the removal of adsorbed CO species, especially in polymeric-electrolyte-membrane fuel cell and more specifically for reformate electrodes as well as for methanol oxidation. This is achieved by using a specific membrane between the two spaces: the space between the rods and the walls of the holes and the space between the parallel plates.

An advantage of the new design is that bipolar plates that are a must in conventional fuel cells (and have corrosion problems if not made of expensive materials) are optionally omitted from the new design. In the new design, due to the truly 3 dimensional design, the bipolar plates are optionally placed on the faces of the cell, not inside the cell. This helps with the life and cost of the fuel cell, providing a major advantage as in the new design the current collectors can be in the middle of the plates and rods, thus they are not in contact with the electrolyte. The current collectors also optionally give the desired structural strength to the cell; this is in addition to the structural integrity due to the packed system of tight contacts between the rods and the walls of the holes.

A major benefit of the new design is that it can handle the thermal shocks, especially those in Fuel cells, much better compared to the conventional systems. This adds to the life of the system.

Besides hydrogen, it is also able to run on biogas (which delivers the most energy per hectare of crops), natural gas, propane, ethanol, diesel or biodiesel. This is because of the ability of the added ability of fuel dissociation in the cell due to the new design.

In a typical planar fuel cell design, if an individual cell plate fails, replacement of the cell plate is difficult due to permanent nature of the interconnections between the cells and the bipolar interconnects within the stack. Therefore an entire substack consisting of a multiplicity of cell plates and associated non-cell components must normally be replaced. A fuel cell stack design wherein the cell-containing packets themselves could be replaced, with only a minimum exchange of non-cell components, would offer a significant economic advantage.

One advantage of the new design is that the gas and liquid phases of the products of the reaction are separable by adding membranes (permeable to gas but not to liquid; for example, using PP or PE or other inert materials with desired pore sizes) between the rods and the plates at the levels of beginning and end of the plates. That is the distance between the membranes is equal to the thickness of the perforated plates and the membrane can be like a thin donut of say 0.01 mm thick and width of about a few micrometer to a few millimeters (to fill the space between the rods and the plates). This is very useful as an example for hydrogen and bromine flow battery in which removing the bromine gas in conventional design is difficult. In the new design the gas diffuses to the space between the plates, where it can be solved in a liquid or partially mixed with another gas and be removed from the cell, wither by diffusing out of the system or by assisted flow, say by a pump.

The electrolyte is optionally Aqueous alkaline solution or Aqueous alkaline solution, Polymer membrane (ionomer), Polymer membrane or humic acid, Molten phosphoric acid (H3PO4) or Molten alkaline carbonate or O2-conducting ceramic oxide or salt water or H+-conducting ceramic oxide or yttria-stabilized zirconia (YSZ) or lithium potassium carbonate salt or Ceria.

In general, the electrolyte sheets employed for the construction of compliant multi-cell-sheet structures are maintained below 45 microns in thickness, preferably below 30 microns in thickness, and most preferably in the range of 5-20 microns in thickness. Flexible polycrystalline ceramic electrolyte sheets enhance both thermal shock resistance and electrochemical performance; examples of such sheets are disclosed in U.S. Pat. No. 5,089,455 to Ketcham et al., hereby incorporated by reference. Examples of suitable compositions for such electrolytes include partially stabilized zirconias or stabilized zirconias doped with a stabilizing additive selected from the group consisting of the oxides of Y, Ce, Ca, Mg, Sc, Nd, Sm, Eu, Gd, Tb, Dy, Ho, Er, Tm, Yb, Lu, In, Ti, Sn, Nb, Ta, Mo, and W and mixtures thereof.

Among the electrode materials useful in combination with pre-sintered electrolytes are cermet materials such as nickel/yttria stabilized zirconia cermets, noble metal/yttria stabilized zirconia cermets, these being particularly useful, but not being limited to use, as anode materials. Useful cathode materials include such ceramic and cermet materials as strontium-doped lanthanum manganite, other alkaline earth-doped cobaltites and manganites as well as noble metal/yttria stabilized zirconia cermets. Of course the foregoing examples are merely illustrative of the various electrode and interconnect materials which are useful and are not intended as limiting.

Cathode and anode materials useful for fuel cell construction preferably comprise highly conductive but relatively refractory metal alloys, such as noble metals and alloys amongst and between the noble metals, e.g., silver alloys. Examples of specific alloy electrode compositions of this type include silver alloys selected from the group consisting of silver palladium, silver-platinum, silver-gold and silver-nickel, with the most preferred alloy being a silver-palladium alloy. Alternative electrode materials include cermet electrodes formed of blends of these metals or metal alloys with a polycrystalline ceramic filler phase. Preferred polycrystalline ceramic fillers for this use include stabilized zirconia, partially stabilized zirconia, stabilized hafnia, partially stabilized hafnia, mixtures of zirconia and hafnia, ceria with zirconia, bismuth with zirconia, gadolinium, and germamum. In addition, Graphene is optionally used as either of the electrodes.

The three most common electrolyte materials in SOFCs are: doped ceria (CeO2), doped lanthanum gallate (LaGaO3) (both are oxygen ion conductors) and doped barium zirconate (BaZrO3) (a proton conductor).

In fuel cells the anode is usually hydrogen or hydrocarbon fuels, including diesel, methanol and chemical hydrides.

The membrane is optionally Nafion or Polyarylenes or polybenzimidazole (PBI) with phosphoric acid.

Conventional fuel cells in general have slow reaction rates, leading to low currents and power. The new design makes the reaction rate much faster by increasing the active surface area and also by better management of the flow of the reaction products, and also by making the cell more homogeneous.

### Example 14

### SOFC Fuel Cell

This example describes a single oxide fuel cell operating at a temperature of up to 700 degrees Celsius. Geometry: Here rods are hollow and have a square cross section. Each rod is 100 mm long, and has an outer size of 14.95 mm×14.95 mm. The outer layer of each rod is cathode active material (Doped LaMnO₃) 0.2 mm thick with low porosity and small mean pore diameter (1 μm or less). The inner layer is a 1 mm thick support material with higher porosity and larger mean pore diameter (2 μm or more).

Electrolyte is solid thin tubes, 100 m long, with 0.05 mm thickness. The rods are coated with the electrolyte which fills the space between the rods and the walls of the holes of the plates. The Electrolyte material is YSZ.

The plates are 2 mm thick. They have a 1.8 mm steel in the center with 0.1 mm thick coating on each side made of the anode material (Ni/YSZ). They are 100 mm×100 mm wide-long. They have square holes of 15 mm×15 mm size. The holes are distributed periodically. The least distance between the holes is 10 mm wall to wall. The distance between parallel plates is 10 mm.

The fuel flows in the space between the plates. The oxidizing fluid, such as oxygen gas, flows in the inner space of the hollow rods.

### Example 15

### Supercapacitor, First Example

This example describes an electrochemical supercapacitor. The geometry of the device is a box of 1×1×1 cm. In this example, the rod electrodes are 0.02 mm diameter and are 10 mm long. There are 10 parallel plate electrodes, each 10×10×0.02 mm. The plate electrodes have periodic holes of 0.03 mm diameter and the distance between the holes is 0.02 mm wall to wall. The distance between parallel plates is 0.08 mm. The space between the parallel plates and between each rod and the corresponding walls of the holes is filled with the electrolyte.

All rods have a 0.01 mm diameter copper core. The active material is the shell such that: half of the rods are made of MnO₂, the other half are made of activated Carbon. They are assembled next to each other: each MnO₂ rod has four nearest neighbors of Carbon; and each carbon has four nearest neighbors of MnO2.

All plates have a 0.01 mm thick copper core. The active material is the shell such that: half of the plates are made of activated Carbon. The other half are made of MnO₂. Each Carbon plate has two MnO₂ neighbors (top and bottom), and each MnO₂ plate has two carbon plate neighbors.

The electrolyte is 0.5M H₂SO₄ in water. The rods are positively charged and the plates are negatively charged.

A fuel flows in the space between the plates. The oxidizing fluid, such as an oxygen containing gas, flows in an inner space of the hollow ode electrodes.

### Example 16

### Supercapacitor, Second Example

This example describes a supercapacitor. The geometry is a box of 1×1×1 cm. In this example, the rods electrodes are 0.02 mm diameter and are 10 mm long. The plate electrodes are 10×10×0.02 mm, and have periodic holes of 0.03 mm diameter. The distance between the holes is 0.02 mm wall to wall. The distance between parallel plates is 0.08 mm. There are 10 parallel plates. The space between the parallel plates and between each rod and the corresponding walls of the holes is filled with the electrolyte. In this example, the electrolyte is 1 M LiClO₄ in Propylene Carbonate.

All rods have a 0.01 mm diameter copper core. The active material is the shell such that: half of the rods are made of MnO₂, the other half are made of activated Carbon. They are assembled next to each other: each MnO₂ rod has four nearest neighbors of Carbon; and each carbon has four nearest neighbors of MnO₂.

All plates have a 0.01 mm thick copper core. The active material is the shell such that: half of the plates are made of activated Carbon. The other half are made of MnO₂. Each Carbon plate has two MnO₂ neighbors (top and bottom), and each MnO₂ plate has two carbon plate neighbors.

The MnO₂ rods and plates are positively charged and the Carbon rods and plates are negatively charged.

The MnO₂ rods and plates are positively charged from bottom and left of the cell and the Carbon rods and plates are negatively charged from top and right side of the cell.

### Example 17

### Supercapacitor, Third Example

This example describes a small design supercapacitor. The geometry of the device is a box of 0.1×0.1×0.1 mm inside size. The rod electrodes are 0.01 mm diameter. They are 0.1 mm long. The plates electrodes are 0.1×0.1×0.005 mm, and have periodic holes of 0.015 mm diameter, the distance between the holes is 0.01 mm wall to wall. The distance between parallel plates is 0.005 mm. There are 10 parallel plates. The space between the parallel plates and between each rod and the corresponding walls of the holes is filled with the electrolyte. The electrolyte in this example is 1 M LiClO₄ in Propylene Carbonate.

Half of the rods are made of MnO₂, the other half are made of activated Carbon. They are assembled next to each other: each MnO₂ rod has four nearest neighbors of Carbon; and each carbon has four nearest neighbors of MnO₂.

Half of the plates are made of activated Carbon. The other half are made of MnO₂. Each Carbon plate has two MnO₂ neighbors (top and bottom), and each MnO₂ plate has two carbon plate neighbors.

The MnO₂ rods and plates are positively charged and the Carbon rods and plates are negatively charged.

### Example 18

### Half Semi-Solid Battery

This example describes a semi-solid battery. The geometry of the device is a box of 100×100×100 mm inside size. The rod electrodes are 5 mm in diameter and are 100 mm long. The plate electrodes are 100×100×2 mm, and have periodic holes of 6 mm diameter; the distance between the holes is 2 mm wall to wall. The distance between parallel plates is 0.5 mm. There are 40 parallel plates in this example.

The space between the parallel plates and between each rod and the corresponding walls of the holes is filled with the electrolyte and cathode particles. Electrolyte and cathode particles enter from outside of the cell though the open spaces between the rods and the walls of the holes in the plates and also between the plates. One or several pumps can be used for this purpose.

Cathode particles are LiCoO₂ powder (nanometer size to micrometer size) mixed with carbon black powders (nanometer size to micrometer size), 90% to 10% weight. The electrolyte is 1 M LiPF₆ in alkyl carbonate blend.

The rods are made of copper. The plates are made of three silicon (anode) layers that are separated by two perforated copper plates, 0.010 mm thick. The distance between the copper plates is 1 mm.

The surfaces, including edges of the walls of the holes, of the plates are covered with an inert micro-porous material as a coating, here 0.1 mm PE separator.

### Example 19

### Full Semi-Solid Battery

This example describes a semi-solid battery. The geometry of the device is a box of 100×100×100 mm inside size. The rod electrodes are 5 mm in diameter and are 100 mm long.

Plates are 100×100×2 mm, and have periodic holes of 6 mm diameter; the distance between the holes is 2 mm wall to wall. The distance between parallel plates is 0.5 mm. There are 40 parallel plates in this example.

The space between the parallel plates and between each rod and the corresponding walls of the holes is filled with the electrolyte and cathode particles.

Electrolyte 1 and cathode particles enter from outside of the cell though the open spaces between the rods and the walls of the holes in the plates.

Electrolyte 2 and anode particles enter from outside of the cell though the open spaces between the plates. One or several pumps can be used for this purpose.

Cathode particles are LiFePO₄ powder (nanometer size to micrometer size) mixed with carbon black powders (nanometer size to micrometer size), 90% to 10% weight.

Electrolyte 1 is 1 M LiPF₆ in alkyl carbonate blend.

Anode particles are Li₄Ti₅O₁₂ powder (nanometer size to micrometer size) mixed with carbon black powders (nanometer size to micrometer size), 90% to 10% weight.

Electrolyte 2 is 70:30 (weight) 1,3-dioxolane and LiBETI.

The rods are made of copper and the plates are made of copper.

Between each of the rods and the walls of the holes of the plates there is a tube of PE separator, 0.05 mm thick, same length as the rods, 100 mm, with external diameter of 6 mm.

To construct an electrode array of this design, the tubes are placed after all the plates are aligned and before the rods are placed through the holes. Then the tubes are inflated by introducing a fluid, such as hexane or the cathode electrolyte, into them through both ends (or from one end while the other end is kept closed) while the tube is in tension from both ends from the outside.) Optionally, a balloon can be placed inside the tube to help with the inflation, this works as by inflating the balloon the tube is sealed to the walls of the holes of the plates. The balloon is removed after the inert tube is fit with the walls of the holes. Optionally, all the plates are attached to each other first, then the tube is inflated and the distance between the plates is adjusted while still inflating the tubes with either of the above methods.

### Example 20

### Small Semi-Solid Battery

This example describes a small/nano scale battery. The geometry of the device is a box of 0.01×0.01×0.01 mm inside size. The rod electrodes are 0.001 mm in diameter and are 0.01 mm long. The plate electrodes are 0.01×0.01×0.0005 mm, and have periodic holes 0.0015 mm in diameter, where the distance between the holes is 0.001 mm wall to wall. The distance between parallel plates is 0.0005 mm. There are 10 parallel plates in this example.

The space between the parallel plates and between each rod and the corresponding walls of the holes is filled with the electrolyte. Here, the electrolyte is 1 M LiClO₄ in Propylene Carbonate.

The rods are made of LiCoO₂ and the plates are made of silicon.

### Example 21

### Composite Rod Electrode

This example describes a rod electrode that is a composite electrode itself. For example, in reference to the embodiment shown in FIG. 14, a rod electrode has a core of current collector material such as aluminum. Surrounding the current collector is a layer of LiCoO₂, for example, 0.1 mm thick. Surrounding the LiCoO₂ layer, then there is a layer of PE or PP or Celgard, for example 0.2 mm thick. Surrounding this layer is a layer of Si, for example, 0.10 mm thick. Surrounding the Si layer is a second current collector, a layer of, for example, 0.01 mm copper. Surrounding the second current collector is a layer of Si, for example, 0.01 mm thick.

In this example, a three-dimensional electrode array comprises 30 parallel plates of LiCoO₂, each 0.2 mm thick (optionally having a 0.01 mm thick Al current collector in the middle), and 7.5 mm×7.5 mm long and wide.

The footprint area of this example is more than 41 times smaller than a conventional design, which makes it an ideal case for small electronic, MEMS, and biomedical devices.

The volume of the design in this example is about 0.67 of that of the conventional design, much smaller than the conventional design.

The surface areas of the plate and rod electrodes are respectively, 1.52 and 1.02 times increased from the conventional design.

### Example 22

### Novel 3-Dimensional Metal-Gas Batteries, Especially Lithium-Air Batteries

This example describes a 3-dimensional metal-gas battery, with a specific focus on lithium-air batteries. The metal-air batteries described here feature increased power density over conventional metal-air batteries, as well as significantly improved lifetime.

The metal-gas cell described in this example comprises metal rods such as lithium rods or its alloys, and hollow porous graphite rods and perforated porous carbon plates, and electrolyte. The number of the each of the rods and the spacing between them are adjustable across various embodiments. In one embodiment, the number of the each of the rods and the spacing between them are fixed. The number of the parallel plates and the spacing between them are adjustable across various embodiments. In one embodiment, the number of the parallel plates and the spacing between them are fixed. The distance between the metal rods and the carbon rods, wall to wall, is optionally selected over the range of 10 nm to 100 mm. In this example, the distance between the metal rods and the carbon rods, wall to wall, is 100 micrometers. In embodiments comprising lithium-air batteries, conventional materials, including electrolytes, used in lithium-air batteries are optionally employed.

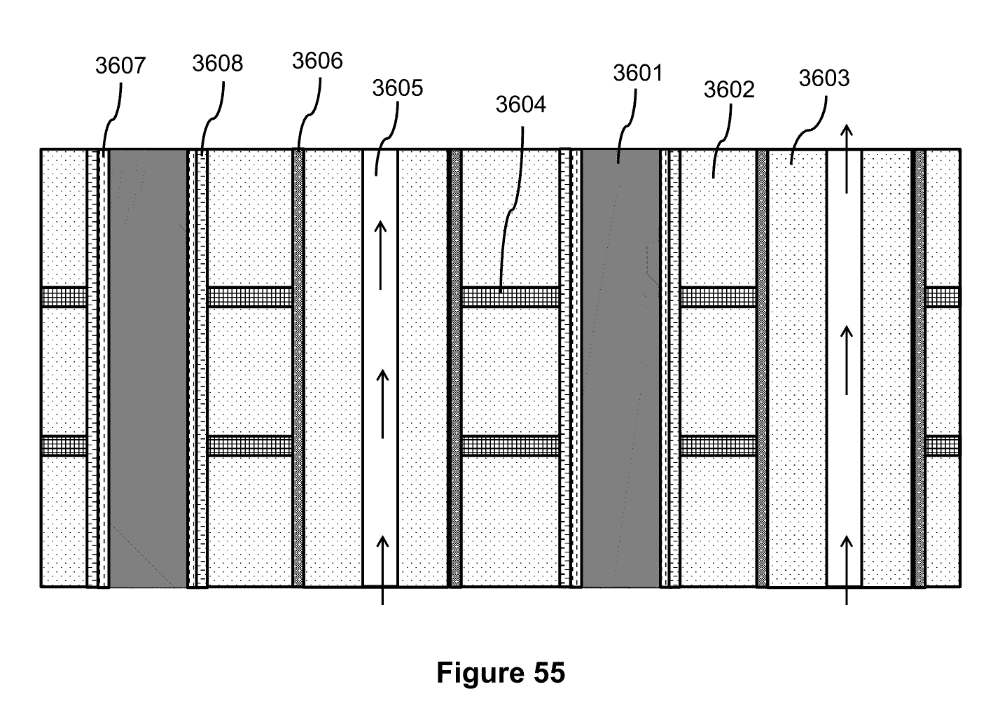

FIG. 55 illustrates an exemplary lithium-air cell. In this embodiment, lithium electrode rods 3601 pass through apertures in porous carbon plates 3602. Optionally the lithium rods have a diameter selected over the range of 10 μm to 10 mm. In this example, the lithium rods 3601 have a diameter of 200 μm. Hollow carbon rods 3603 are also passed through apertures in the porous carbon plates 3602. Optionally the carbon plates 3602 have a thickness selected over the range of 10 nm to 10 mm. In this example, the carbon plates 3602 have a thickness of 200 μm. Optionally, the carbon rods 3603 have a wall thickness selected over the range of 10 nm to 10 mm. In this example, the carbon rods 3603 have a wall thickness of 200 μm. Optionally, the carbon rods 3603 have a diameter selected over the range of 10 nm to 10 mm. In this example, the carbon rods 3603 have a diameter of 400 μm. Optionally, the carbon rods 3603 and plates 3602 are immersed in liquid or solid electrolyte.

Between adjacent carbon plates 3602 is a spacing 3604. Optionally the spacing 3604 is filled with liquid or solid electrolyte. Optionally, physical spacing elements, such as rings, are positioned between in the spacing 3604 between adjacent carbon plates to maintain the distance between carbon plates 3602. Optionally, the spacing between carbon plates 3602 is selected over the range of 1 μm to 1 mm. In this example, the spacing between carbon plates 3602 is 10 μm.

There is a hollow space 3605 within each carbon rod 3603. Optionally, the hollow space 3605 has a diameter selected over the range of 10 nm to 10 mm. In this example, the hollow space 3605 has a diameter of 200 μm. The hollow space 3605, filled with an O₂ containing gas, and carbon rod 3603 together form an electrode. Optionally, the O₂ containing gas is air or pure O₂. In this example, the O₂ containing gas is O₂. In this example, the O₂ containing gas is flowed through the hollow space 3605 of each carbon rod 3603, and permeates through the carbon rod 3603 towards the lithium rods 3601. Optionally, a flow of O₂ containing gas is introduced within each carbon plate 3602, which permeates through the carbon plates 3602 towards the lithium rods 3601.

Optionally, an ionic conductive layer 3606 is placed in the cell. In this example, an ionic conductive layer 3606 surrounds each carbon rod 3603. Optionally, the thickness of the ionic conductive layer 3606 is selected over the range of 10 nm to 1 mm. In one embodiment, the ionic conductive layer 3606 has a thickness of 3 μm. The ionic conductive layer 3606 optionally behaves as a semi-permeable membrane, for example, permitting some materials to pass, such as O₂, while preventing other materials from passing, such as H₂O. Another ion transfer material, such as an electrolyte, is optionally used in place of the ionic conductive layer 3606 to facilitate ion transfer.

Similarly, an ion conductive layer 3607 is optionally placed around the lithium rod 3601. Optionally, the ion conductive layer 3607 is chemically resistant. Optionally, the thickness of the ionic conductive layer 3607 is selected over the range of 10 nm to 10 μm. In one embodiment, the ionic conductive layer 3607 has a thickness of 1 μm. Another ion transfer material, such as an electrolyte, is optionally used in place of the ionic conductive layer 3607 to facilitate ion transfer.

Similarly, an ion conductive layer 3608 is optionally placed around the within the apertures in the carbon plate 3602. Optionally, the ion conductive layer 3608 is chemically resistant. Optionally, the thickness of the ionic conductive layer 3608 is selected over the range of 10 nm to 10 μm. In one embodiment, the ionic conductive layer 3608 has a thickness of 10 μm. The ionic conductive layer 3608 optionally behaves as a semi-permeable membrane, for example, permitting some materials to pass, such as O₂ or specific ions, while preventing other materials from passing, such as H₂O. Another ion transfer material, such as an electrolyte, is optionally used in place of the ionic conductive layer 3608 to facilitate ion transfer.

### Example 23

### Part Solid, Part Fluid Electrochemical Cells

Part solid, part fluid electrochemical cells may include the following systems, for example, metal-air (e.g., li-air, zinc-air), metal-water (e.g., li-water), metal-metal based redox couple (e.g., Li anode-iron cyanide dissolved in water as cathode), metal-semisolid (e.g., Redox flow devices, for example, wherein at least one of the positive electrode or negative electrode-active materials is a semi-solid or is a condensed ion-storing electroactive material, and for example, wherein at least one of the electrode-active materials is transported to and from an assembly at which the electrochemical reaction occurs, producing electrical energy, and, for example, wherein at least one of said positive and negative electrode comprises electrode-active material comprising an insoluble flowable semi-solid or condensed liquid ion-storing redox composition or redox compound which is capable of taking up or releasing said ions and remains insoluble during operation of the cell.)

### Examples

### Zn-Air

Anode: Zn+4OH⁻→Zn(OH)₄²⁻+2e⁻(E₀=−1.25 V)

Fluid: Zn(OH)₄²⁻→ZnO+H₂O+2OH⁻

Cathode: 1/2O₂+H₂O+2e⁻→2OH⁻(E₀=0.34 V pH=11)

Overall: 2Zn+O₂→2ZnO(E₀=1.59 V)

### Al-Air

The anode oxidation half-reaction is Al+3OH⁻→Al(OH)₃+3e⁻−1.66 V.
The cathode reduction half-reaction is O₂+2H₂O+4e⁻→4OH⁻+0.40 V.
The total reaction is 4Al+3O₂+6H₂O→4Al(OH)₃+2.71 V.

### Carbon Air

Cathode: O2+2CO2+4e−=2CO32−Anode: C+2CO32−=3CO2+4e−Net reaction: C+O2=CO2
Others: Iron-air, Sodium-air, Magnesium-air, Titanium-air, Aluminum-air, Lithium-air, Berylium-air electrochemical cell

### Example 24

### Novel 3-dimensional electrochemical/chemical cells

The invention provides novel 3-dimensional electrode arrays for chemical and electrochemical cells. In an aspect, electrochemical cells of the invention provide significantly higher power densities than conventional systems utilizing the same chemistry. The 3 dimensional cells of the invention include, but are not limited to, energy storage systems such as batteries, flow batteries, fuel cells and/or metal air batteries such as lithium air batteries.

In an embodiment, electrochemical cells of the invention include metal air batteries such as in lithium air batteries. The invention provides, for example, an electrochemical cell comprising at least two series of electrodes, in which the electrodes of each series are parallel to each other but have an angle, preferably 90 degrees, with the other series. The space between the electrodes of each series may contain an first electrolyte and the space between each member of the electrode series may contain a second electrolyte that can be different from the first electrolyte.

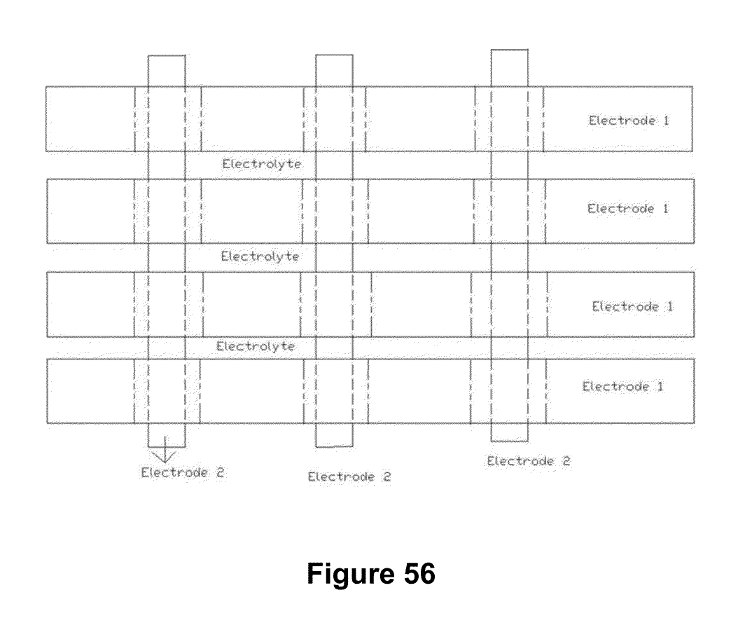

FIG. 56 provides a schematic diagram illustrating a 3-dimensional electrode array of the invention showing a first series of electrodes (each designated “Electrode 1”) and a second series of electrodes (each designated “Electrode 2”). Each of the electrolytes can be solid or fluid (gas or liquid) or semisolid (solid particles in a fluid). Each of the electrodes can be a solid or can be a fluid and a porous solid (the fluid can be static or can be flowing) or can be a fluid and a hollow solid, such as those similar to air cathode in fuel cells or in metal air batteries.

Millimeter Scale Embodiment

In one example of the present electrochemical cells, the anode electrodes are a series of plate electrodes provided in a parallel configuration with respect to each other. In an embodiment, the plate electrodes have an average thickness selected from the range of 0.1 millimeter to 10 millimeter, preferably for some applications the plate electrodes have an average thickness on the order of 1 mm. The thickness of the plate electrodes can be constant for all the plates and for the entire plate or can vary with position (e.g., having non-uniform thickness). In an embodiment, the plate electrodes have an arbitrary geometry such as rectangular plates or disks. In an embodiment, the spacing between the plate electrodes is selected from the range of 0.01 to 1 millimeter, preferably in the order of 0.025 millimeter. In an embodiment, the plate electrodes have an arbitrary array of holes such as a periodic rectangular array. In an embodiment, the holes have an arbitrary shape, for example, such as a circular shape or a square shape. In an embodiment, the holes have a diameter selected from the range of from 0.1 millimeter to 10 millimeter, preferably in the order of 1 millimeter. In an embodiment, the second array of electrodes comprises a series of rod electrodes having a cross-sectional geometry similar to the holes or different from that of the holes. The physical dimensions of the rod electrodes are such that they can be provided inside the holes of the plate electrodes without touching the walls of the holes of the plate electrodes so as to prevent an electrical short.

Micrometer Scale Embodiment

In one example of the present electrochemical cells, the anode electrodes are a series of plate electrodes provided in a parallel configuration with respect to each other. In an embodiment, the plate electrodes have an average thickness selected from the range of 0.01 millimeter to 1.0 millimeter, preferably for some applications the plate electrodes have an average thickness on the order of 0.1 mm. The thickness of the plate electrodes can be constant for all the plates and/or for the entire plate or can vary with position (e.g., having non-uniform thickness). In an embodiment, the plate electrodes have an arbitrary geometry such as rectangular plates or disks. In an embodiment, the spacing between the plate electrodes is selected from the range of 0.001 to 0.1 millimeter, preferably in the order of 0.0025 millimeter. In an embodiment, the plate electrodes have an arbitrary array of holes such as a periodic rectangular array. In an embodiment, the holes have an arbitrary shape, for example, such as a circular shape or a square shape. In an embodiment, the holes have a diameter selected from the range of from 0.01 millimeter to 1.0 millimeter, preferably in the order of 0.1 millimeter. In an embodiment, the second array of electrodes comprises a series of rod electrodes having a cross-sectional geometry similar to the holes or different from that of the holes. The physical dimensions of the rod electrodes are such that they can be provided inside the holes of the plate electrodes without touching the walls of the holes of the plate electrodes so as to prevent an electrical short.

Nanometer Scale Embodiment

In one example of the present electrochemical cells, the anode electrodes are a series of plate electrodes provided in a parallel configuration with respect to each other. In an embodiment, the plate electrodes have an average thickness selected from the range of 0.001 millimeter to 0.10 millimeter, preferably for some applications the plate electrodes have an average thickness on the order of 0.01 mm. The thickness of the plate electrodes can be constant for all the plates and/or for the entire plate or can vary with position (e.g., having non-uniform thickness). In an embodiment, the plate electrodes have an arbitrary geometry such as rectangular plates or disks. In an embodiment, the spacing between the plate electrodes is selected from the range of 0.0001 to 0.01 millimeter, preferably in the order of 0.00025 millimeter. In an embodiment, the plate electrodes have an arbitrary array of holes such as a periodic rectangular array. In an embodiment, the holes have an arbitrary shape, for example, such as a circular shape or a square shape. In an embodiment, the holes have a diameter selected from the range of from 0.001 millimeter to 0.01 millimeter, preferably in the order of 0.1 millimeter. In an embodiment, the second array of electrodes comprises a series of rod electrodes having a cross-sectional geometry similar to the holes or different from that of the holes. The physical dimensions of the rod electrodes are such that they can be provided inside the holes of the plate electrodes without touching the walls of the holes of the plate electrodes so as to prevent an electrical short.

As an example for metal-air batteries such as lithium air batteries, the anode electrodes are made of lithium metal or another chemistry suitable for anode electrodes. In an embodiment, for example, the cathode electrode comprises porous graphite or another chemistry suitable for cathode electrodes. In an embodiment, the cathode electrode further has have a flow of air or oxygen that reacts with the anode material to release energy.

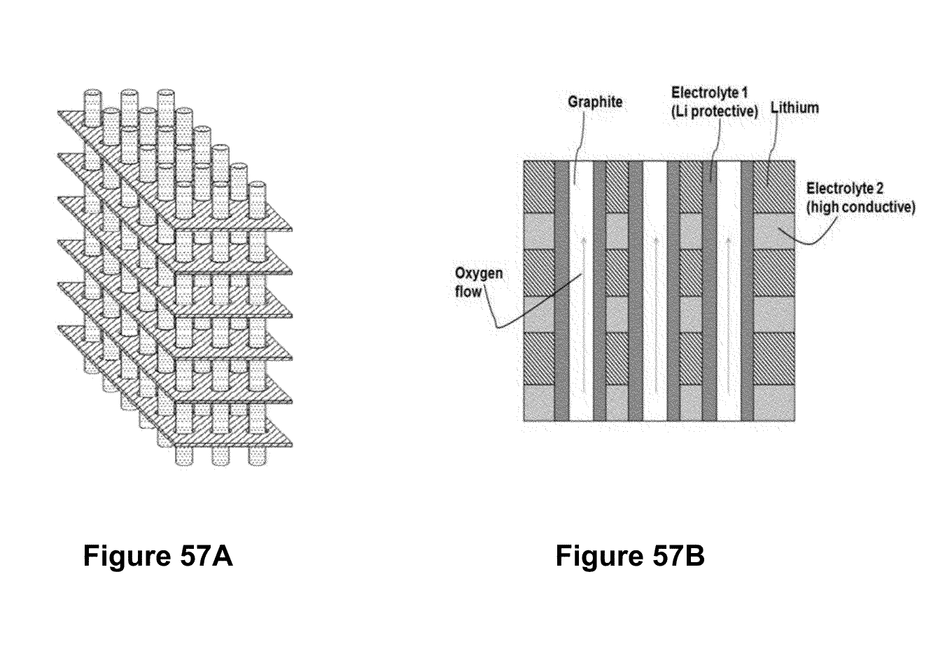

FIGS. 57A and 57B provides a schematic diagrams illustrating a 3 dimensional electrode array of the present invention, for example for use in a metal-air batteries such as in lithium-air batteries. In an embodiment, the anode electrodes are a series of parallel plate electrodes and the cathode electrodes are a series of rods electrodes extending through the series of parallel plate electrodes. The rods can be hollow such that air or oxygen can flow inside it. FIG. 57A provide a perspective view of a 3D electrode array. FIG. 57B provides a cross sectional view of an alternative electrode configuration. By changing the electrode configuration relative to a conventional electrode geometry, the active surface area of the new design is several time higher than that of conventional lithium-air batteries having the same foot print. This change results in several times high power densities and faster charge-discharge as the ion transportation is now possible in 3 dimensions in contrast to the one dimension in typical 2D systems.

The invention provides metal-air batteries such as in lithium-air batteries. In some embodiments, the cathode electrodes are the parallel plate electrode series and the anode electrodes are the rod electrode series. The space between the plate electrode, such as a graphite plate electrode, optionally is such that air or oxygen flows inside it.

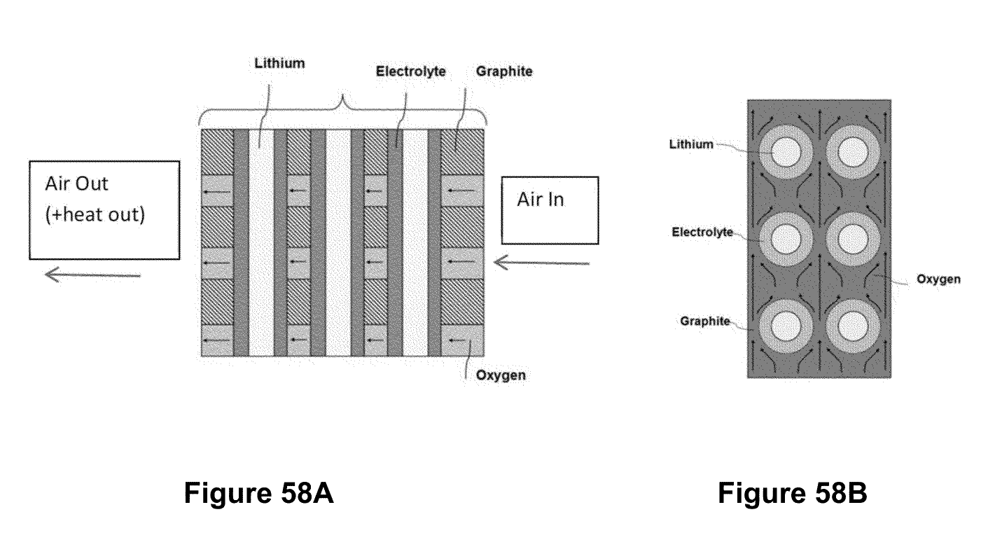

FIGS. 58A and 58B provide schematic diagrams of an example electrode array of the present invention, for example, for use in a metal-air battery of the present invention. An advantage of the present electrode arrays for lithium-air batteries is that the air-flow in and the air flow out is optionally separated, as an example in-flow from beneath the battery and out-flow from the top. This aspect of the present lithium-air batteries improves safety by being able to turn off the air supply easily and also results in higher energy densities as the air flows will not block or impede each other. FIG. 58A provides a side view of the metal-air battery and FIG. 58B provides a cross sectional view of the metal-air battery.

Some lithium-air batteries have been demonstrated to provide extremely high theoretical energy densities, 1000-5000 Wh/kg, approaching those of gasoline internal combustion engines due to the use of a high capacity lithium anode and oxygen from the air. However, there are several problems the currently limited the commercialization of Li-air batteries. Particularly, the problems of the conventional design that limit the rate and power density of the Li-air batteries include 1) Low O₂ diffusion inside the cell 2) clogging at the cathode electrode (The discharge product Li₂O₂ or Li₂O is not soluble in organic electrolyte, which inevitably clogs porous catalytic electrode. After fully clogged by formed Li₂O₂ deposit, the porous catalytic electrode cannot reduce O₂ from environment any more) 3) Volume expansion of the cathode due to the formation of Li₂O₂ 4) Li-dendrite formation and shorting of the cell. The 3-D electrode array geometry of the present invention reduces, or entirely avoids, some of the problems. For example, the novel 3-D design results in order of magnitude improvement in O₂ diffusion in the cell, greatly increases the reactive surface area per foot print and significantly reduces the clogging problem. In addition, in the second part of the report we show that our novel separator optionally stops the lithium dendrites from shorting the cell and thus problem number 4 is taken care of. Also the volume expansion of the cathode is taken care by the distance between the plate layers. In addition, our novel design allows a very efficient usage of flow in the system which itself increases the power density significantly. A flow-through mode of the cathode optionally provide a full and efficient match of the capacity of a lithium-metal anode. The flow of the cathode solution continuously brings heat out of the battery system and keeps the battery working near a mild condition.

The electrode arrays and electrochemical cells described herein is also optionally used for fuel cells by replacing the anode electrode material with a suitable fuel cell anode such as a hydrogen electrode.

The electrode arrays and electrochemical cells described herein are also optionally used for flow batteries by replacing the electrodes materials with suitable flow battery electrode materials.

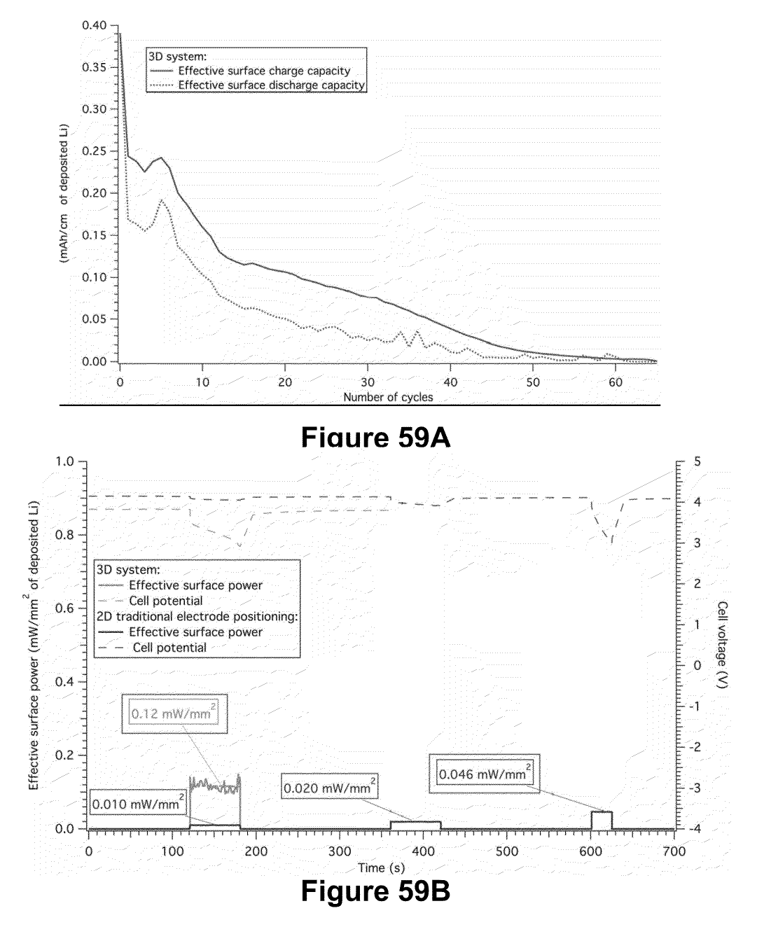

FIG. 59A provides a plot of 3D cell capacity for a cell, designed as anode limited, comprising LiCoO₂ plates and lithium rods, versus number of cycles illustrating the charge-discharge capacity. FIG. 59B provides a plot of 3D cell power density in comparison to a conventional parallel plate cell with the same mass of active material and same current per anode surface area versus time, illustrating the surface power density of an electrochemical cell having the 3D electrode geometry of the present invention. The experimental conditions reflected in FIG. 59B reflect the 3^{rd} cycle of the same electrochemical cell.

### Example 25

### Aprotic Li-Air Electrochemical Cell

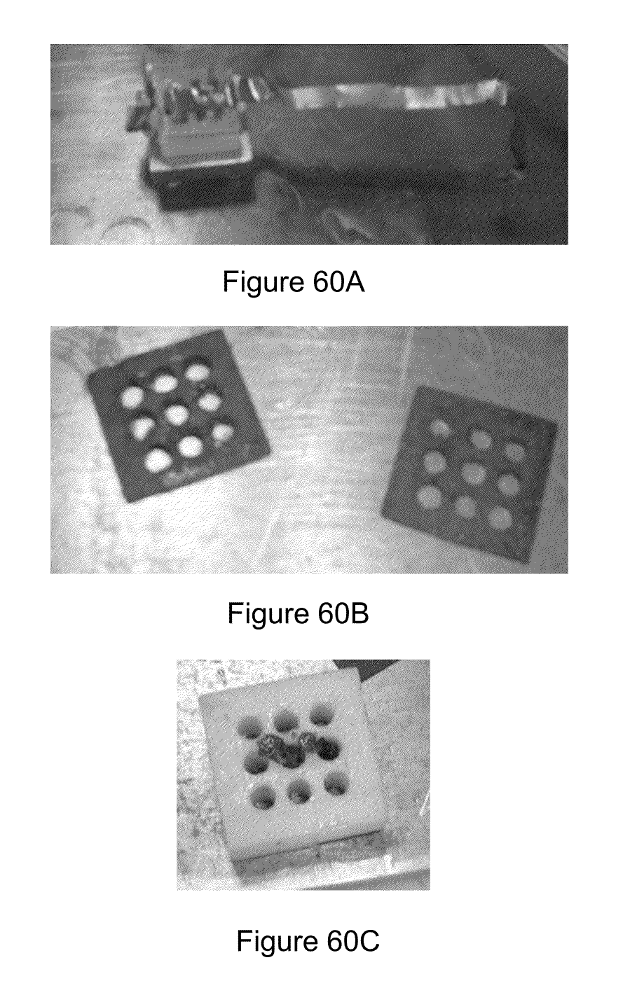

In an embodiment the invention provides an aprotic Li-Air electrochemical cell comprising a plurality of Li rods, a plurality of porous graphite plates (e.g., gas diffusion layer) and a plurality of hollow rods operationally configured to allow oxygen into the cell. In an embodiment, for example, the electrolyte is aprotic, LP71 from Merk. Optionally, one or more liquid-gas membranes are provided for some of the hollow rods to ensure that oxygen is transported into the bottom of the cell, as the oxygen diffusivity in electrolyte may be limited and, thus, may not be enough to have sufficient oxygen in the bottom of the cell in the absence of a liquid-gas membrane. FIGS. 60A, 60B and 60C provide images of an aprotic Li-Air electrochemical cell of the invention and components thereof.

### Example 26

### Experimental Testing of Electrochemical Cells

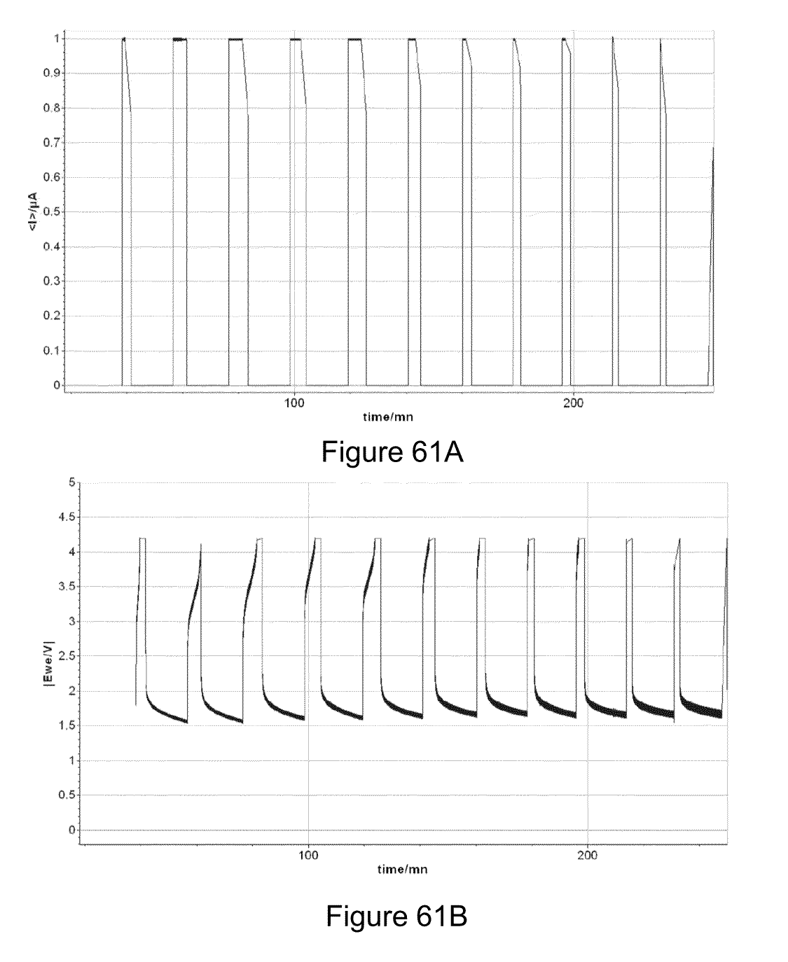

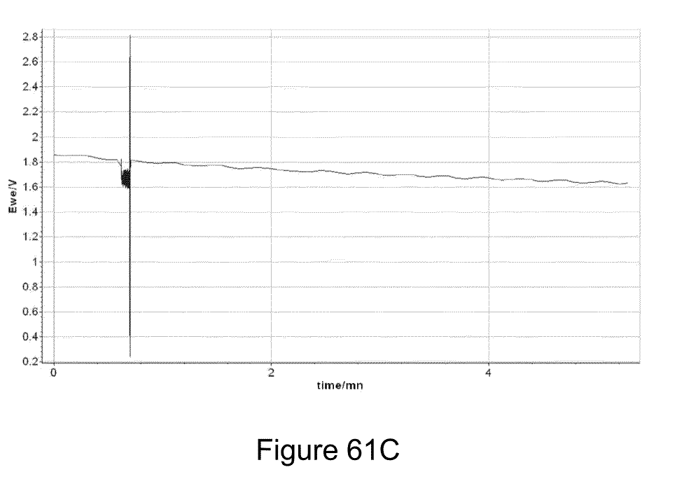

FIGS. 61A and 61B show the results of experimental testing of a 3-d electrochemical cell of the present invention comprising 2 lithium rods, each about 2 mm diameter, 3 carbon based gas diffusion layers (no catalyst) and 7 holes for oxygen gas. FIG. 61C shows the open circuit voltage of the cell. The figures show the voltage difference between the lithium rods as anode and gas diffusion layers as cathode due to the applied current. Voltage range of 2.5V to 4.2V was set. Two of the oxygen gas rod holes have a tube made of parafilm inside them to allow oxygen gas reach the bottom of the cell to overcome oxygen gas diffusion limitations in organic electrolytes. LP 71 electrolyte from Merk was uses. No separator was used. The cell was attached to an oxygen gas cylinder operating at about 1 atm. The discharge rate was set to 1 microAmp.

### REFERENCES

U.S. Pat. Nos. 7,618,748, 7,553,584, 6,781,817, 5,510,209, 5,089,455, 4,981,672, 4,871,428, 4,786,567, 4,346,152, 4,041,211, 3,607,422, 3,168,458, 528,647.
US Patent Application Publications US 2002/0160263, US 2003/0096147, US 2003/0099884, US 2004/0018431, US 2004/0175626, US 2004/0241540, US 2005/0074671, US 2005/0095504, US 2007/0059584, US 2007/0117000, US 2008/0153000, US 2009/0035664, US 2009/0087730, US 2009/0197170, US 2009/0214956, US 2009/0208834, US 2009/0214956, US 2010/0047671, US 2010/0090650, US 2010/0266907, US 2011/0027648, US 2011/0104521, US 2011/0171518, US 2011/0183186, US 2012/0263986, US 2012/0270088.
International Patent Application Publications WO 2008/019398, WO 2010/0057579, WO 1997/006569, WO 2008/049040, WO 2008/153749, WO 2010/062391.
http://www.liquicel.com/uploads/documents/Membrane%20Contactors%20-%20An %20Introduction%20To%20The%20Technology.pdf
Journal of The Electrochemical Society, 157, 1, A50-A54 (2010).
Lu, Goodenough and Kim, “Aqueous Cathode for Next-Generation Alkali-Ion Batteries.” J. Am. Chem. Soc., 2011, 133 (15), pp 5756-5759.
Christensen et al. “A Critical Review of Li/Air Batteries.” J. Electrochem. Soc., Volume 159, Issue 2, pp. R1-R30 (2012).
Mihai Duduta, Bryan Ho, Vanessa C. Wood, Pimpa Limthongkul, Victor E. Brunini, W. Craig Carter, and Yet-Ming Chiang “Semi-Solid Lithium Rechargeable Flow Battery”, DOI: 10.1002/aenm.201100152, Advanced Energy Materials Volume 1, Issue 4, pages 511-516, July, 2011.
Chem. Rev. 2004, 104, 4463-4492 4463.
J. Mater. Chem., 2011, 21, 9876.
Nano Lett., 2012, 12 (3), pp 1198-1202.
http://hdl.handle.net/10062/25375.
Adv. Energy Mater., 1, 511 (2011).
J. Electrochem. Soc. 2012, Volume 159, Issue 8, Pages A1360-A1367.
Solid State Electrochem (2012) 16:2019-2029.
Appl Electrochem (2011) 41:1137-1164.
J. Phys. Chem. B, 2012, 116 (30), pp 9056-9060.
Nature Material, 11, 19-29 (2012).
J. Electrochem. Soc. 2011, Volume 159, Issue 2, Pages R1-R30.
Electrochemistry Communications 14 (2012) 78-81.
ACS Appl. Mater. Interfaces, 2012, 4 (1), pp 49-52.
CARBON50 (2012) 727-733.
ACS Catal., 2012, 2 (5), pp 844-857.
Science 3 Aug. 2012 Vol. 337 no. 6094 pp. 563-566.
Chem. Soc. Rev., 2012, 41, 2172.
Nature Chemistry 4, 579-585.
ChemSusChem 2012, 5, 177-180.
Mater. Chem., 2011, 21, 10113-10117.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods optionally include a large number of optional composition and processing elements and steps.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed are optionally replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Many of the molecules disclosed herein contain one or more ionizable groups [groups from which a proton can be removed (e.g., —COON) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every formulation or combination of components described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A part solid, part fluid electrochemical cell comprising:
a plurality of plate electrodes, wherein each plate electrode includes an array of apertures, wherein the plate electrodes are arranged in a substantially parallel orientation such that the each aperture of an individual plate electrode is aligned along an independent plate alignment axis passing through an aperture of each of the other plate electrodes;
one or more solid rod electrodes, wherein the one or more solid rod electrodes are arranged such that each solid rod electrode extends a length along an independent solid rod alignment axis passing through an aperture of each plate electrode;
one or more porous rod electrodes, wherein the one or more porous rod electrodes are arranged such that each porous rod electrode extends a length along an independent porous rod alignment axis passing through an aperture of each plate electrode;
at least one electrolyte provided between said solid rod electrodes and said plate electrodes and said porous rod electrodes, wherein said at least one electrolyte is capable of conducting charge carriers;
wherein a first surface area includes a cumulative surface area of the plurality of plate electrodes, wherein a second surface area includes a cumulative surface area of each aperture array, wherein a third surface area includes a cumulative surface area of each of the solid rod electrodes and wherein a fourth surface area includes a cumulative surface area of each of the porous rod electrodes.

2. A flow electrochemical cell comprising:
a plurality of plate electrodes, wherein each plate electrode includes an array of apertures, wherein the plate electrodes are arranged in a substantially parallel orientation such that the each aperture of an individual plate electrode is aligned along an independent plate alignment axis passing through an aperture of each of the other plate electrodes;
one or more porous rod positive electrodes, wherein the plurality of porous rod positive electrodes are arranged such that each porous rod positive electrode extends a length along an independent positive electrode alignment axis passing through an aperture of each plate electrode;
one or more porous rod negative electrodes, wherein the plurality of porous rod negative electrodes are arranged such that each porous rod negative electrode extends a length along an independent negative electrode alignment axis passing through an aperture of each plate electrode;
at least one electrolyte provided between said porous rod negative electrodes and said plate electrodes or between said porous rod negative electrodes and said porous rod positive electrodes, wherein said at least one electrolyte is capable of conducting charge carriers;
wherein a first surface area includes a cumulative surface area of the plurality of plate electrodes, wherein a second surface area includes a cumulative surface area of each aperture array, wherein a third surface area includes a cumulative surface area of each of the porous rod positive electrodes and wherein a fourth surface area includes a cumulative surface area of each of the porous rod negative electrodes.

3. The electrochemical cell of claim 1 wherein a ratio of the second surface area to the first surface area is selected over the range of 0.01 to 20 or wherein a ratio of the second surface area to the sum of the third surface area and fourth surface area is selected over the range of 0.01 to 20.

4. (canceled)

5. The electrochemical cell of claim 1, further comprising one or more electronically insulating and ion-permeable separators positioned between said plate electrodes and said solid rod electrodes.

6. (canceled)

7. (canceled)

8. The electrochemical cell of claim 1, wherein any of the plate electrodes and any of the rod electrodes independently comprise a positive electrode or a negative electrode.

9. (canceled)

10. (canceled)

11. The electrochemical cell of claim 1, wherein one or more plate electrodes comprise a porous material having a porosity selected from the range of 10% to 99%.

12. (canceled)

13. (canceled)

14. (canceled)

15. (canceled)

16. (canceled)

17. The electrochemical cell of claim 1, further comprising an in-line sensor operationally arranged to determine a property of a flowable ion-storing redox composition provided to at least a portion of said plate electrodes, said porous rod electrodes, or any combination of these.

18. The electrochemical cell of claim 1, wherein each plate electrode independently comprises a material selected from the group of: carbon, graphite, graphene, catalized carbon, nanocarbon, Ketjen black, carbon paper, carbon cloth, carbon fiber material, metal foams, metal netting, stainless steel mesh, porous PTFE, porous metal oxide, porous ZnO, porous ZrO₂, porous metals, porous Ni, porous Cu, porous gold, porous platinum, porous Al, porous Ti, a metal mesh, a Cu mesh, Ni mesh, Al mesh, Ti mesh, a porous metal, a porous metal alloy, an electronic conductive polymer mesh, an electronic conductive porous polymer, any alloy thereof and any combination of these; or wherein each plate electrode comprises an electronically and thermally conductive material; or wherein each plate electrode comprises a porous material and one or more coatings provided on or within said porous material.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. The electrochemical cell of claim 1, wherein said porous rod electrodes provide for transport of an active cathode flow or active anode flow from the outside of the electrochemical cell into the cell or from inside of the electrochemical cell to outside of the electrochemical cell.

32. The electrochemical cell of claim 1, wherein each porous rod electrode independently comprises a material selected from the group of: carbon, graphite, graphene, catalized carbon, nanocarbon, Ketjen black, carbon paper, carbon cloth, carbon fiber material, stainless steel mesh, porous metal oxide, porous ZnO, metal foams or metal netting, calcium, calcium oxide, porous ZrO₂, porous metals, porous Ni, porous Cu, porous gold, porous platinum, porous Al, porous Ti, a metal mesh, a Cu mesh, a Ni mesh, an Al mesh, a Ti mesh, porous metals, porous metal alloys, an electronic conductive polymer mesh, an electronic conductive porous polymer, an electronic and thermal conductor and any combinations these.

33. The electrochemical cell of claim 1, wherein each porous rod electrode comprises a porous material having a porosity selected from the range of 10% to 99%.

34. (canceled)

35. (canceled)

36. The electrochemical cell of claim 1, wherein said solid rod electrodes comprise negative electrodes of said electrochemical cell.

37. The electrochemical cell of claim 1, wherein one or more solid rod electrodes, or one or more plate electrodes comprise an active material selected from the group consisting of: lithium, a lithium metal oxide; a lithium alloy, lithium-aluminum, lithium-tin, lithium-magnesium, lithium-lead, lithium-zinc and lithium-boron; an alkali metal, Na, K, Rb and Cs; lithium metal alloyed with one or more of Ca, Mg, Sn, Ag, Zn, Bi, Al, Cd, Ga, In and Sb; an alkaline earth metal, Be, Mg, Ca, Sr, Ba and alloys thereof; Zn, an alloy of Zn; Al, an alloy of Al; Fe, an alloy of Fe; Ni, an alloy of Ni; copper, an alloy of copper; Si, an alloy of Si; Sn, an alloy of Sn; carbon, graphite, nanocarbon, graphene; Pb, an alloy of Pb; lithium metal oxide; lithium metal phosphate; LiFePO₄, LiCoO₂, LiMn₂O₄; FeO, Vanadium pentoxide, bromine; Sulfur; an alkaline cathode, an alkaline anode, a lithium ion based anode, a lithium ion based cathode; any oxides of these, any solutions of these, any solutions of oxides of these, any solutions containing suspended particles of these; and any combination thereof.

38. (canceled)

39. (canceled)

40. (canceled)

41. (canceled)

42. (canceled)

43. (canceled)

44. The electrochemical cell of claim 1, wherein each aperture of said plate electrodes has a cross sectional dimension independently selected from the range of 10 nm to 100 mm; or wherein each solid rod electrode has a cross sectional dimension independently selected from the range of 100 nm to 100 mm; or wherein each porous rod electrode has a cross sectional dimension independently selected from the range of 10 nm to 100 mm.

45. (canceled)

46. (canceled)

47. The electrochemical cell of claim 1, wherein each porous rod electrode comprises a hollow cavity surrounded by a porous electrode material and wherein each hollow cavity within each porous rod electrode has a cross sectional dimension independently selected from the range of 10 nm to 10 mm.

48. (canceled)

49. The electrochemical cell of claim 1, further comprising a flowable ion-storing redox composition provided within at least a portion of said porous rod electrodes, said plate electrodes, or any combination of these; where said flowable ion-storing redox composition undergoes an electrochemical reaction at said porous rod electrodes, said plate electrodes, or any combination of these during charge or discharge of the electrochemical cell.

50. The electrochemical cell of claim 47, wherein said flowable ion-storing redox composition comprises an oxygen containing gas or liquid; water; air; a flow of particles of redox couple in an aqueous or aprotic solution; ironcyanide in water; a flow of semisolid active materials or LiFePO₄ in a fluid electrolyte or PC or DMC or EC or DMF or Ethers; or wherein said flowable ion-storing redox composition comprises at least one compound selected from a ketone; a diketone; a triether; a compound containing 1 nitrogen and 1 oxygen atom; a compound containing 1 nitrogen and 2 oxygen atoms; a compound containing 2 nitrogen atoms and 1 oxygen atom; a phosphorous containing compound, and/or fluorinated, nitrile, and perfluorinated derivatives.

51. (canceled)

52. (canceled)

53. (canceled)

54. (canceled)

55. (canceled)

56. (canceled)

57. The electrochemical cell of claim 1, wherein the at least one electrolyte comprises a first electrolyte surrounding each solid rod electrode and a second electrolyte surrounding the porous rod electrodes, the plate electrodes or any combination of these.

58. (canceled)

59. The electrochemical cell of claim 57, wherein each of the first electrolyte and the second electrolyte is independently a solid electrolyte, a polymer electrolyte, a gel electrolyte or a liquid electrolyte or wherein each of the first electrolyte and the second electrolyte independently comprises one or more materials selected from the group consisting of: an aqueous solution; an organic solvent; a lithium salt; sulfuric acid; potassium hydroxide; an ionic liquid; a solid electrolyte; a polymer; poly(ethylene oxide); poly(propylene oxide); poly(styrene); poly(imide); poly(amine); poly(acrylonitrile); poly(vinylidene fluoride); polyacryonitrile, poly(vinyl chloride), poly(vinyl sulfone), poly(ethylene glycol diacrylate), poly(vinyidene fluoride), poly(tetrahydrofuran), poly(dioxolane), poly(ethylane oxide), poly(propylene oxide), poly(vinyl pyrrolidinoe); EC, PC, DME, DMC, LiClO₄, methoxyethoxyethoxy phosphazine; diiodomethane; 1, 3-diiodopropane; N,N-dimethylformamide; imethypropylene urea; ethylene carbonate; diethylene carbonate; dimethyl carbonate; propylene carbonate; a block copolymer lithium electrolyte doped with a lithium salt; glass; glass doped with at least one of LiI, LiF, LiCl, Li₂O—B₂O₃—Bi₂O₃, Li₂O—B₂O₃—P₂O₅ and Li₂OB₂O₃; a sol of at least one oxide of Si, B, P, Ti, Zr, Bb and Bi; a sol of at least one hydroxide of Si, B, B, Ti, Zr, Pb and Bi; a gel of at least one oxide of Si, B, P, Ti, Zr, Bb and Bi; a gel of at least one hydroxide of Si, B, B, Ti, Zr, Pb and Bi; LiClO₄, LiBF₄, LiAsF₆, LiCF₃, SO₃, LiPF₆, and LiN(SO₂CF₃)₂; salts of Mg(ClO₄)₂, Zn(ClO₄)₂, LiAlCl₄, and Ca(ClO₄)₂; solids of phosphorous based glass, oxide based glass, oxide sulfide based glass, selenide glass, gallium based glass, germanium based glass, sodium and lithium betaalumina, glass ceramic alkali metal ion conductors, Nasiglass; a polycrystalline ceramic of LISICON, NASICON, Li_{0.3}La_{0.7}TiO₃, sodium and lithium beta alumina; LISICON polycrystalline ceramics of lithium metal phosphates, LiTi₂(PO₄)₃; composite reaction products of alkali metal with Cu₃N, L₃N, Li₃P, LiI, LiF, LiBr, LiCl and LiPON; amides, amines, nitriles, organophosphorous solvents, and organasulfur solvents, N,N-dimethylformamide (DMF), N,N-dimethylacetamide (DMAC), dimethylsulfoxide (DMSO), hexamethylphosphoramide (HMPA), acetonitrile (AN) alcohols, dials and liquid polyols, diol, ethylene glycol, ethers, glymes, carbonates, g-butyrolactone (GBL), PEO, PVDF, KOH, NaOH, LiOH, LIPON, Sulfuric Acid, Nafion and any combination of these.

60. (canceled)

61. The electrochemical cell of claim 1, further comprising one or more semi-permeable layers, wherein each semi-permeable layer is positioned to surround at least one porous rod electrode, is positioned to surround at least one solid rod electrode, is positioned to surround at least one porous plate electrode, is positioned to surround at least one solid plate electrode, or is positioned inside at least one aperture of said plate electrodes, or is positioned on one or more sides of the cell.

62. (canceled)

63. (canceled)

64. (canceled)

65. (canceled)

66. (canceled)

67. (canceled)

68. The electrochemical cell of claim 1, further comprising a plurality of ion conducting layers, wherein each ion conducting layer surrounds a solid rod electrode or a porous rod electrode or a plate electrode or one or more ion conducting layers surrounding walls of one or more apertures of the plate electrodes.

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. The electrochemical cell of claim 1, wherein the electrochemical cell comprises a metal-air battery, a lithium-air battery, a zinc-air battery, or a lithium-water battery.

86. (canceled)

87. (canceled)

88. (canceled)

89. The electrochemical cell of claim 1, wherein at least one electrode comprises electrode-active material comprising an insoluble flowable semi-solid or condensed liquid ion-storing redox composition or redox compound which is capable of taking up or releasing said ions and remains insoluble during operation of the cell

90. (canceled)

91. The electrochemical cell of claim 1, wherein each rod electrode is a positive rod electrode; or wherein each rod electrode is a negative rod electrode; or wherein each plate electrode is a positive plate electrode; or wherein each plate electrode is a negative plate electrode.

92. (canceled)

93. (canceled)

94. (canceled)

95. The electrochemical cell of claim 1, wherein one or more rod electrodes are positive rod electrodes and wherein one or more rod electrodes are negative rod electrodes; or wherein one or more plate electrodes are positive plate electrodes and wherein one or more plate electrodes are negative plate electrodes.

96. (canceled)

97. An electrochemical cell comprising:
a plurality of plate electrodes, wherein each plate electrode includes an array of apertures, wherein the plate electrodes are arranged in a substantially parallel orientation such that the each aperture of an individual plate electrode is aligned along an independent plate alignment axis passing through an aperture of each of the other plate electrodes;
a plurality of rod electrodes, wherein the plurality of rod electrodes are arranged such that each rod electrode extends a length along an alignment axis passing through an aperture of each plate electrode; and
at least one electrolyte provided between said plate electrodes and said rod electrodes, wherein said electrolyte is capable of conducting charge carriers;
wherein at least one of said plate electrodes, at least one of said rod electrodes or both at least one of said plate electrodes and at least one of said rod electrodes each independently comprise a porous material for flowing a flowable ion-storing redox composition, wherein a first surface area includes a cumulative surface area of the plurality of plate electrodes, wherein a second surface area includes a cumulative surface area of each aperture array and wherein a third surface area includes a cumulative surface area of each of the plurality of rod electrodes.

98-159. (canceled)
